(19) United States
(12) Patent Application Publication
(10) Pub. No.: US 2010/0318511 A1
(43) Pub. Date: Dec. 16, 2010

(54) Techniques for connectors in a system for collaborative work

(75) Inventors: Nhat Phan, Canton, MA (US); Kevin Kelley, Wakefield, MA (US); Gideon Moran, Westford, MA (US); Hung Phan, Dorchester, MA (US); Stuart Rudolph, Winchester, MA (US)

Correspondence Address: Patent GC LLC;c/o CPA Global, P.O. Box 52050, Minneapolis, MN, 55402, US

(73) Assignee: VirtualAgility

(21) Appl. No.: 12/770,129

(22) Filed: Apr. 29, 2010

Related U.S. Application Data
(63) Continuation-in-part of application No. PCT/US2009/036804, filed on Mar. 11, 2009.
Application No. PCT/US2009/036804 is a continuation-in-part of application No. 11/939,250, filed on Nov. 13, 2007.
(60) Provisional application No. 61/174,486, filed on Apr. 30, 2009.

(51) Int. Cl. G06F 17/30

(52) U.S. Cl. 707/722; 707/769; 707/E17.014

(57) ABSTRACT

Improved techniques for using connectors in a system for collaborative work for users unskilled in data processing techniques, including UI techniques. Data may be augmented by associating a connector query to obtain additional data and the data viewed in a “drill down” fashion, or by associating an additional resource for entering additional data by clicking on a link: the additional resource is created as needed and is a full-fledged resource of the system. A number of other connector queries may be combined into a single query that composes them, and information from different information sources may be combined easily, such as to make the form consistent; the information may also be transformed in a complex fashion. An alternative source for an information result may be used by a connector query to optimize performance, such as a cached result. A connector may be used to obtain information from resources created by other users within the system, and a connector may be used to obtain information from the resource in which it is used.

### CROSS-REFERENCE TO RELATED APPLICATIONS

This application claims priority from co-pending U.S. provisional patent application Ser. No. 61/174,486, entitled, “Workspace connectors, query composer connectors and resources that augment query results with other data,” filed on Apr. 30, 2009.
The present application has inventors and an assignee in common and is a Continuation-In-Part of, and claims priority to co-pending application PCT/US2009/036804, Kelley et al, “Techniques for Integrating Parameterized Information Requests into a System for Collaborative Work”, filed Mar. 11, 2009 (PCT/US2009/036804 henceforth “Connector application”).
USN PCT/US2009/036804 is a Continuation-In-Part of, and claims priority from co-pending application U.S. Ser. No. 11/939,250, Ahlgren, et al, “System for supporting collaborative activity”, filed 13 Nov. 2007) (U.S. Ser. No. 11/939,250 henceforth “Collaboration application”), which further claims priority from U.S. provisional patent application 61/036,489, Rudolph et al, “System for Delivery of External Data to Support Collaborative Activity, filed 11 Mar. 2008.

The present application hereby incorporates each of these patent applications by reference for all purposes.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

1. Field of the Invention

This invention relates to systems for improving communication among people who are collaborating in the performance of a task.

2. New material

The present application claims priority to co-pending U.S. provisional application Ser. No. 61/174,486, entitled, “Workspace connectors, query composer connectors and resources that augment query results with other data,” filed on Apr. 30, 2009 and has inventors and an assignee in common and is a Continuation-In-Part of co-pending application PCT/US2009/036804, Kelley et al, “Techniques for Integrating Parameterized Information Requests into a System for Collaborative Work”, filed Mar. 11, 2009 (henceforth “Connector application”). The new material may be found at the following locations' in the present application:
The portion Background Concerning Improved Techniques for connectors in a system for collaborative work in the section BACKGROUND OF THE INVENTION.
The section BRIEF SUMMARY OF THE INVENTION
The portion Improvements to Techniques for Connectors in the section DETAILED DESCRIPTION, and
Starting at FIG. 51 in the figures.

The Connector application is a Continuation-In-Part of co-pending application U.S. Ser. No. 11/939,250, Ahlgren, et al, “System for supporting collaborative activity”, filed 13 Nov. 2007, U.S. Ser. No. 11/939,250 (henceforth “Collaboration application”). The new material of the Connector application with respect the Collaboration application may be found at the following locations in the present application:
the portion Background concerning Parameterized Information Requests in the section BACKGROUND OF THE INVENTION.
the portion Connectors in the section DETAILED DESCRIPTION, and
starting at FIG. 35 in the figures and ending with FIG. 50

3. Description of Related Art

Computers coupled to networks have made collaborative work easier than ever before. At the most fundamental level, file sharing and email have eliminated the requirement that collaborators be in physical proximity to each other. The change tracking arrangements that are provided by most document processing systems further support collaborative work, as do computer-implemented scheduling and tracking systems. Integrated systems for collaborative work provide features such as file sharing, email, change tracking, scheduling, and tracking in a single package. A problem with these tools and integrated systems for collaborative work is that they are very general. It is up to the user to adapt them to his or her needs. To be sure, a skilled user of a tool such as a spreadsheet can adapt the tool to almost any purpose, but to do this, extensive programming is required. Such programming requires a specialist, and the result of the programming is often opaque to those who are not masters of the tool and of what is being represented. Indeed, a general problem with tools that require extensive programming to adapt them to a user's needs is that the programming is usually done by a specialist who understands the tools or the system, but not the nature of the collaboration, and as is usual in such situations, communication between the programming specialist and the users is usually difficult and sometimes impossible.

Another approach to collaborative work has been systems that are specialized for collaborative work in a particular special area, such as bookkeeping. For example, the Quickbooks small business accounting software provides a model of a small business as seen from the point of view of an accountant that the user of Quickbooks can customize for his or her own purposes. While the model of the small business that Quickbooks provides is very useful for accounting, it has no relevance whatever to other aspects of the business.

Another approach is described in U.S. patent application Ser. No. 10/765,424 ('424 application). FIG. 34 shows a diagram of a model 4101 as described in the '424 application. A number of collaborators 4005 (1 . . . n) are organized into one or more collaborator groups 4003 (1 . . . m). A collaborator 4005 may belong to more than one group 4003. The context in which the collaborators 4005 work is represented by a domain hierarchies 4009 (1 . . . k), goal-project hierarchies 4011 (1 . . . m), and initiative hierarchies 4109 (1 . . . o).

Each goal-project hierarchy 4011 has at its head a project or a goal. A goal may have other goals and projects 4015 as its children. A project 4015 may have other projects as its children, but may not have a goal as a child. Any goal, project, domain, or initiative may have one or more items of information 4017 associated with it, as indicated by arrows 4105. The information may include documents, messages, discussions, reminders, Web links, and alerts. The ability to relate information 4017 directly to any kind of hierarchy entity is particularly useful when the information is global to the entire domain or initiative.

An initiative 4109 is not a member of any domain hierarchy 4010 or goal-project hierarchy 4011, but is rather the root of an initiative hierarchy 4111 which may include sub-initiatives and a single level of goals and/or projects from any of the goal-project hierarchies. A goal or project may belong to any number of initiatives. Information may be related to an initiative in the same way that it may be related to any hierarchy entity.

Access to domains, goals, and projects is by collaborator groups 4003. A given collaborator group 4003(i) may have access to any combination of domains, goals, projects, and initiatives in model 4101. The kinds of access which a collaborator belonging to a particular group has to a particular domain, goal, project, or initiative depend on the group's group type and the permissions which the group has for the particular domain, goal, project, or initiative.

Collaborators with the proper permissions may modify not only the information 4017 associated with a goal, project, domain, or initiative, but may also modify the form of the respective hierarchy.

A limitation of the model 4101 is that it provides only one view of the hierarchies' structure. This limits the usefulness of the model to more complex processes or organizations, where multiple views of the hierarchies would be helpful.

### Background Concerning Parameterized Information Requests

The system of the Collaboration application, while providing access to a number of information sources in useful ways, did not support information sources that respond to parameterized information requests. For example, it did not provide access to relational database management systems (RDBMS). The complexity of supporting parameterized information requests is illustrated in FIG. 35 for an example RDBMS system:
3500 shows the request parameter for a parameterized information request for this information source. The request parameter for this information source must be expressed in a dialect of the SQL query language.
3550 shows the data text of the information response, after special programming has converted it from the on-the-wire format for this particular information source.

The example in FIG. 35 is for an RDBMS information source that provides information about security incidents. The request parameter at 3500 requests a list of recent security incidents and information about them. The response is a list of incidents and information as specified in the request parameter

Neither of the examples of FIG. 35 is understandable to general users

Parameterized information requests are an important feature of a system for information sharing and collaborative work:
Parameterized information requests allow a client of an information source to request specifically desired information.
Many information sources require support for parameterized information requests: they provide information only as a response to such requests in proper form.

The difficulty with supporting parameterized information requests is that they are complex. They involve special programming at multiple levels, special languages for specifying what is requested, and special expertise.

For a system supporting real-time collaborative work, it is also important that appropriate users of the system can add new information sources and new parameterized information requests to the system quickly and with minimal difficulty.

There are many information sources that provide information in response to parameterized information requests. For example, an information source with real-time information about hospitals may be able to provide many kinds of information, such as the number of emergency-patient beds currently available in hospitals near a certain location. An information source about the weather may be able to provide many kinds of current information about weather conditions and weather forecasts for different locales on different days.

However, these systems provide the information only in response to parameterized information requests, in the form for the particular information source, that specify what information is requested.

The technical aspects of supporting parameterized information requests are a barrier to and a limitation on their use. There are difficulties and burdens associated with parameterized information request at several levels.

One burden is the need to have an appropriate user interface for requesting and presenting particular information from particular information sources as needed by the user. The user interface must provide support for parameterized information requests in a fashion that is not difficult for a general user.

Another burden is that query request parameters often must be expressed in a special query language. The example of 3500 uses a dialect of the SQL language.

However, many languages for query request parameters exist: while SQL is used for many RDBMS information sources, SQL is implemented in a number of dialects by different vendors. Another relevant language standard is SOAP, which involves the complex language XML. The ISO 8583 standard describes yet another such language for financial information, and the OCSP standard describes yet another language for computer security status. Many information sources involve yet other languages, and a language may even be unique to the particular information source.

General users of collaborative systems will not have expertise in these languages. Even for users who have some expertise in one particular language, the languages can be complex and awkward to use, and interfere with the tasks of real-time collaboration and information sharing.

A further barrier is that accessing multiple information sources generally requires expertise in multiple different programming systems, as different information sources are programmed differently. A further barrier is that different kinds of information sources must be accessed by different programming protocols and interfaces.

For example, Relational data base systems require programming according to JDBC Java classes, or another programming interface. Many information sources implemented as web services require programming according to SOAP method calls or other programming standards. Information sources implemented according to IBM's ESB Enterprise Service Bus require yet different programming. Yet other information sources require specialized programming unique to the particular source. There is also considerable variation in the programming for authentication, encryption, network protocols, and other aspects of the necessary programming, even for systems of the same kind.

It is thus an object of the invention of the Connector application to overcome these limitations and to provide a system for collaborative work that permits collaborators to make parameterized information requests.

### Background Concerning Improved Techniques for Connectors in a System for Collaborative Work

Experience with an embodiment of the system of the Connector application (in the following, the embodiment may be referred to as “system of the Connector application” or “system” for ease of reading) showed that while the system provided powerful capabilities for collaborative work beyond that of the prior art, such as for accessing single external information sources, there were a number of limitations, including the following:

Experience with an embodiment of the system of the Connector application has shown that users at times needed a sufficiently convenient way to define resources that access data defined by other users in other user-defined resources of the system. This can be referred to in the present context as a need for accessing local resources or Workcenter resources of the system.

In the system of the Connector application, a JDBC-type of connector could, in principle, be defined to obtain the desired information from the relational database management system (RDBMS) in which part of the system was implemented, provided the RDBMS permitted or was modified to permit access to its internal tables.

However, this would be overly complex and awkward in many ways, for example: for every such connector query, defining a connector query to access data of a local resource required knowledge of the particular information structures of the tables in which the system was implemented; special expertise in the SQL language was required for any user defining such a query, and in the particular SQL dialect used in the implementation of the system with the RDBMS; the necessary access to the tables of the RDBMS raised significant security concerns and complications both with regards to opening access to the internal tables of the RDBMS, and to defining and maintaining appropriate security permissions via the internal security features of the RDBMS; and further, all such connector queries that may have been defined by different users at different times were at risk of failing, or having to be changed, whenever a change was made to the implementation of the system in RDBMS.

Experience with the system of the Connector application also showed that there often exists a need to combine easily information from separate external systems and organization, and further to combine information when the information sources return information with different structures. For example, in structured data obtained from two different systems, the field names may be different in the two systems, and one system may have some fields that the other does not, or information may need to be combined in complex fashions. There was also a need for a convenient way to obtain information from more than one information source in single parameterized information request. These needs are referred to in this present context as a need for information merging.

Previous solutions for information merging entailed considerable complexity, for example by requiring implementation a specialized component to merge information from specific systems, such as an SQL-connector, from two organizations that each have information sources for staff members working in a task-group for an emergency incident, but the two sources have different field names for the same information. In addition, one source may have some information the other does not (e.g. personal cell phone numbers), information that may be considered to be the same in a given context may be represented differently, the two information sources may be accessed using different protocols (e.g. JDBC/SQL versus SOAP), and may return data in different formats (e.g. in an XML format, and in a format of an SQL ResultSet). Creating such specialized components for a multitude of cases and uses would be burdensome and complex.

In addition, experience with the system of the Connector application showed that users at times need to access information of a current resource, such as values of data fields of the resource in order to combine it with other information, and the embodiment of the Connector application system did not provide an easy way for a user to accomplish this.

For example, a resource might contain a data field whose value is a street address, and a a connector field that obtains other geographic information to display on a map, and it is desired to display location icons on the map both for the other geographic information and for the street address. In principle, it would have been possible in an embodiment of the system of the Connector application to obtain information of the current resource with a specially-constructed query of a JDBC-type connector to access tables of the RDBMS system in which part of the embodiment was implemented. However, this would present many problems: for example, it would have been exceedingly complex for users to accomplish, and raised substantial concerns about security of accessing the RDBMS, as well as about maintainability of any such specially-constructed queries if the RDBMS implementation of the embodiment were altered in any way. Other solutions of the prior art were also problematically complex.

Further experience with an embodiment of the system of the Connector application showed that there was a need for a more a convenient way for a user to improve the performance of applications by allowing a connector to obtain results from a source other than the information source of the connector, in cases where this would be appropriate.

For example, in a number of cases, it would be known that the cost of performing a connector's query would be expensive in terms such as time or money (in the case of a pay-for-service information source), and also known that the information result obtained under certain conditions would be substantially the same as an information result previously obtained from the information source: it would therefore be useful to store previously obtained information results within the system for subsequent re-use when a previous result would be acceptable for use as the result of a parameterized information request. In the present context, this may be referred to as a need for improved techniques for a user to specify and the system to employ an alternative source for a connector's query's information result.

It was also found from experience with the system of the Connector application that there was a need for a sufficiently convenient way for a user to define a resource that made it easy for a user to add information in context to a portion of the resource, and also to make the additional information available for other users as a full-fledged resource of the system. Further, it was found that there was a need for a sufficiently convenient way for a user to make it possible for other users easily to see additional information related to a portion of a resource in a “drill down” fashion. In the present context, these are referred to as a need for improved techniques for data augmentation.

In the system of the Connector application, it was at possible to define a resource with greater amounts of information and correspondingly more UI information elements, but this was found to be insufficiently flexible, and to lead to difficulties such as resources with complex and large UIs with many information elements that were awkward to use.

What is desired is a system that overcomes each of these and other limitations by providing new and improved techniques for connectors and for the use of connectors in a system for collaborative work.

### BRIEF SUMMARY OF THE INVENTION

In the system of the Connector application, there was only one general kind of connector: a connector that represents a query to an external information source. There was more than one type of these external connectors: for example, for external information sources that employed the JDBC protocol, that employed the ESB protocol, and that employed the Web Services SOAP protocol.

In the system of the present application, there are additional types of connectors. The additional types that have been added include the following:
A local resource connector, also termed a WorkCenter resource connector, is a connector that represents a query on the relational database system in which much of the information used by the system is stored, and obtains information of a number of resources of the system defined by users, the resources being determined by the query.
A current resource connector is a connector that represents a query on the relational database system in which information used by the present system is stored, and obtains information of the resource that is the current resource in which the connector query is being used.
A query composer connector is a connector that combines queries belonging to already-existing connector objects.

Other useful additions have also been made to the connectors to the system of the Connector application, including:
Techniques for defining an alternative source for obtaining information instead obtaining the information of from the information source of the connector query permits the performance of a system to be improved easily in useful ways. For example, in one embodiment, a caching of query responses to connector queries permits stored results of previously-performed connector queries to be used as an alternative source.

Further improvements include data augmentation and information merging.
Data augmentation is a technique by which an additional resource or additional information is easily associated with a portion of a first resource, permitting data of the first resource to be augmented with additional data.
Information merging is a technique whereby information from different information sources can be combined easily. In one embodiment, it permits information from different information sources to be transformed to a consistent form. In another embodiment, information from different information sources is combined in other useful ways. One embodiment of information merging employs the techniques of query composer connectors with a transformation component.

A readily-apparent advantage of the techniques of the present invention is that the various techniques may be used in combination and in conjunction.

Other objects and advantages will be apparent to those skilled in the arts to which the invention pertains upon perusal of the following Detailed Description and drawing, wherein:

### BRIEF DESCRIPTION OF THE SEVERAL VIEWS OF THE DRAWINGS

FIG. 1 provides an overview of the system 101 for supporting collaborative activity.

FIG. 2 illustrates a user's access to workspaces.

FIGS. 3A and 3B show the tables that are relevant to the implementation of the system.

FIGS. 4A-4K show more detailed views of entity-relationship diagrams for select groups of tables.

FIG. 5 illustrates the setup of the logo for the application.

FIGS. 6A-6C illustrate the set up of companies that will be sharing the navigation GUI.

FIGS. 7-8C illustrate the set up of resources.

FIGS. 9A-9E illustrate the set up of workspaces.

FIGS. 10A-10F illustrate the set up of users.

FIGS. 11A-12 illustrate a login by a user.

FIG. 13 illustrates an overview screen of a default workspace.

FIG. 14 shows an isolated view of the default workspace screen.

FIGS. 15A-15B show isolated views of the navigator 1302.

FIGS. 16A-16D show views of the agency information.

FIGS. 17A-17C show the creation of a resource.

FIGS. 18A-18D show the set up of discussion topics for a resource.

FIGS. 19A-191 show the set up of links for a resource.

FIGS. 20A-20F show the set up of RSS feeds for a resource.

FIGS. 21A-21F show the set up of text documents for a workspace.

FIGS. 22A-22F show the adding of a document to the workspace.

FIGS. 22G-221 show the updating of a resource.

FIG. 23A illustrates a message window.

FIGS. 23B-23C show the importing of resources for a workspace.

FIGS. 24A-24E show the set up of knowledge boards.

FIGS. 25A-25F show the set up of an operation.

FIG. 26 shows a search results screen.

FIG. 27A shows how a user enters the message center.

FIG. 27B shows the refreshing of the message center.

FIG. 28 shows the set up of alerts.

FIGS. 29A-29F show the set up of messages.

FIG. 30 shows the set up of permissions.

FIGS. 31A-31C illustrate the set up of user's personal preferences and password:

FIG. 32 shows the display a map option.

FIG. 33A shows a system managers screen.

FIG. 33B shows the set up of the document manager.

FIG. 33C shows the set up of the security manager.

FIG. 33D shows the set up of the encryption manager.

FIG. 33E shows the set up of the mapping manager.

FIG. 33F shows the set up of the email manager.

FIG. 33G shows the set up of the search manager.

FIG. 34 shows a diagram of a prior art collaboration model.

FIG. 35 shows examples for programming a parameterized information request and the response from an information source to that request.

FIG. 36 shows an example of the GUI for connectors.

FIG. 37 shows an example of the GUI for specifying a parameterized information request for a connector

FIG. 38 shows a system of the Collaboration application in which an embodiment of the invention of the Connector application has been implemented.

FIG. 39 shows tables used to represent connectors in an embodiment of the invention of the Connector application.

FIG. 40 shows how connectors relate to the system of the Collaboration application.

FIG. 41 shows additions to the tables of figures FIG. 4D and FIG. 4G of the Collaboration application.

FIG. 42 shows an example of an XSL document that may be used with the system of the Connector application.

FIG. 43 shows an example of the GUI for viewing and editing the specification of a connector.

FIG. 44 shows details of the GUI for specifying a connector.

FIG. 45 shows details of the GUI for specifying a query request parameter for a connector.

FIG. 46 shows an example of the GUI for uploading and using an XSL document file.

FIG. 47 shows an example of saving a specification to an export/import file.

FIG. 48 shows the GUI for specifying a connector field in a template.

FIG. 49 shows further details of the GUI for specifying a connector field in a resource template.

FIG. 50 shows an example of the GUI for specifying bind parameters in a resource.

FIG. 51 shows two parts of a UI to define a WorkCenter resource connector.

FIG. 52 shows a view of a UI for a definition of a WorkCenter resource connector.

FIG. 53 shows a first part of a UI for the definition of a template using a WorkCenter connector.

FIG. 54 shows two UI views relating to the definition of a query for a WorkCenter resource connector.

FIG. 55 shows two UI view of an embodiment for defining bindings for a WorkCenter resource connector query at a template level.

FIG. 56 shows a view of a UI for definition a resource using a template associated, with a WorkCenter resource connector.

FIG. 57 shows UI views of two of several exemplary resources.

FIG. 58 shows a UI view of a resource associated with a WorkCenter resource connector.

FIG. 59 shows two parts of a UI for a user to define a current resource connector.

FIG. 60 shows a view of a UI for the definition of a current resource connector.

FIG. 61 shows two view of parts of a UI for defining a connector query for a current resource connector.

FIG. 62 shows a UI for the definition of a template using a current resource connector.

FIG. 63 shows a UI view of a resource of a template associated with a current resource connector.

FIG. 64 shows a data view of an information result returned by a current resource connector.

FIG. 65 shows an exemplary XSL script for processing information obtained by a current resource connector.

FIG. 66 shows a general block diagram for an embodiment of information merging.

FIG. 67 shows a block diagram for an embodiment of information merging employing connectors.

FIG. 68 shows two screenshots of a use of information merging in an embodiment.

FIG. 69 shows an example of use of an embodiment of information merging.

FIG. 70 shows a UI for the definition of a template in a use of information merging.

FIG. 71 shows screenshots of two part of a UI for the definition of a field in a use of information merging.

FIG. 72 shows a screenshot of a third part of the UI of FIG. 71.

FIG. 73 shows a screenshot of the UI of a connector in a use of information merging.

FIG. 74 shows a screenshot for the definition of a connector query in a use of information merging.

FIG. 75 shows a screenshot of a further part of the UI of FIG. 74.

FIG. 76 shows a screenshot for the definition of a connector in a use of information merging.

FIG. 77 shows a first part of a screenshot of a UI for the definition of a connector query of FIG. 76.

FIG. 78 shows a screenshot of a further part of a UI for defining query bindings in a use of information merging.

FIG. 79 shows a UI for the definition of a connector in a use of information merging.

FIG. 80 shows a first part of a UI for the definition of a connector query in a use of information merging.

FIG. 81 shows an exemplary embodiment of an SQL query in a use of information merging.

FIG. 82 shows a simplified E-R diagram of tables of an embodiment.

FIG. 83 shows a simplified E-R diagram of further tables of an embodiment.

FIG. 84 shows an exemplary portion of information result information.

FIG. 85 shows a further exemplary portion of information result information.

FIG. 86 shows a first flowchart of a customized script that processes an information result.

FIG. 87 shows a second flowchart of a customized script that processes an information result.

FIG. 88 shows an exemplary excerpt from an XSL script of FIG. 74.

FIG. 89 shows a further excerpt from an XSL script of FIG. 74.

FIG. 90 shows a further excerpt from an XSL script of FIG. 74.

FIG. 91 shows a flowchart of the steps of a connector query caching method.

FIG. 92 shows the operation of clicking on a spyglass icon in an embodiment of data augmentation.

FIG. 93 shows two exemplary URLS of an example of data augmentation.

FIG. 94 shows a UI view illustrating the operations associated with a notebook icon of an example of data augmentation.

FIG. 95 shows two views of a UI of an embodiment for an exemplary notebook icon.

FIG. 96 shows two further views of a UI regarding an exemplary notebook icon.

FIG. 97 shows a simplified E-R diagram of tables of an embodiment.

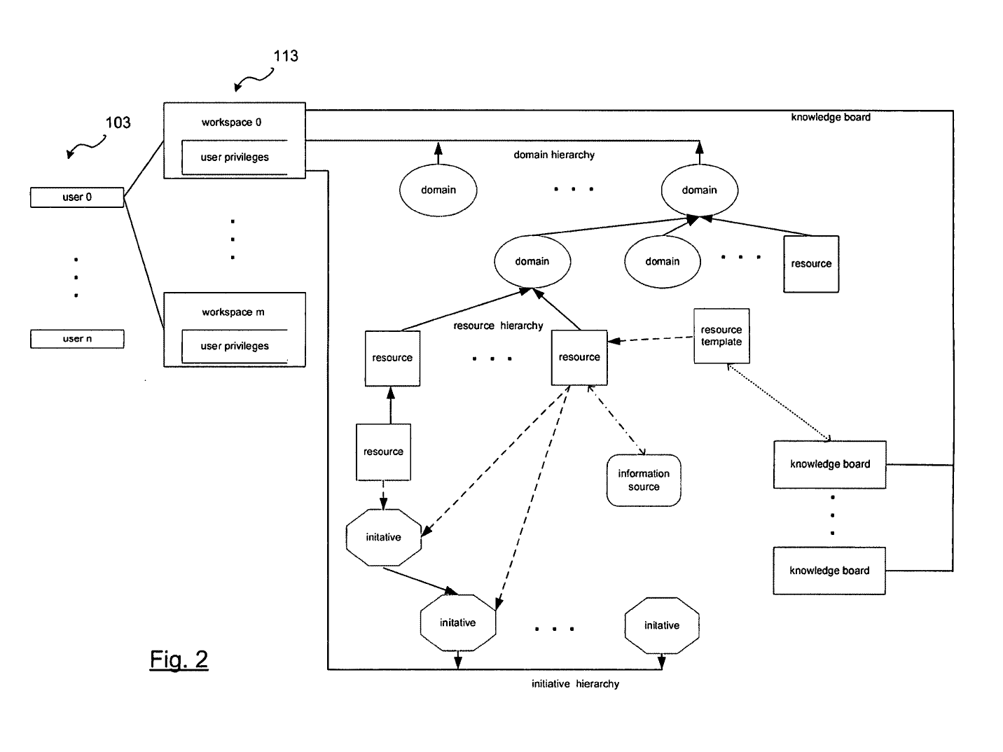

Reference numbers in the drawing have three or more digits: the two right-hand digits are reference numbers in the drawing indicated by the remaining digits. Thus, an item with the reference number 203 appears as item 203 in FIG. 2, and generally this is the first appearance.

### DETAILED DESCRIPTION OF THE INVENTION

The new material of the present application in the Detailed Description begins at the portion entitled Improvements to Techniques for Connectors.

A system for supporting collaborative activity includes a processor and an interface that is provided to collaborators by the processor. The processor has access to a

A. Overview of the System

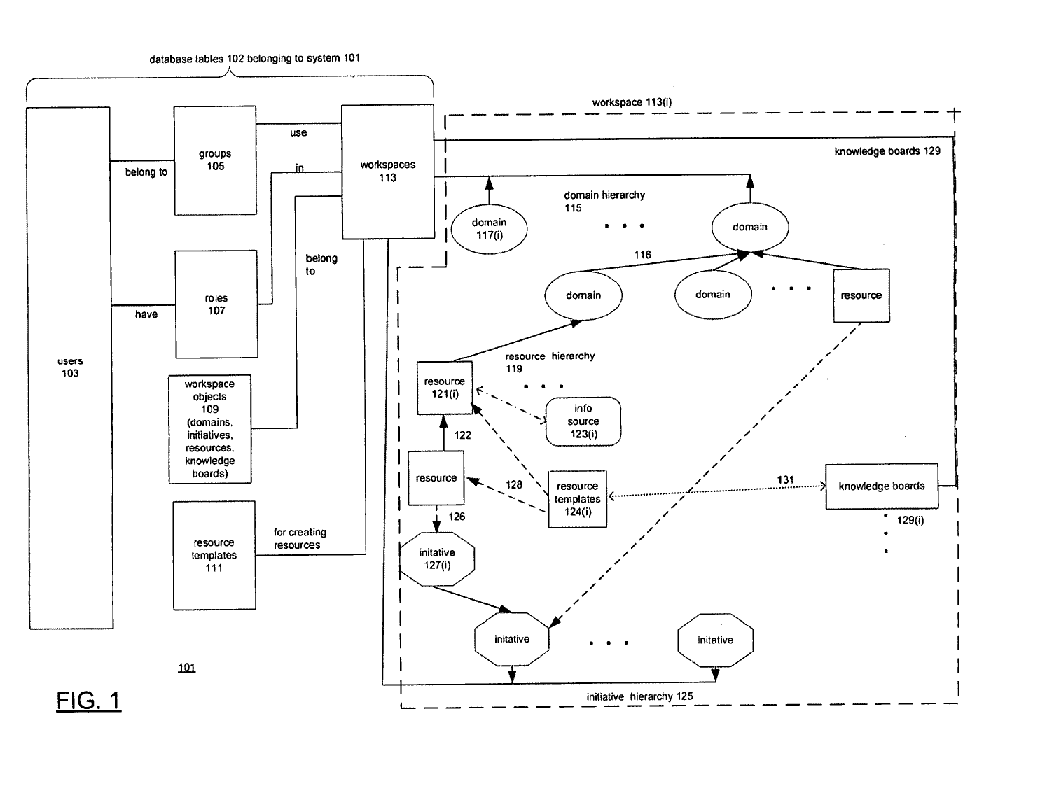

FIG. 1 provides an overview of the system 101 for supporting collaborative activity. The system is scalable to be usable in very large collaborative enterprises. The system contains two types of elements, those that are structural (domains and initiatives) and those that are shareable (resources). Domains 117 represent the organizational structure of the groups coming together in the system. Initiatives 127 represent one or more process structures for how the group or teams accomplish their goals. Domains and initiatives provide two different views of the resource without the need to duplicate the resources. Resources 121 are collections of elements defined by users that give the users access to information sources 123. The individual information sources to which the resource gives access are associated with fields in the resource.

Collaborating users can organize domains 117 and initiatives 127 into hierarchies 115 and 125. A user can associate a resource 121 with a domain, a sub-domain, or another resource associated with a domain. Resources can be presented as many times as required within the initiative, and therefore could be used in multiple scenarios, without the need to be duplicated. The domain and initiatives hierarchies thus provide users with ability to view objects of information (such as resources and/or knowledge boards (described below)) within an organization structure or an operational structure without need to duplicate the objects.

Domains, initiatives, and resources can be renamed by administrators to reflect the terminology used by their organization. For example, a domain can be renamed as an organization or an agency; an initiative can be renamed as an operation or a process; and a resource can be renamed as a record.

Resources may be organized into resource hierarchies, as shown by arrow 122, and the resource hierarchies belong to domains 117, which themselves may be hierarchically organized (115). A resource may have a domain as a parent, but a domain cannot have a resource as a parent. A given resource 121 may belong to only one domain 117. Generally, though not necessarily, the domain hierarchy reflects the organization chart of the collaboration. For example, if the collaboration is a business, there may be domains for manufacturing, engineering, sales, accounting, human resources, and corporate management, with sub-domains within the domains, for example, a sub-domain for hourly employees in human resources.

In addition to being related to a domain, a resource may also be related to an initiative 127. Initiatives may form hierarchies 125. The navigation GUI for system 101 permits the user to navigate to a resource either by means of the domain hierarchy or by means of the initiative hierarchy. Generally, though not necessarily, initiatives are created to deal with specific problems where the resources required to deal with the problem cut across domain lines. For example, if the domains are set up as described in the foregoing example and the business has a quality control problem, an initiative may be set up to deal with the quality control problem and may include resources from the manufacturing, engineering, and corporate management domains. Domains and initiatives thus give participants different perspectives on the resources needed for the collaboration.

Resource templates 124 are global objects that define classes of resources, as defined by a system administrator. They specify what types of information are associated with resources belong to the class defined by the resource template by defining the number and types of data fields associated with them. When a user creates a resource, the user begins with a resource template. The fields of the resource template are filled in by the user when the resource is created or modified, according to the domain or initiative the resource relates to.

In addition to viewing resources within a domain or initiative, the resource template can be used to locate resources belonging to the class that the template defines. This location of resources is defined by users in knowledge boards or dashboards 129. When a user creates a knowledge board, the user uses the resource template to associate resources belonging to the resource template's class with the knowledge board and to select what information from resources of the class will be displayed in the knowledge board. The relationship between the resource template and the resources created from the template are maintained in the system for the knowledge boards. A knowledge board is defined for a workspace but does not belong to any of the hierarchies. The navigation GUI lists the workspace's knowledge boards along with both the initiative and domain hierarchies. The users select the columns (data fields) in the resource template to display and filter by parameters, such as specific text, dates, etc. These data fields are used to locate resources to which the template belongs and are then displayed in the knowledge board report in a table form.

The domains, initiatives, and resources are organized into a plurality of workspaces, each of which provides a managed environment. The system gives each collaborator/user access to one or more workspaces where a user may have different roles in different workspaces. The workspaces may be configured by non-technical people. The components of a workspace include domains 117, resources 121, initiatives 127, information sources 123, and dashboards or knowledge boards 129. These are termed in the following as the workspace's objects. Preferably, the system is implemented in a client-server architecture. The system server stores the workspace and its objects, as well as global objects, such as users and resource templates. The client comprises a processor which ahs access to the system elements. Users access the system's elements through a GUI at the client. Users may have different kinds of access to the objects in a workspace. The workspace includes a navigation GUI as part of the online collaborative software platform that presents the content of its objects. A system administrator can create a unique workspace for a group of people, assign local administration responsibilities, and assign global resources from a global pool of resources. Users can be part of multiple workspaces and carry different access permissions. For example, a specific user can be a user only in one workspace and have administrator rights in another. User access permissions are described further below.

In an exemplary embodiment, information sources that can be related with a resource include documents, text files, links, RSS (Really Simple Syndication) feeds, and discussions. For documents already created and stored locally, a user can select from his workstation or from any shared drive a document to add to a resource. The document is then physically copied and loaded into the system server and will reside on its file directory system. All documents loaded on the system are maintained for the life of the system. This enables users to upload and store documents relevant to the resource. To modify the document after its association with the resource, a user “checks out” the document and downloads it from the server to the client for editing. When the editing's done, the user uploads the modified document from the client to the server.

The system also provides a simple text editor at a client of the system with which a user can create and upload a text file of the .txt type to the system server. This enables users to create a free format text file that can be created, uploaded, and opened by users without the need for a word processing application.

The system provides users the ability to relate links to the resource. Links provide quick access to information or tools. The link can be an external link or an internal link. External links provide access to an outside source, utilizing an address like an URL, or a link to a network source, utilizing a link to a shared device. This enables users to link to a shared document or other file types without the need to upload the files to the system. Other users on the network could access the same file without being part of the system. Internal links provide access to other resources within the system. When users want to use a resource that resides in a different structure of the system, they can provide a link that will launch that resource whenever it is called. This provides the flexibility to reuse resources without the need to create special initiatives for aggregation.

The system provides users the ability to relate an RSS feed to the resource. RSS feeds are web feeds in XML format that enable users to receive updated news or information articles through a special reader screen. The ability to provide these connections allow users to create a link that provides new, updated article every time the link is selected and articles are presented.

The system provides users the ability to relate discussions to the resource. Discussions are on-line, asynchronous, threaded chat boards that provide users a place to exchange questions, opinions, and remarks in relation to the resource topic. Users can initiate a discussion in-context to the resource's objective and either receives answers to the discussed topic or reply to a discussion topic started by another user.

FIG. 2 illustrates a user's access to workspaces. Users 103 can be part of multiple workspaces 113 and carry different access permissions or privileges. The access that a given user has to a given object in a given workspace depends on the permissions that the user has to access the object in the workspace and the role that the user has in the workspace. The permissions in an exemplary embodiment are: no permission; read; read-create; read-create-update; read-create-update-delete. Permissions may be assigned to individual users and to groups of users. Group permissions override individual permissions. For example, if an individual user has no access to a given object but belongs to a group that has read-create access, the user will have read-create access as long as he or she is a member of the group. If a user has neither permission as an individual nor permission as a group member to access an object, that object will be invisible to the user.

Actual access to a given object may be limited by the given user's role in the workspace. The workspace roles in an exemplary embodiment are: viewer; user; manager; and administrator. For example, a user who has a viewer role may read but not create, update, or delete objects in the workspace. Consequently, such a user will see only those objects to which the user has some kind of access by virtue either of the user's individual permissions or by virtue of the group permissions of a group to which the user belongs. Because the user has the viewer role, the user will be able to do nothing with the objects to which he or she has access but read them.

Returning to FIG. 1, database tables 102 contain the information used to represent a workspace 113(i) and its components. In an exemplary embodiment, database tables 102 are implemented using a standard commercial database system such as those manufactured by Oracle Corporation™. The tables are shown in FIG. 1 in logical terms. A table of users 103 contains an entry for each user who has access to workspace in system 101. The users who have access to a given workspace are organized into groups in the workspace by a group table 105 and are assigned roles in the workspace by a role table 107.

A workspace table 113 has an entry for each workspace. Associated with the entry for the workspace are the groups that have access to the workspace, the roles these groups have, the resource templates used in the workspace (table 111), and the domains, initiatives, resources, and knowledge boards belonging to the workspace (table 109).

The system provides an internal messaging center to allow quick communication between users or whole groups of users. The message center does not rely on an email server so it can be used even when access to other systems in limited. The message center displays alerts generated by the system 101 and messages to specific users. Users can proactively select important resources within the system and let the system alert them whenever a new resource is added, changed, document are uploaded, links created, and others. This allows users to be selective as for what is important to them to be alerted of and reduce the need for users to send email messages alerting users of updates or changes to information. An email option is available for users who wish to receive the messages and/or the alerts on their email system as well. In this way, users who are away from the system can still be alerted to important information.

The system allows administrators to perform global setup of the navigation GUI. This includes the GUI for the application and the definitions of companies for which the workspaces are created. The system administrator can customize the application's logo, licensing keys, and application level administrative roles and names. The system administrator can define the companies that are sharing the GUI, including names and information of the companies, divisions, and departments.

B. Tables Implementing System

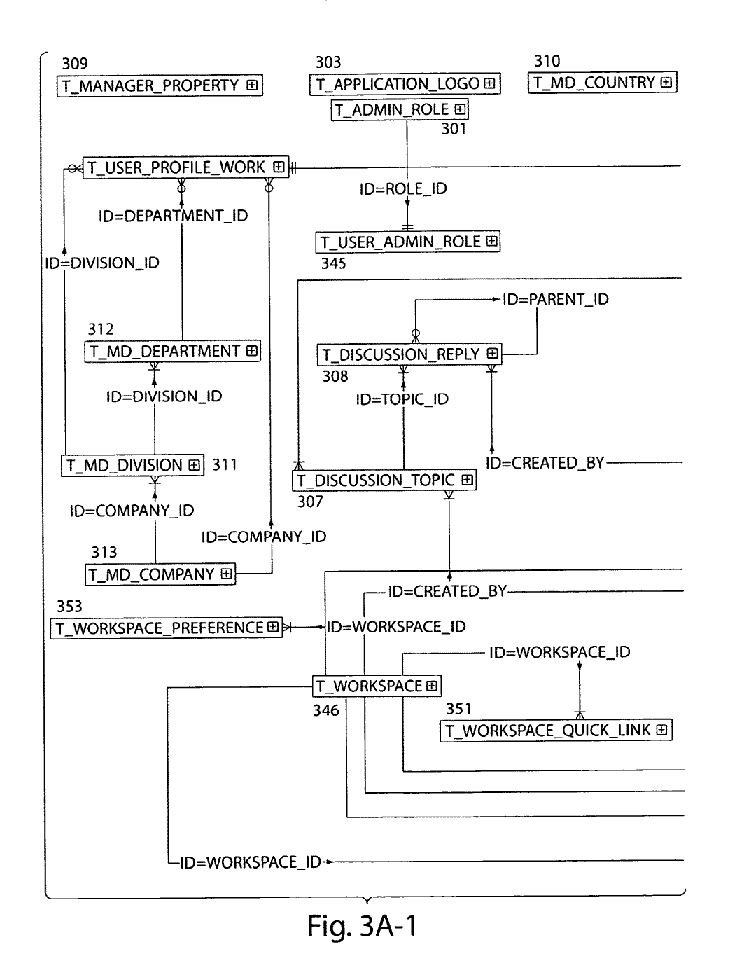

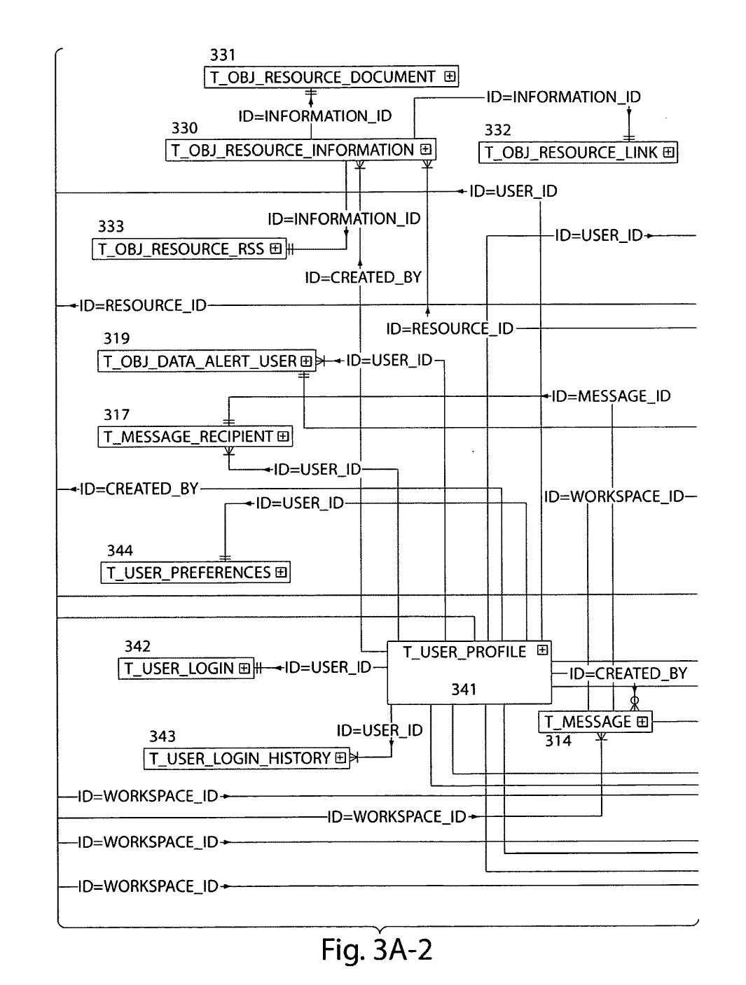

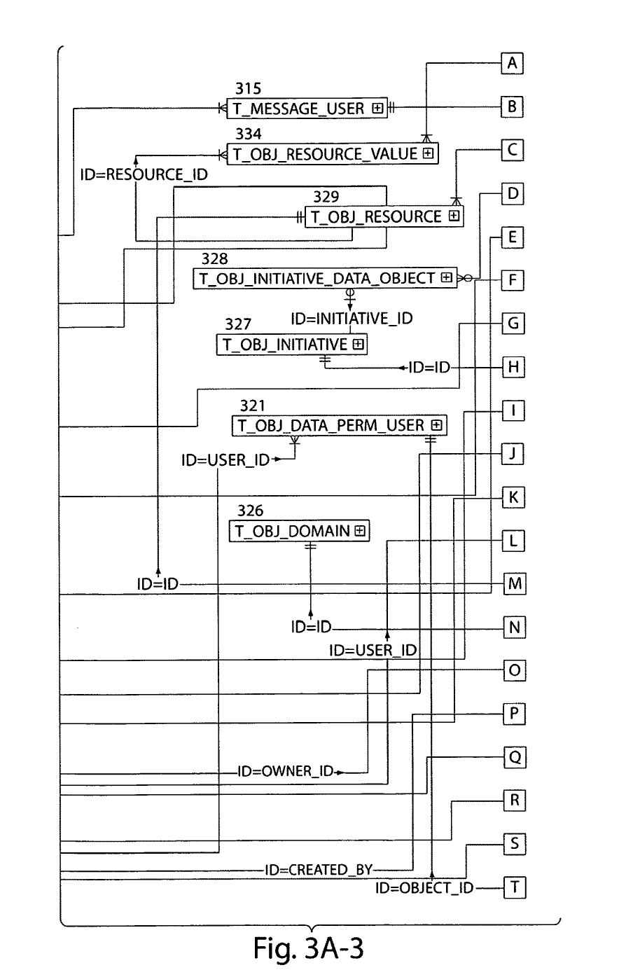

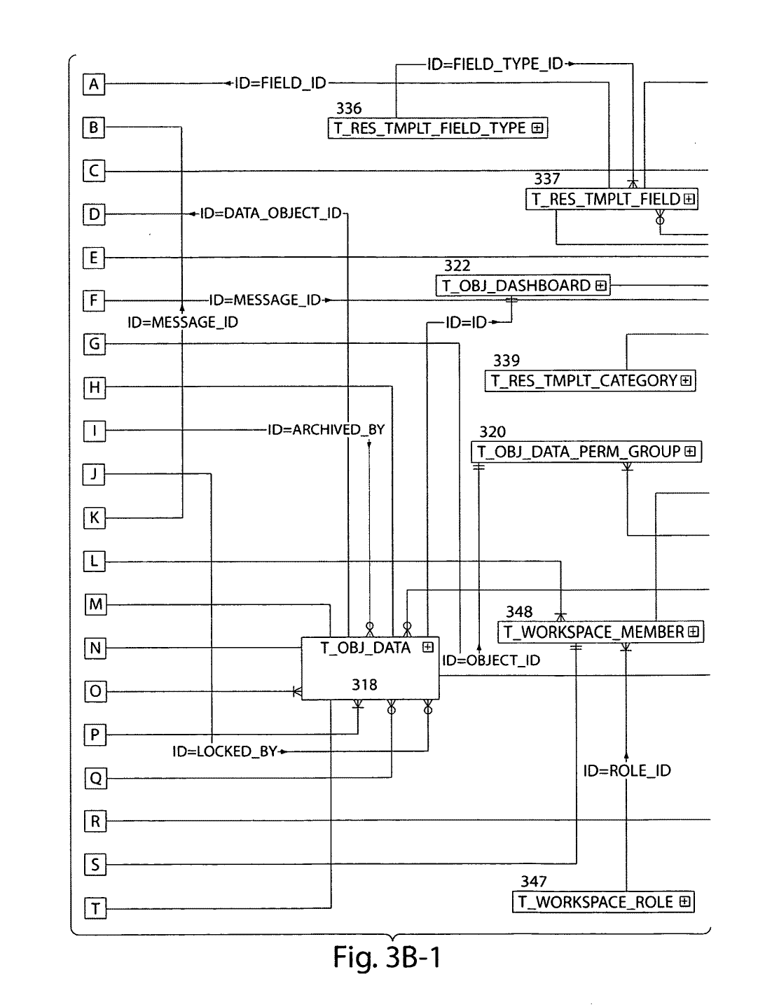

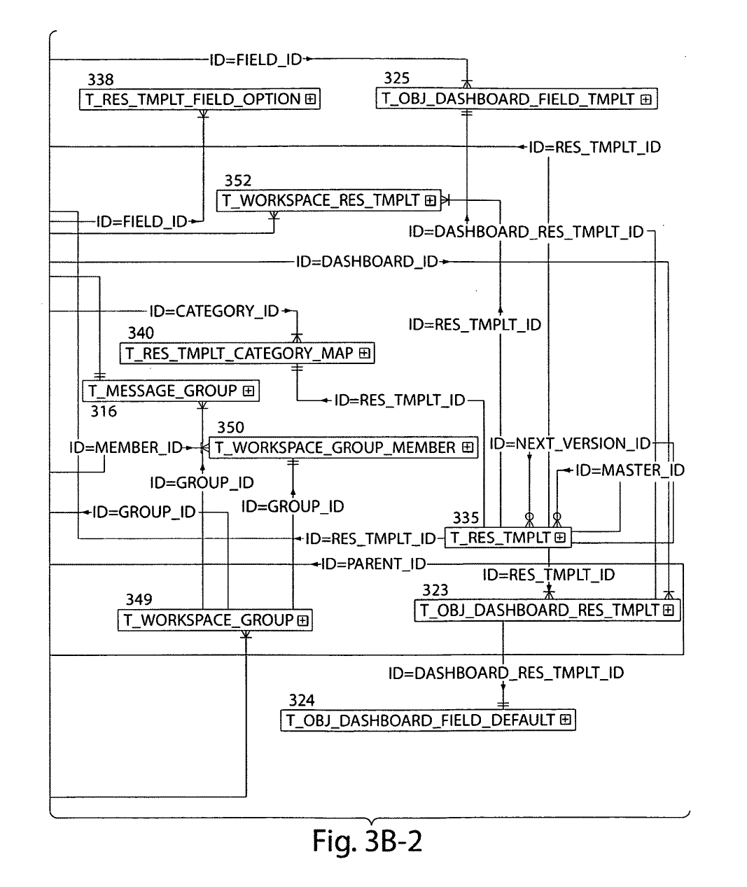

FIGS. 3A and 3B show the tables that are relevant to the implementation of the system as shown in FIGS. 1 and 2. FIGS. 3A and 3B are entity-relationship diagrams of the relevant tables. In such diagrams, arrows connecting the tables show relationships between them that are based on the occurrence of keys for rows in one table as values of non-key fields in rows in others of the tables. For example, each row of the table T_USER_ADMIN_ROLE table 345 contains a field whose value is a key for a record in the table T_ADMIN_ROLE 301. As shown there, the table in which the identifying value is a key is at the head of the arrow and the other table at the tail. In functional terms, what the arrow indicates is that the value of a field in a row of the table at the tail of the arrow can be used to retrieve a row from the table at the head of the arrow. The number of branches at the head of the arrows indicates how the numbers of rows in the two tables relate to each other. Multiple branches indicate a many-1 relationship, where many rows in the table at the tail of the arrow contain the key of a given row in the table at the head of the arrow. A single branch indicates a 1-1 relationship, where there will be a single row in the table at the tail of the arrow that has the key of the given record.

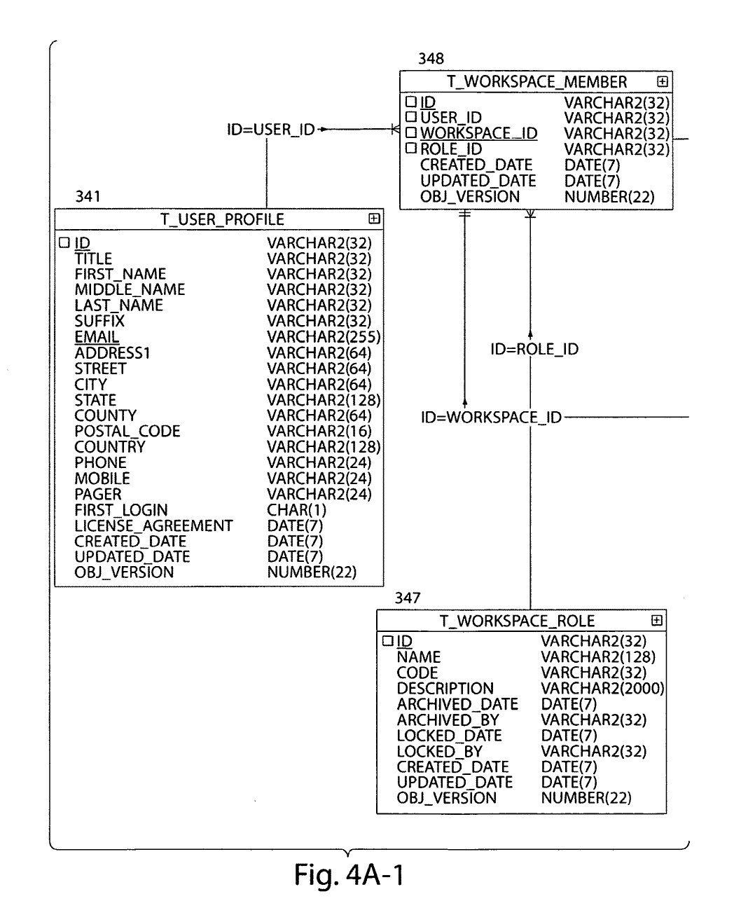

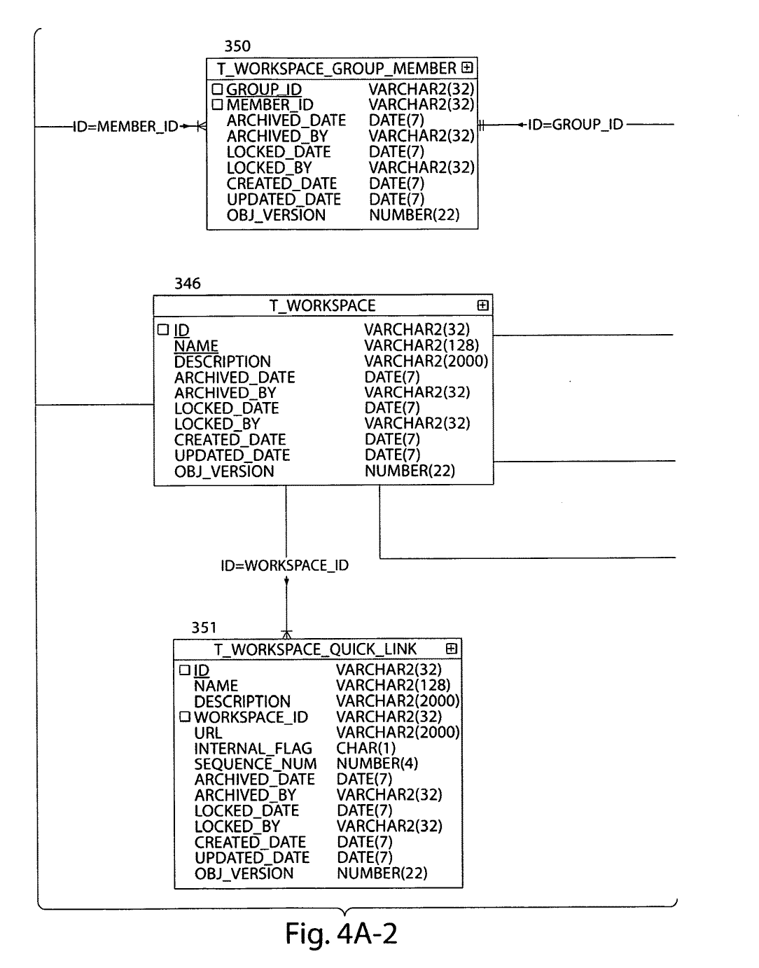

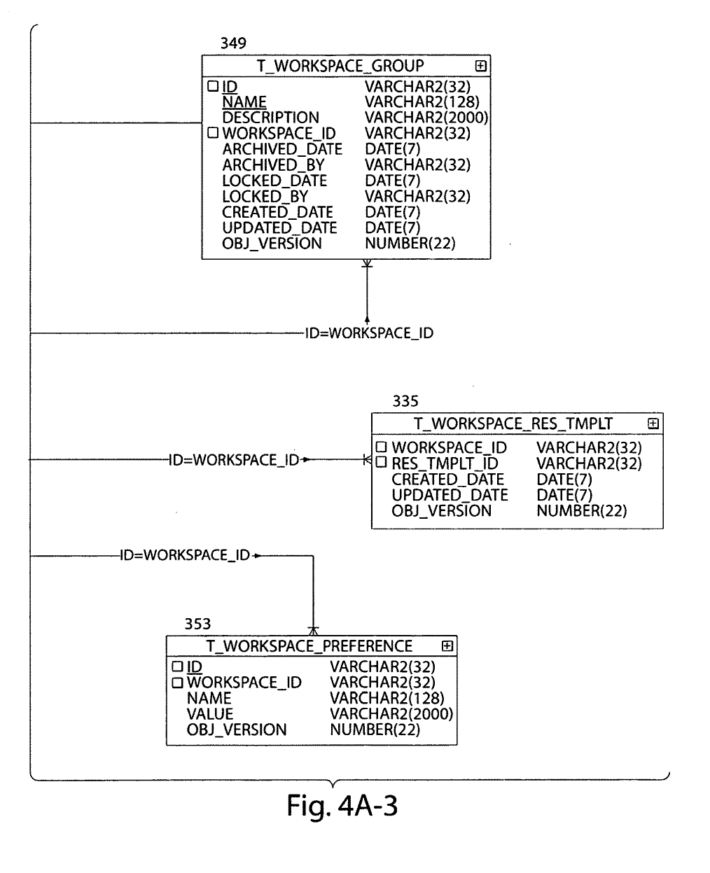

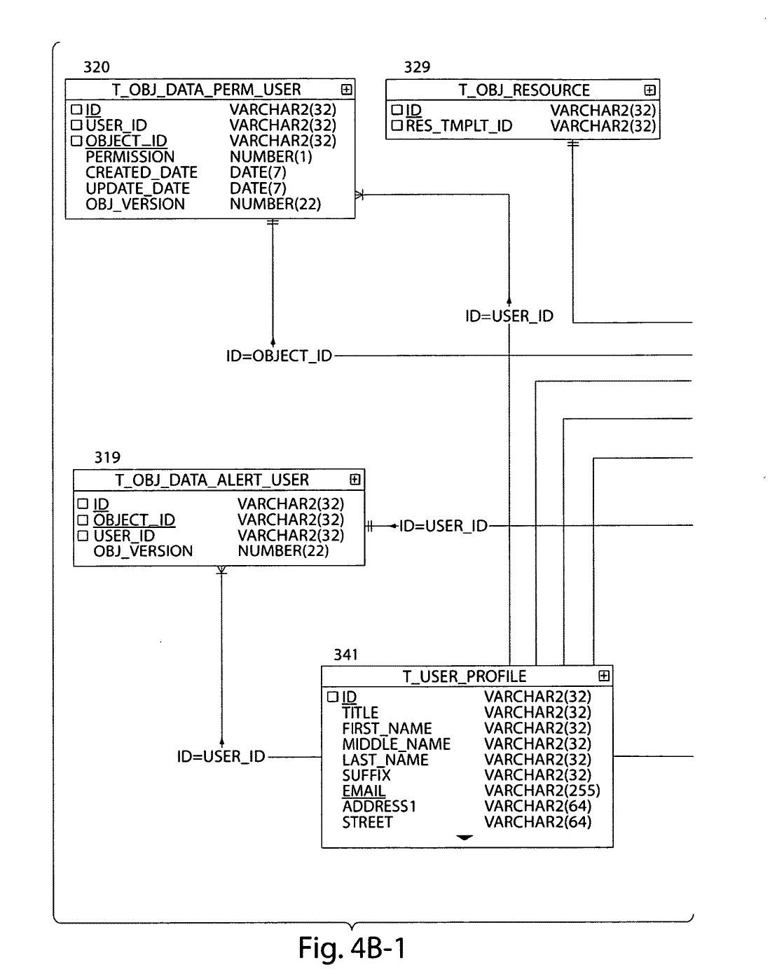

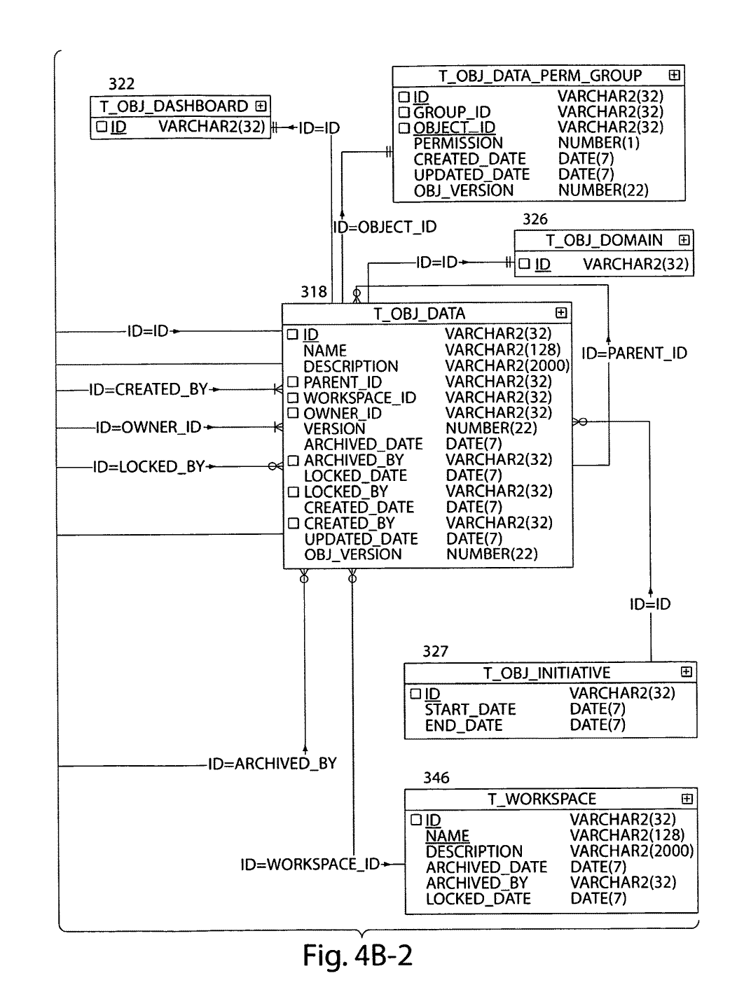

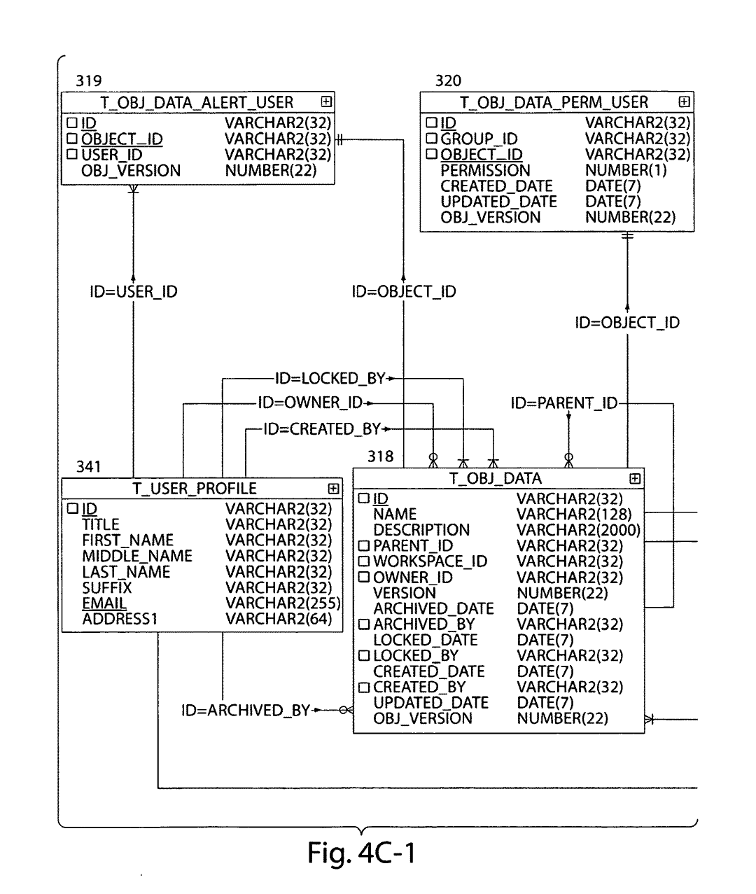

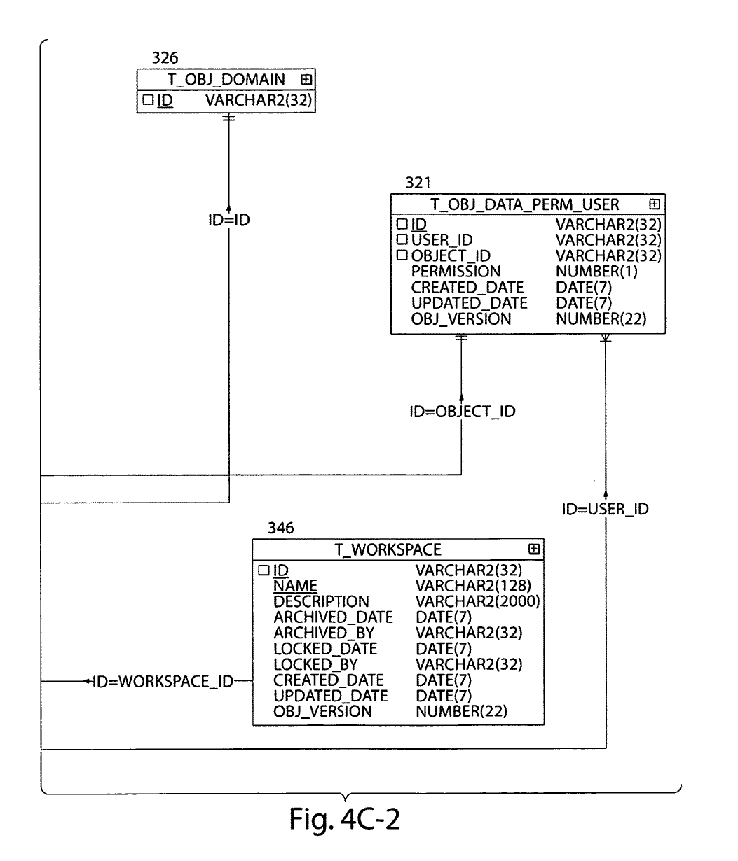

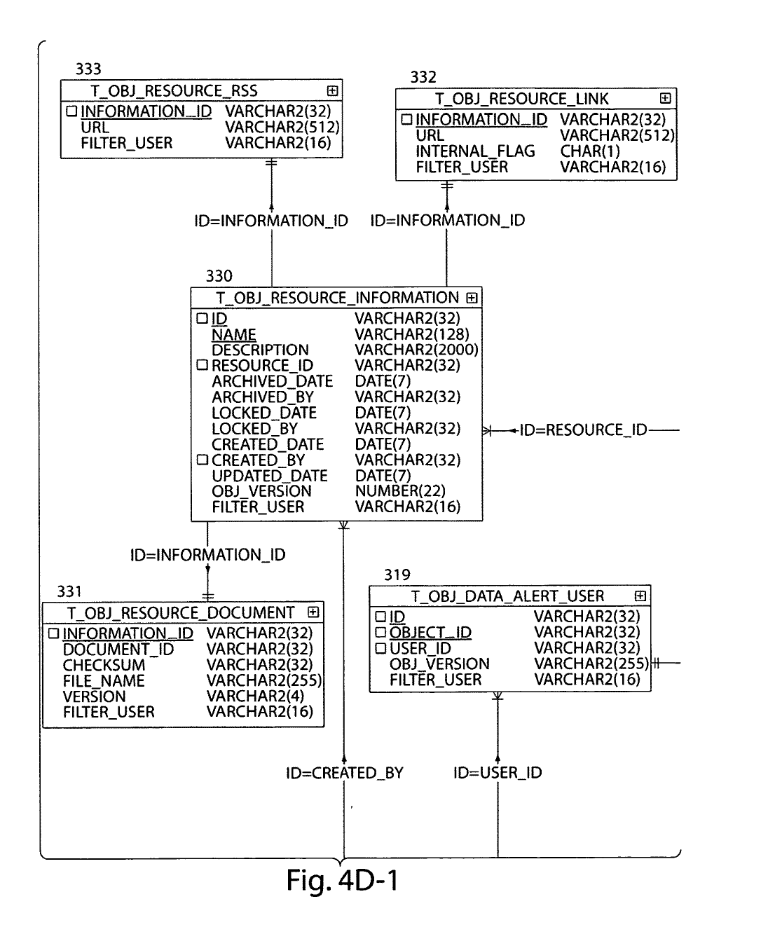

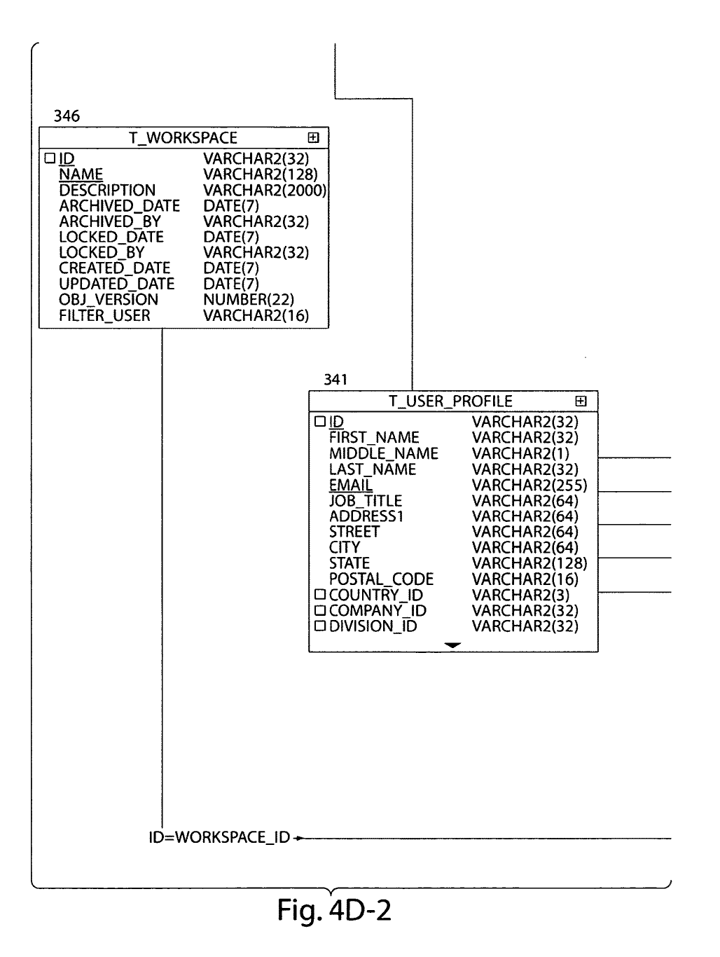

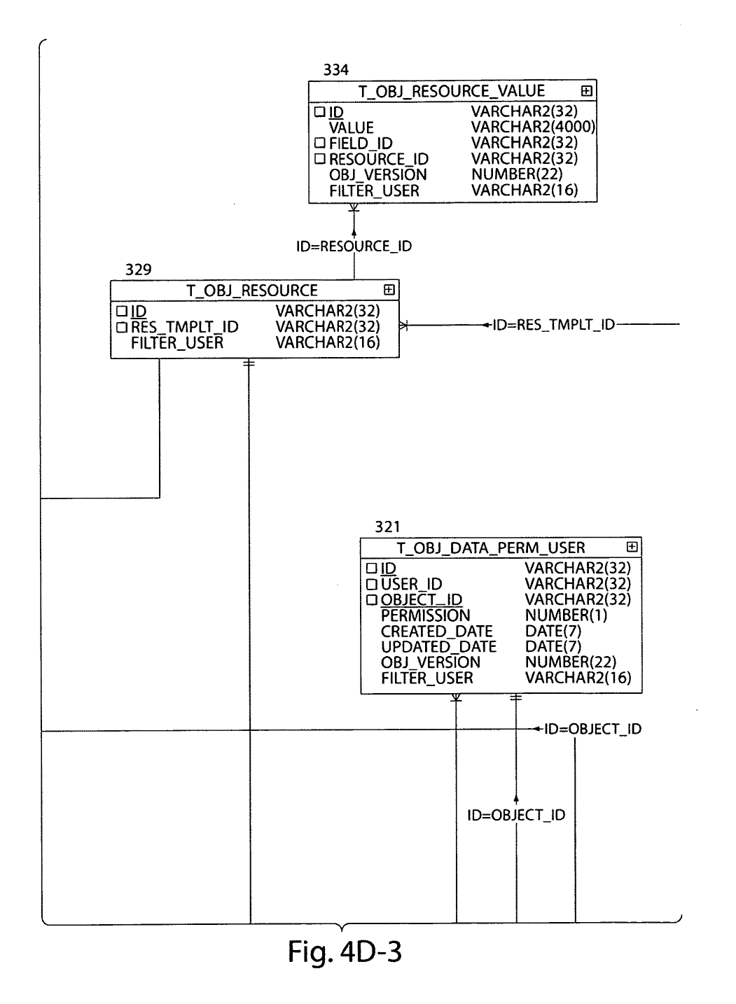

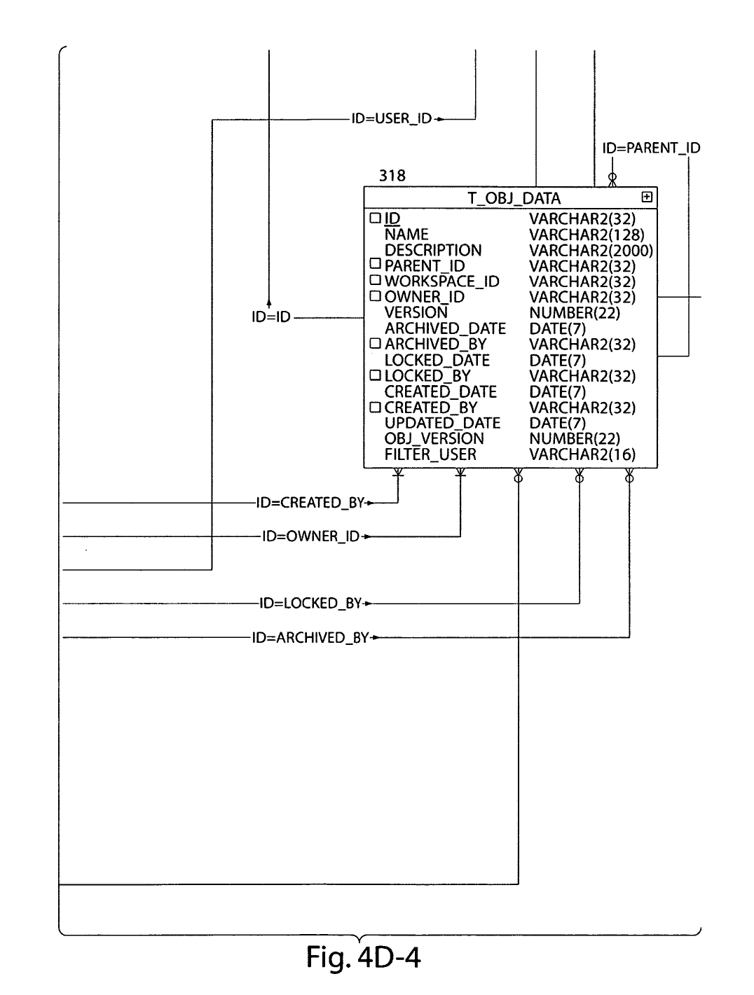

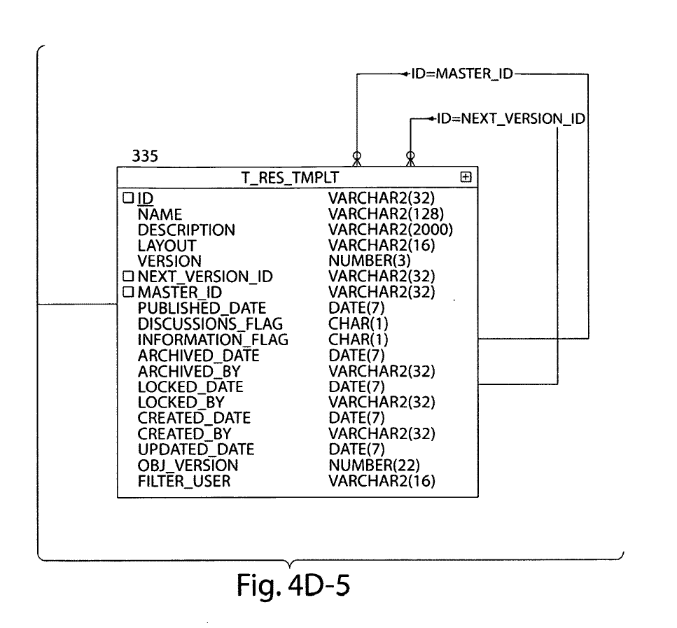

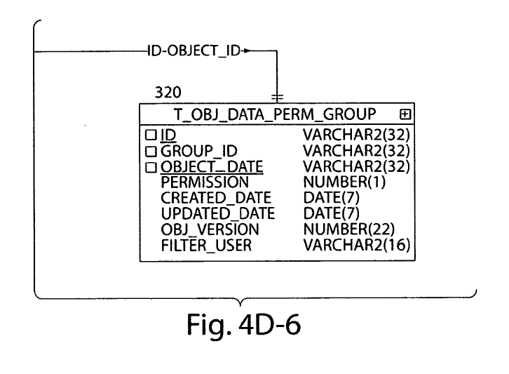

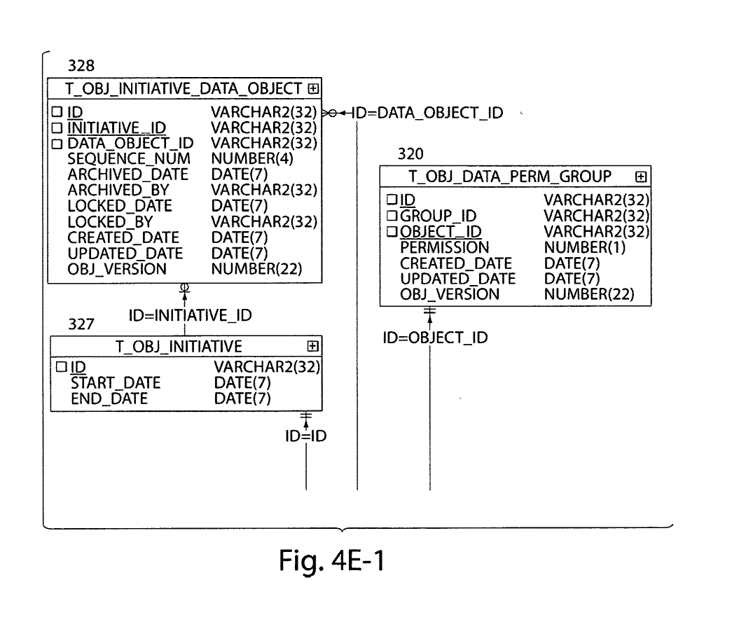

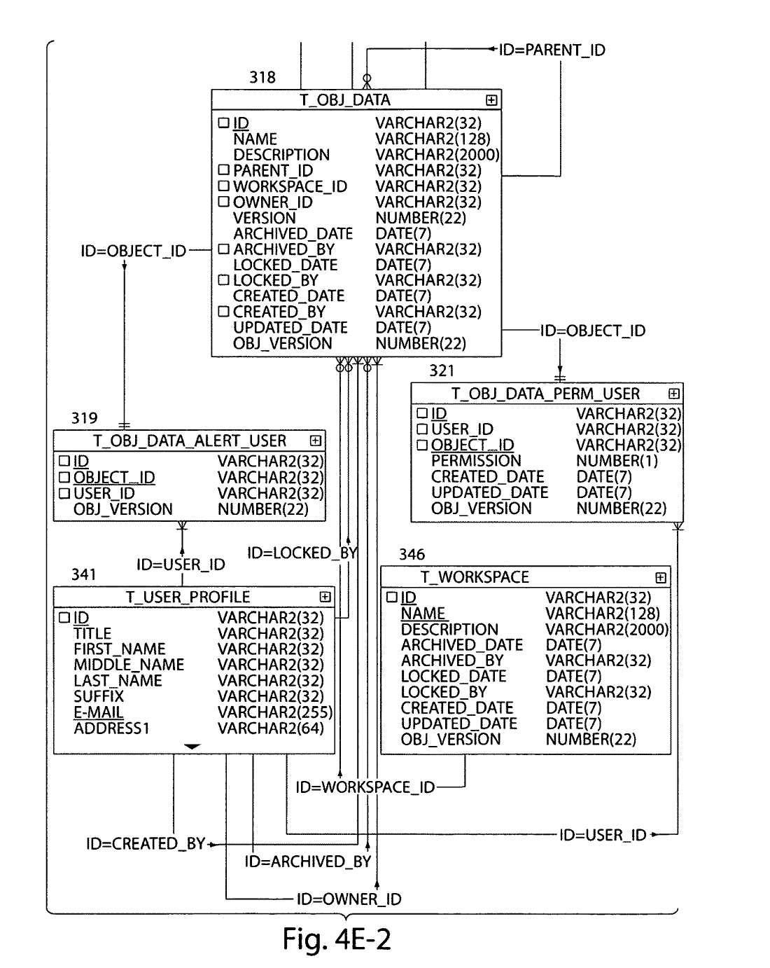

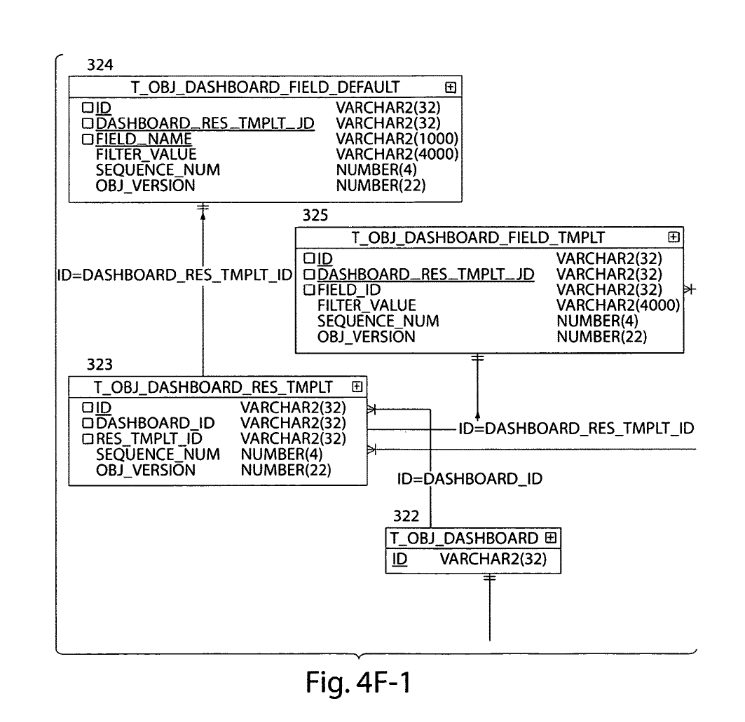

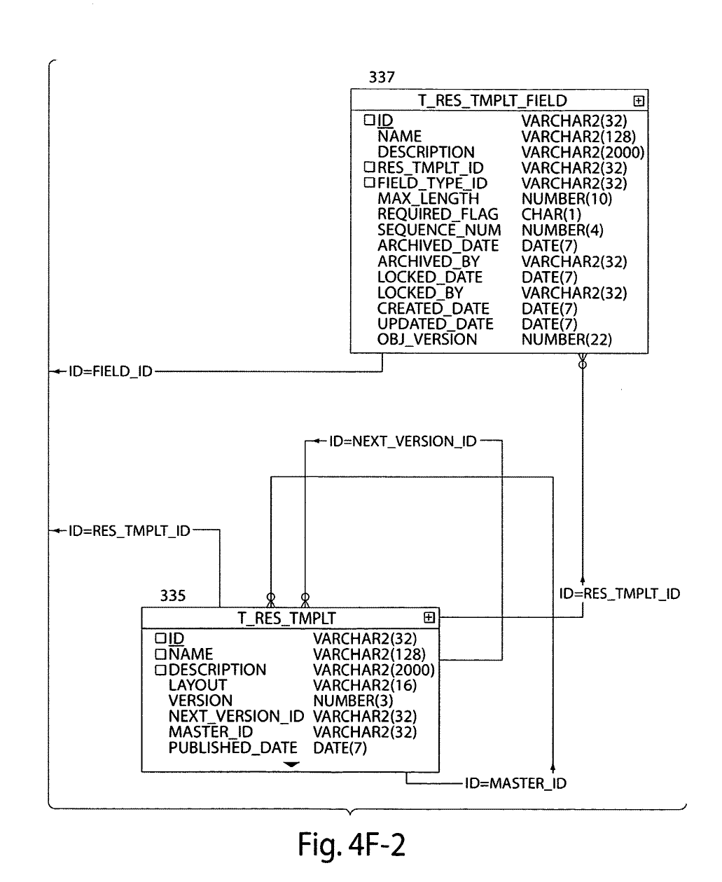

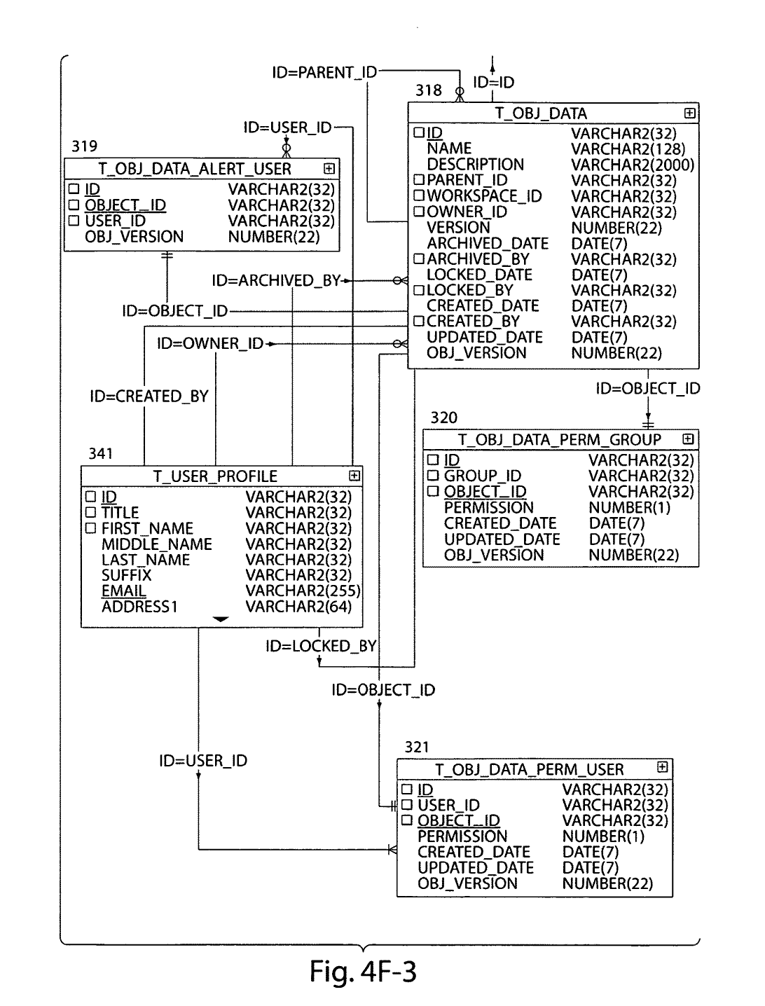

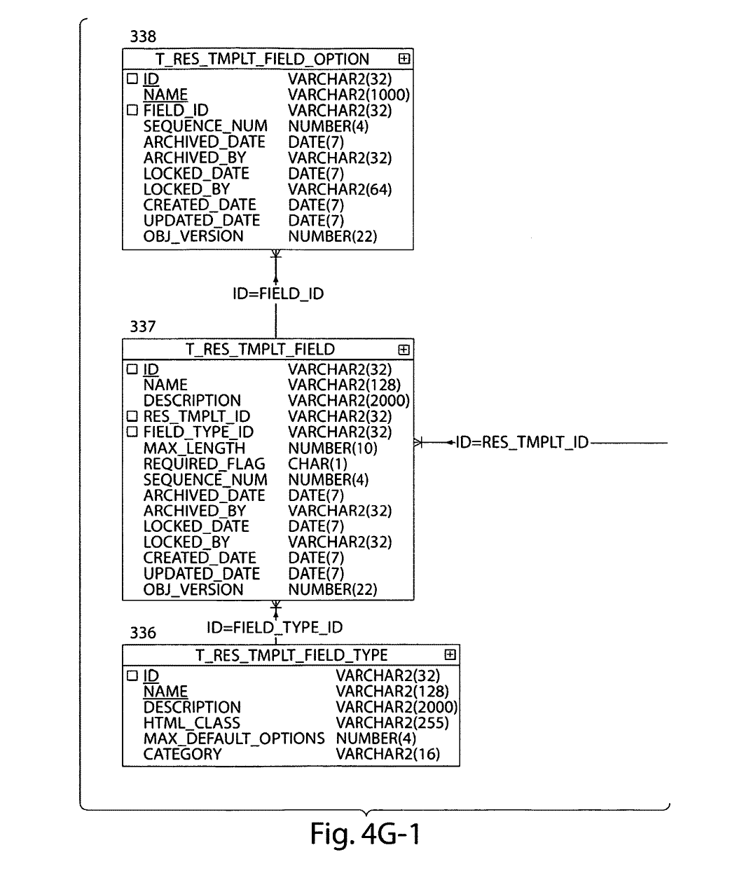

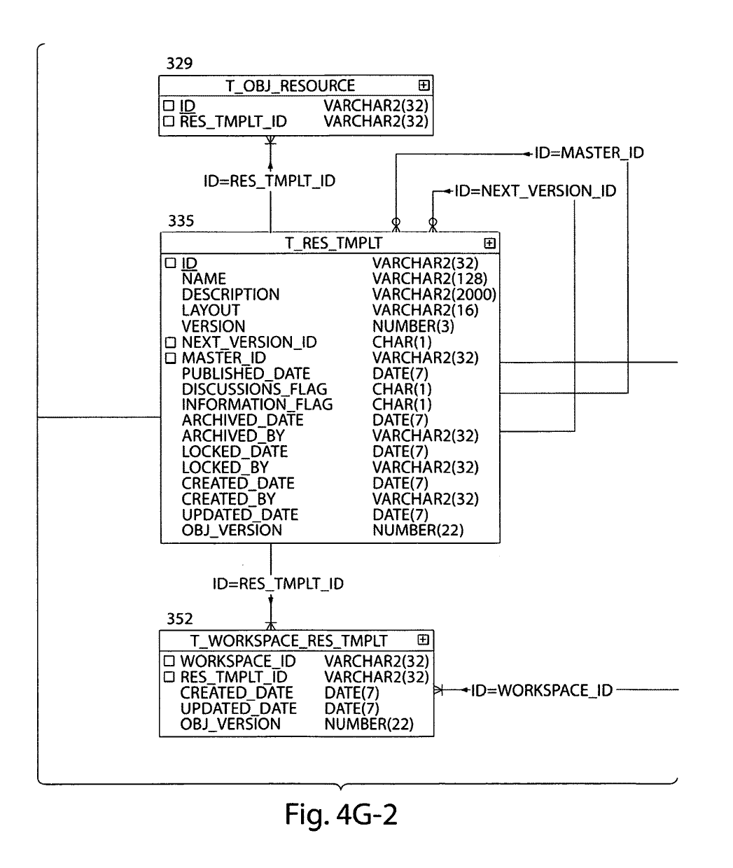

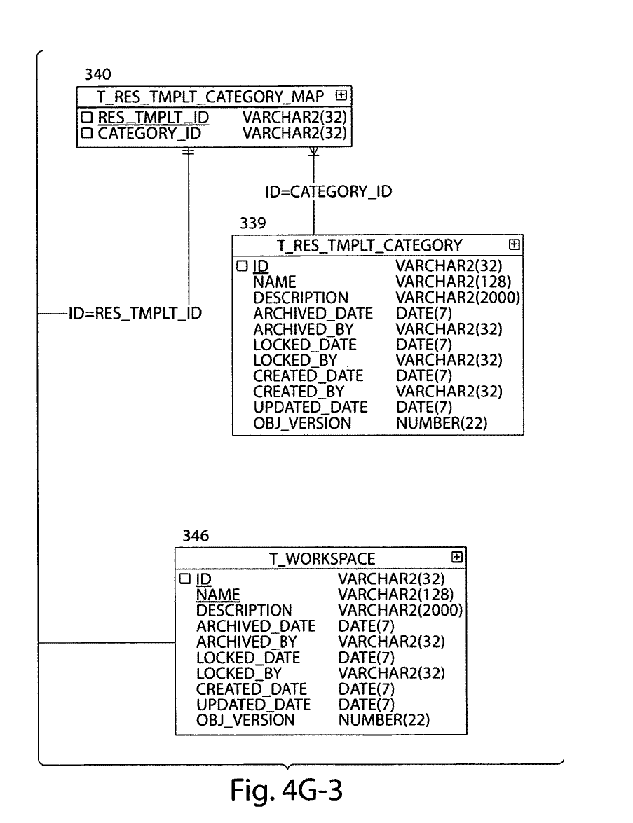

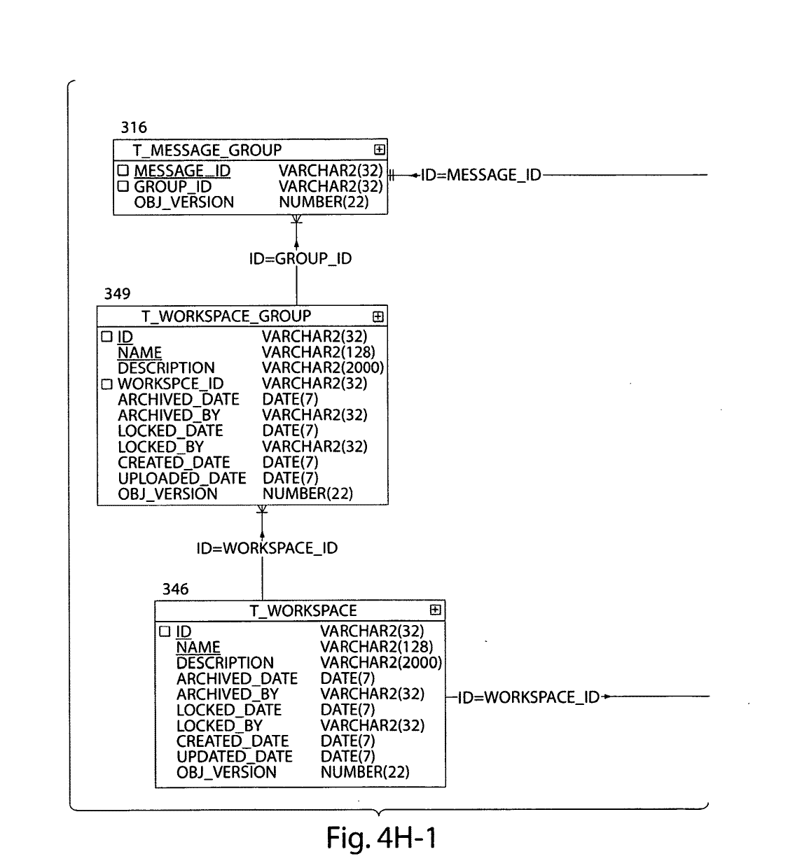

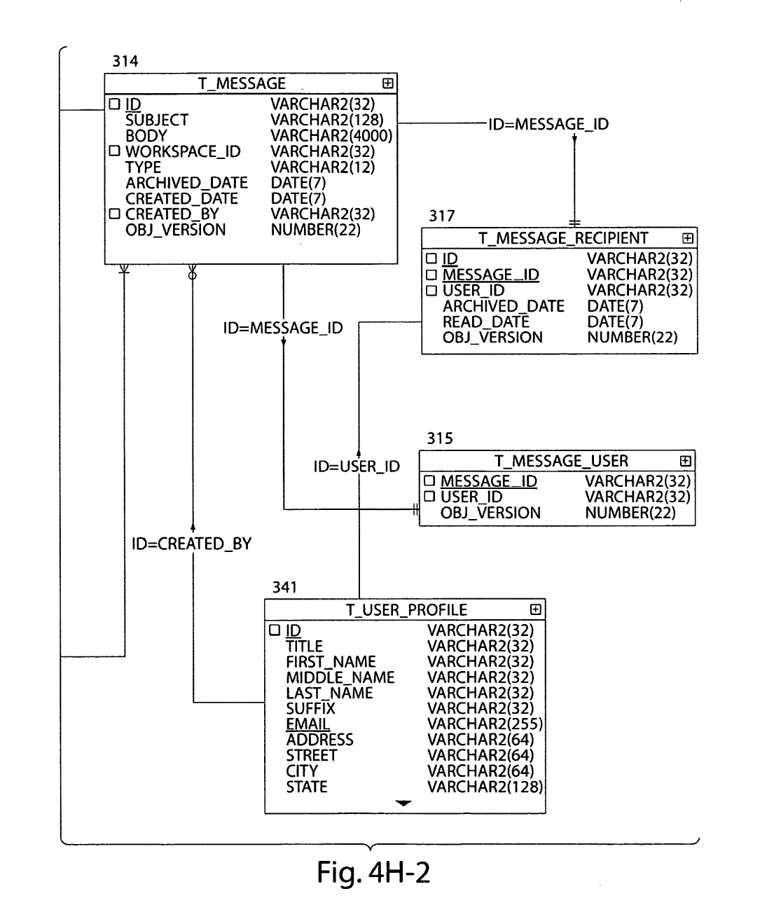

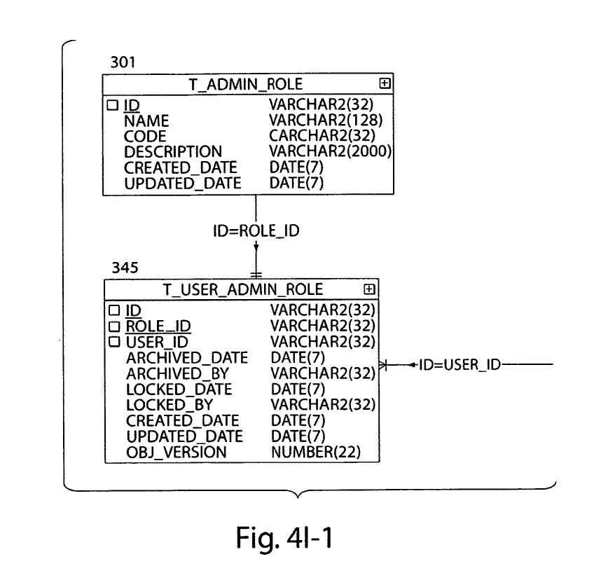

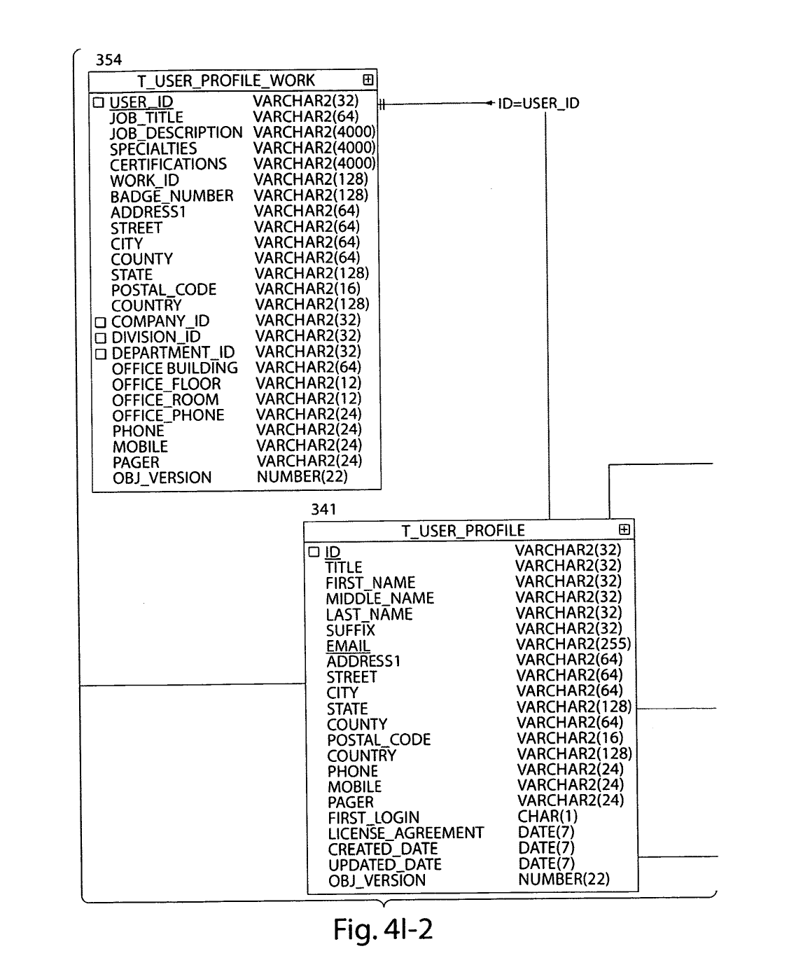

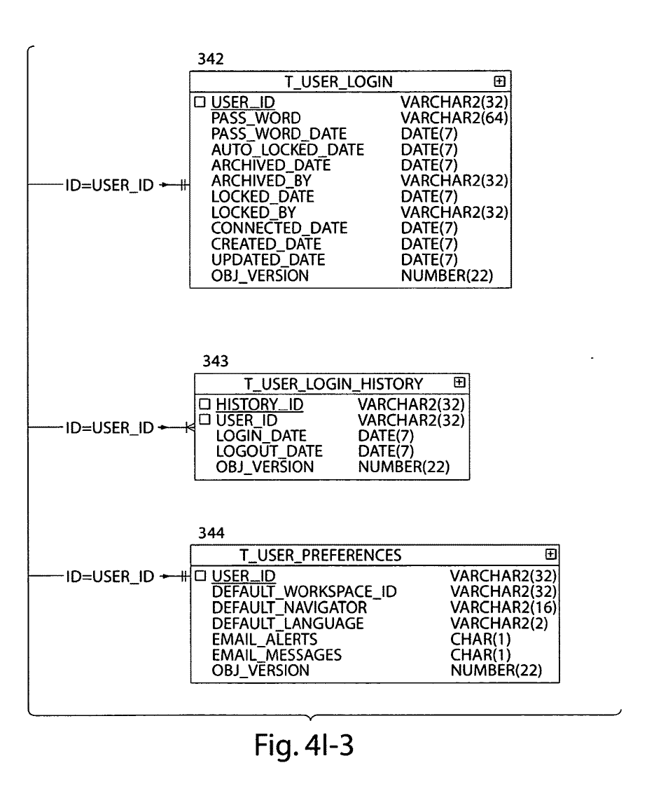

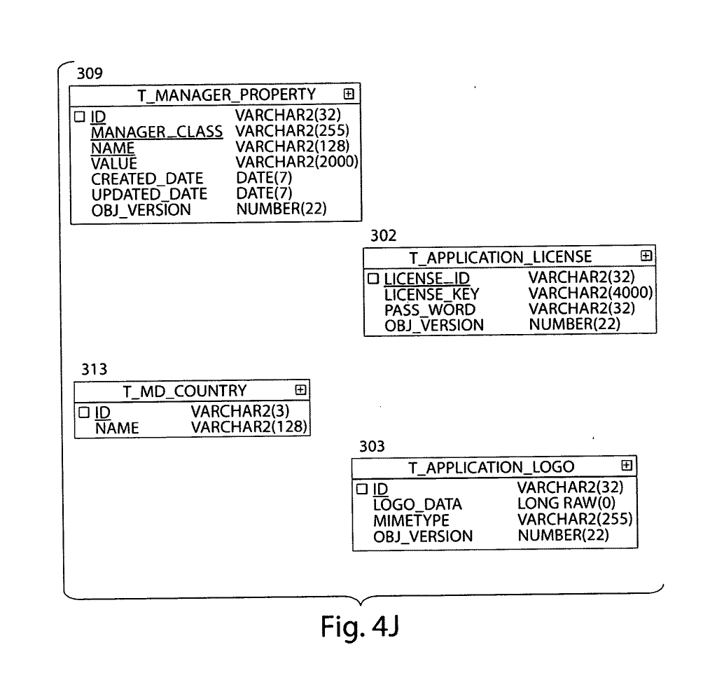

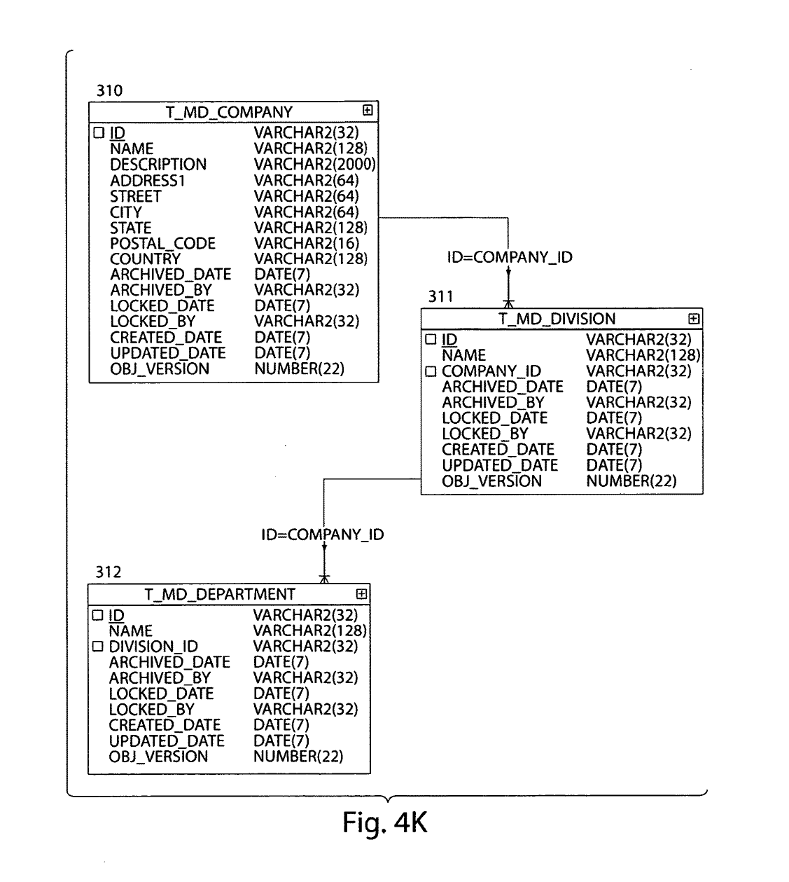

FIGS. 4A-4K show more detailed views of entity-relationship diagrams for select groups of tables. FIG. 4A shows the tables relevant to workspaces 113. FIG. 4B shows the tables relevant to data objects, which are the super class for workspace objects 109, including domains 116, initiatives 127, knowledge boards 129, and resources 121. FIG. 4C shows the tables relevant to domains 116. FIG. 4D shows the tables relevant to resources 121. FIG. 4E shows the tables relevant to initiatives 127. FIG. 4F shows the tables relevant to knowledge boards 129. FIG. 4G shows the tables 111 relevant to resource templates 124. FIG. 4H shows the tables relevant to messages. FIG. 4I shows the tables relevant to users 103, including groups 105 and their roles 107. FIG. 4J shows the tables relevant to applications. FIG. 4K shows the tables relevant to companies.

Descriptions of the tables shown in FIGS. 4A through 4K are provided below.

T_ADMIN_ROLE (301): The T_ADMIN_ROLE table 301 holds the application level administrator role identifiers and names. There is an entry for each administrator. There is a code that is used to easily identify the role when adding it to a user. The fields in the table's entries are as follows:

| Name | Type | Description |
|---|---|---|
| ID | varchar2(32) | record identifier |
| NAME | varchar2(128) | name of administrative role |
| CODE | varchar2(132) | code for administrative role |
| DESCRIPTION | varchar2(2000) | description for administrative role |
| CREATED_DATE | date | date created |
| UPDATED_DATE | date | date last updated |

T_APPLICATION_LICENSE (302): The T_APPLICATION_LICENSE table 302 holds the license key that enables certain features in the system. There is an entry for each license key. The fields in the table's entries are as follows:

| Name | Type | Description |
|---|---|---|
| LICENSE_ID | varchar2 (32) | license identifier |
| LICENSE_KEY | varchar2 (400) | license key |
| PASS_WORD | varchar2 (32) | license password |
| OBJ_VERSION | integer | version number |

T_APPLICATION_LOGO (303): The T_APPLICATION_LOGO table 303 holds the default logo for the application. It can also store another row that contains an administrative uploaded logo. The LOGO_DATE row holds the binary data for the image file itself. The fields in the table's entries are as follows:

| Name | Type | Description |
|---|---|---|
| ID | varchar2(32) | record identifier |
| LOGO_DATA | long raw | data for logo image file |
| MIMETYPE | varchar2(255) | mime type |
| OBJ_VERSION | integer | version number |

T_DISCUSSION_TOPIC (307): The entries in the T_DISCUSSION_TOPIC table 307 relate discussion topics to a resource. There is an entry for each discussion topic. Each entry references the resource's record in the T_OBJ_RESOURCE table 329. The fields in the table's entries are as follows:

| Name | Type | Description |
|---|---|---|
| ID | varchar2(32) | record identifier |
| NAME | varchar2(128) | discussion topic name |
| COMMENTS | varchar2(4000) | comments |
| RESOURCE_ID | varchar2(32) | record identifier from |
| | | T_OBJ_RESOURCE |
| ARCHIVED_DATE | date | date archived |
| ARCHIVED_BY | varchar2(32) | user archiving record |
| LOCKED_DATE | date | date locked |
| LOCKED_BY | varchar2(32) | user locking record |
| CREATED_DATE | date | date created |
| CREATED_BY | varchar2(32) | user creating record from |
| | | T_USER_PROFILE |
| UPDATED_DATE | date | date last updated |
| OBJ_VERSION | integer | version number |

T_DISCUSSION_REPLY (308): The entries in the T_DISCUSSION_REPLY table 308 relate discussion replies to a discussion topic. There is one entry for each reply. Each entry references the discussion topic's record in the T_DISCUSSION_TOPIC table 307 and the parent message. The parent can be another reply in the same table. Replies can be children of other replies in order to maintain a threaded discussion. The fields in the table's entries are as follows:

| Name | Type | Description |
|---|---|---|
| ID | varchar2(32) | record identifier |
| TOPIC_ID | varchar2(32) | record ID from |
| T_DISCUSSION_TOPIC | | |
| PARENT_ID | varchar2(32) | parent topic |
| NAME | varchar2(128) | topic name |
| COMMENTS | varchar2(4000) | comments |
| ARCHIVED_DATE | date | date archived |
| ARCHIVED_BY | varchar2(32) | user archiving record |
| LOCKED_DATE | date | date locked |
| LOCKED_BY | varchar2(32) | user locking record |
| CREATED_DATE | date | date created |
| CREATED_BY | varchar2(32) | user creating record from |
| T_USER_PROFILE | | |
| UPDATED_DATE | date | date last updated |
| OBJ_VERSION | integer | version number |

T_MANAGER_PROPERTY (309): The entries in the T_MANAGER_PROPERTY table 309 stores custom property values for various system managers. There is an entry for each property value. Each manager is configured with its own default values. When a system administrator updates those values, they are stored in this table. The fields in the table's entries are as follows:

| Name | Type | Description |
|---|---|---|
| ID | varchar2(32) | record identifier |
| MANAGER_CLASS | varchar2(255) | manager class |
| NAME | varchar2(128) | property name |
| VALUE | varchar2(2000) | property value |
| CREATED_DATE | date | date created |
| UPDATED_DATE | date | date updated |
| OBJ_VERSION | integer | version number |

T_MD_COMPANY (310): The T_MD_COMPANY table 310 has an entry for each entity, such as a company, that a user of the system may belong to. Entries for users in the system refer to this table to indicate the companies the users belong to. The fields in the table's entries are as follows:

| Name | Type | Description |
|---|---|---|
| ID | varchar2(32) | record identifier |
| NAME | varchar2(128) | company name |
| DESCRIPTION | varchar2(2000) | company description |
| ADDRESS1 | varchar2(64) | company address |
| STREET | varchar2(64) | street |
| CITY | varchar2(64) | city |
| STATE | varchar2(128) | state |
| COUNTRY_ID | varchar2(128) | country code |
| POSTAL_CODE | varchar2(16) | postal code |
| ARCHIVED_DATE | date | date archived |
| ARCHIVED_BY | varchar2(32) | archived by |
| LOCKED_DATE | date | date locked |
| LOCKED_BY | varchar2(32) | locked by |
| CREATED_DATE | date | date created |
| UPDATED_DATE | date | date last updated |
| OBJ_VERSION | integer | version number |

T_MD_DIVISION (311): The T_MD_DIVISION table 311 has an entry for each division under a company. Entries for users in the system refer to this table to indicate the division the users belong to. Each entry references a company's record in the T_MD COMPANY table 310. The fields in the table's entries are as follows:

| Name | Type | Description |
|---|---|---|
| ID | varchar2(32) | record identifier |
| NAME | varchar2(128) | division name |
| COMPANY_ID | varchar2(32) | company ID from |
| | | T_MD_COMPANY |
| ARCHIVED_DATE | date | date archived |
| ARCHIVED_BY | varchar2(32) | user arching record |
| LOCKED_DATE | date | date locked |
| LOCKED_BY | varchar2(32) | user locking record |
| CREATED_DATE | date | date created |
| UPDATED_DATE | date | date last updated |
| OBJ_VERSION | integer | version number |

T_MD_DEPARTMENT (312): The T_MD_DEPARTMENT table 312 has an entry for each department under a division. Entries for users in the system refer to this table to indicate the department the users belong to. Each entry references a division's record in the T_MD_DIVISION table 311. The fields in the table's entries are as follows:

| Name | Type | Description |
|---|---|---|
| ID | varchar2(32) | record identifier |
| NAME | varchar2(128) | department name |
| DIVISION_ID | varchar2(32) | division ID from |
| | | T_MD_DIVISION |
| ARCHIVED_DATE | date | date archived |
| ARCHIVED_BY | varchar2(32) | user archiving record |
| LOCKED_DATE | date | date locked |
| LOCKED_BY | varchar2(32) | user locking record |
| CREATED_DATE | date | date created |
| UPDATED_DATE | date | date last updated |
| OBJ_VERSION | integer | version number |

T_MD_COUNTRY (313): The T_MD_COUNTRY table 313 holds the names for the countries. There is an entry for each country. These are used for address fields in user profiles and company profiles. The fields in the table's entries are as follows:

| Name | Type | Description |
|---|---|---|
| ID | varchar2(3) | record identifier |
| NAME | varchar2(128) | country name |

T_MESSAGE (314): The T_MESSAGE table 314 holds messages sent by users of the system. There is an entry for each message. Each entry references the record of a workspace in which the message was sent from the T_WORKSPACE table 346 and the record of the message creator from the T_USER_PROFILE table 341. The fields in the table's entries are as follows:

| Name | Type | Description |
|---|---|---|
| ID | varchar2(32) | record identifier |
| SUBJECT | varchar2(128) | message subject |
| BODY | varchar2(4000) | message body |
| WORKSPACE_ID | varchar2(32) | workspace ID from |
| | | T_WORKSPACE |
| ARCHIVED_DATE | date | date archived |
| CREATED_DATE | date | date created |
| CREATED_BY | varchar2(32) | user creating message |
| OBJ_VERSION | integer | version number |

T_MESSAGE_USER (315): The entries in the T_MESSAGE_USER table 315 relate messages to the user to which they were addressed. There is an entry for each user message recipient for each message. Each entry references the message's record in the T_MESSAGE table 314 and the user's record in the T_USER PROFILE table 341. The fields in the table's entries are as follows:

| Name | Type | Description |
|---|---|---|
| MESSAGE_ID | varchar2(32) | message ID |
| USER_ID | varchar2(32) | user ID from |
| | | T_USER_PROFILE |
| OBJ_VERSION | integer | version number |

T_MESSAGE_GROUP (316): The entries in the T_MESSAGE_GROUP table 316 relates message to the groups to which the message was addressed. There is an entry for each group message recipient for each message. Each entry references the message's record in the T-MESSAGE table 314 and the group's record from the T_WORKSPACE_GROUP table 349. The fields in the table's entries are as follows:

| Name | Type | Description |
|---|---|---|
| MESSAGE_ID | varchar2(32) | message ID |
| GROUP_ID | varchar2(32) | group ID from |
| | | T_WORKSPACE_GROUP |
| OBJ_VERSION | integer | version number |

T_MESSAGE_RECIPIENT (317): The T_MESSAGE_RECIPIENT table 317 relates messages to users the message was sent to. It breaks out users from the groups that were addressed. There is an entry for each user regardless if the user was selected from the user or group side. There is an entry for each user message recipient for each message. Each entry references the message's record in the T_MESSAGE table 314 and the user's record in THE T_USER_PROFILE table 341. When a user reads the message, it is marked here. The fields in the table's entries are as follows:

| Name | Type | Description |
|---|---|---|
| ID | varchar2(32) | record identifier |
| MESSAGE_ID | varchar2(32) | message ID from |
| | | T_MESSAGE |
| USER_ID | varchar2(32) | user ID from |
| | | T_USER_PROFILE |
| ARCHIVED_DATE | DATE | date archived |
| READ_DATE | DATE | date read |
| OBJ_VERSION | integer | version number |

T_OBJ_DATA (318): The T_OBJ_DATA table 318 holds the details of the data object. It's the superclass for all other data objects (Domains, Initiatives, Dashboards and Resources). There is an entry for each data object. The fields in the table's entries are as follows:

| Name | Type | Description |
|---|---|---|
| ID | varchar2(32) | record identifier |
| NAME | varchar2(128) | name of object |
| DESCRIPTION | varchar2(2000) | description of object |
| WORKSPACE_ID | varchar2(32) | workspace ID from |
| | | T_WORKSPACE |
| PARENT_ID | varchar2(32) | ID of parent object in this table |
| OWNER_ID | varchar2(32) | owner ID from |
| | | T_USER_PROFILE |
| ARCHIVED_DATE | date | date archived |
| ARCHIVED_BY | varchar2(32) | user archiving record |
| LOCKED_DATE | date | date locked |
| LOCKED_BY | varchar2(32) | user locking record |
| CREATED_DATE | date | date created |
| CREATED_BY | varchar2(32) | user creating record |
| UPDATED_DATE | date | date last updated |
| OBJ_VERSION | integer | version number |

T_OBJ_DATA_ALERT_USER (319): The entries in the T_OBJ_DATA_ALERT_USER table 319 relate alerts to users and data objects. There is an entry for each user and each data object. Each entry references the object's record in the T_OBJ_DATA table 318 and the user's record in the T_USER_PROFILE table 341. The fields in the table's entries are as follows:

| Name | Type | Description |
|---|---|---|
| ID | varchar2(32) | record identifier |
| OBJECT_ID | varchar2(32) | object ID from |
| | | T_OBJ_DATA |
| USER_ID | varchar2(32) | user ID from |
| | | T_USER_PROFILE |
| OBJ_VERSION | integer | version number |

T_OBJ_DATA_PERM_GROUP (320): The entries in the T_OBJ_DATA_PERM_GROUP table 320 relate permissions for groups to data objects. There is an entry for each permission for a group for each data object. Each entry references the object's record in the T_OBJ_DATA table 318 and the group's record in the T_WORKSPACE_GROUP table 349. Possible permission values are:
0=no permission
1=read
2=read-create
3=read-create-update
4=read-create-update-delete

The fields in the table's entries are as follows:

| Name | Type | Description |
|---|---|---|
| ID | varchar2(32) | record identifier |
| GROUP_ID | varchar2(32) | group ID from |
| | | T_WORKSPACE_GROUP |
| OBJECT_ID | varchar2(32) | object ID from |
| | | T_OBJ_DATA |
| PERMISSION | number(1) | permission code |
| CREATED_DATE | date | date created |
| UPDATED_DATE | date | date last updated |
| OBJ_VERSION | integer | version number |

T_OBJ_DATA_PERM_USER (321): The T_OBJ_DATA_PERM_USER table 321 relates permissions for a user to data objects. There is an entry for each permission for a user for each data object. Each entry references the object's record in the T_OBJ_DATA table 318 and the user's record in the T_USER PROFILE table 341. Possible permission values are:
0=no permission
1=read 2=read-create
3=read-create-update
4=read-create-update-delete

The fields in the table's entries are as follows:

| Name | Type | Description |
|---|---|---|
| ID | varchar2(32) | record identifier |
| USER_ID | varchar2(32) | user ID from |
| | | T_USER_PROFILE |
| OBJECT_ID | varchar2(32) | object ID from |
| | | T_OBJ_DATA |
| PERMISSION | number(1) | permission code |
| CREATED_DATE | date | date created |
| UPDATED_DATE | date | date last updated |
| OBJ_VERSION | integer | version number |

T_OBJ_DASHBOARD (322): The T_OBJ_DASHBOARD table 322 holds the details of a knowledge board. The fields in the table's entries are as follows:

| Name | Type | Description |
|---|---|---|
| ID | varchar2(32) | record identifier |

T_OBJ_DASHBOARD_RES_TMPLT (323): The entries in the T_OBJ_DASHBOARD_RES_TMPLT table 323 relates resource templates with a particular knowledge board. There is an entry for each resource template/knowledge board association. Each entry references a knowledge board's record in the T_OBJ_DASHBOARD_TABLE 322 and a resource's record in the T_OBJ_RESOURCE table 329. The fields in the table's entries are as follows:

| Name | Type | Description |
|---|---|---|
| ID | varchar2(32) | record identifier |
| DASHBOARD_ID | varchar2(32) | knowledge board ID from |
| | | T_OBJ_DASHBOARD |
| RES_TMPLT_ID | varchar2(32) | resource ID from |
| | | T_OBJ_RESOURCE |
| SEQUENCE_NUM | number(4,0) | display sequence number |
| OBJ_VERSION | integer | version number |

T_OBJ_DASHBOARD_FIELD_DEFAULT (324): The T_OBJ_DASHBOARD_FIELD_DEFAULT table 324 holds the list of default fields that should be shown on a knowledge board for a particular resource template and any filter data. There is an entry for each field. Each entry references a knowledge board's record in the T_OBJ_DASHBOARD_RES_TMPLT table 323. The fields in the table's entries are as follows:

| Name | Type | Description |
|---|---|---|
| ID | varchar2(32) | record identifier |
| DASHBOARD_RES_TMPLT_ID | varchar2(32) | knowledge board ID with resource |
| | | from |
| | | T_OBJ_DASHBOARD_RES_TMPLT |
| FIELD_NAME | varchar2(1000) | field name |
| FILTER_VALUE | varchar2(4000) | filter value |
| SEQUENCE_NUM | number(4,0) | display sequence number |
| OBJ_VERSION | integer | version number |

T_OBJ_DASHBOARD_FIELD_TMPLT (325): The T_OBJ_DASHBOARD_FIELD_TMPLT table 325 holds the list of dynamic fields that should be shown on a knowledge board for a particular resource template and any filter data. There is an entry for each field. Each entry references a knowledge board's record in the T_OBJ_DASHBOARD_RES_TMPLT table 325 and a field's record in the T_RES_TMPLT_FIELD table 337. The fields in the table's entries are as follows:

| Name | Type | Description |
|---|---|---|
| ID | varchar2(32) | record identifier |
| DASHBOARD_RES_TMPLT_ID | varchar2(32) | knowledge board ID with resource |
| | | from |
| | | T_OBJ_DASHBOARD_RES_TMPLT |
| FIELD_ID | varchar2(32) | field ID from T_RES_TMPLT_FIELD |
| FILTER_VALUE | varchar2(4000) | filter value |
| SEQUENCE_NUM | number(4,0) | display sequence number |
| OBJ_VERSION | integer | version number |

T_OBJ_DOMAIN (326): The T_OBJ_DOMAIN table 326 holds the details of a domain. There is an entry for each domain. The fields in the table's entries are as follows:

| Name | Type | Description |
|---|---|---|
| ID | varchar2(32) | record identifier |

T_OBJ_INITIATIVE (327): The T_OBJ_INITIATIVE table 327 holds the details of an initiative. There is an entry for each initiative. The fields in the table's entries are as follows:

| Name | Type | Description |
|---|---|---|
| ID | varchar2(32) | record identifier |
| START_DATE | date | start date |
| END_DATE | date | end date |

T_OBJ_INITIATIVE_DATA_OBJECT (328): The entries in the T_OBJ_INITIATIVE_DATA_OBJECT table 328 relate data objects to initiatives. There is an entry for each initiative/data object association. Each entry references the initiative's record in the T_OBJ_INITIATIVE table 327 and the data object's record in the T_OBJ_DATA table 318. The initiative is related to a workspace through the Workspace_ID in the object's record. The fields in the table's entries are as follows:

| Name | Type | Description |
|---|---|---|
| ID | varchar2(32) | record identifier |
| INITIATIVE_ID | varchar2(32) | initiative ID from |
| | | T_OBJ_INITIATIVE |
| DATA_OBJECT_ID | varchar2(32) | data object ID from |
| | | T_OBJ_DATA |
| SEQUENCE_NUM | number(4,0) | display sequence number |
| ARCHIVED_DATE | date | date archived |
| ARCHIVED_BY | varchar2(32) | user archiving record |
| LOCKED_DATE | date | date locked |
| LOCKED_BY | varchar2(32) | user locking record |
| CREATED_DATE | date | date created |
| UPDATED_DATE | date | date last updated |
| OBJ_VERSION | integer | version number |

T_OBJ_RESOURCE (329): The T_OBJ_RESOURCE table 329 holds the details of a resource. There is an entry for each resource. Each entry references the resource template's record in the T_RES_TMPLT 335 from which the resource was created. This association is used in knowledge boards to find resources belonging to the resource template for the purpose of generating a report, as described above. The fields in the table's entries are as follows:

| Name | Type | Description |
|---|---|---|
| ID | varchar2(32) | record identifier |
| RESOURCE_TMPLT_ID | varchar2(32) | resource template ID from |
| T_RES_TMPL | | |

T_OBJ_RESOURCE_INFORMATION (330): The entries in the T_OBJ_RESOURCE_INFORMATION table 330 relate information (documents, links & RSS feeds) to resources. There is an entry for each piece of information. Each entry references the resource's record in the TOBJ_RESOURCE table 329. The fields in the table's entries are as follows:

| Name | Type | Description |
|---|---|---|
| ID | varchar2(32) | record identifier |
| NAME | varchar2(128) | information name |
| DESCRIPTION | varchar2(2000) | information description |
| RESOURCE_ID | varchar2(32) | resource ID from |
| | | T_OBJ_RESOURCE |
| ARCHIVED_DATE | date | date archived |
| ARCHIVED_BY | varchar2(32) | user archiving record |
| LOCKED_DATE | date | date locked |
| LOCKED_BY | varchar2(32) | user locking record |
| CREATED_DATE | date | date created |
| UPDATED_DATE | date | date last updated |
| OBJ_VERSION | integer | version number |

T_OBJ_RESOURCE_DOCUMENT (331): The entries in the T_OBJ_RESOURCE_DOCUMENT table 331 relate documents to the information table. It subclasses the T_RESOURCE_INFORMATION table 330. There is an entry for each document. Each entry references an information's record in the T_OBJ_RESOURCE_INFORMATION table 330. The document is related to a resource through the Resource_ID in the information's record. The fields in the table's entries are as follows:

| Name | Type | Description |
|---|---|---|
| INFORMATION_ID | varchar2(32) | information ID from |
| | | T_OBJ_RESOURCE_INFORMATION |
| DOCUMENT_ID | varchar2(32) | document ID |
| CHECKSUM | varchar2(32) | checksum value |
| FILE_NAME | varchar2(255) | file name |
| VERSION | varchar2(4) | version number |

T_OBJ_RESOURCE_LINK (332): The entries in the T_OBJ_RESOURCE_LINK 332 table relate links to information. It subclasses the T_RESOURCE_INFORMATION table 330. There is an entry for each link. Each entry references an information's recording the T_OBJ_RESOURCE_INFORMATION table 330. The link is related to a resource through the Resource_ID in the information's record. The fields in the table's entries are as follows:

| Name | Type | Description |
|---|---|---|
| INFORMATION_ID | varchar2(32) | information ID from |
| | | T_OBJ_RESOURCE_INFORMATION |
| URL | varchar2(512) | URL for link |
| INTERNAL_FLAG | char(1) | set if internal link |

T_OBJ_RESOURCE_RSS (333): The entries in the T_OBJ_RESOURCE_RSS table 333 relate RSS feeds to information. It subclasses the T_RESOURCE_INFORMATION table 330. There is an entry for each RSS feed. Each entry references an information's record in the T_OBJ_RESOURCE_INFORMATION table 330. The RSS feed is related to a resource through the Resource_ID in the information's record. The fields in the table's entries are as follows:

| Name | Type | Description |
|---|---|---|
| INFORMATION_ID | varchar2(32) | information ID from |
| | | T_OBJ_RESOURCE_INFORMATION |
| URL | varchar2(512) | URL for RSS feed |

T_OBJ_RESOURCE_VALUE (334): The T_OBJ_RESOURCE_VALUE table 334 holds values for each field of each resource, as set by a user. There is an entry for each field of each resource. Each entry references a field's record in the T_RES_TMPLT_FIELD table 337 and a resource's record in the T_OBJ_RESOURCE table 329. The field ID's come from the resource template associated with this resource. The fields in the table's entries are as follows:

| Name | Type | Description |
|---|---|---|
| ID | varchar2(32) | record identifier |
| VALUE | varchar2(4000) | field value |
| FIELD_ID | varchar2(32) | field ID from |
| | | T_RES_TMPLT_FIELD |
| RESOURCE_ID | varchar2(32) | resource ID from |
| | | T_OBJ_RESOURCE |
| OBJ_VERSION | varchar2 | version number |

T_RES_TMPLT (335): The T_RES_TMPLT table 335 holds the details of the resource templates. There is an entry for each resource template. The fields in the table's entries are as follows:

| Name | Type | Description |
|---|---|---|
| ID | varchar2(32) | record identifier |
| NAME | varchar2(128) | template name |
| DESCRIPTION | varchar2(2000) | template description |
| LAYOUT | varchar2(16) | template display layout |
| VERSION | number(3) | version number |
| NEXT_VERSION_ID | varchar2(32) | next version record ID in this |
| | | table |
| MASTER_ID | varchar2(32) | master template record ID in |
| | | this table |
| PUBLISHED_DATE | date | date published |
| DISCUSSIONS_FLAG | char(1) | set if discussions associated |
| INFORMATION_FLAG | char(1) | set if information associated |
| ARCHIVED_DATE | date | date archived |
| ARCHIVED_BY | varchar2(32) | user archiving record |
| LOCKED_DATE | date | date locked |
| LOCKED_BY | varchar2(32) | user locking record |
| CREATED_DATE | date | date created |
| CREATED_BY | varchar2(32) | user creating record |
| UPDATED_DATE | date | date updated |
| OBJ_VERSION | integer | version number |

T_RES_TMPLT_FIELD_TYPE (336): The T_RES_TMPLT_FIELD_TYPE table 336 holds a number of different types a data field in a resource template can exist as. There is an entry for each data field type. This is used when producing a visual representation of the field. Each field type can be associated with a category. The fields in the table's entries are as follows:

| Name | Type | Description |
|---|---|---|
| ID | varchar2(32) | record identifier |
| NAME | varchar2(128) | field name |
| DESCRIPTION | varchar2(2000) | field description |
| HTML_CLASS | varchar2(255) | HTML class |
| MAX_DEFAULT_OPTIONS | number(4.0) | default maximum |
| | | number of options |
| CATEGORY | varchar2(16) | category of field type |

T_RES_TMPLT_FIELD (337): The T_RES_TMPLT_FIELD table 337 holds both global data fields that apply to multiple object types and resource template specific data fields. The difference is determined by the RES_TMPLT_ID field. If this field is null, the field is global. Global fields are used when creating a new resource template. There is an entry for each data field. The Each entry references the resource template's record in the T_RES_TMPLT table 335, and the field type's record in the T_RES_TMPLT_FIELD_TYPE table 336. The fields in the table's entries are as follows:

| Name | Type | Description |
|---|---|---|
| ID | varchar2(32) | record identifier |
| NAME | varchar2(128) | name of data field |
| DESCRIPTION | varchar2(2000) | description of data field |
| RES_TMPLT_ID | varchar2(32) | resource template ID from T_RES_TMPLT |
| FIELD_TYPE_ID | varchar2(32) | field type ID from T_RES_TMPLT_FIELD_TYPE |
| MAX_LENGTH | number(10,0) | maximum text length |
| REQUIRED_FLAG | char(1) | set if value required for field |
| SEQUENCE_NUM | number(4,0) | display sequence number |
| ARCHIVED_DATE | date | date archived |
| ARCHIVED_BY | varchar2(32) | user archiving record |
| LOCKED_DATE | date | date locked |
| LOCKED_BY | varchar2(32) | user locking record |
| CREATED_DATE | date | date created |
| UPDATED_DATE | date | date last updated |
| OBJ_VERSION | integer | version number |

T_RES_TMPLT_FIELD_OPTION (338): The T_RES_TMPLT_FIELD OPTION table 338 holds options values for the various data fields in the resource templates. There is an entry for each option. Each entry references the field's record in the T_RES_TMPLT_FIELD table 337. For instance, a select list might contain 15 different predefined options. These can be setup for both global fields and resource template specific fields. The fields in the table's entries are as follows:

| Name | Type | Description |
|---|---|---|
| ID | varchar2(32) | record identifier |
| NAME | varchar2(128) | name of data field |
| FIELD_ID | varchar2(32) | field ID from |
| | | T_RES_TMPLT_FIELD |
| SEQUENCE_NUM | number(4,0) | display sequence number |
| ARCHIVED_DATE | date | date archived |
| ARCHIVED_BY | varchar2(32) | user archiving record |
| LOCKED_DATE | date | date locked |
| LOCKED_BY | varchar2(32) | user locking record |
| CREATED_DATE | date | date created |
| UPDATED_DATE | date | date updated |
| OBJ_VERSION | integer | version number |

T_RES_TMPLT_CATEGORY (339): The T_RES_TMPLT_CATEGORY table 339 holds the details of the resource template categories. There is an entry for each category. The fields in the table's entries are as follows:

| Name | Type | Description |
|---|---|---|
| ID | varchar2(32) | record identifier |
| NAME | varchar2(128) | category name |
| DESCRIPTION | varchar2 | category description |
| ARCHIVED_DATE | date | date archived |
| ARCHIVED_BY | varchar2(32) | user archiving record |
| LOCKED_DATE | date | date locked |
| LOCKED_BY | varchar2(32) | user locking record |
| CREATED_DATE | date | date created |
| CREATED_BY | varchar2(32) | user creating record |
| UPDATED_DATE | date | date last updated |
| OBJ_VERSION | integer | version number |

T_RES_TMPLT_CATEGORY_MAP (340): The entries in the T_RES_TMPLT_CATEGORY_MAP table 340 relate categories to resource templates. There is an entry for each template/category association. Each entry references the resource template's record in the T_RES_TMPLT table 335 and the category's record in the T_RES_TMPLT_CATEGORY table 339. The fields in the table's entries are as follows:

| Name | Type | Description |
|---|---|---|
| RES_TMPLT_ID | varchar2(32) | resource template ID from |
| | | T_RES_TMPLT |
| CATEGORY_ID | varchar2(32) | category ID from |
| | | T_RES_TMPLT_CATEGORY |

T_USER_PROFILE (341): The T_USER_PROFILE table 341 holds the information of users in the system and relates the user to a company, division, and department. There is an entry for each user. Each entry references a company's record in the T_MD_COMPANY table 310, a division's record in the T_MD_DIVISION table 311, and a department's record in the T_MD_DEPARTMENT table 312. The fields in the table's entries are as follows:

| Name | Type | Description |
|---|---|---|
| ID | varchar2(32) | record identifier |
| TITLE | varchar2(32) | user job title |
| FIRST_NAME | varchar2(32) | first name |
| MIDDLE_NAME | varchar2(32) | middle name |
| LAST_NAME | varchar2(32) | last name |
| SUFFIX | varchar2(32) | name suffix |
| EMAIL | varchar2(255) | email address |
| ADDRESS1 | varchar2(64) | address |
| STREET | varchar2(64) | street |
| CITY | varchar2(64) | city |
| COUNTY | varchar2(64) | county |
| STATE | varchar2(128) | state |
| COUNTRY | varchar2(128) | country |
| POSTAL_CODE | varchar2(16) | postal code |
| PHONE | varchar2(24) | phone number |
| MOBILE | varchar2(24) | mobile number |
| PAGER | varchar2(24) | page number |
| FIRST_LOGIN | char(1) | whether logged |
| | | in for first time |
| LICENSE_AGREEMENT | date | date accept |
| | | license agreement |
| CREATED_DATE | date | date created |
| UPDATED_DATE | date | date last updated |
| OBJ_VERSION | integer | version number |

T_USER_PROFILE_WORK (354): The T_USER_PROFILE_WORK table holds the information of users in the system. There is an entry for each user, and each entry references the user's record in the T_USER_PROFILE table 341. The fields in the table's entries are as follows:

| Name | Type | Description |
|---|---|---|
| USER_ID | varchar2(32) | user ID from |
| | | T_USR_PROFILE |
| JOB_TITLE | varchar2(64) | user job title |
| JOB_DESCRIPTION | varchar2(4000) | job description |
| SPECIALTIES | varchar2(4000) | user specialties |
| CERTIFICATIONS | varchar2(4000) | user certifications |
| WORK_ID | varchar2(128) | user work ID |
| BADGE_NUMBER | varchar2(128) | user badge number |
| ADDRESS1 | varchar2(64) | address |
| STREET | varchar2(64) | street |
| CITY | varchar2(64) | city |
| COUNTY | varchar2(64) | county |
| STATE | varchar2(128) | state |
| COUNTRY | varchar2(128) | country |
| POSTAL_CODE | varchar2(16) | postal code |
| COMPANY_ID | varchar2(32) | company ID from |
| | | T_MD_COMPANY |
| DIVISION_ID | varchar2(32) | division ID from |
| | | T_MD_DIVISION |
| DEPARTMENT_ID | varchar2(32) | department ID from |
| | | T_MD_DEPARTMENT |
| PHONE | varchar2(24) | phone number |
| MOBILE | varchar2(24) | mobile number |
| PAGER | varchar2(24) | page number |
| OFFICE_BUILDING | varchar2(64) | office building |
| OFFICE_FLOOR | varchar2(12) | office floor |
| OFFICE_ROOM | varchar2(12) | office room |
| OFFICE_PHONE | varchar2(24) | office phone number |
| OBJ_VERSION | integer | version number |

T_USER_LOGIN (342): The entries in the T_USER LOGIN table 342 relate login information to users in the system, if authenticating users through the application. There is one entry for each user. Each entry references the user's record in the T_USER_PROFILE table 341. The fields in the table's entries are as follows:

| Name | Type | Description |
|---|---|---|
| USER_ID | varchar2(32) | user ID from |
| | | T_USER_PROFILE |
| PASS_WORD | varchar2(64) | password |
| PASS_WORD_DATE | date | date password set |
| AUTO_LOCKED_DATE | date | date auto locked set |
| ARCHIVED_DATE | date | date archived |
| ARCHIVED_BY | varchar2(32) | user archiving record |
| LOCKED_DATE | date | date locked |
| LOCKED_BY | varchar2(32) | user locking record |
| CONNECTED_DATE | date | date connected |
| CREATED_DATE | date | date created |
| UPDATED_DATE | date | date last updated |
| OBJ_VERSION | integer | version number |

T_USER_LOGIN_HISTORY (343): The entries in the T_USER_LOGIN_HISTORY table 343 relate the login/logout dates/times to individual users. There is an entry for each login and each logout. Each entry references a user's record in the T_USER PROFILE table 341. The fields in the table's entries are as follows:

| Name | Type | Description |
|---|---|---|
| HISTORY_ID | varchar2(32) | history ID |
| USER_ID | varchar2(32) | user ID from T_USER_PROFILE |
| LOGIN_DATE | date | date of login |
| LOGOUT_DATE | date | date of logout |
| OBJ_VERSION | integer | version number |

T_USER_PREFERENCES (344): The entries in the T_USER_PREFERENCES table 344 relate preferences to individual users. There is an entry for each user. Each entry references a user's record in the T_USER_PROFILE table 341. The fields in the table's entries are as follows:

| Name | Type | Description |
|---|---|---|
| USER_ID | varchar2(32) | user ID from |
| | | T_USER_PROFILE |
| DEFAULT_WORKSPACE_ID | varchar2(32) | default workspace |
| DEFAULT_NAVIGATOR | varchar2(16) | default navigator view |
| DEFAULT_LANGUAGE | varchar2(2) | default language |
| EMAIL_ALERTS | char(1) | set to receive email alerts |
| EMAIL_MESSAGES | char(1) | set to receive email |
| | | message |
| OBJ_VERSION | integer | version number |

T_USER_ADMIN_ROLE (345): The entries in the T_USER_ADMIN_ROLE table 345 relate application level admin role assignments to users. Users can have multiple admin roles. There is an entry for each role assignment. Each entry references the role's record in the T_ADMIN_ROLE table 301 and the user's record in the T_USER_PROFILE table 341. The fields in the table's entries are as follows:

| Name | Type | Description |
|---|---|---|
| ID | varchar2(32) | record identifier |
| ROLE_ID | varchar2(32) | role ID from T_ADMIN_ROLE |
| USER_ID | varchar2(32) | user ID from T_USER_PROFILE |
| ARCHIVED_DATE | date | date archived |
| ARCHIVED_BY | varchar2(32) | user archiving record |
| LOCKED_DATE | date | date locked |
| LOCKED_BY | varchar2(32) | user locking record |
| CREATED_DATE | date | date created |
| UPDATED_DATE | date | date updated |
| OBJ_VERSION | integer | version number |

T_WORKSPACE (346): The T_WORKSPACE table 346 holds information about workspaces. There is an entry for each workspace. The fields in the table's entries are as follows:

| Name | Type | Description |
|---|---|---|
| ID | varchar2(32) | record identifier |
| NAME | varchar2(128) | workspace name |
| DESCRIPTION | varchar2(2000) | workspace description |
| ARCHIVED_DATE | date | date archived |
| ARCHIVED_BY | varchar2(32) | user archiving record |
| LOCKED_DATE | date | date locked |
| LOCKED_BY | varchar2(32) | user locking record |
| CREATED_DATE | date | date created |
| UPDATED_DATE | date | date last updated |
| OBJ_VERSION | integer | version number |

T_WORKSPACE_ROLE (347): The T_WORKSPACE_ROLE table 347 holds the four workspace roles available: Viewer, User, Manager, and Administrator. There is an entry for each workspace role The fields in the table's entries are as follows:

| Name | Type | Description |
|---|---|---|
| ID | varchar2(32) | record identifier |
| NAME | varchar2(128) | role name |
| CODE | varchar2(32) | role code |
| DESCRIPTION | varchar2(2000) | role description |
| ARCHIVED_DATE | date | date archived |
| ARCHIVED_BY | varchar2(32) | user archiving record |
| LOCKED_DATE | date | date locked |
| LOCKED_BY | varchar2(32) | user locking record |
| CREATED_DATE | date | date created |
| UPDATED_DATE | date | date last updated |
| OBJ_VERSION | integer | version number |

T_WORKSPACE_MEMBER (348): The entries in the T_WORKSPACE_MEMBER table 348 relate users to a workspace and assign their role within the workspace. Users can have different roles in different workspaces. There is an entry for each user/workspace relationship. Each entry references the user's record in the T_USER_PROFILE table 341, the workspace's record in the t-WORKSPACE table 346, and the role's record in the T_WORKSPACE_ROLE table 347. The fields in the table's entries are as follows:

| Name | Type | Description |
|---|---|---|
| ID | varchar2(32) | record identifier |
| USER_ID | varchar2(32) | user ID from T_USER_PROFILE |
| WORKSPACE_ID | varchar2(32) | workspace ID from |
| | | T_WORKSPACE |
| ROLE_ID | varchar2(32) | role ID from |
| | | T_WORKSPACE_ROLE |
| CREATED_DATE | date | date created |
| UPDATED_DATE | date | date last updated |
| OBJ_VERSION | integer | version number |

T_WORKSPACE_GROUP (349): The entries in the T_WORKSPACE_GROUP table 349 relate groups to a workspace. Groups are just a way of grouping a number of users together for easy reference. There is an entry for each group/workspace relationship. Each entry references a workspace's record in the T_WORKSPACE table 346. The fields in the table's entries are as follows:

| Name | Type | Description |
|---|---|---|
| ID | varchar2(32) | record identifier |
| NAME | varchar2(128) | group name |
| DESCRIPTION | varchar2(2000) | group description |
| WORKSPACE_ID | varchar2(32) | workspace ID from |
| | | T_WORKSPACE |
| ARCHIVED_DATE | date | date archived |
| ARCHIVED_BY | varchar2(32) | user archiving record |
| LOCKED_DATE | date | date locked |
| LOCKED_BY | varchar2(32) | user locking record |
| CREATED_DATE | date | date created |
| UPDATED_DATE | date | date updated |
| OBJ_VERSION | integer | version number |

T_WORKSPACE_GROUP_MEMBER (350): The entries in the T_WORKSPACE_GROUP_MEMBER table 350 relate users to workspace groups. Users can belong to any number of groups. There is an entry for each user/workspace relationship. Each entry references the group's record in the T_WORKSPACE_GROUP table 349 and a member's record in the T_WORKSPACE_MEMBER table 348. The fields in the table's entries are as follows:

| Name | Type | Description |
|---|---|---|
| GROUP_ID | varchar2(32) | group ID from T- |
| | | WORKSPACE_GROUP |
| MEMBER_ID | varchar2(32) | member ID from |
| | | T_WORKSPACE_MEMBER |
| ARCHIVED_DATE | date | date archived |
| ARCHIVED_BY | varchar2(32) | user archiving record |
| LOCKED_DATE | date | date locked |
| LOCKED_BY | varchar2(32) | user locking record |
| CREATED_DATE | date | date created |
| UPDATED_DATE | date | date last updated |
| OBJ_VERSION | integer | version number |

T_WORKSPACE_QUICK_LINK (351): The entries in the T_WORKSPACE_QUICK_LINK table 351 relate links to workspaces. They can be used to quickly access information for the entire workgroup. There is an entry for each link/workspace relationship. Each entry references the workspace's record in the T_WORKSPACE table 346. The fields in the table's entries are as follows:

| Name | Type | Description |
|---|---|---|
| ID | varchar2(32) | record identifier |
| NAME | varchar2(128) | link name |
| DESCRIPTION | varchar2(2000) | link description |
| WORKSPACE_ID | varchar2(32) | workspace ID from |
| | | T_WORKSPACE |
| URL | varchar2(2000) | URL for link |
| TARGET | varchar2(32) | target of link |
| SEQUENCE_NUM | number(4,0) | display sequence number |
| ARCHIVED_DATE | date | date archived |
| ARCHIVED_BY | varchar2(32) | user archiving record |
| LOCKED_DATE | date | date locked |
| LOCKED_BY | varchar2(32) | user locking record |
| CREATED_DATE | date | date created |
| UPDATED_DATE | date | date last updated |
| OBJ_VERSION | integer | version number |

T_WORKSPACE_RES_TMPLT (352): The entries in the T_WORKSPACE_RES_TMPLT table 352 relate resources templates to workspaces. There is an entry for each workspace/template relationship. Each entry references the workspace's record in the T_WORKSPACE table 346, and the resource template's record in the T_RES_TMPLT table 335. The fields in the table's entries are as follows:

| Name | Type | Description |
|---|---|---|
| WORKSPACE_ID | varchar2(32) | workspace ID from |
| | | T_WORKSPACE |
| RES_TMPLT_ID | varchar2(32) | resource template ID from |
| | | T_RES_TMPLT |
| CREATED_DATE | date | date created |
| UPDATED_DATE | date | date last updated |
| OBJ_VERSION | integer | version number |

T_WORKSPACE_PREFERENCE (353): The T_WORKSPACE_PREFERENCE table 353 has a many-to-one relationship with T_WORKSPACE 345 and holds an array of preferences for each workspace. There is an entry for each workspace preference. Each entry references the workspace's record in the T_WORKSPACE table 346. The fields in the table's entries are as follows:

| Name | Type | Description |
|---|---|---|
| ID | varchar2(32) | record identifier |
| WORKSPACE_ID | varchar2(32) | workspace ID from |
| | | T_WORKSPACE |
| NAME | varchar2(128) | preference name |
| VALUE | varchar2(2000) | preference value |
| OBJ_VERSION | integer | version number |

C. Administrative Setup

1. Company

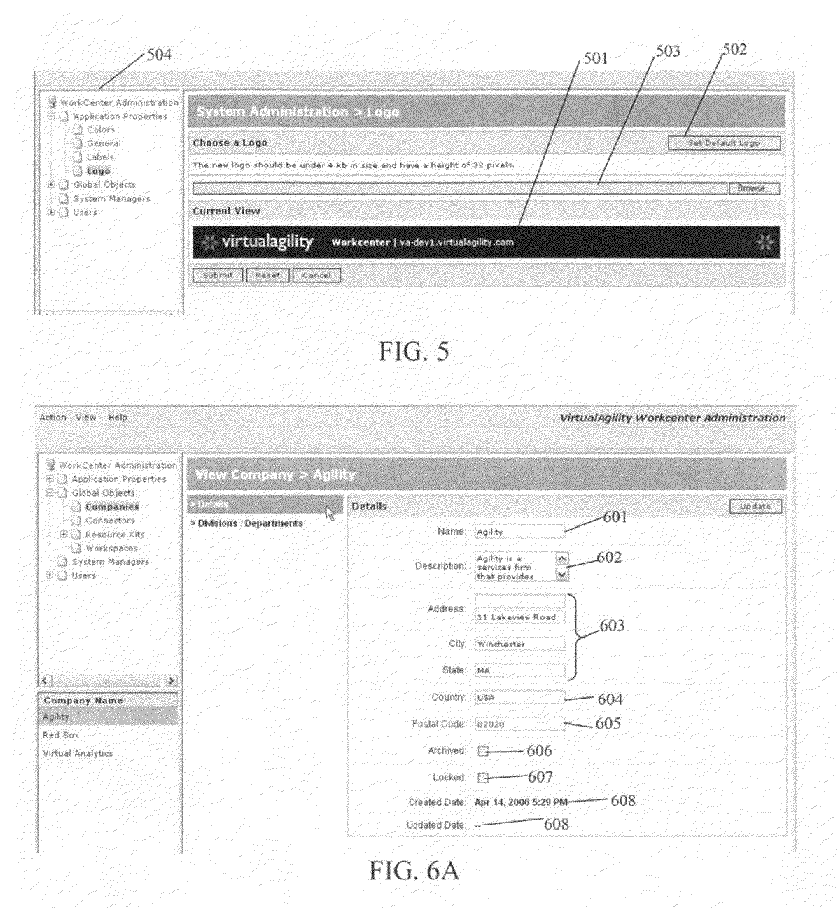

FIGS. 5-10F show administrative tools for setup and management of the system. Administrators can customize non-workspace objects, such as logos to provide a corporate identity to the navigation GUI. The non-workspace objects are displayed in the left navigation GUI 504. As illustrated in FIG. 5, the current logo 501 is shown on the screen. An administrator can choose to set the default logo by selecting the “Set Default Logo” button 502 and selecting the file of the logo in field 503. The logo information is stored in the T_APPLICATION LOGO table 303.

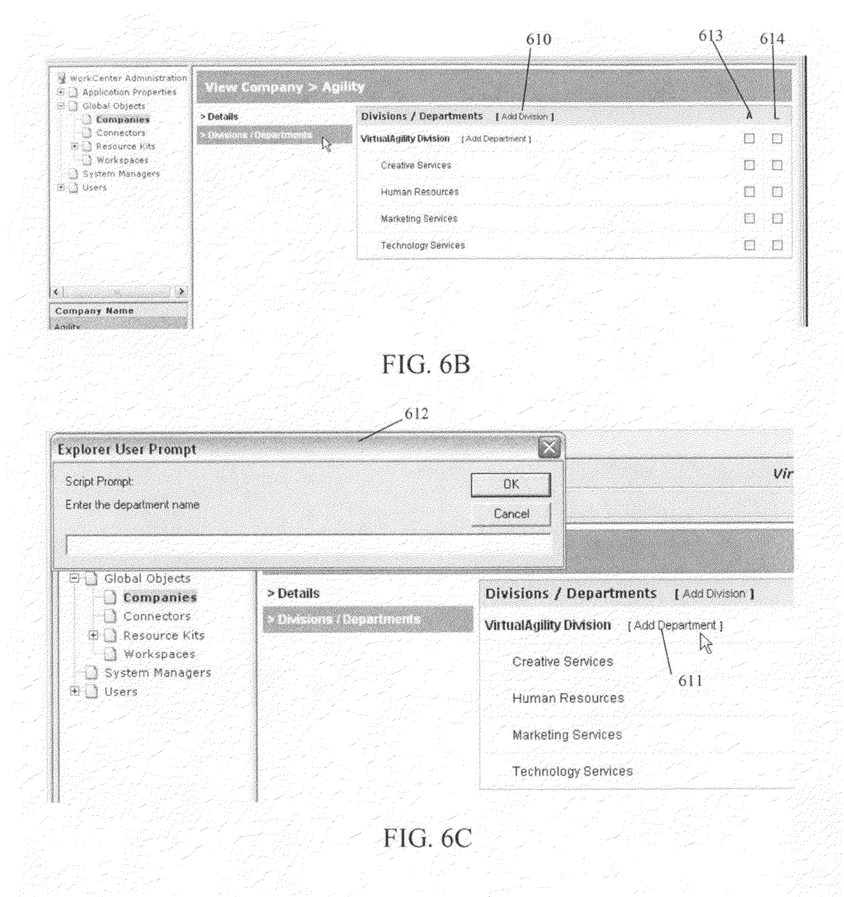

FIGS. 6A-6C illustrate the set up of companies that will be sharing the navigation GUI. An administrator can set the companies, divisions, and departments in the system. Information for a company is stored in an entry in the T_MD_COMPANY table 310. As illustrated in FIG. 6A, the administrator sets the name 601, description 602, the address, city, and state 603, country 604, and postal code 605. The date that the company's record was created 608 and the date that the company information was last updated 609 are also stored in the T_MD_COMPANY table 310.

An administrator can further select the Archive 606 or Lock 607 options. These options provide the ability to lock or archive the system's elements or documents. These options are important in supporting the compliance aspect of the system, where any user, company or element, including any document ever put in the system, is maintained forever. Selection of the Lock option 607 provides the ability to protect an entity so that no other person can change or remove it from the system. The selection of the Archive option 606 means that the record for the company will be removed from the view on the system but will remain within the system's database and could be retrieved if needed.

As illustrated in FIG. 6B, a division can be created and associated with the company by selecting “Add Division” 610. The administrator is then prompted for information for the division. Division information is stored in an entry in the T_MD_DIVISION table 311. The administrator sets the name of the division, the company with which the division is associated, the date the division's record was created, and the date the division information was last updated, which are stored in the entry. The entry references the company in the Company_ID field. The administrator can further select the archive option 613 and/or the lock option 614 for this division.

As illustrated in FIG. 6C, a department can be created and associated with the division by selecting “Add Department” 611. The administrator is then prompted for information for the department, such as through a prompt window 612 for the department name. Information for the department is stored in an entry in the T_MD_DEPARTMENT table 312. The administrator sets the name of the department, the division with which the department is associated, the date the department's record was created, and the date the department information was last updated, which are stored in the entry. The entry references the division in the Division_ID field. The administrator can further select the archive option and/or the lock option (not shown).

2. Resources

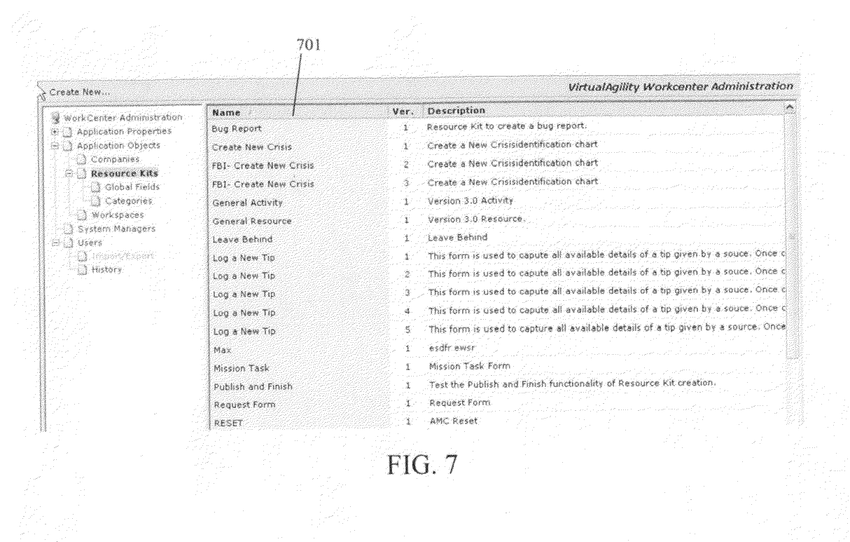

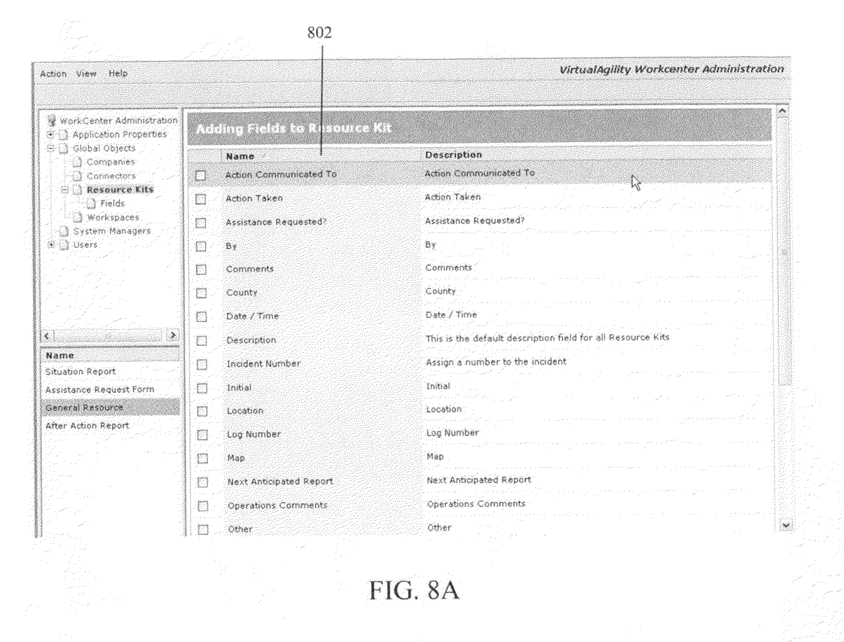

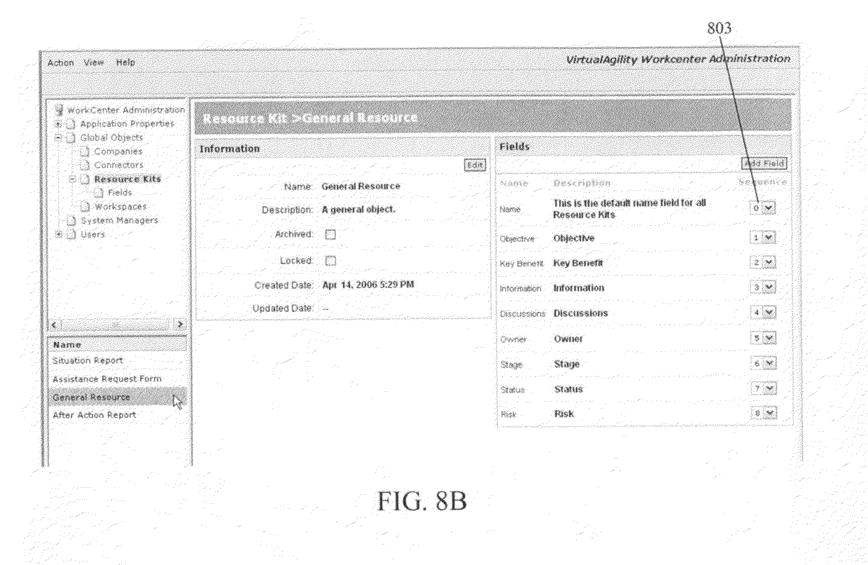

FIGS. 7-8C illustrate the set up of resources. Resource information is stored in the T_OBJ_RESOURCE table 329. As illustrated in FIG. 7, the system first displays the available resources templates 701, which are stored in the T_RES_TMPLT table 335. The fields in a resource template are stored in the T_RES_TMPLT_FIELD_TYPE table 336, the T_RES_TMPLT_FIELD table 337, and the T_RES-TMPLT_FIELD_OPTION table 338. An administrator can choose one of the available resource templates 701 from which to create a new resource template. As illustrated in FIG. 8A, when creating a new resource template, an administrator selects the field(s) they want to use in the resource that will be created from the resource template. The system will contain a list of available fields 802, such as Action Communicated To, Action Taken, Assistance Requested, and others as shown in FIG. 8A. In addition, an administrator can add new fields by defining the type of field and the elements presented. As illustrated in FIG. 8B, the fields can then be placed in the order in which they will appear in the resource template by setting the sequence 803. The creation of a resource from the resource template is described further below in the User's Experience section.

The administrator can further create template categories (not shown) to which the resource template can be related. The template categories are stored in the T_RES_TMPLT CATEGORY table 339, with the resource template/category association stored as an entry in the T_RES_TMPLT_CATEGORY_MAP table 340.

3. Workspaces

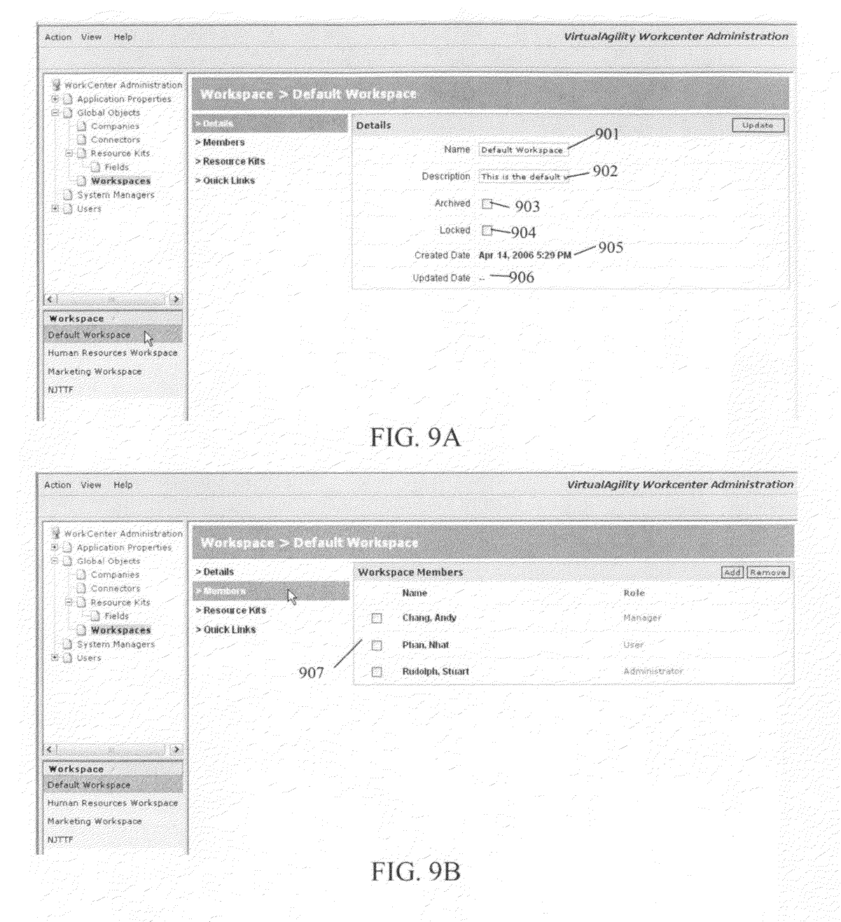

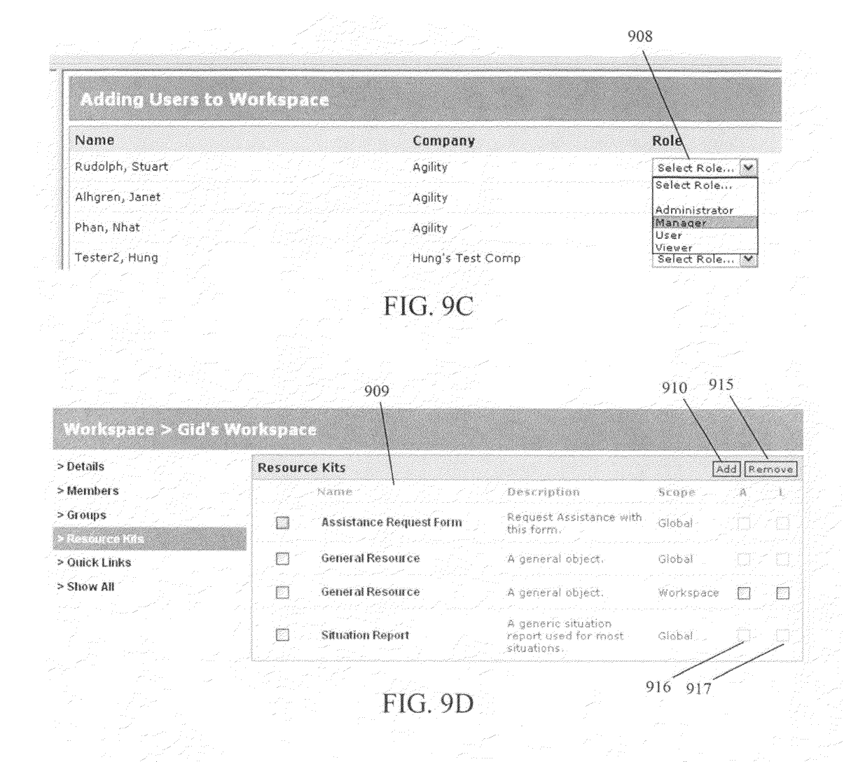

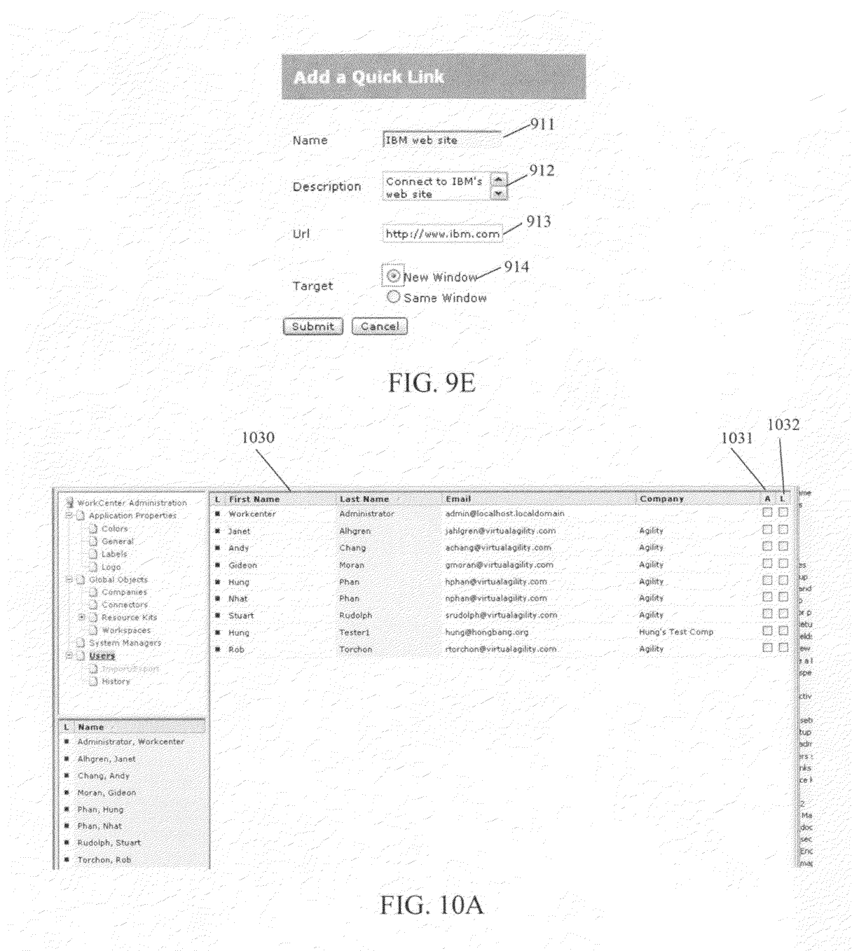

FIGS. 9A-9E illustrate the set up of workspaces. An administrator sets workspace information, which is stored in the T_WORKSPACE table 346. As illustrated in FIG. 9A, workspace information includes the name of the workspace 901, a description of the workspace 902, the date the workspace record was created 905, and the date the workspace information was last updated 906. The administrator can further select the archive option 903 and/or the lock option 904.

As illustrated in FIG. 9B, the administrator can add users 907 as members of the workspace. Information for each user member is stored in the T_WORKSPACE_MEMBER table 348. The information includes the identity of the user member, the User_ID coming from the T_USER_PROFILE table 341. The workspace to which the user is a member is stored in the Workspace_ID field, the workspace ID coming from the T_WORKSPACE table 346. As illustrated in FIG. 9C, each member is assigned privileges or roles 908. The role of a member is stored in the Role_ID field in the T_WORKSPACE_MEMBER TABLE 348, the Role_ID coming from the T_WORKSPACE_ROLE table 347.

If a workspace group is created (not shown), then the workspace group information is stored in the T_WORKSPACE GROUP table 349. Users are then added as members of the workspace group by adding an entry to the T_WORKSPACE_GROUP_MEMBER table 350 with a user's Member_ID and a Group_ID for a workspace group. The Member_ID comes from the T_WORKSPACE_MEMBER table 348. This links users to the workspace group.

As illustrated in FIG. 9D, resource templates 909 can be associated or disassociated with the workspace by checking the appropriate resource template and selecting the Add button 910 or Remove button 915. The association is stored in the T_WORKSPACE_RES_TMPLT table 352, which stores the Workspace_ID from the T_WORKSPACE table 346 and the Res_Tmplt_ID FROM THE T_RES_TMPLT table 335 in the same record. The administrator can further select the archive option 916 or the lock option 917 for any of the resource templates 909.

As illustrated in FIG. 9E, quick links can also be added to the workspace. The quick links are stored in the T_WORKSPACE_QUICK_LINK table 351, including the name 911 of the quick link in the Name field, the description 912 of the quick link, the URL 913 for the quick link, and whether the Target 914 of the quick link is to be displayed in a new window or the same window as the workspace.

4. Users

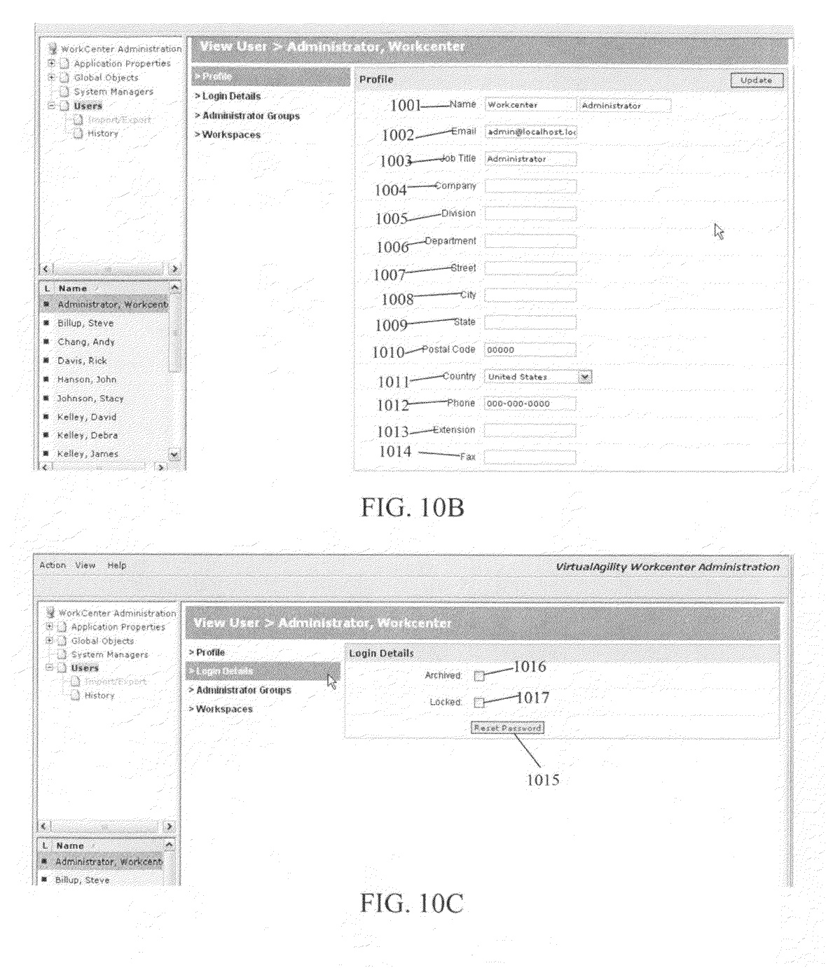

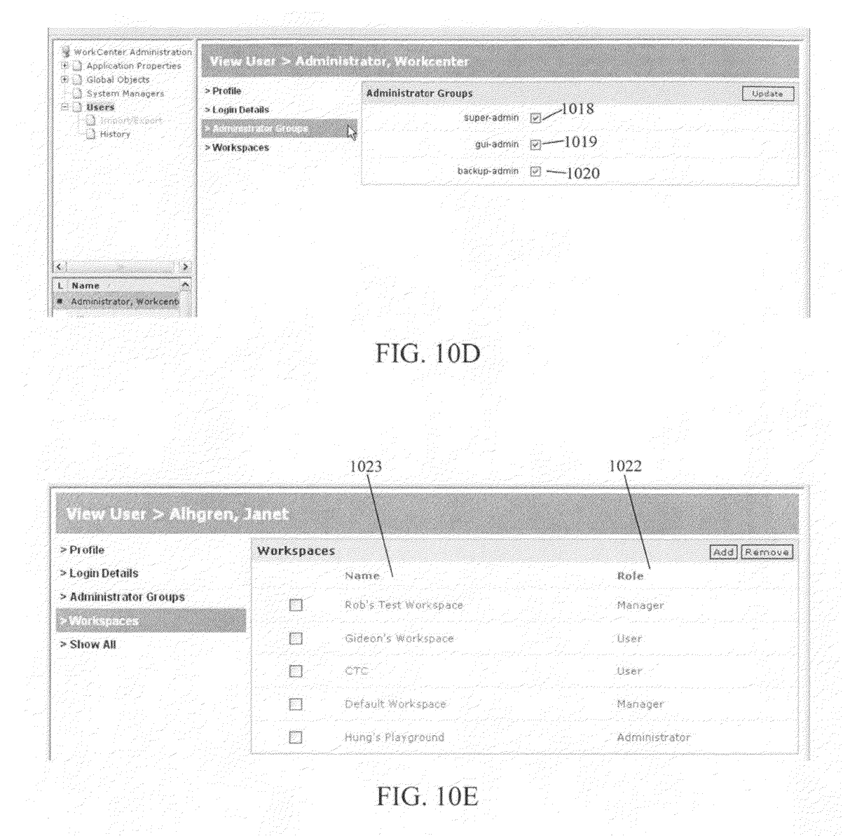

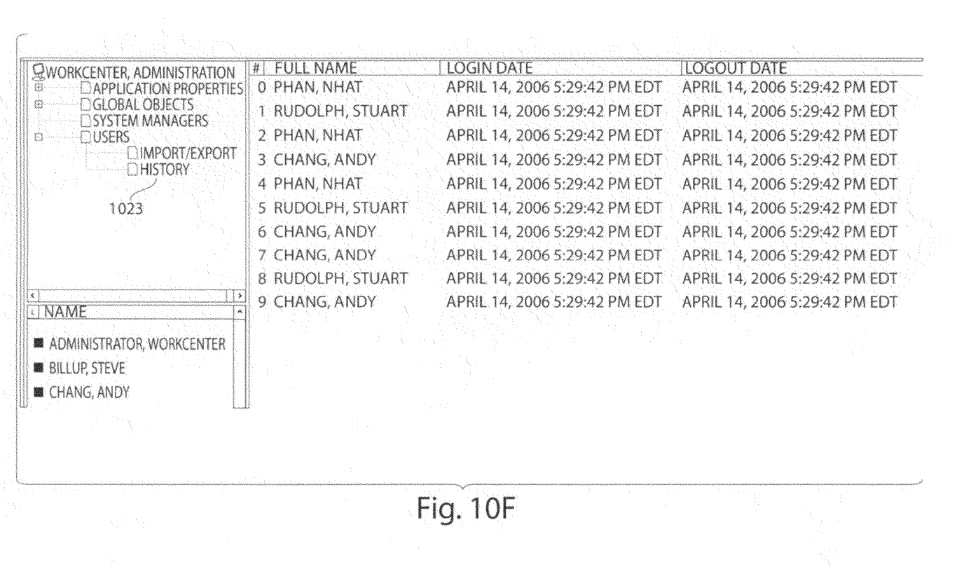

FIGS. 10A-10F illustrate the set up of users. Setting up users is a key function of the system administrator. Users can be added to and removed from the system at any point in time. Since the activities of a user are recorded and information loaded by users might be in use after the user's departure, there is a need to maintain the identity of a user even after he has left or has been terminated from using the system. Therefore, a user is never deleted but rather “archived”. The administrator can create a new user by setting the personal information, provide passwords, and associate the user's role within the system. Users are associated with a company, division, and department as set in the company's profile option. The administrator can update users' information or archive them.

As illustrated in FIG. 10A, the administrator is first shown a list of existing users 1030. From this screen, the administrator can select the archive option 1031 or the lock option 1032 for any of the users 1030. When the administrator selects an “Add User” option (not shown), a blank profile is displayed, as illustrated in FIG. 10B. The administrator fills in the fields, and the field values are stored in the T_USER_PROFILE table 341 and the T_USER_PROFILE_WORK table 354. The user information includes the user name 1001, the email address 1002, the job title 1003, the company 1004, which comes from the T_MD_COMPANY table 310, the division, which comes from the T_MD_DIVISION table 311. and the department, which comes from the T_MD_DIVISION table 312. Also set are the street 1007, city 1008, state 1009, postal code 1010, and country 1011 of the user's address, and the user's phone 1012, extension 1013, and fax 1014 numbers. Also stored in the T_USER_PROFILE table 341 are the first time the user logs in the system, the date the user accepts the application license agreement, the date the user's profile was created, and the date the user's profile was last updated. Drop down menu can be used for any of these fields.

As illustrated in FIG. 10C, the administrator can reset the user's password by selecting the reset password button 1015. The password is stored as part of the user's record in the T_USER_LOGIN table 342, which also stores the date the password was created, the date the login record was created, and the date the login record was last updated. Users can be archived by selecting the archive option 1016, and/or or locked by selecting the lock option 1017.

As illustrated in FIG. 10D, the administrator can authorize the user for administrative roles by selecting a super-admin (site administrator) option 1018, a GUI administrator option 1019, or a backup administrator option 1020. The super-admin has authority to manage anything in the system. The GUI administrator has authority only to manage the navigator GUI. The backup administrator has authority to manage only the backup of the system. The user's role is stored in the T_USER_ADMIN_ROLE table 345, which includes the User_ID and the Role_ID fields. The User_ID comes from the T_USER PROFILE table 341, and the Role_ID comes the T_ADMIN_ROLE table 301.

The administrator can assign users 1021 to each workspace. At the time of selecting a workspace, the administrator can assign to users roles and privileges. Possible roles include Workspace administrator, Manager, User, and Viewer. These assignments are stored in the T_WORKSPACE_MEMBER table 348, which includes the User_ID field from the T_USER_PROFILE table 341, and the Role_ID field from the T_WORKSPACE_ROLE table 347. Users can have different roles in different workspaces. For example, as illustrated in FIG. 10E, user Janet Alhgren is given access to the workspaces listed 1021 and assigned the roles listed 1022 in each respective workspace.

As illustrated in FIG. 10F, the administrator can select History and view the log of each user' access to the system. The login history is stored in the T_USER_LOGIN_HISTORY table 343.

D. User Experience

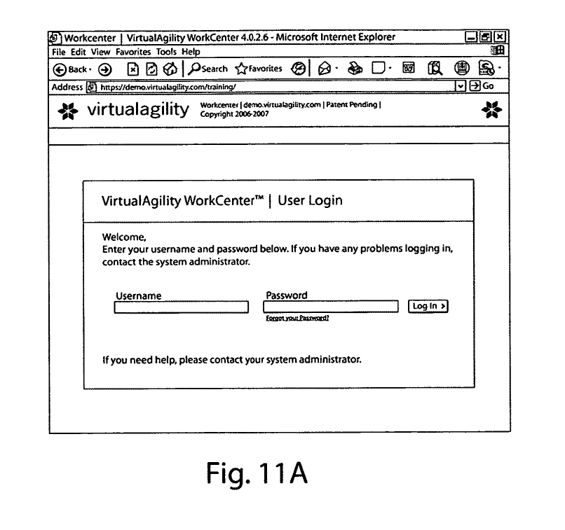

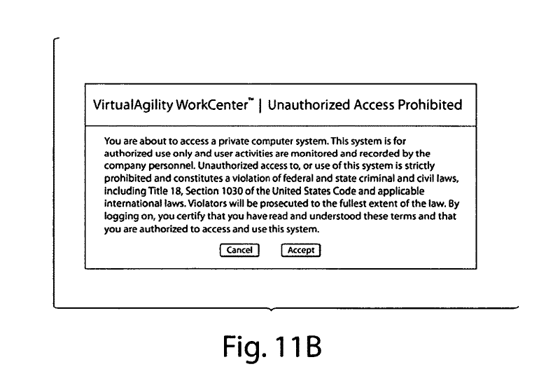

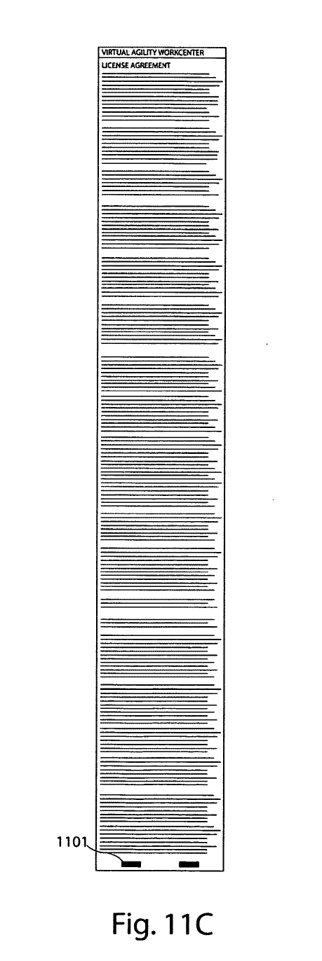

Once the system administrator sets up an account for a user, the user has the ability to log into the system and access the workspaces. The user is provided with a URL for accessing the workspaces, as well as a unique username and password. The user, through a web enabled application, accesses the site at the URL. FIGS. 11A-33G show an example user's experience in using the system to access workspaces.

1. Login

The user launches an Internet browser application at a client and enters the URL address in the browser address field. The user enters the user name and password provided by the administrator in the logon screen, illustrated in FIG. 11A. A corporate network and server usage message may show, as illustrated in FIG. 11B. The user continues by accepting the terms.

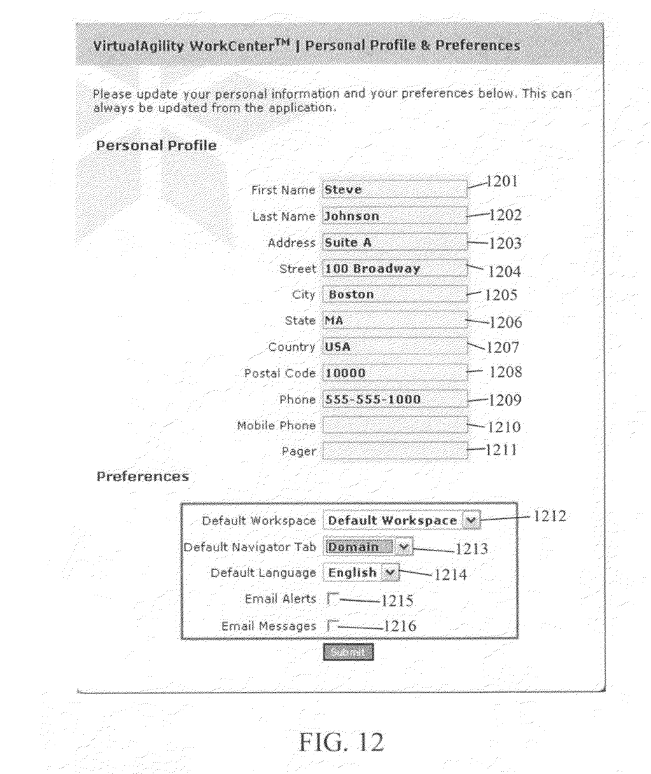

For first time users, a screen will display the licensing agreement and terms of use, as illustrated in FIG. 11C. The user continues by selecting an accept button 1101. The user is then provided an opportunity to add, update, or correct his personal profile information, as illustrated in FIG. 12. The personal profile information is stored in the T_USER_PROFILE table 341 and the T_USER_PROFILE_WORK table 354, and the preferences are stored in the T_USER_PREFERENCES table 344.

The person profile information includes the user's first name 1201 and last name 1202, address 1203, street 1204, city 1205, state 1206, country 1207, and postal code 1208, and the phone 1209, mobile phone 1210, and pager 1211 numbers.

The user preferences include the default workspace 1212, the default navigator tab 1213, and the default language 1214. The user can further choose whether or not to receive email alerts and/or email messages by selecting/deselecting the email alerts option 1215 and email messages option 1216.

Future logons by the user will bypass the licensing agreement and the personal profile setup.

2. Overview Screen

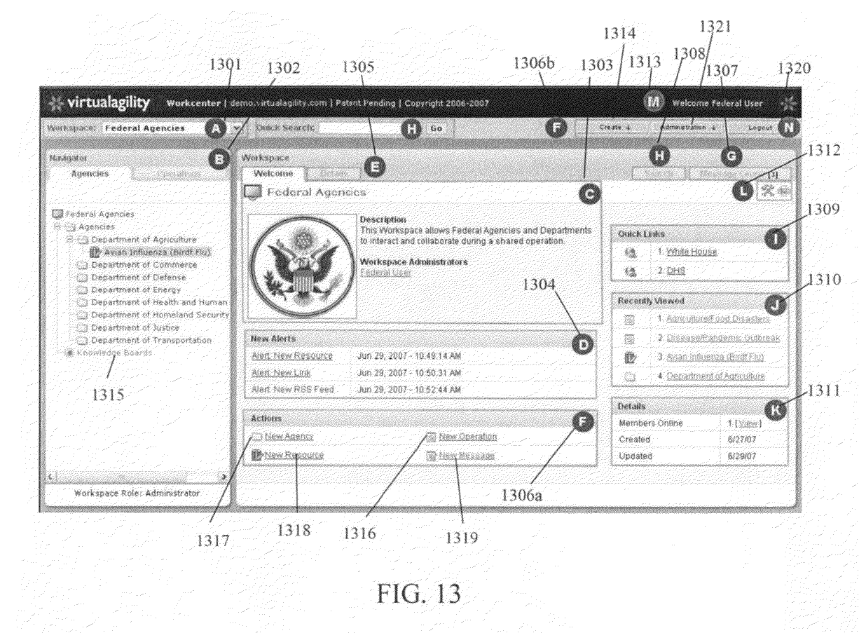

After logging on, the user is displayed the overview screen of the default workspace, an example of which is illustrated in FIG. 13. The overview screen is divided into areas that provide the tools to interact with the system and navigate through the system. The areas include: (A) Default workspace 1301 and a pull down selection to navigate to other workspaces (if applicable); (B) Navigator screen 1302, which is divided into two tables for agencies (domains) and operations (initiatives); (C) overview workspace screen 1303, which includes the logo, a description of the displayed workspace, and a list of administrators; (D) List of new alerts 1304; (E) Detail view 1305 (hidden) which shows the agency, operation, or resource when selected; (F) List of actions 1306a through which the user can start working in the workspace, which can also be taken through pull down tabs 1306b; (G) Message Center 1307 (hidden), providing the ability to see all alerts and messages and the ability for the user to read, send, forward, or reply to alerts and messages; (H) Search 1308 (hidden), for searching the agency, operation, or resource of the workspace; (I) Quick links 1309, which provide general purpose links to web sites or tools; (J) Recently viewed information 1310 for quick reference to last visited pages; (K) Details 1311, which includes creation date and updated date for the workspace, and a list of workspace members on-line or off-line; (L) Tools and print 1312 for editing the welcome screen, if the user has permission to do so, or to print the page; (M) User name display 1313; and (N) Logout button 1320 to ensure that sessions are terminated.

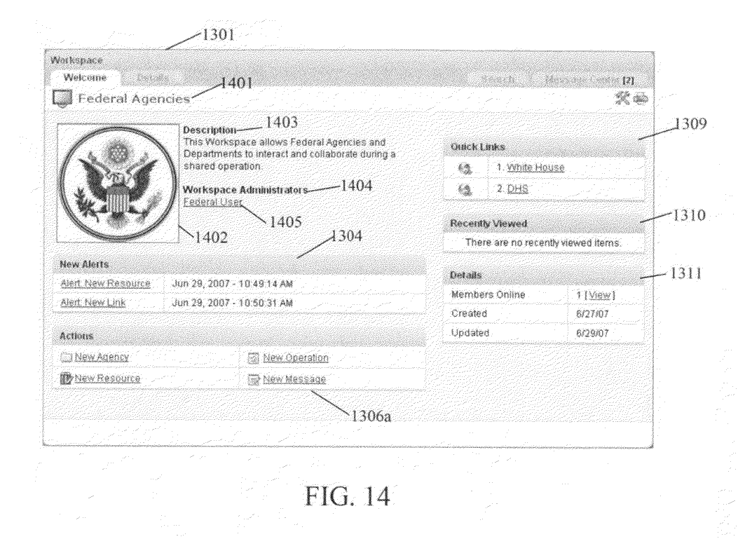

FIG. 14 shows an isolated view of the default workspace screen 1301. The default workspace 1301 includes a title or name of the workspace 1401, a logo or graphic 1402 representing the agency, department or any unique identity for the workspace or its users, a description 1403 that explains the workspace's goal or its purpose, and a list of workspace administrators 1404 and a link 1405 for sending a message to any of the administrators with issues like access, permissions or guidelines. The logo is stored in the T_APPLICATION_LOGO table 303. The name 1401 and description 1402 are stored in the T_WORKSPACE table 346. The list of administrators 1404 is stored in the T_WORKSPACE_MEMBER table 348 as users with a Role_ID field that indicates an administrator role.

The workspace 1301 further includes the list of unread alerts 1304 that are in the user's Message Center, actions 1306a, quick links 1309, recently viewed list 1310, and details 1311. The alerts 1304 are stored in the T_OBJ_DATA_ALERT_USER table 319. Selecting any of the alerts will open the Message Center and the appropriate alert for reference. The Message Center will be further described later in this specification.

The actions 1306a provide direct access to respective Creates dialog where users create new structures or shareable resource element for an agency, operation, resource or message. The create dialogues are shown and described later below. The agency (domain) is stored in the T_OBJ_DOMAIN table 326. The operation (initiative) is stored in the T_OBJ_INTIATIVE table 327. The resource is stored in the T_OBJ_RESOURCE table 329. The agency, operation, and resource are associated with a workspace through the T_OBJ_DATA table 318 as illustrated in FIGS. 4C-4E.

The quick links 1309 provide quick access to general purpose information (or tools) related to the main function of a workspace. The quick links are stored in the T_WORKSPACE_LINK table 350.

The recently viewed list 1310 shows the last screens the user visited. The list is refreshed during logon. Selecting any of the presented entries will open the page in detail view. This enables a user to “jump” to recently visited pages without the need to use the navigator 1302 (FIG. 13).

The details 1311 provide information on the date the workspace was created or modified, stored in the T_WORKSPACE table 346. Depending on the options set up by the administrator for the user, the details 1311 may provide the ability to view other workspace members and whether they are online or offline.

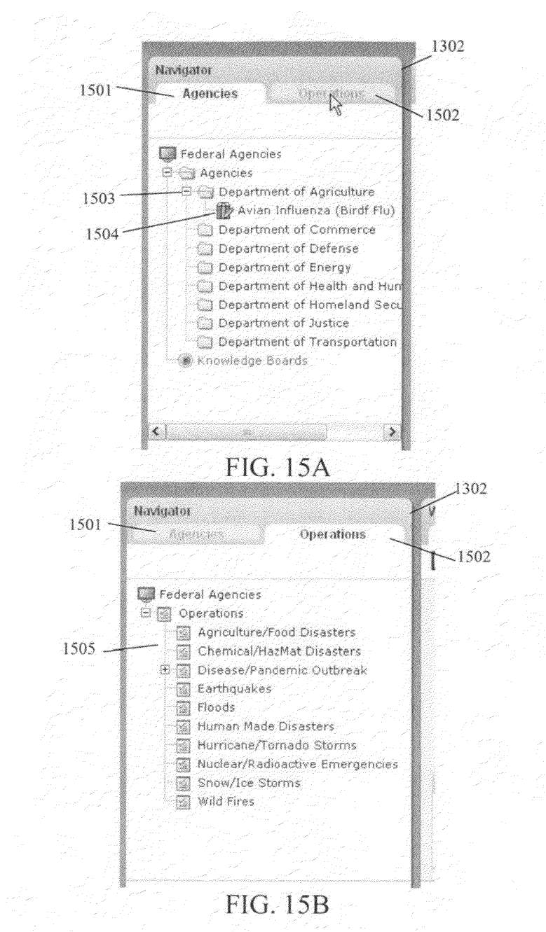

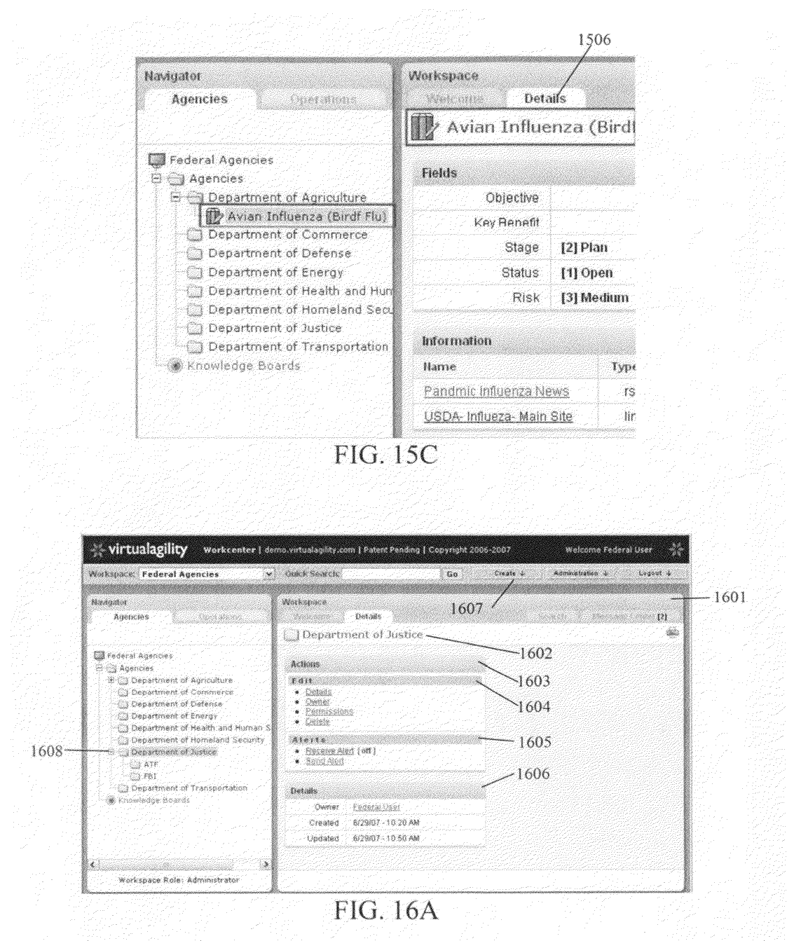

FIGS. 15A-15B show isolated views of the navigator 1302. The navigator 1302 shows the two different views of the resources: the agencies (domains) 1501 and the operations (initiatives) 1502. The two views are selectable through the tabs at the top. Through these views, the entire domain 115 and initiatives 125 hierarchies (FIG. 1) can be accessed. The Agencies 1501 are stored as domains in the T_OBJ_DOMAIN table 326, and the Operations 1502 are stored as initiatives in the T_OBJ_INITIATIVE table 327. These labels can have different names to address the type or function of the organization. Renaming the labels can be done by the administrator.

FIG. 15A shows an example agency view 1501 in the navigator 1302. The agencies represent the organizational structure of the groups coming together, whether they are multiple agencies 1503 or departments 1504 within an organization. These structural elements organize the available information and tools, while indicating who is responsible for creating and maintaining the resources gathered within their domain of responsibility. Here, Federal Agencies is the workspace. Under the Federal Agencies workspace are the agencies (domains) hierarchy. The agencies hierarchy includes sub-domains/sub-agencies, including the Department of Agriculture, Department of Commerce, etc. Under the Department of Agriculture sub-agency 1503 is the resource named Avian Influenza 1504. Selecting the resource 1504 displays the resource's objects in the workspace details view 506, as shown in FIG. 15C.

FIG. 15B shows an example operation view 1502 in the navigator 1302. The operations represent one or more process structures or how the groups or teams accomplish the goals of the workspace. The operations process structure enables users to bring together at each step the resources (tools and information) needed to accomplish that task. The resources 1505 are predefined structure modules created from resource templates. Each resource 1506 can contain fields for data entry, attached documents, and presentations, links to web sites and tools, discussion forums and more. The creation of a resource is described further below.

The resources can be renamed by an administrator to better represent their usage. They can be presented as many times as desired both the agency and operation hierarchies without duplication. This allows users to update and add information in a single place and instantly provide these upgrades to all users without replication. Here, Federal Agencies is the workspace. Under the Federal Agencies workspace are the operations (initiatives). The operation hierarchy 1505 includes sub-operations, including the Agriculture/Food Disasters, Chemical/HazMat Disasters, etc. Under the operations are the objects (hidden) associated with the operations. Selecting one of the objects displays the object's details in the workspace details view 1305. During the launching of the application, the navigator 1302 will be displayed and remain continuously on the screen.

3. Agency (Domain) Screens

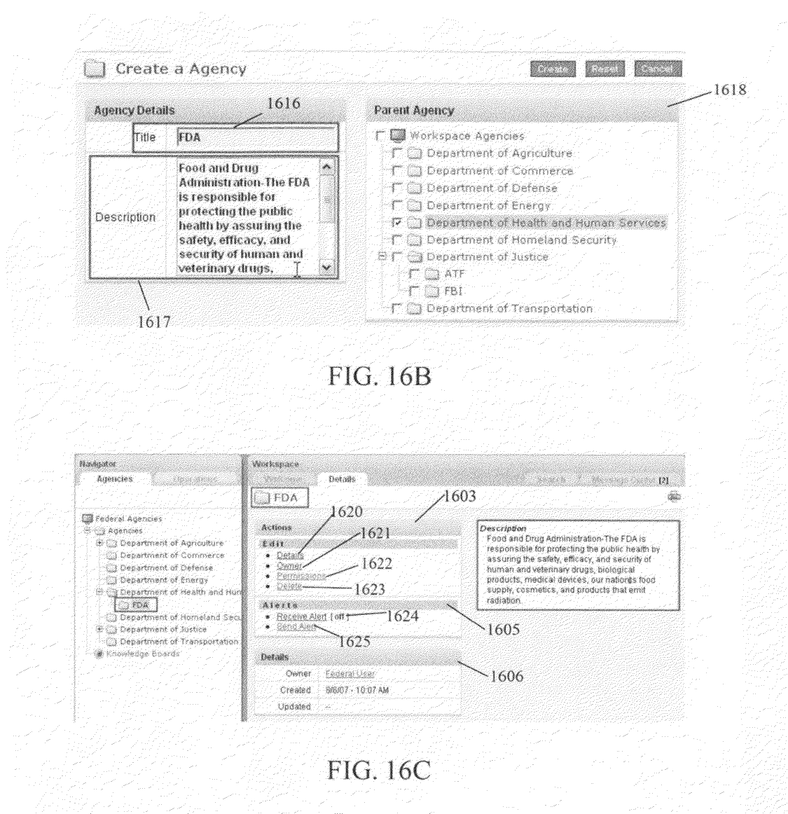

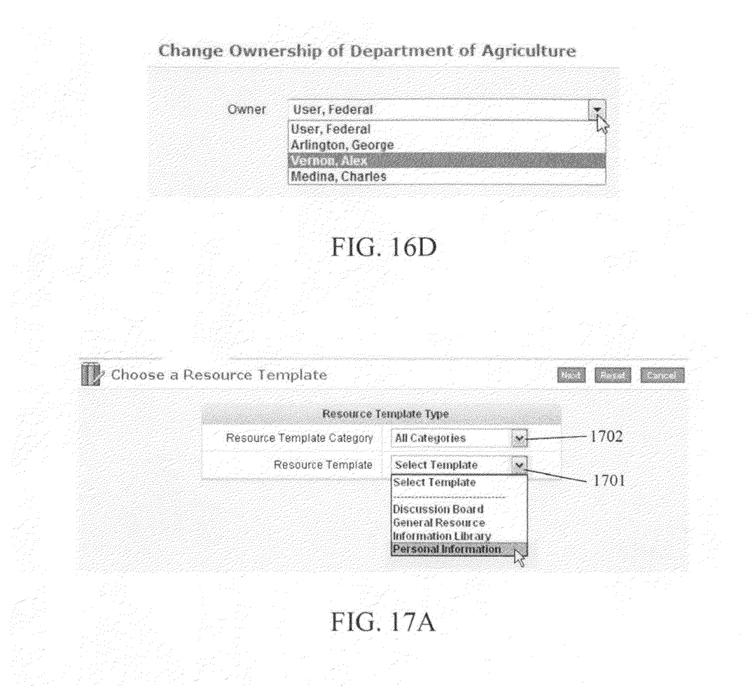

Selecting any of the agencies 1503 from the navigator 1302 will display the agency information within the workspace details view. FIGS. 16A-16D show views of the agency information. FIG. 16A shows the agency main screen. The agency main screen 1601 includes the name of the agency 1602, actions 1603, and details 1606. The actions 1603 include edit 1604 and alerts 1605.

When a user selects the create button 1607 to create a new agency entry, or selects the New Agency option 1317 (FIG. 13) in the overview screen 1301, the screen illustrated in FIG. 16B is shown. The user sets the title 1616 of the agency and the description 1617 of the agency. Both are stored in the T_OBJ_DATA table 318, with the ID of the agency stored in the T_OBJ_DOMAIN table 326 referenced in the Parent_ID field in the T_OBJ_DATA table 318. (See FIG. 4C.) The placement in the parent/daughter domain hierarchy 1618 can also be set, with the parent domain stored in the Parent_ID field of the daughter domain record in the T_OBJ_DATA table 318. The daughter will carry the permissions setup of the parent.

Once created, the new entry is displayed, as illustrated in FIG. 16C. Agency elements can be managed by selection any of the action options: details 1620, owner 1621, permissions 1622, and delete 1623. Selecting details 1620 will open a window similar to the create window shown in FIG. 16B and will allow users to change the title, description, or reposition the agency under another parent agency. Selecting owner 1621 will open a window illustrated in FIG. 16D, which will provide users the option to reassign the responsibility for the agency element to another user. The owner is stored in the Owner_ID field in the T_OBJ_DATA table 318. This feature provides accountability for maintenance of the system's elements because there must always be a user named as the primary owner for each object. Returning to FIG. 16C, selecting permissions 1622 provide users with the option to change the pre-assigned permissions that were granted during the creation of the parent agency. Users can add or remove groups or individual users, or change the permission level for viewer, user, manager, or administrator. These permissions are stored in the T_OBJ_DATA_PERM_GROUP table 320 and the T_OBJ_DATA_PERM_USER table 321. Selecting delete 1623 will archive the agency entry and remove it from view.

Every change to the agency will be marked as an update and will be displayed in the details window 1606.

Users can elect to be or not be alerted of any changes to agency elements by toggling the receive alert option 1624. When toggled “on”, an alert entry will be generated within the message center. The message center is described later below. The receive alert option 1624 is transferred to all daughter domains. To send an alert to other users, the send alert option 1625 is selected. This will open a message window where groups and users are selected and a message to accompany the alert can be typed.

4. Resources

The resources are the main working elements of the application. They contain information, tools, links, and data. Resources are created from resource templates as set by the administrator and assigned to specified workspaces. How a resource template is built is described above in the administrative setup section. Each resource is “owned” by a specific user who is responsible for creating and maintaining the contents.

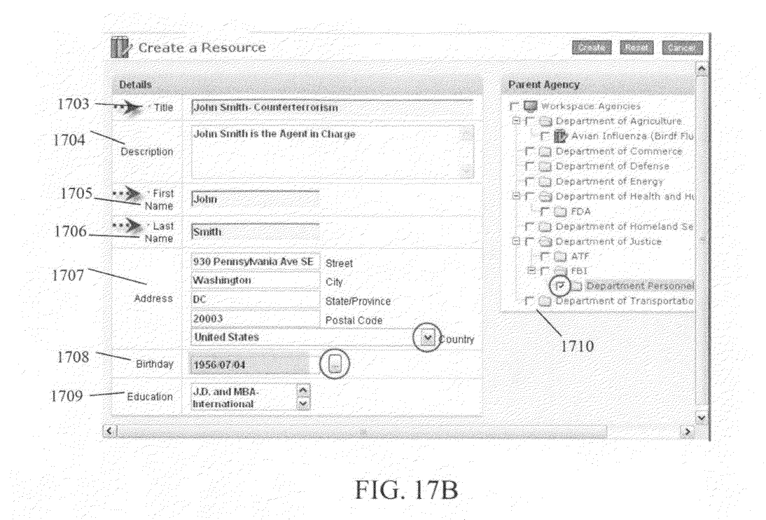

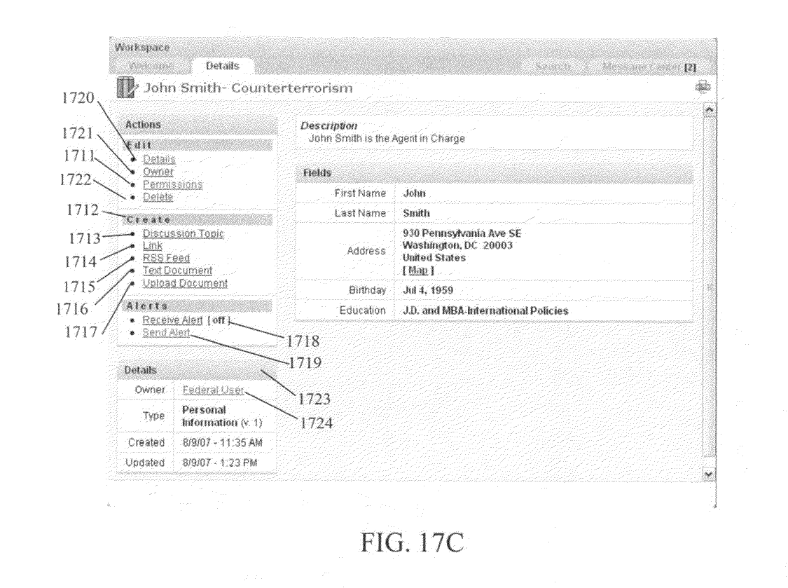

FIGS. 17A-17C show the creation of a resource. To create a resource, the New Resource option 1318 (FIG. 13) on the overview screen 1301 is selected, and a new resource creation dialog is shown to the user, as illustrated in FIG. 17A. The user selects a resource template 1701 to be used for building the resource. An administrator might have defined the template within a category 1702 to help reduce the number of templates presented to the users. The resource templates are stored in the T_RES_TMPLT table 335, and the resource template categories are stored in the T_RES_TMPLT CATEGORY table 339. A resource template related to a template category through an entry in the T_RES_TMPLT_CATEGORY_MAP table 340.

Once the resource template is selected, a blank resource template screen is opened, as illustrated in FIG. 17B. The user enters the title 1703 and description 1704, as well as the name 1705-1706, address 1707, birthday 1708, and education 1709 of the owner of the resource. The user further sets the default placement of the resource in the navigator tree by selecting the parent resource 1710. These pieces of information are stored as records in the T_OBJ_DATA table 318. A completed resource view is shown in FIG. 17C.

Access to the resource is based on permissions. The permissions are automatically set when a resource is created and, during the creation process only, are inherited from the original parent domain/agency or resource in which it is created. At any time, users can confirm the permissions set up or make changes to users and groups by selecting the permissions option 1711. These permissions are stored in the T_OBJ_DATA_PERM_GROUP table 320 and the T_OBJ_DATA_PERM_USER table 321 and were set by the system administrator.

Once a resource is created, content can be added to the resource through the create options 1712. The create options include discussion topic 1713, link 1714, RSS feed 1715, text document 1716, and upload document 1717. These options are optional and are selected to be included with the resource template by the system administrator.

a. Discussion Topics

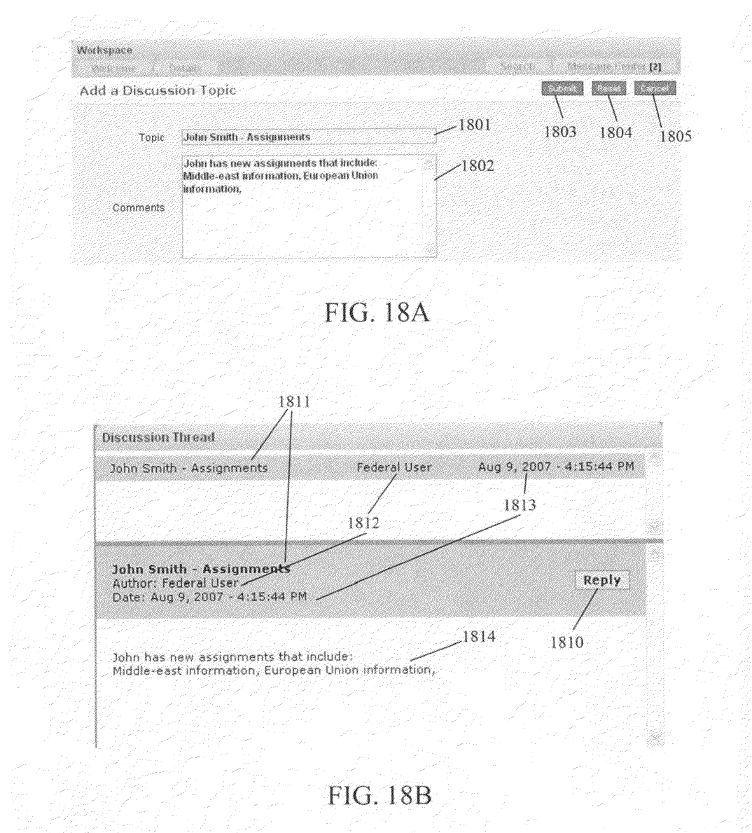

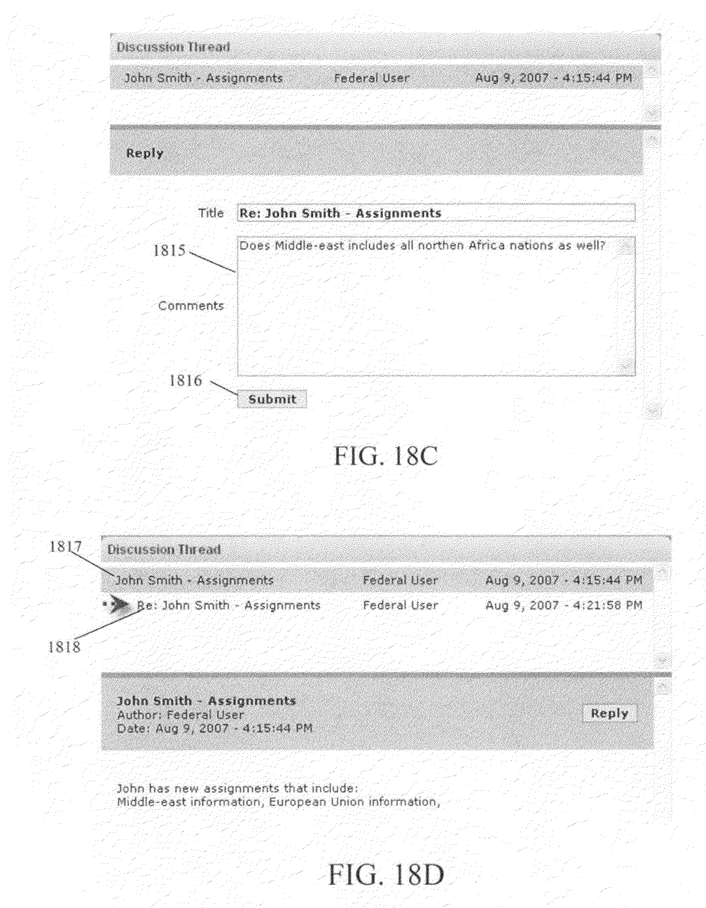

FIGS. 18A-18D show the set up of discussion topics for a resource. Discussions are asynchronous chat boards that provide users with a place to exchange questions, opinions, and remarks in relation to the resource topic. Being asynchronous, it provides the ability to exchange information even when members are offline.

By selecting the discussion topic option 1713 (FIG. 17C), an add a discussion topic dialog is opened, as illustrated in FIG. 18A. The user enters a topic name 1801 and enters text into the comments field 1802. The user selects the submit button 1803 to upload the discussion, the reset button 1804 to start over, and the cancel button 1805 to close and return to the previous screen. Once submitted, the discussion topic is stored in the T_DISCUSSION_TOPIC table 307 and linked to the resource by storing the resource's ID in the Resource_ID field.

FIG. 18B shows an example discussion topic new. The view includes the topic name 1811, the author 1812, the date and time of the posting 1814. A user with the proper permissions can read the topic and reply by selecting the reply button 1810. A reply dialog is then displayed, as illustrated in FIG. 18C, in which the user can type his reply in the comments field 1815. When the submit button 1816 is selected, the reply is stored in the T_DISCUSSION_REPLY table 308.

The discussion topic is then shown with the original discussion 1817 and its replies 1818, as illustrated in FIG. 18D. Discussions are organized as threaded discussions, and the replies are indented to present a visual hierarchy of replies.

b. Links

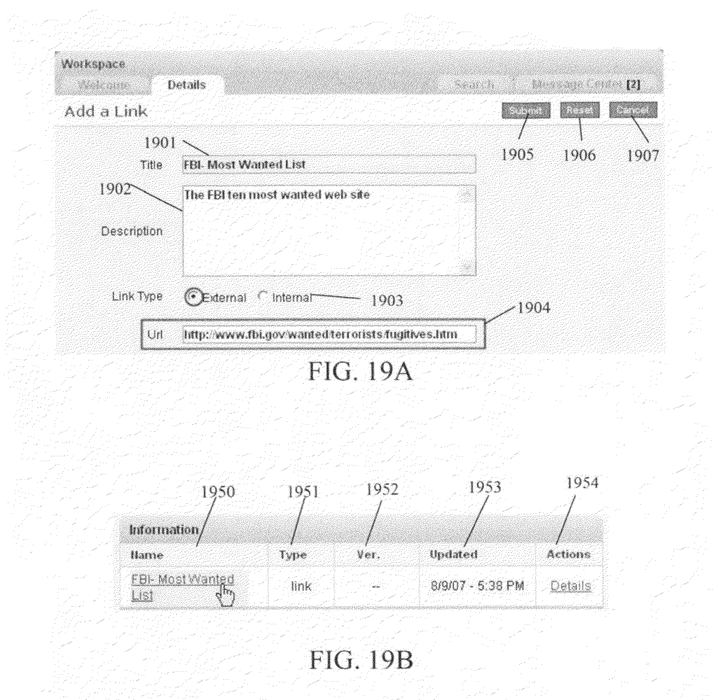

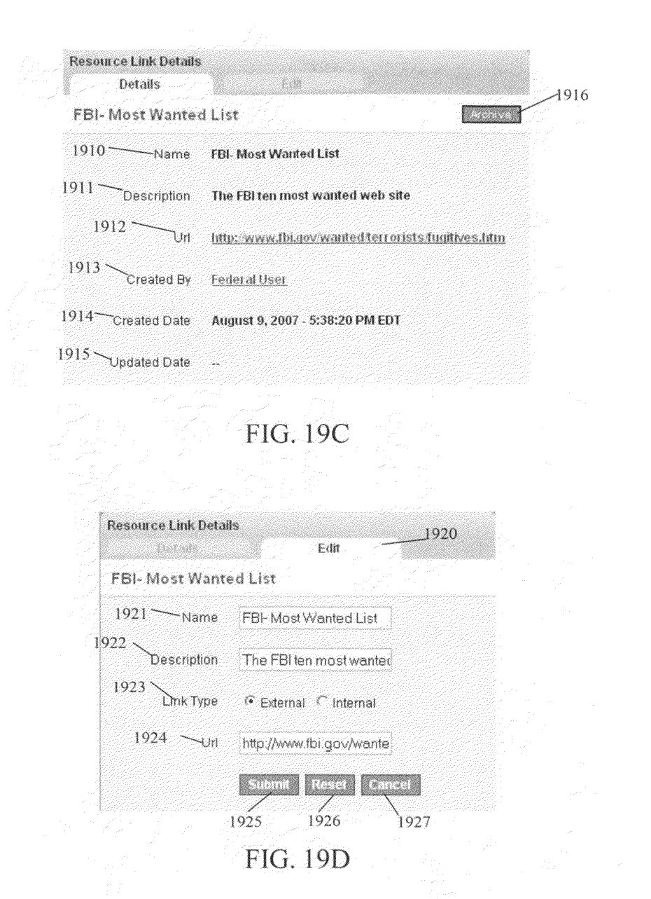

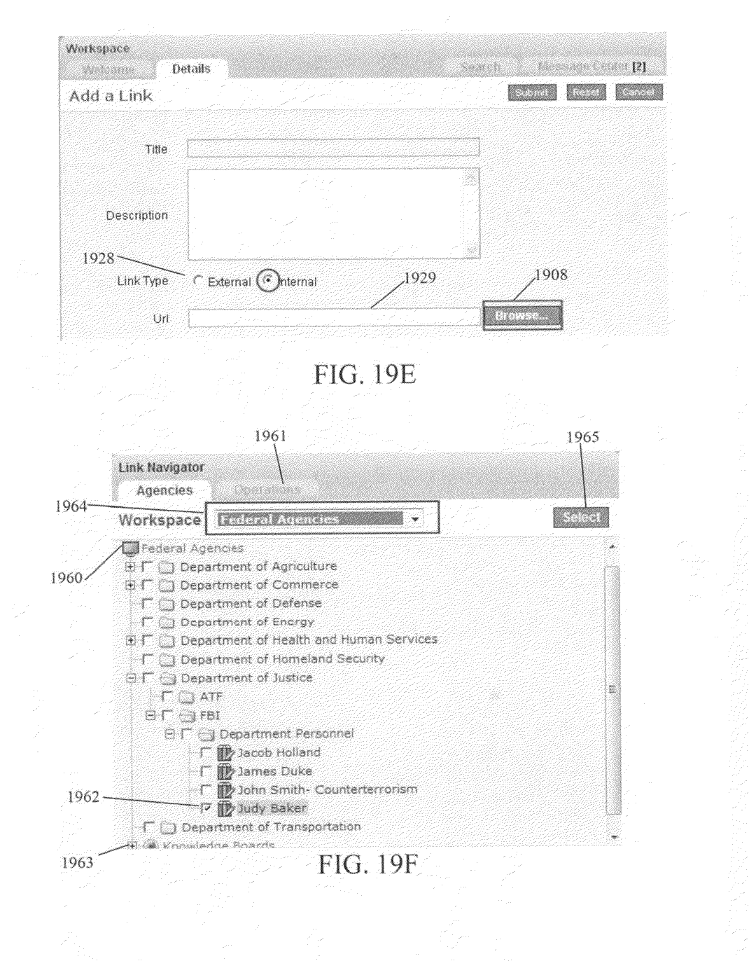

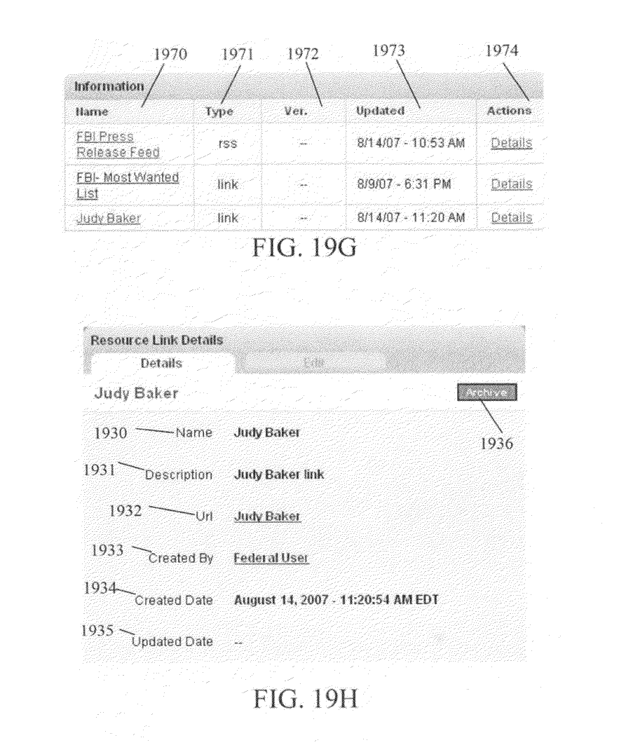

FIGS. 19A-19I show the set up of links for a resource. Links provides quick access to information or tools through providing a network path, like a URL (Uniform Resource Locator). Other types of links can point to or documents on a shared file server. Links are also provided for connecting various resources or knowledge boards within the application so people can access them within the resource topic they are currently utilizing.

To create a link, the link option 1714 (FIG. 17C) is selected. An add a link dialog is displayed, as illustrated in FIG. 19A. The user enters a title 1901 and a description 1902 of the link. The link type 1903 of either external or internal is selected. External link type is for links to external web sites or other systems. Internal link type is for links to resources or knowledge boards within the application. The URL for the link 1904 is entered. The user selects the submit button 1905 to upload the link, the reset button 1906 to start over, and the cancel button 1907 to close and return to the previous screen. Once submitted, the link is stored in the T_OBJ_RESOURCE_INFORMATION table 330 and the T_OBJ_RESOURCE_LINK table 332. The link is then shown in the resource workspace, as shown in FIG. 19B, which includes the title 1950, type 1951, version 1952, date updated 1953, and a details option 1954.

Selection of the title 1950 opens a new window in the web browser to display the contents of the listed URL file or tools, or to launch the appropriate software application. To view details of the link, the details option 1954 is selected, and a link details dialog is displayed, as illustrated in FIG. 19C. The dialog displays the title 1910, description 1911, URL 1912, name of the creator 1913, date created 1914, and date updated 1915. To archive the link and remove it from view, the archive button 1916 is selected.

To change any of the link parameters, the edit tab 1920 is selected, as illustrated in FIG. 19D. The user can Modify or update a name 1921, description 1922, link type 1923, and/or URL 1924. The user selects the submit button 1925 to upload the changes, the reset button 1926 to start over, and the cancel button 1927 to close and return to the previous screen.

Some resource topics can benefit from an internal link connecting to another element in the workspace. A user with permission to access multiple workspaces can also link the resources across workspaces. FIG. 19E shows the creation of an internal link. The internal link provides a link internally to another agency, resource, operation or knowledge board. On the link dialog, the internal link option 1928 is selected. The browse button 1908 is selected to display, as illustrated in FIG. 19F, a list of agencies 1960, operations 1961 (hidden), resources 1962, and knowledge boards 1963, under various workspaces 1964. One of these objects is selected by selecting the select button 1965. A link to the object is automatically entered in the field 1929 in FIG. 19E. Once the internal link is uploaded, it is displayed in the resource workspace, as shown in FIG. 19G, including the title 1970, type 1971, version 1972, date updated 1973, and a details option 1974.

Selection of the details option 1974 displays the link details in a new window, as illustrated in FIG. 19H. The internal link details presents all the information related to the link, including name 1930, description 1931, link 1932, name of the creator 1933, date created 1934, and date updated 1935. To archive the link and remove it from view, the archive button 1936 is selected.

To change any of the link parameters, the edit tab 1947 is selected, as illustrated in FIG. 19I. The user can modify or update a name 1940, description 1941, link type 1942, and/or URL 1943. The user selects the submit button 1944 to upload the changes, the reset button 1945 to start over, and the cancel button 1946 to close and return to the previous screen.

c. RSS Feeds

Some resources can benefit from regular and automatic information updates provided through RSS feeds. An RSS feed is a web feed format used to publish frequently updated content from Internet websites. RSS content is read in a special web browser window called an RSS reader. To link to an RSS feed, the user needs to define the link/address of the feed. Many news providers provide RSS feed links on their web sites.

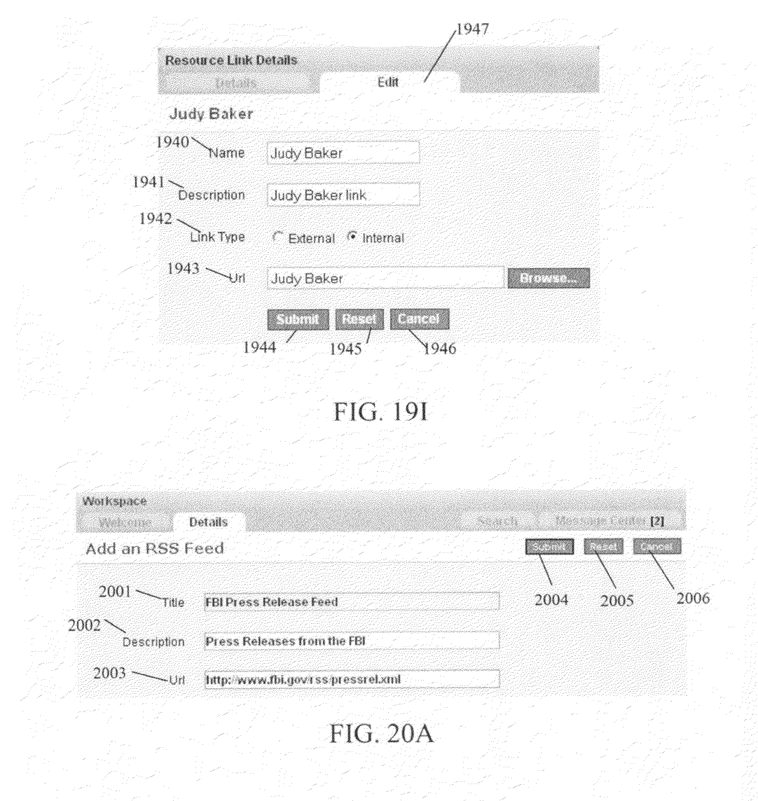

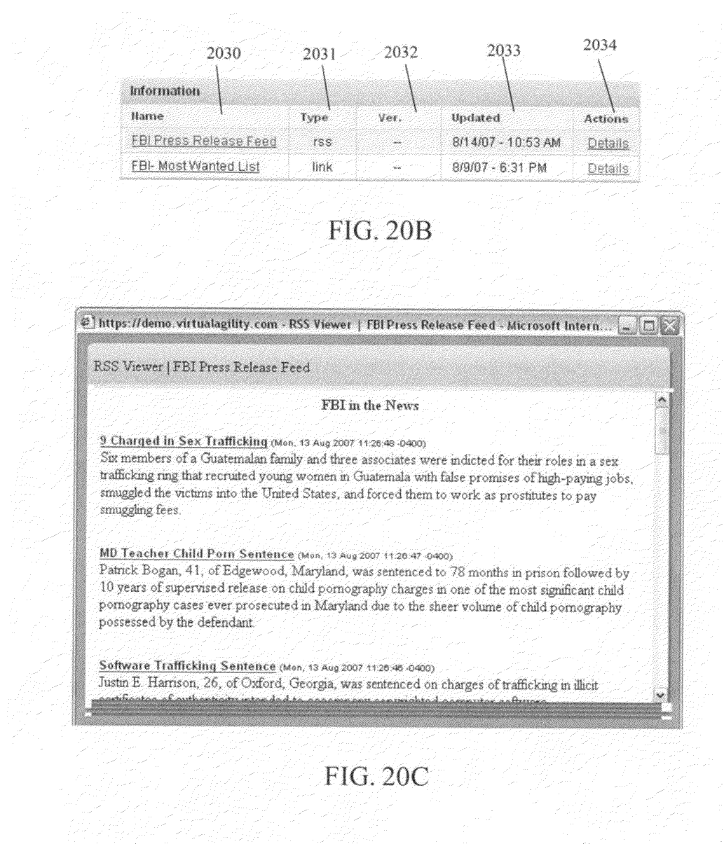

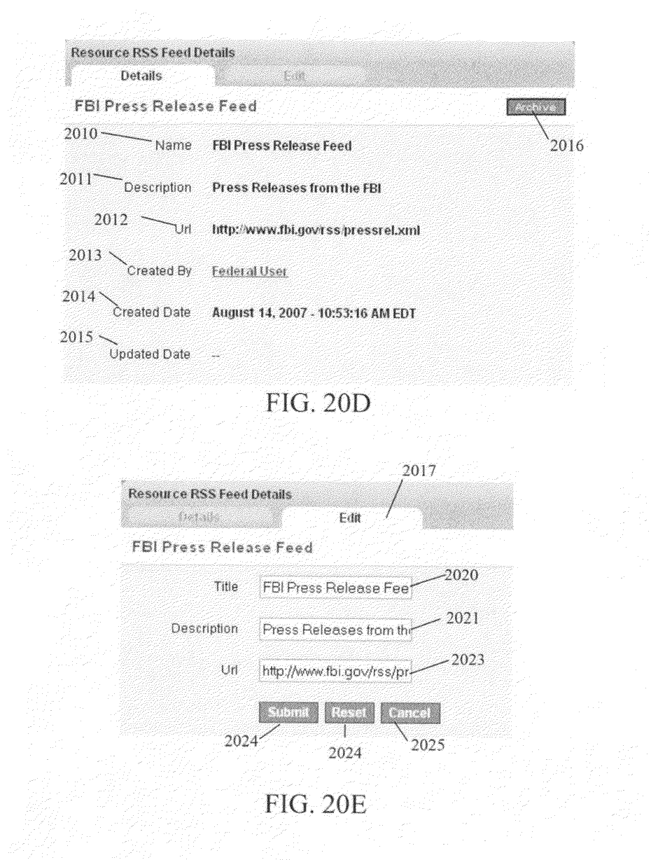

FIGS. 20A-20F show the set up of RSS feeds for a resource. The user first locates a site providing the RSS feed and captures the URL. To add an RSS feed to the workspace, the RSS Feed option 1715 (FIG. 17C) is selected. An add a RSS feed dialog is displayed, as illustrated in FIG. 20A. The user enters a title 2001, a description 2002 of the RSS feed, and the URL 2003 for the RSS feed. The user selects the submit button 2004 to upload the RSS feed, the reset button 2005 to start over, and the cancel button 2006 to close and return to the previous screen. Once submitted, the RSS feed is stored in the T_OBJ_RESOURCE_INFORMATION table 330 and the T_OBJ_RESOURCE_RSS table 333. The RSS feed is then shown in the resource workspace as shown in FIG. 20B, including the title 2030, type 2031, version 2032, date updated 2033, and a details option 2034.

Selection of the RSS feed title 2030 launches the web site with a full article, as illustrated in FIG. 20C. The user can choose to view the details of the RSS feed by selecting the details option 2024, as illustrated in FIG. 20D. The RSS feed details presents the information related to the RSS feed, including the name 2010, description 2011, URL 2012, name of the creator 2013, date created 2014, and date updated 2015. To archive the RSS feed and remove it from view, the archive button 2016 is selected.

To change any of the RSS feed parameters, the edit tab 2017 is selected, as illustrated in FIG. 20E. The user can modify or update a name 2020, description 2021, and/or URL 2022. The user selects the submit button 2023 to upload the changes, the reset button 2024 to start over, and the cancel button 2025 to close and return to the previous screen.

d. Text Files

The option to create a text file provides users with the ability to create text and add a “.txt” file to the system without using a work processing program. A text file (.txt) can be opened with a standard text editor program provided by all computers. This is a simple and easy way to create and share written documents with other users. It is also an easy way to share and preserve emails by simply copying the email, paste it into an open text document, and storing it in a resource. The email information thereby becomes part of the resource and can be shared.

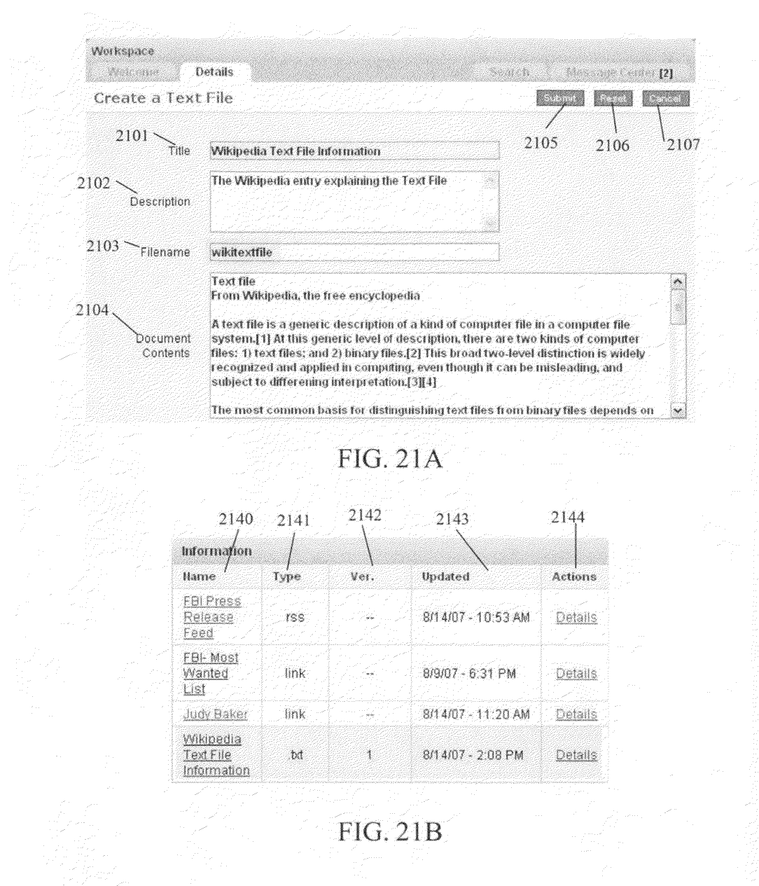

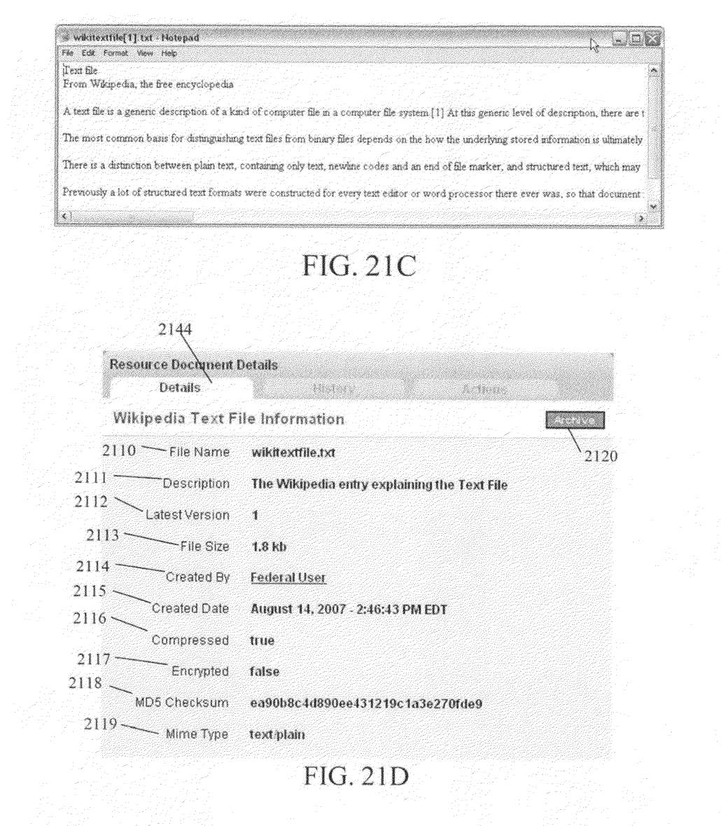

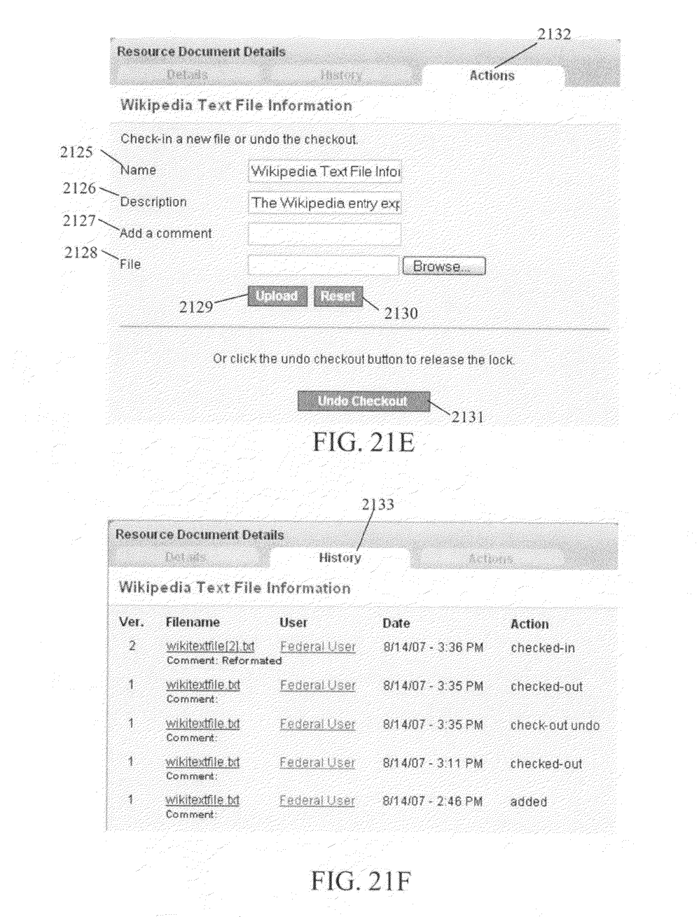

FIGS. 21A-21F show the set up of text files for a workspace. To add a text file, the Text Document option 1716 (FIG. 17C) is selected. A create a text file dialog is displayed, as illustrated in FIG. 21A. The user enters a title 2101, a description 2102 of the text file, a file name 2103, and the document contents 2104. The user selects the submit button 2105 to create and save the text file, the reset button 2106 to start over, and the cancel button 2107 to close and return to the previous screen. Once submitted, the text file is stored in the T_OBJ_RESOURCE_INFORMATION table 330 and the T_OBJ_RESOURCE_DOCUMENT table 331. The text file is then shown in the resource workspace as shown in FIG. 21B, including the title 2140, type 2141, version 2142, date updated 2143, and a details option 2144.

Selection of the text file title 2140 displays the text content in a text editor program, as illustrated in FIG. 21C, where it can be viewed, edited or save to the user's computer under a different file name. The save allows users to add the file to their local computer for future use, re-naming it as necessary.

The user can choose to view details of the information on the text file by selecting the details option 2144, as illustrated in FIG. 21D. The text file details include the file name 2110, description 2111, latest version 2112, file size 2113, name of the creator 2114, date created 2115, whether the file is compressed 2116, whether the file is encrypted 2117, the MD5 checksum 2118 for the file, and the mime type 2119. To archive the text file and remove it from view, the archive button 2120 is selected.

To change any of the text file parameters, the actions tab 2132 is selected, as illustrated in FIG. 21E. The user can modify or update a name 2125 and/or description 2126. The user can add a comment 2127 and/or upload a new version of the file 2128. The user selects the upload button 2129 to upload the changes or the reset button 2130 to start over. In order to upload a new version of the text file, the user must first check the file out of the repository. If no changes were made and the user elects to permit the use of the currently loaded text file, the user selects the undo checkout button 2131.

To view the history of the file and changes made to it, the user selects the history tab 2133, as illustrated in FIG. 21F.

e. Documents

The system enables the loading and storing of document files in any format, such as Microsoft Word™, Excel™, PowerPoint™ files and most other multimedia formats (sound, pictures, graphics, text). For the purpose of simplicity, these file formats are referred to herein as “documents”. To share documents with other users will require those users to have the appropriate software application on their computer to launch and open the specific file format.

The adding of a document here differs from the adding of a text file above in that the documents are not in a *.txt format. The documents also exist locally to a user prior to being added to the workspace.

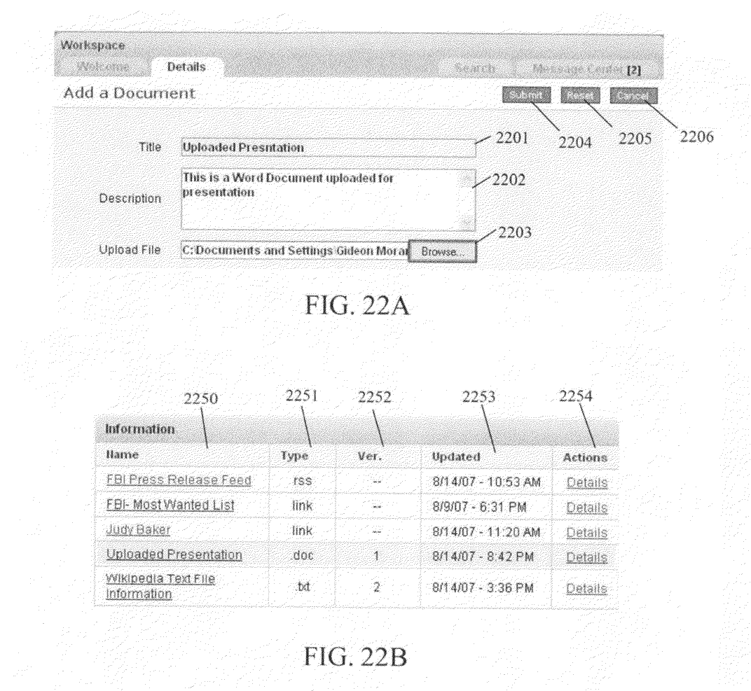

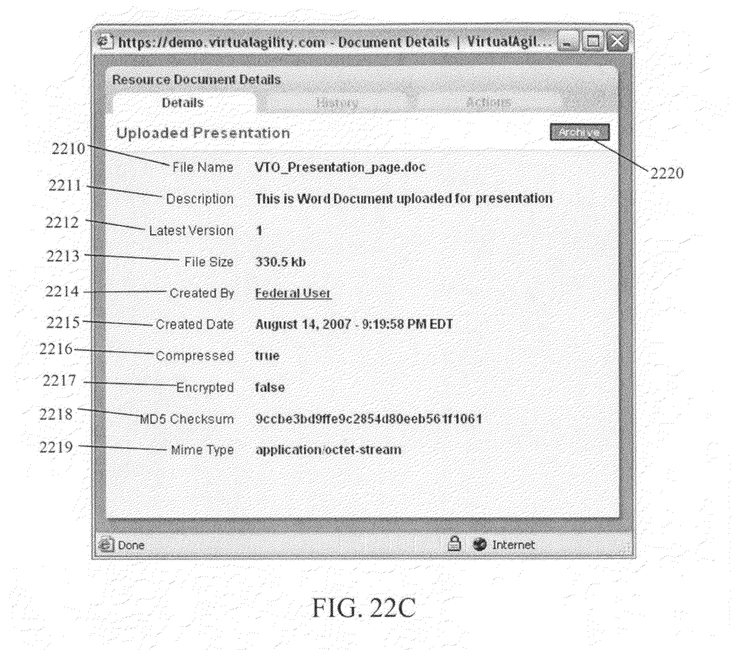

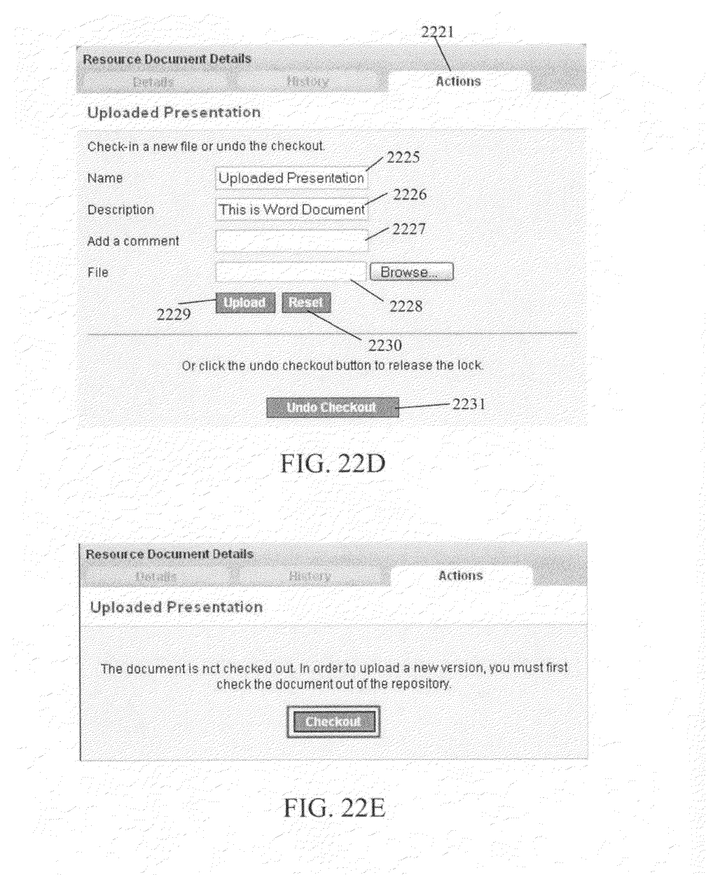

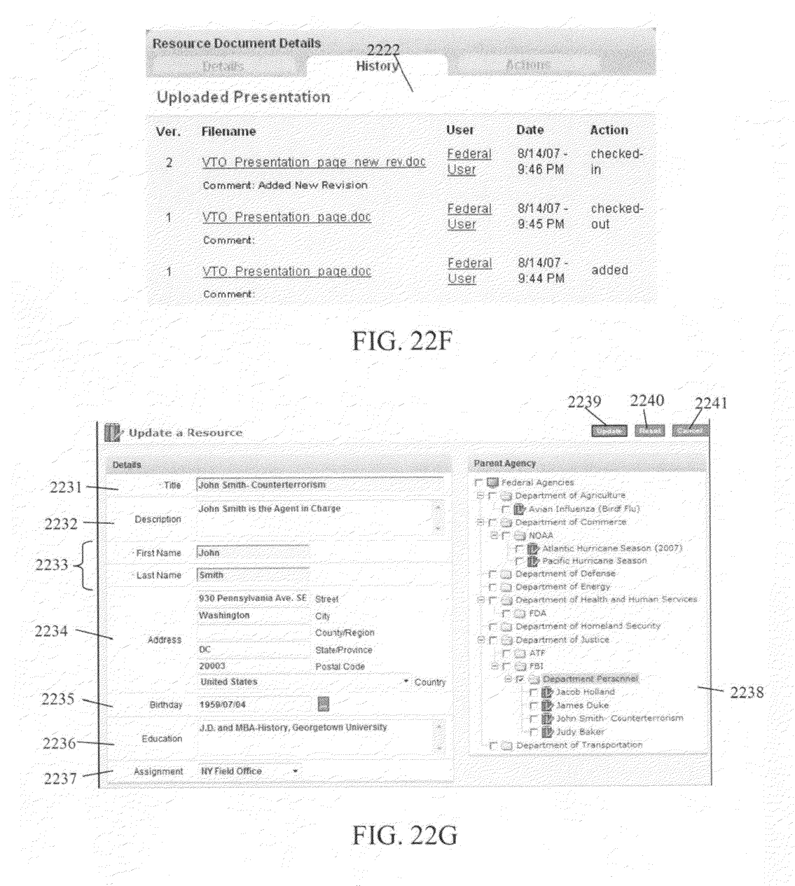

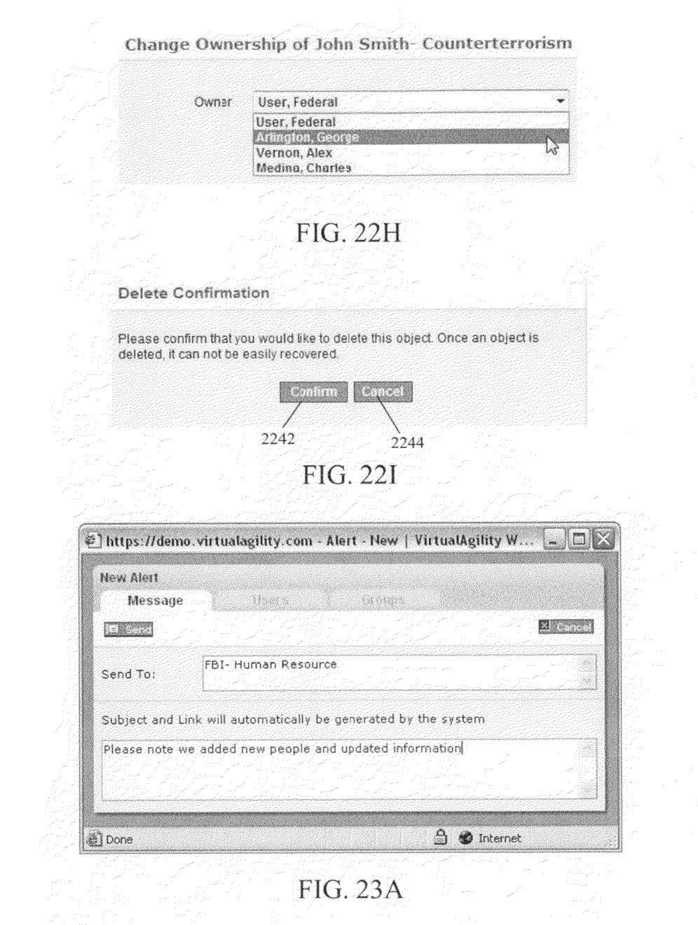

FIGS. 22A-22F show the adding of a document to the workspace. To upload a document, the Upload Document option 1717 is selected (FIG. 17C). An add a document dialog is displayed, as illustrated in FIG. 22A. The user enters a title 2201, a description 2202, and the file to upload 2203. The user selects the submit button 2204 to upload the document, the reset button 2205 to start over, and the cancel button 2206 to close and return to the previous screen. Once submitted, the document is stored in the T_OBJ_RESOURCE_INFORMATION table 330 and the T_OBJ_RESOURCE_DOCUMENT table 331. The document is then shown in the resource workspace as shown in FIG. 22B, including the name 2250, type 2251, version 2252, date updated 2253, and a details option 2254.

Selection of the document name 2250 launches the application with which the document is associated and displays the document contents in the application. The user can choose to view details of the document by selecting the details option 2254, as illustrated in FIG. 22C. The document details include the file name 2210, description 2211, latest version 2212, file size 2213, name of the creator 2214, date created 2215, whether the document is compressed 2216, whether the document is encrypted 2217, the MD5 checksum 2218 for the document, and the mime type 2219. To archive the text document and remove it from view, the archive button 2220 is selected.

To change any of the document parameters, the action tab 2221 is selected, as illustrated in FIG. 22D. The user can modify or update a name 2225 and/or description 2226. The user can add a comment 2227 and/or select a new version of the document to upload 2228. The user selects the upload button 2229 to upload the changes or the reset button 2230 to start over. In order to upload a new version of the document, the user must first check the document out of the repository, as shown in FIG. 22E. If no changes were made and the user elects to permit the use of the currently loaded document, the user selects the undo checkout button 2231 (FIG. 22D).

To view the history of the file and changes made to it, the user selects the history table 222, as illustrated in FIG. 22F.

f. Updating a Resource

FIGS. 22G-22I show the updating of a resource. A resource can be updated by selecting the details option 1720 (FIG. 17C). An update a resource dialog is displayed, as illustrated in FIG. 22G. The user can modify or update the title 2231, description 2232, owner's name 2233, address 2234, birthday 2235, education 2236, assignment 2237, and/or the parent agency 2238. The user selects the update button 2239 to submit the changes, the reset button 2240 to start over, or the cancel button 2241 to terminate the operation and return to the previous screen. Discussions, links, RSS feeds, text documents, and/or loaded documents are not affected and will not be changed, moved, or deleted.

The owner is the original creator of a resource. When there is a need to assign a resource to a different owner due to personnel changes, new responsibilities, or any other reason, a user can select the owner option 1721 (FIG. 17C). A change ownership dialog is displayed, as illustrated in FIG. 22H. A new owner can then be selected from the pull down menu.

A resource can be deleted by selecting the delete option 1722 (FIG. 17C). A delete confirmation dialog is displayed, as illustrated in FIG. 221. The user selects the confirm button 2242 to complete the process and the cancel button 2243 to terminate and return to the previous screen. Deleted resources are removed from the users' view and archived in the system archive storage. No information is permanently deleted. Administrators can un-archive “deleted” resources as required.

g. Alerts

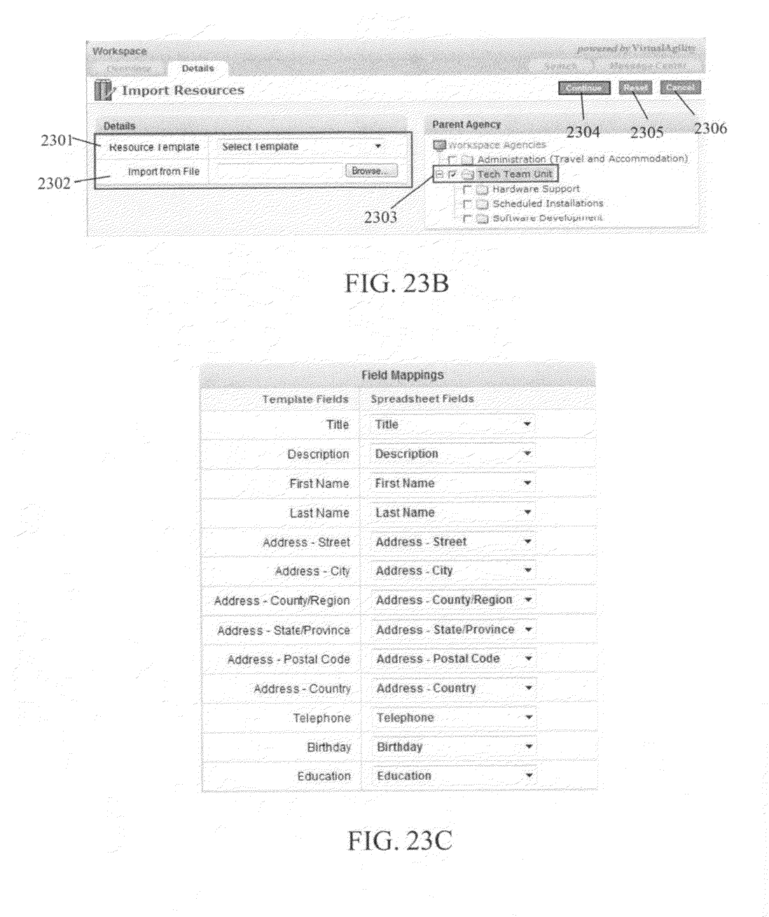

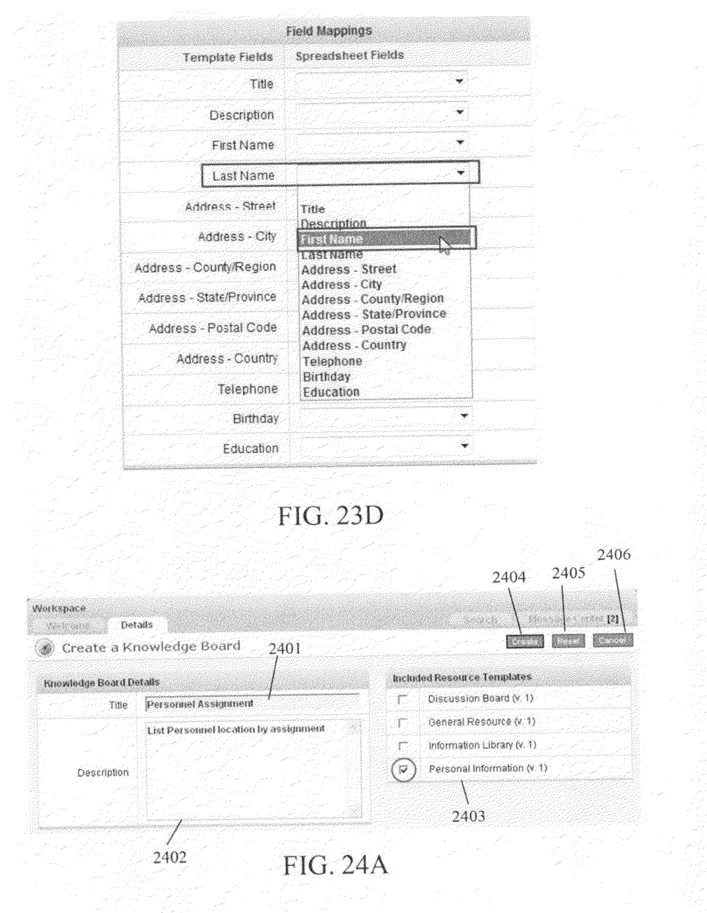

Users can receive an alert message for any change made to each resource listed. FIG. 23A shows the set up of alerts for a workspace. When the user selects the Receive Alert option 1718 (FIG. 17C), an alert entry is generated within the message center. The message center is described further below. Selection of the Receive Alert option 1718 toggles the option on and off. To send an alert to other users, the Send Alert option 1719 is selected. This will open a message window, as illustrated in FIG. 23A, where groups or users are selected and a message to accompany the alert can be typed. The alerts and the users to which the alerts are sent are stored in the T_OBJ DATA ALERT USER table 319.

h. Resource Details

The resource details 1723 (FIG. 17C) provide users with information on the owner who originally created the resource, or the owner who has the resource re-assigned to them. Users can communicate with the owner of the resource by selecting the owner's highlighted name 1724. A new message dialog will then open, as described further below in the context of the message center. The resource details further display the name of the resource template and the version used to create the resource, the date the resource was created, and the last modified date.

i. Importing Resources

The system allows users to import information from an application, such as an Excel worksheet, and automatically create multiple resources. These resources will be created within a selected organization/domain and will automatically be assigned the permission of the parent organization in which they are created.

Users can import any Excel file that contains information organized in columns and rows where the first row defines the field names and the following rows are the records of information. Each row will be imported as single resource. The system attempts to match column names with the resource template fields. Users can manually match columns and fields as well.

The administrators who create the resource templates have the option to export an Excel file that exactly matches the fields and columns and provide it to users as a guide. This Excel template will guide users to create a data source that can be easily and directly imported into specific resources in the system. An Excel file exported directly from the resource template will have the fields of the template already posted in the first row and represent all the fields as columns. Users will fill out the Excel file with the required information in a format organized as rows of data for each resource. This will simplify the import of data from an Excel file to a resource.

FIGS. 23B-23C show the importing of resources for a workspace. To import an Excel sheet, the user selects the Import Resources option (not shown) from the create pull down menu 1314 (FIG. 13). An import resources dialog is displayed, as illustrated in FIG. 23B. The user selects the resource template 2301 that the user wants to use as the format for the imported data, the source data file 2302 to import, and the parent domain 2303 where the new resource will reside. The user selects the continue button 2304 to import the resource, the reset button 2305 to start over, and the cancel button 2306 to terminate and return to the previous screen.

When importing, the system attempts to match the field names in the resource template with the column headers, and displays the matched fields as shown in FIG. 23C. If the system cannot match fields, it will leave those fields blank. The user can manually select the column headers and match them to the selected fields, as shown in FIG. 23D. Once the matching process is completed, the data is imported and the new resource is created.

5. Knowledge Boards

Knowledge boards enable users to create a report based on the information fields contained resource templates, and hence in the resources. Users can customize this to display specific selected columns and filter information according to specific keywords or values. The resulting display in a table in the format of columns (fields) and rows (resources) which dynamically displays a real-time data from across the workspace.

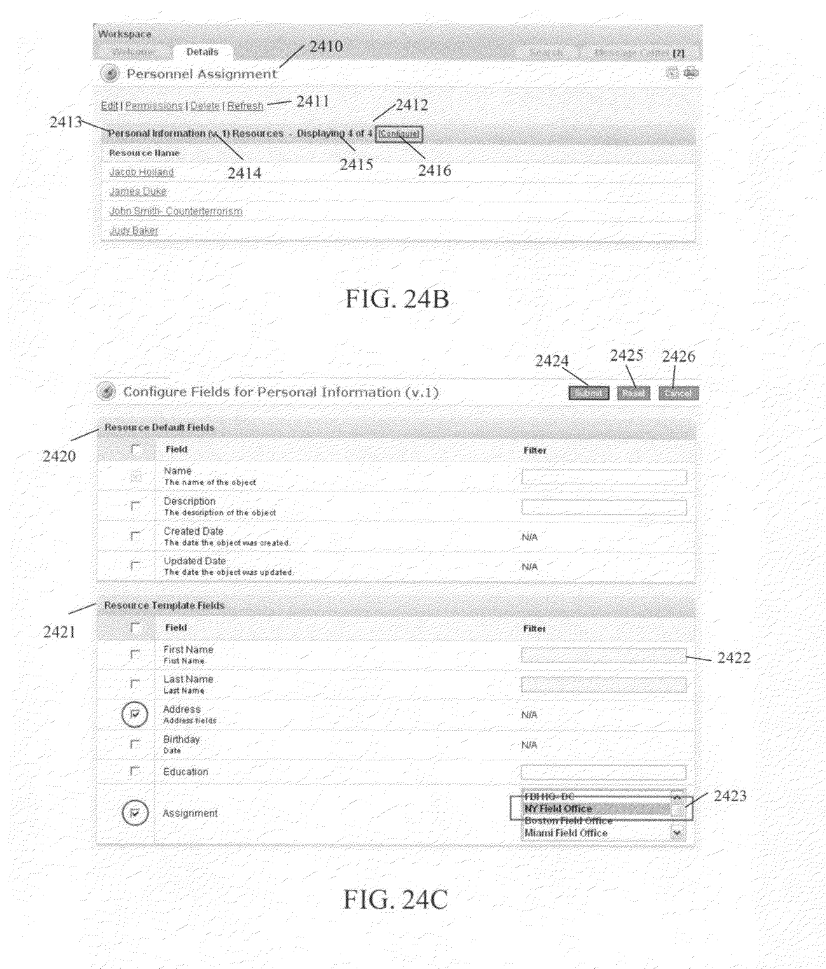

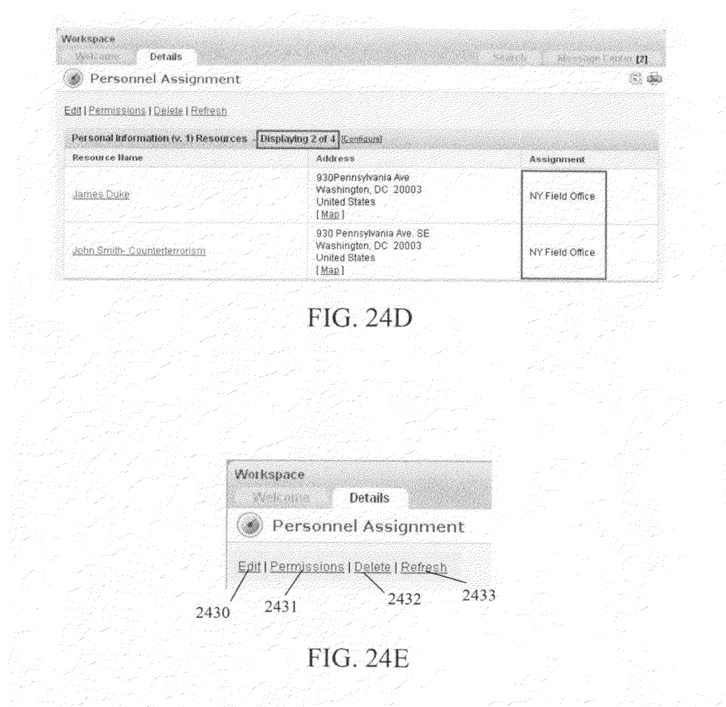

FIGS. 24A-24E show the set up of knowledge boards. When the user selects the knowledge board option (hidden) under the create button 1314 (FIG. 13), a knowledge board dialog is displayed, as shown in FIG. 24A. The user can enter a title 2401, description 2402, and which resource templates 2403 to include in the knowledge board. The user selects the create button 2404 to create the knowledge board, the reset button 2405 to start over, and the cancel button 2406 to close and return to the previous screen. Once created, a new knowledge board entry 1315 (FIG. 13) will be added to the navigator screen 1301. The knowledge board is stored in the T_OBJ_DASHBOARD 322, T_OBJ_DASHBOARD_RES_TMPLT 323, T_OBJ_DASHBOARD_FIELD_DEFAULT 324, and T_OBJ_DASHBOARD_FIELD_TMPLT 325 tables.

When the knowledge board is selected, a knowledge board window is displayed, as shown in FIG. 24B, which includes the title 2410 of the knowledge board, editing buttons 2411, and the selected resource display screen 2412. The title bar of the resource display screen includes the resource template name 2413, version number 2414, and total number of resources 2415 the user has permission to view. This information on the resources and the resource templates are stored in the T_OBJ_RESOURCE 329 and T_RES_TMPLT 335 tables. The link of a resource to a resource template is stored in the Resource_Kit_ID field in the entries of the T_OBJ_RESOURCE table 329. Once filtering is added, the numbers will show the number of resources displayed out of the total available resources.

To customize the report, the configure button 2416 is selected, and a configure dialog is displayed, as shown in FIG. 24C. The configure dialog is divided into two parts. The first part 2420 contains the resource default fields, and the second part 2421 contains the resource template fields. Customization of the selected fields to be displayed as columns is completed by a check mark. The title name of the resource is displayed by default. Checking the top box in each group will select/deselect all fields in the list. To filter each field by a specific keyword, the word is typed into the field 2422 on the right or selected from a list 2423. The user selects the submit button 2424 to upload the updated knowledge board, the reset button 2415 to start over, and the cancel button 2426 to close and return to the previous screen. Here, the Name field in the resources, and the Address and Assignment fields in the resource templates, are selected to be in the report, with the Assignment field filtered to show only those in the NY Field office.

Once submitted, the knowledge board with the newly added fields is displayed, as shown in FIG. 24D, according to the configured filter. The knowledge board shows the resource's name, address, and assignment fields for assignments in the NY field office. As illustrated in FIG. 24E, the knowledge board can be managed by selecting the edit option 2430, the permissions option 2431, the delete option 2432, or the refresh option 2433. Selecting the edit option 2430 reopens the create dialog (FIG. 24A) and allows the user to modify the title 2401, description 2402, and select/deselect/add resources 2403. Selecting the permissions option 2431 allows the user to share the knowledge board with other groups and/or individual users. Selecting the delete option 2432 removes the knowledge board from view and archives it in storage. The knowledge board is automatically refreshed every time it is opened. Some changes may happen while the knowledge board is displayed. To ensure the data is fully updated, the user can select the refresh button 2433 at any time while viewing it. The knowledge board report can be exported to an Excel spreadsheet. Change to data in this Excel export document will not affect, change, or update data stored in the system.

6. Operations (Initiatives)

The operations process structure enables users to bring to others at each step in the process those resources (tools and information) needed to accomplish that task. In the operations view, users can build the various structures that will provide the framework for working with the information and tools stored in the system. The operations structure enables the use of resources (shared from the agencies that created and maintained them) within one or multiple procedures to accomplish a task.

The operations structure might be a timeline listing hours or days with the information presented in steps, reports and requests for assistance. Or, additional “views” might be step-by-step plans for responding to different types of emergencies, Concept of Operations plans, a National or Regional Response Plan, a mutual aid procedure, or any other formats that may be relevant to operations of this organization or group of organizations.

The main benefit of the operations view is that the information created and maintained in the agencies view can be shared with one or multiple operations and re-used as many times as required (different operational plans) without the need to duplicate the information and struggle to keep it current. Operations enable multiple viewing, usage and organization of the same data/information by different users for different activities.

With resources and knowledge board reports being shared in the operations view, any changes, updates or additions will be immediately distributed and shared within all the processes and windows where these resources are being used, thereby eliminating the need to alert users via telecommunication or electronic mail.

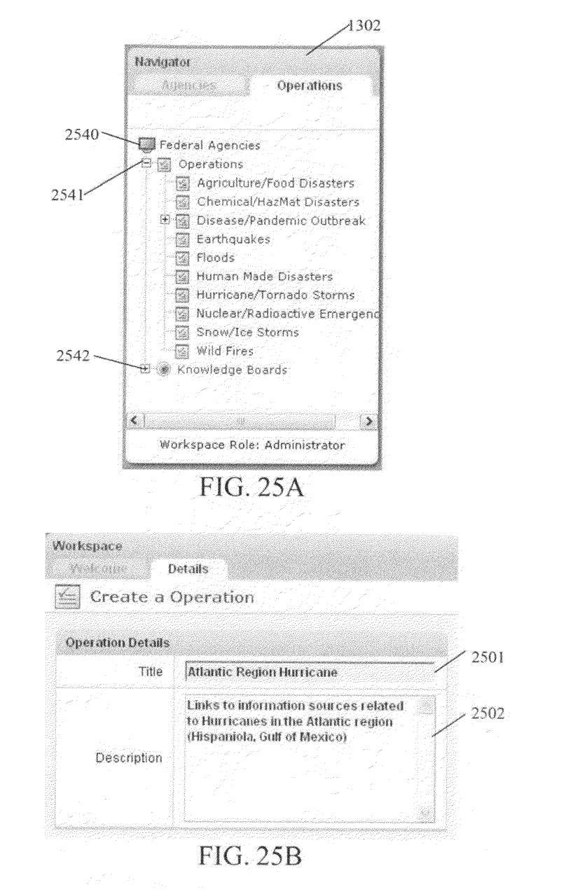

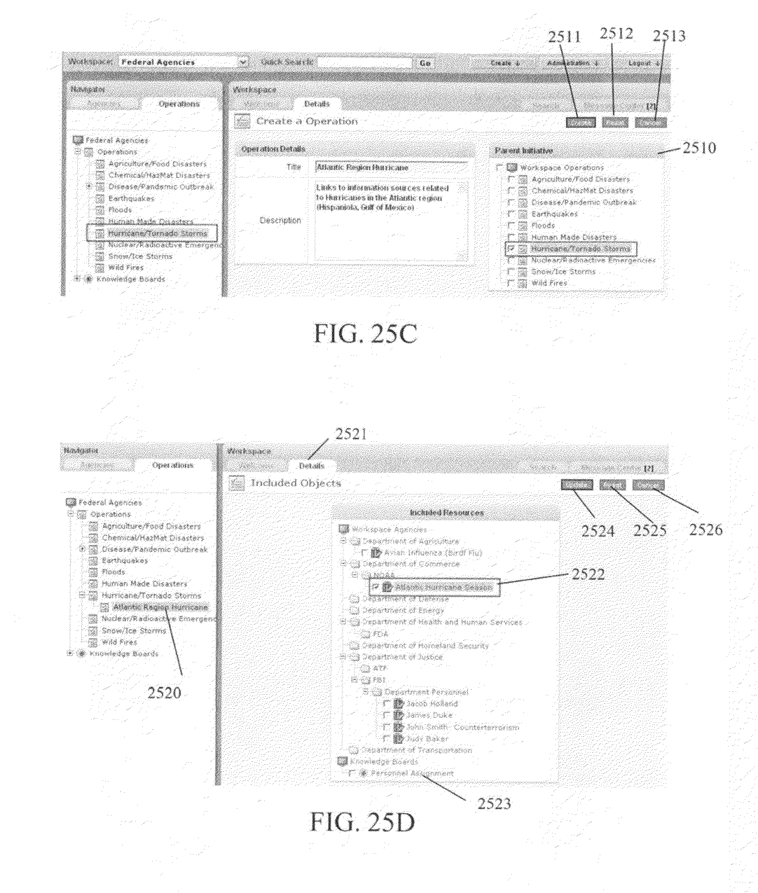

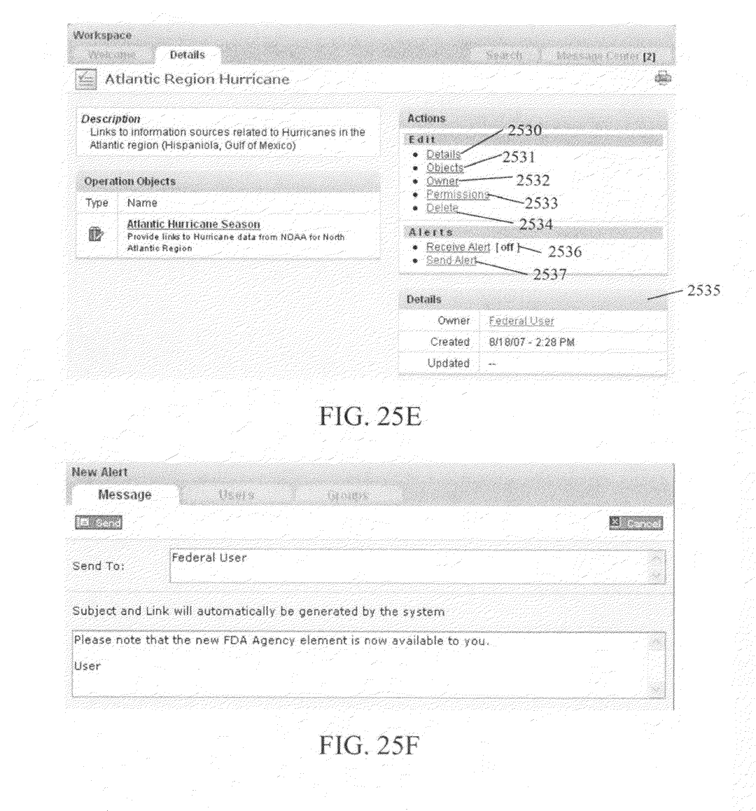

FIGS. 25A-25F show the set up of an operation. The operations structure is displayed in the navigator 1302 (FIG. 13) as shown in FIG. 25A. Federal Agencies 2540 is the workspace. Under the workspace is the operation hierarchy 2541. Also part of the workspace, but not in the operation hierarchy, are the knowledge boards 2542. To create a new operation entry, the user selects the New Operation option 1316 in the Actions section 1306a of the overview screen 1301 (FIG. 13). A create an operation dialog is displayed, as shown in FIG. 25B. The user enters the title of the operation entry 2501 and a description 2502, which are stored in the T_OBJ_DATA table 318 and the T_OBJ_INITIATIVE table 327.

When creating a new operation entry, the system will automatically set the default placement in a parent/daughter hierarchy, as shown in FIG. 25C. The system displays the structure of the navigator's operation layout and places the new entry as a daughter to the operation where the user is when selecting the create option. At any time, the user can elect to reposition the new entry by selecting any of the check boxes 2510. The new sub-element (daughter) will carry the permissions set up of the parent.

Once the user completes the entry of the title and description of the parent, he may choose the create button 2511 to finish and create the new entry, the reset button 2512 to clean the fields and start again, or the cancel button 2513 to terminate the operation and return to the previous screen.

As shown in FIG. 25D, after selecting the create button 2511, the system will create the new operation entry 2520 in the navigator and provide an opportunity to include objects in the operation, i.e., associating resources and knowledge boards available from various agencies. An include objects dialog is displayed on the right side in FIG. 25D. The included objects details tab 2521 displays a full list of all resources/objects the user has permission to access. The user selects the resources 2522 and knowledge boards 2523 to be assigned as objects (available from various agencies) to this operation element. The user selects the update button 2524 to finish and add objects to the new entry, the reset button 2525 to clean the fields and start again, and the cancel button 2526 to terminate the operation and return to the previous screen. Each object related to the operation is stored in an entry in the T_OBJ_INITIATIVE_DATA OBJECT table 328, which references the operation in the Initiative_ID field and the object in the Data_Object_ID field.

Once created, the operation is displayed as shown in FIG. 25E. Here, an example operation, Atlantic Region Hurricane, is shown with one object, the resource, Atlantic Hurricane Season. All operation elements can be managed by selecting any of the following options: details 2530, objects 2531, owner 2532, permissions 2533, or delete 2534. Selecting the details option 2530 opens a window similar to the create window shown in FIG. 25B, which allows users to change the title, description, or reposition the operation under another parent. Selecting the objects option 2531 opens an include object window shown in FIG. 25D, which allows the user to switch, add, or remove resources or knowledge boards from the navigator screen by selecting or deselecting checkboxes. Selecting the owner option 253 provides users the option to reassign the ownership responsibility for the operation object to another user. This feature provides accountability for maintenance of the system's elements by ensuring there is always a specific user associated with each entry. Selecting the permissions option 2533 provides users with the option to change the pre-assigned permissions that were granted during the object's creation and inherited from the parent operation. Users can add or remove groups or individual users, or change the permission level for viewer, user, manager, or administrator roles. Selecting the delete option 2534 archives the operation entry and removes it from view. Each change to the operation is marked as an update and is displayed in the details window 2535

Users can select to be alerted of any changes to the operation objects. Selecting the receive alerts option 2536 toggles the option on and off. When toggled to on, an alert entry is generated within the message center. To send an alert to other users, the send alert option 2537 is selected. This opens a message window, shown in FIG. 25F, where groups or users are selected and a message to accompany the alert can be typed.

7. Search

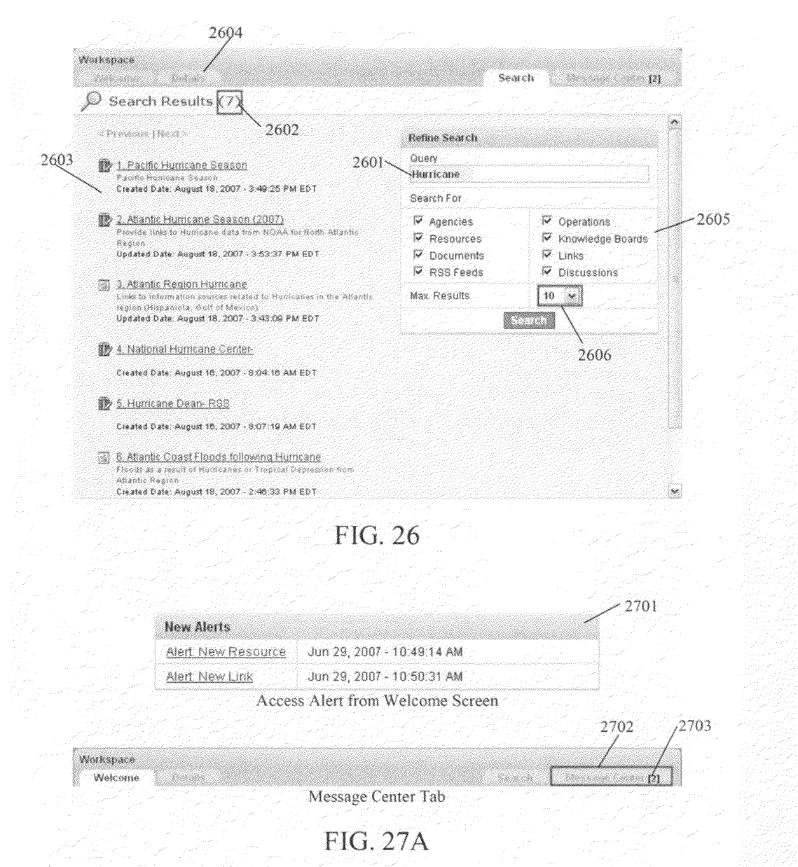

A quick search function provides users with the ability to enter a keyword to be searched upon at any time. All the data and information entered into the fields in the workspace are searchable, including titles, description, data fields, and names and descriptions of uploaded files. FIG. 26 shows a search results screen. The search results screen provides the following information: the search keyword 2601; the total number of entries found 2602; and the list of the entries found during the search 2603. Selecting any of the highlighted titles of the entries opens the element in a details window 2604 (hidden). The user can refine the search by modifying the query term, select to limit the search 2605 for a specific entry like resources or document, and select the number of entries 2606 to be displayed in each screen.

8. Message Center

The message center displays alerts generated by the system, and messages from other groups and/or user of the system. The message center displays alerts and messages to a specific user, generated from all workspaces. This provides each user with an awareness of activities within other workspaces to which they have access.

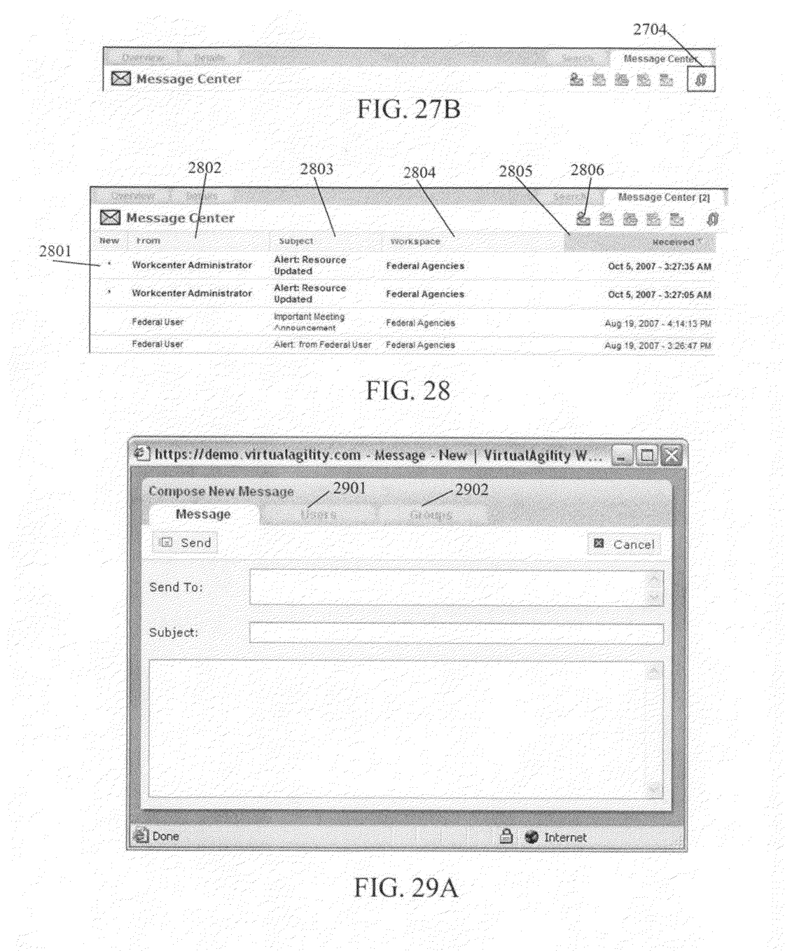

FIG. 27A shows how a user enters the message center. A user may enter the message center by selecting any of the alerts 2701 presented in the overview screen or by selecting the message center tab 2702 from the menu bar. The message center tab displays the number of new messages 2703. The message center is updated frequently by the system, and the number of new unread messages will reflect the changes. The messages are stored in the T_MESSAGE 314, T_MESSAGE_USER 315, T_MESSAGE_GROUP 316, and T_MESSAGE_RECIPIENT 317 tables. As illustrated in FIG. 27B, a user can select a refresh button 2704 while working in the message center to check for new alerts and messages that have very recently arrived.

a. Alerts

FIG. 28 shows the set up of alerts. Alerts are the messages generated within the system regarding changes for which the user have requested alerts, or initiated by other users wanting to alert the user of changes made in specific objects, including agencies, operations, resources, or knowledge boards. The alert message entry contains an identification 2801 if the message is new, the message originator (system or user) 2802, the subject of the message 2803, workspace 2804 where the message was generated from, and the date and time 2805.

Selecting an alert will display the message. The message includes a brief description of the nature of the alert and a link to the element. Selecting the link opens the element in the workspace window. If an alert was sent by another user, the message will contain the name of the sender and message the user typed. Each alert is stored in an entry in the T_OBJ_DATA_ALERT_USER table 319, which references the object in the Object_ID field and the user in the User_ID field.

b. Messages

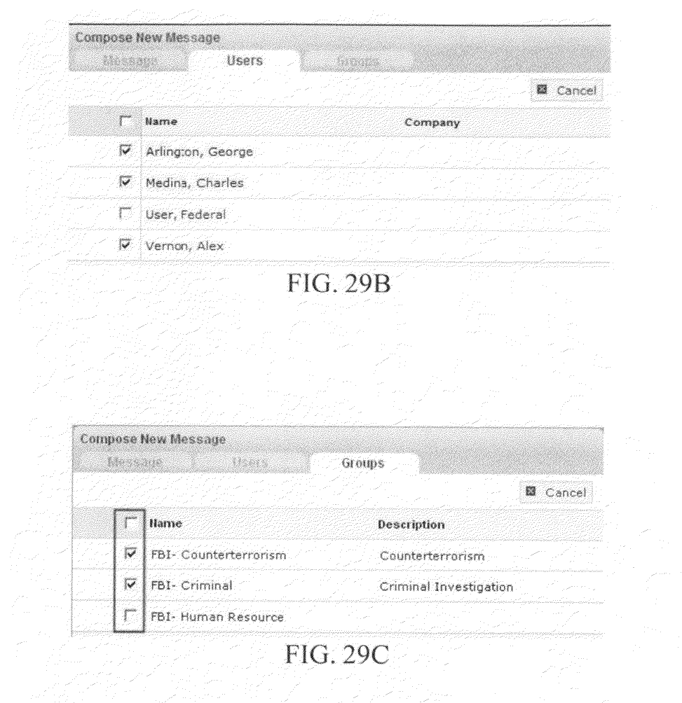

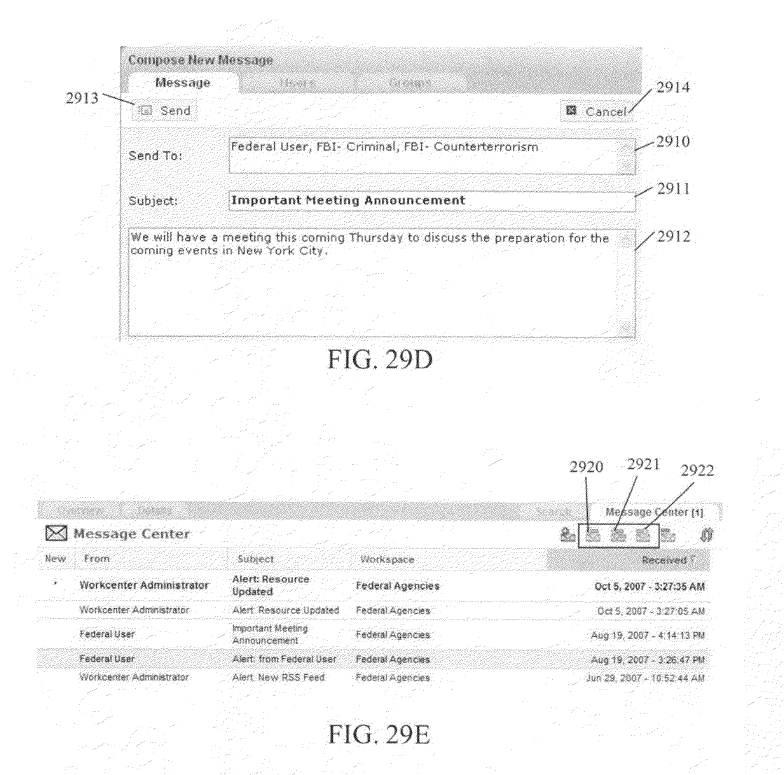

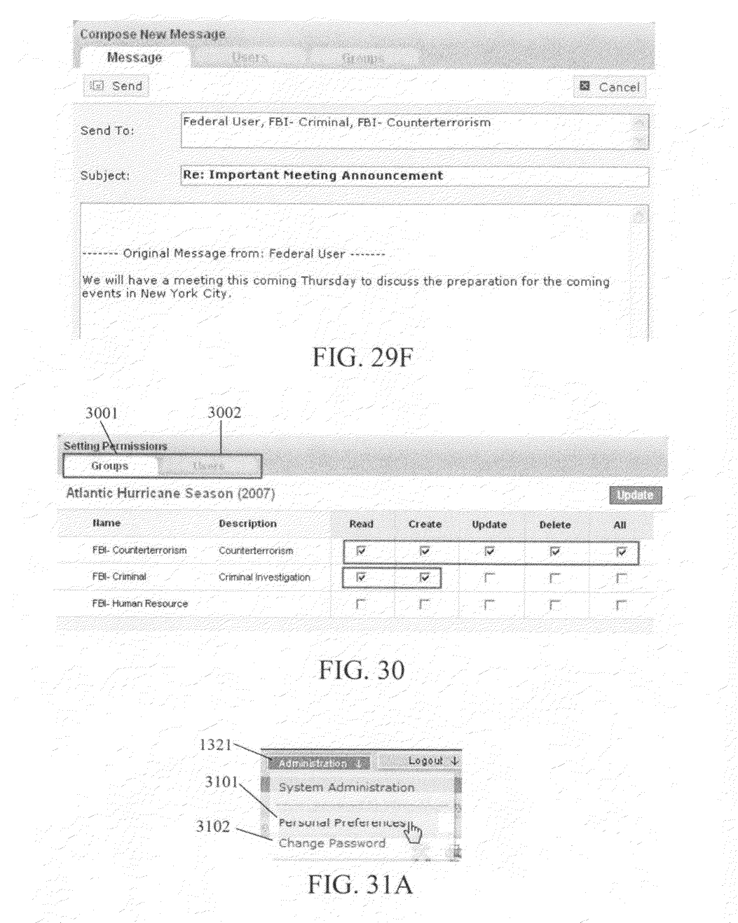

FIGS. 29A-29F show the set up of messages. Messages can be exchanged between users or groups of users utilizing the message center email-like option. To send a message, the new message icon 2806 (FIG. 28) in the message center screen is selected, and a compose new message dialog is displayed, shown in FIG. 29A. The messages are stored in the T_MESSAGE table 314, which references the workspace in the Workspace_ID field. The users tab 2901 can be selected to select individual users as recipients, as shown in FIG. 29B. Here, the users George Arlinton, Charles Medina, and Alex Vernon are selected as recipients. Each user is stored in an entry in the T_MESSAGE_USER table 315, which references the message in the Message_ID field and the user in the User_ID field. The groups tab 2902 can be selected to select groups of users, as shown in FIG. 29C. Each group is stored in an entry in the T_MESSAGE_GROUP table 316, which references the message in the Message_ID field and the group in the Group_IF field. Each individual user and each user in a group are also stored as an entry in the T_MESSAGE_RECIPIENT table 317. When a user reads the message, this is marked in this table. The users and groups names are then displayed in the send to field 2910, as shown in FIG. 29D. The subject 2911 and message 2912 are then typed in. The send button 2913 is selected to send the message, or the cancel button 2914 is selected to terminate and return to the message center screen.

As shown in FIG. 29E, messages can be replied to the sender by selecting the reply icon 2920, replied to all addresses by selecting the reply all icon 2921, or forwarded to other users and/or groups by selecting the forward icon 2922. A compose new message window is then displayed, shown in FIG. 29F, with the previous message displayed and with space to type a new message. When forwarding, users and groups need to be selected as recipients. The message center is not an external email program and cannot be used to send anything outside the system.

9. Permissions

User access to information in the system is based upon roles and responsibilities that are setup within the permissions. For each workspace, a user can be set up as a viewer, a user, a manager, or an administrator. These set ups are performed by a system or users' administrator. Users might be set up differently in different workspaces, and therefore will have different roles in each workspace. This set up of roles in workspaces supersedes any set up in permissions.

With the Viewer role, a user has view-only permission to see selected objects as assigned. The user cannot perform any functions, such as create, details, or delete. With the User role, a user can create new objects like agencies, operations, resources, and knowledge boards within objects as assigned. The user cannot change roles or permissions, and will not see objects created by other users that are not shared. With the Manager role, the user can see all the permissions and can assign permissions only to objects for which they have permission to change. With the Administrator role, the user can see all the permissions and can assign permissions to anyone at any level. Users who create an object are automatically granted full permission to that object. They can grant any of their permission levels to other users or groups they share.

If users can access the permission setup, by definition they have permission to assign rights to any of the groups of users or individual users that are visible to them. Permissions are assigned per object and will be automatically transferred to all sub-objects that are created later. The system does not adjust permissions when objects are repositioned to/from other parent objects. After re-positioning an object, users must view and update the permissions and attributes for the moved object(s). Available permissions include read, create, update, and delete. Read permission allows a user to view object elements, including agencies, resources, operations, and knowledge boards (data fields, documents, links, or discussions in resources) only but does not allow the user to make changes. Create permission allows a user to create domains, resources, initiatives, and knowledge boards. The user cannot change details documents or links details. Update permission allows a user to modify the objects (agency, operation, resource), as well as change details, documents, links, and owners. Delete permission allows a user to delete/archive the object, to reposition the object, and grant permissions to other users or groups.

FIG. 30 shows the set up of permissions. A user selects the groups tab 3001 or users tab 3002 to set up permissions for groups of users or individual users, respectively. The permission level for each group or user is then selected. The permissions are stored in the T_OBJ_DATA_PERM_GROUP 320 and T_OBJ_DATA_PERM_USER 321 tables.

10. Personal Setup

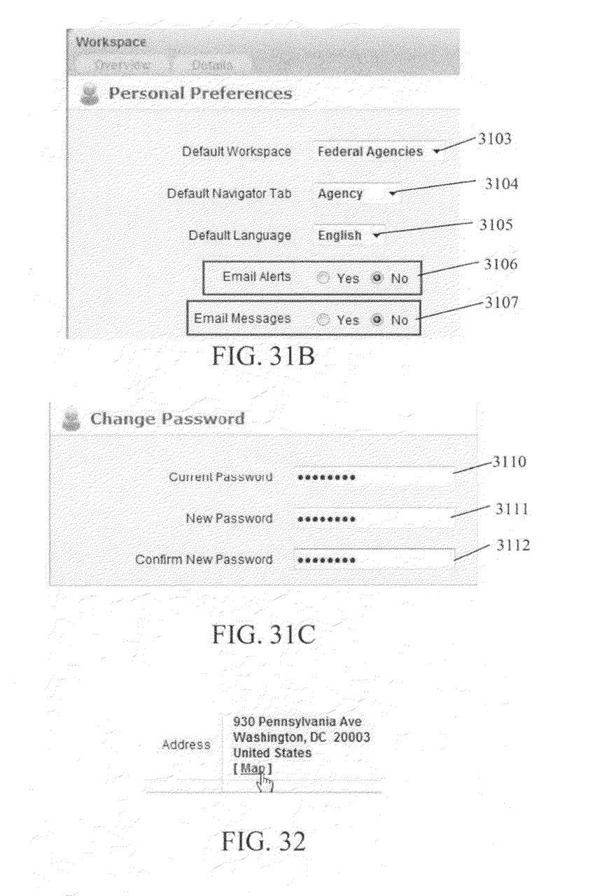

FIGS. 31A-31C illustrate the set up of user's personal preferences and password. The preferences are stored in the T_USER_PROFILE table 341 and the T_USER PREFERENCES table 344. The set up the personal preferences, the user selects Personal Preferences 3101 from the Administration pull down menu 1321 (FIG. 13), as illustrated in FIG. 31A. A personal preferences dialog is displayed, as shown in FIG. 318. The user sets the default workspace 3103 (if they belong to more than one), default navigator tab 3104 (operation or agency), the default language 3105, whether to forward alerts to their registered email account 3106, and whether to forward message to their registered email account 3107. The user can then select an update button (not shown) to submit the changes, or a reset button (not shown) to start over.

Users can elect to change the password for their account by selecting the Change Password 3102 (FIG. 31A) from the Administrator pull down menu 1321. A change password dialog is displayed, as shown in FIG. 31C. The user enters the current password 3110, the new password 3111, and a confirmation of the new password 3112. The user then selects an update button (not shown) to submit the changes, or a reset button (not shown) to start over.

11. Logout

To ensure that the session has terminated on the user's workstation and no other users can access the user's account, the user selects the Logout button 1320 (FIG. 13). The system will terminate the session. The administrator also sets a timeout period for the system. If there is no activity on an open session for the timeout period defined by the administrator, the system will automatically log out the user and terminate the session.

12. Map Feature

When utilizing the predefined address field in resources, the system provides the option to display a map based on the address information, as shown in FIG. 32. The default map option is set by the administrator, and can be a mapping application provided on the Internet or a proprietary mapping application.

E. System Management

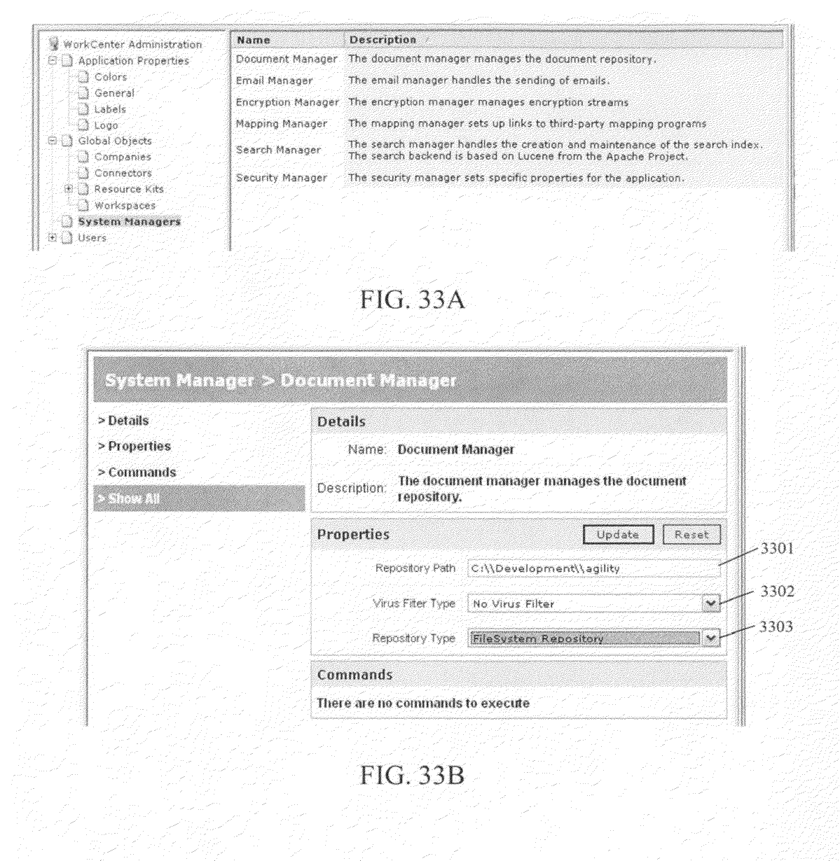

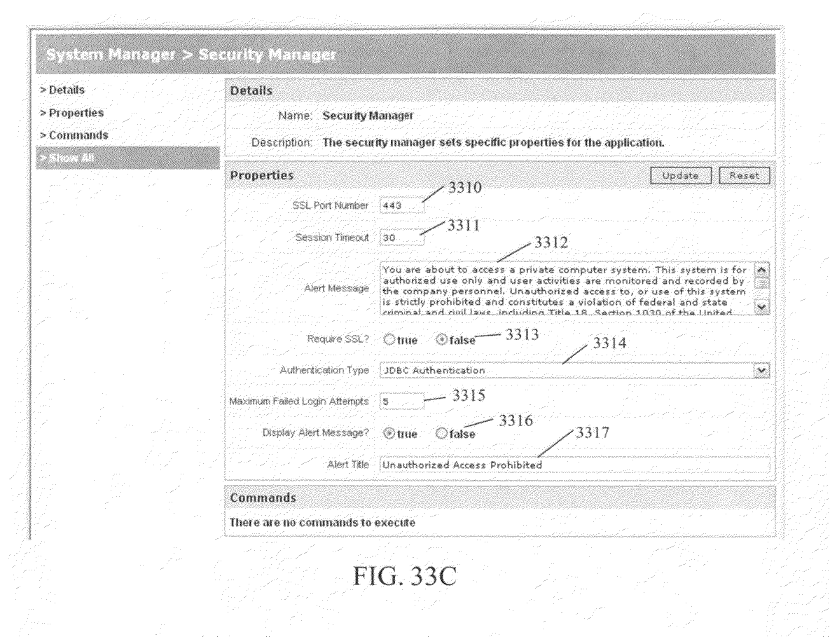

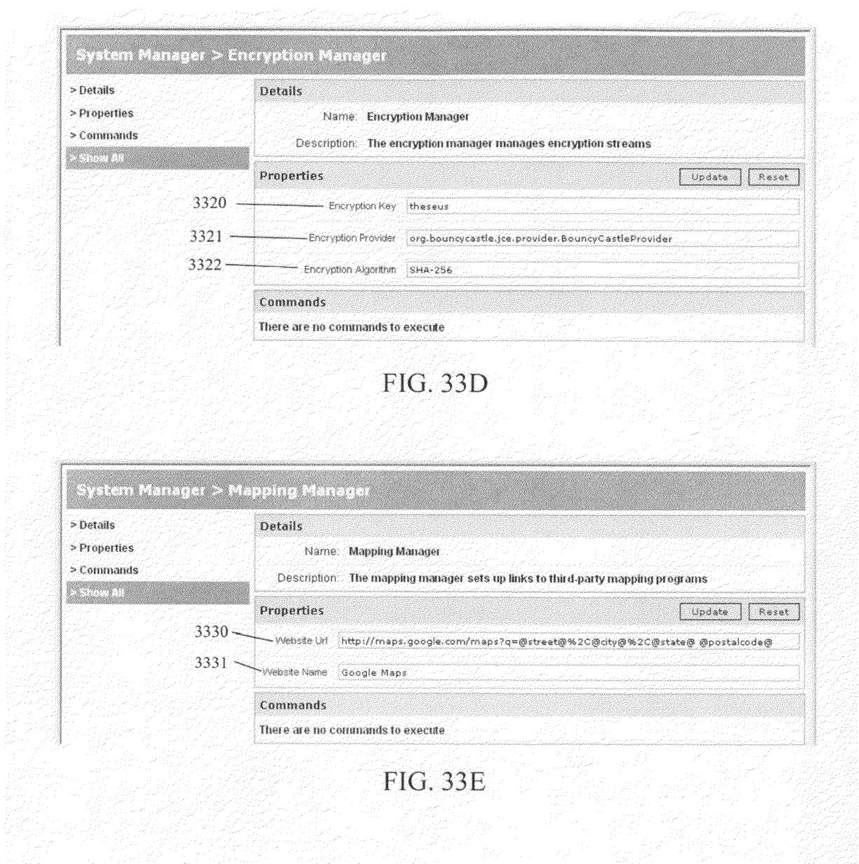

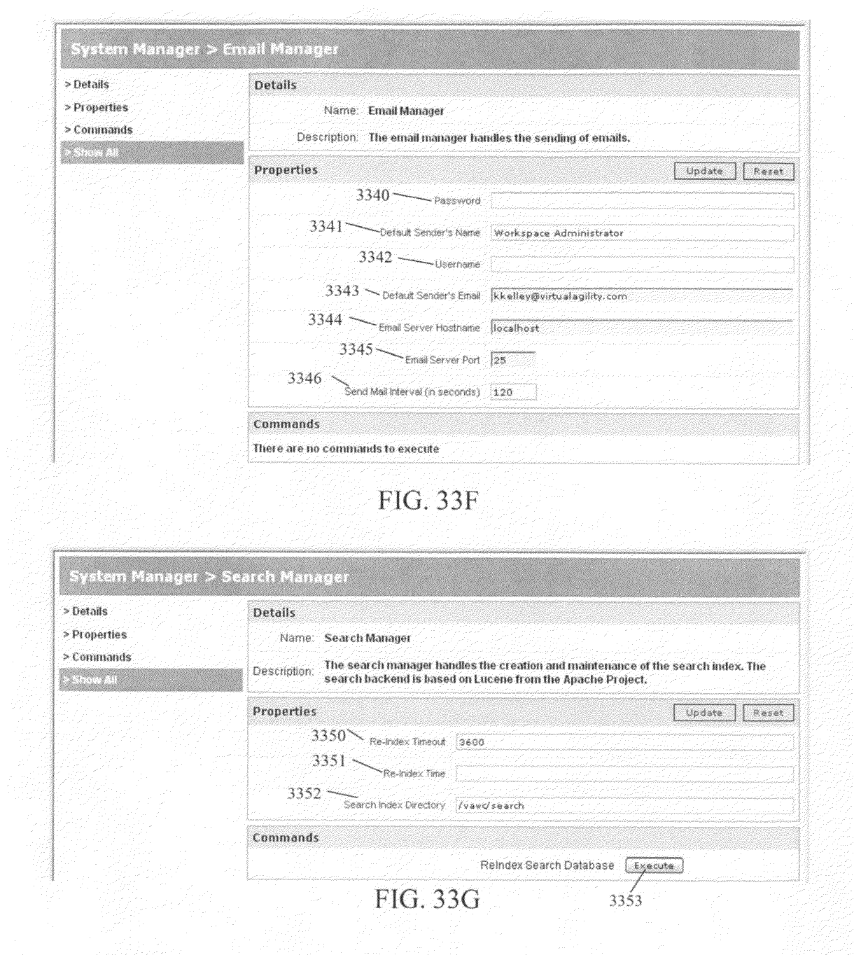

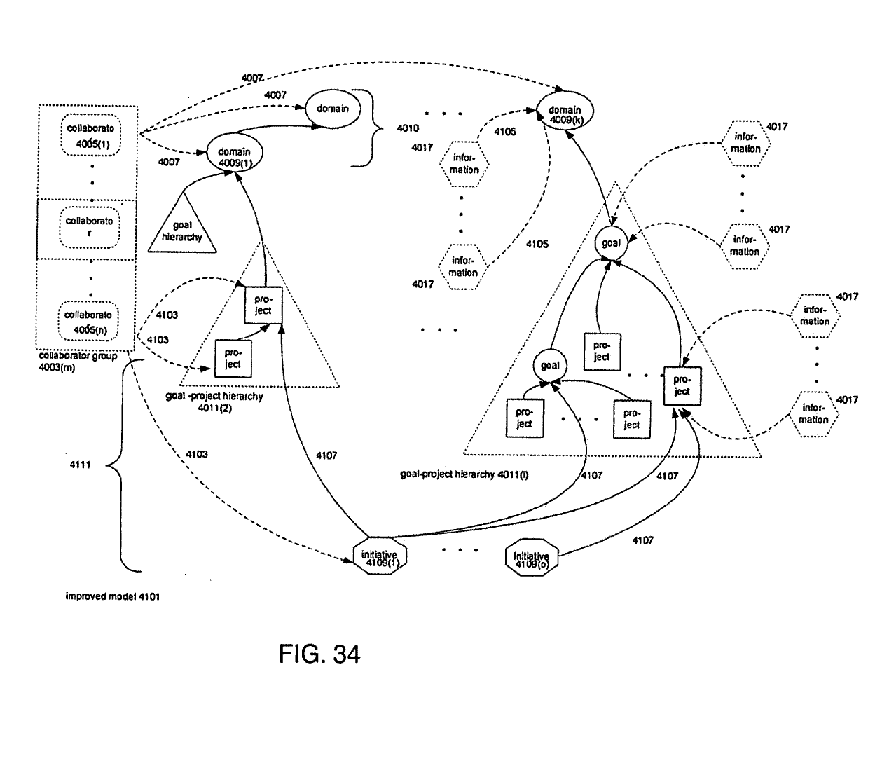

In addition to the management of the system, as described above, a system administrator can set up a number of parameters for supporting applications, including: document management, email management, encryptions management, mapping management, search management, and security management. These functions are designed to provide enhanced services to users and administration of the system. An administrator accesses these functions through the system managers screen, shown in FIG. 33A.

1. Document Manager

The document manager provides a record of each document. As each document is uploaded into the system, the system records the time it was uploaded, the originator (person who uploads) of the document, and the time. As the system is designed to provide a full accountability and compliance with regards to the information stored within the system, the system maintains any previous version/revision of a document loaded into it as well as all archived documents. The document management provides the tools to view, archive, replace, and revive all types of documents loaded in the system. FIG. 33B shows the set up of the document manager. The administrator selects the location of the files depository 3301, virus protection software 3302, and type of repository architecture 3303.

2. Security Manager

The security manager is designed to set up the network's environment. As the server is part of a private or public network, and all users have to access it through a network, it is critical that the server cold be configured to limit the access of unauthorized users to the server. These are done by identifying the type of connections used by authorized users and limit the access of all other types of data (including random

FIG. 33C shows the set up of the security manager. The administrator enters the port number 3310, session timeout duration 3311, alert message 3312 to be displayed, whether SSL encryption is required 3313, the authentication type 3314, the maximum failed login attempts allowed 3315, whether to display the alert message 3316 if the number of maximum failed login attempts has been exceeded, and the alert title 3317.

3. Encryption Manager

One of the key elements of the system is the depository of files (documents, images, etc.). As every system that is networked, there is a danger of malicious penetration and removal of sensitive information. To protect from that, the stored information could be encrypted while it is stored and only be decrypted after delivery to authorized users. The administrator of the system can choose the option to encrypt and what encryption technology to use.

FIG. 33D shows the set up of the encryption manager. The administrator can set up encryption key 3320, the encryption provider 3321, and the encryption algorithm 3322.

4. Mapping Manager

The mapping management allows the administrator to provide a link to their choice of a mapping (GIS) system. The ability to provide a tool to link to a mapping system enables users to define areas or locations by either geographical coordinates or street addresses, and let the system display a map or an aerial photograph that represent the location.

FIG. 33E shows the set up of the mapping manager. The administrator can set up the website URL 3330 for the link to the mapping service, and the website name 3331 of the server that is providing the mapping service.

5. Email Manager

The email manager allows the administrator to set a mail server on the system and define the name and address of the administrator. The role of the mail server is to provide users with the option to send alerts and messages from the system to their preferred mail client on their PC, PDA, or cell phone. These options allow users to get updated alerts without the need to be logged into the application. Mobile users can be alerted to changes in information or operation procedures critical to their operation while they are away from their primary computer system.

FIG. 33F shows the set up of the email manager. The administrator can set up for the mail server the password 3140, default sender's name 3341, username 3342, default sender's email 3343, email server hostname 3344, email server port 3345, and the send mail interval 3346.

6. Search Manager

The search engine of the system indexed the entries within the system as keywords. This provides users the ability to locate any type of information by inquiring the database. The inquiry results are displayed to the searching users and provide links for to the presented results. This helps users to allocate requested information without an extensive knowledge of the structure which is critical in many environments where the users may have limited training or no previous knowledge of parts of the system.

FIG. 33G shows the set up of the search manager. The administrator sets up the re-index timeout 3350, the re-index time 3351 (frequency of re-indexing), and the search index direction 3352. The administrator can choose to manually execute a reindexing of the search database by selecting the execute button 3353.

### Connectors

The problem of making information sources that require parameterized information requests available to the system for collaborative work of the Collaboration application is solved by the addition of connectors to the system of the Collaboration application. A connector in this context represents a class of parameterized information requests for an information source and provides a mechanism for specifying particular instances of the class. The connectors are implemented in a presently-preferred embodiment by extending the tables and the user interfaces of the system of the Collaboration application.

In the context of the present application, the following definitions are useful:

Information Request:
a request that a client of an information source provides to the information source to obtain information provided by the information source.

Parameterized Information Request:
an information request that includes a request parameter.

Request Parameter:
a portion of an information request that indicates to the information source what information is to be obtained.

Query Request Parameter:
request parameter that is expressed using a language that is interpreted by the information source.

Bind Parameter:
a portion of a request parameter that is replaced by a value before the information request that contains the request parameter is used in an information request.

In the context of the system of the Connector application, it is useful to refer to the following roles for persons using the system of the Connector application:
User: any person using the system.
Administrator: a user who specifies connectors. An Administrator may also perform the actions of a Query specialist.
Query specialist: a user who specifies parameterized information requests. A Query specialist may also perform the actions of a GUI specialist.
GUI specialist: a user who specifies GUI elements such as resource templates. A GUI specialist may also perform the actions of a Manager.
Manager: a user who specifies resources. A Manager may also perform the actions of a Collaborator.
Collaborator: a user who uses resources.

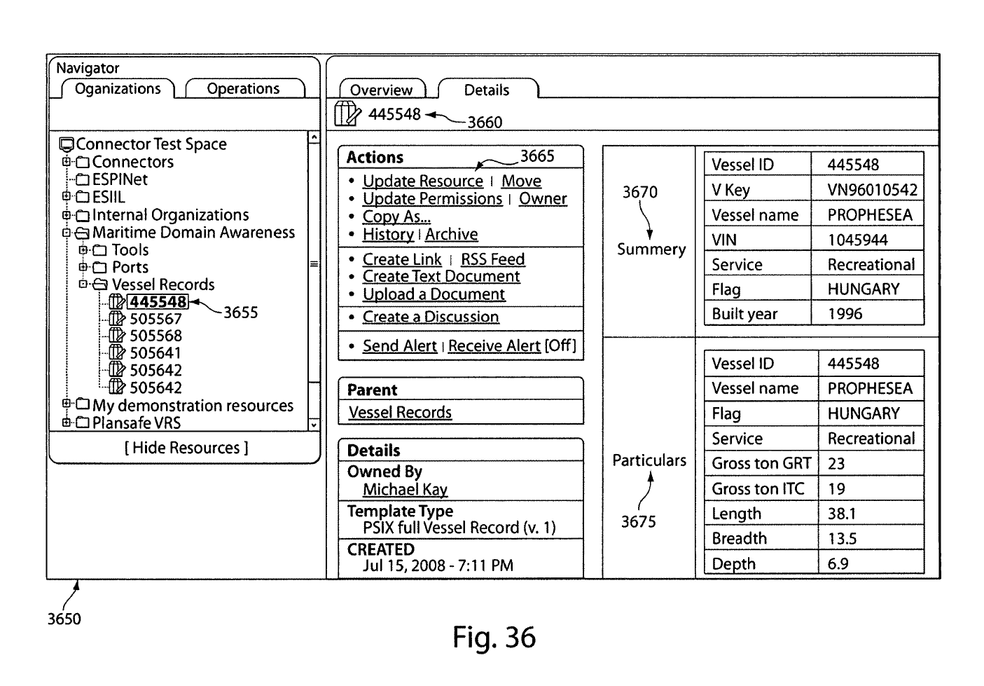

FIG. 36 shows the interface for making a parameterized information request used by a collaborator in a system for collaborative work to which connectors have been added to make parameterized information requests. The parameterized information requests in this example access an information source that provides information about vessels in US seaports. The class of requests represented by the example connector permits the collaborator to specify by selection a vessel ID number and returns the results of several different parameterized requests to the information source for information about the vessel identified by the ID number. The vessel ID number provided by the collaborator is used as the value of a bind parameter in the requests in FIG. 36.

As shown at 3655, the collaborator can select from a list of vessel identifiers. Here, the collaborator has selected vessel 445548, as shown. The system then makes instances of the parameterized information requests represented by the connector in which the vessel identifier 445548 has been used as a bind value in the requests and provides them to the information source. The information source responds with the results of the requests. The desired results of two distinct requests are displayed at 3670 and 3675. The result at 3670 is the “Summary” data about the vessel. The result at 3675 is the “Particulars” data about the vessel.

Additional specifications for connectors and parameterized information requests are easily added to the system by an Administrator. The Administrator adds a connector by specifying access values needed to access the information source, and specifying request parameters for the parameterized information requests to be added. The specifications for the parameterized information requests are then available for a GUI specialist to use in specifying resource templates. Once a connector has been specified and has been associated with one or more resource templates, a collaborator can include the connector among the resources available to him or her in the same fashion that the collaborator can include a document, a web page, or an RSS feed.

Connectors thus allow users to obtain and to share information obtained by parameterized information requests, while freeing them from dealing with the special complexities of such requests.

Overview of Connector Specification

Users in different roles—System Administrators, GUI specialists, and Managers and Collaborators—can specify connectors, parameterized information requests, and templates and resources that specify parameterized information requests, and use those resources. Specifications for bind parameters bind the bind parameter to specific values or to the values of user input fields. An additional feature of the connectors is that the connector specification can specify how the response received from the information source should be displayed to a user.

Administrators can specify connectors and parameterized information requests to give users access to information sources that respond to parameterized information requests. GUI templates are extended to allow GUI specialists to specify information requests and connectors via additional types of fields in a template. Managers can specify resources employed by collaborators using template specifications that specify connectors and their parameterized information requests.

Specifications for bind parameters are supported at more than one level.
An Administrator specifying a connector can specify bind parameters at the connector level. For example, giving a “default” vessel identifier value for an ocean-going vessel.
A GUI specialist specifying a template can override a binding specified for a connector in the resource template. For example, changing a binding from a default value for a vessel identifier to a different value, or to be the value of a “Vessel ID” field for input from a Manager.
A Manager specifying a resource using a Resource template can override a binding specified in the first or second level. For example, the Manager can change the binding to get information about a particular vessel.

### Short Example of GUI Interface for a Connector

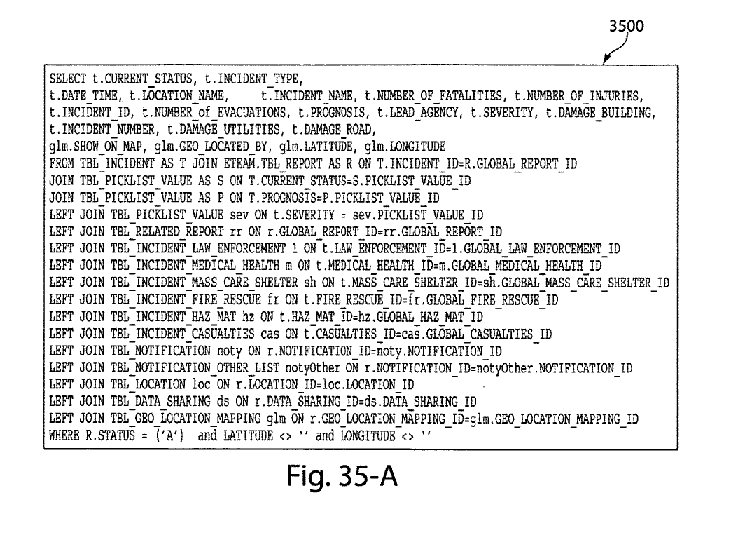

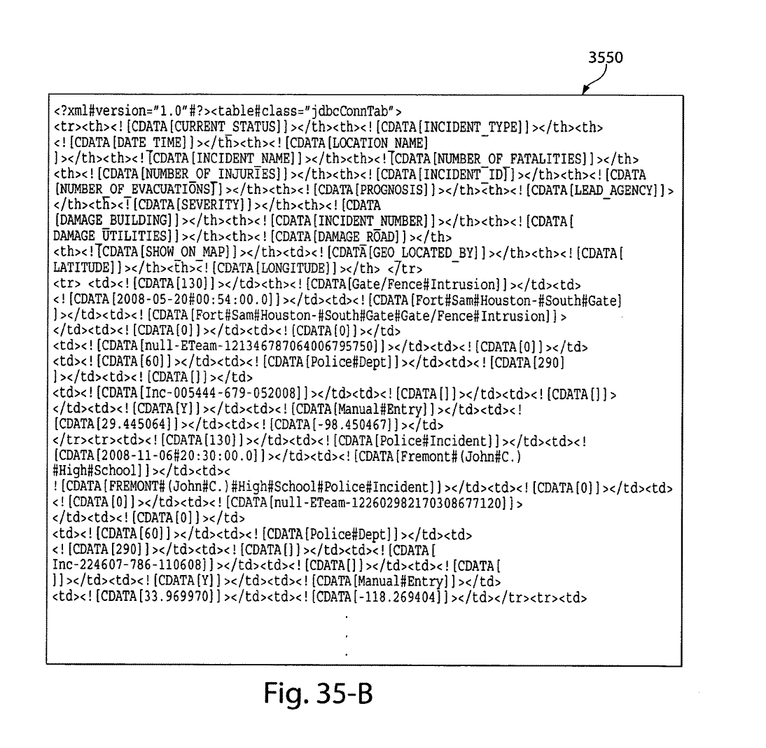

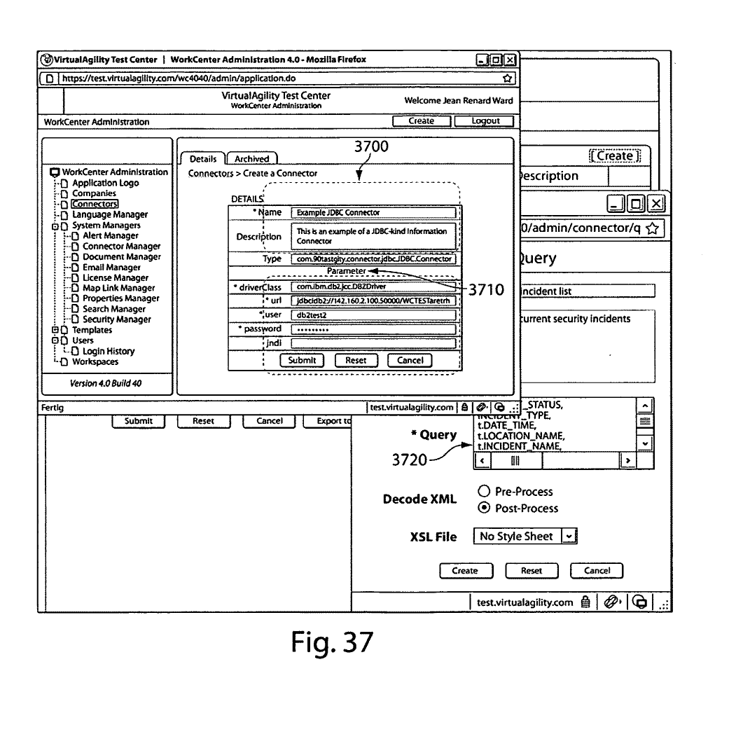

FIG. 37 demonstrates how the specification of a connector in the system of the Connector application is made less complex with an example of the Administrator GUI interface for viewing a connector specification. The GUI interfaces for connectors are described in detail below.
3700 shows the name and description specified by the Administrator for this connector.
3710 shows access values specified by the Administrator for the system to access the information source, such as a username and a password.
3720 shows a portion of the query request parameter, specified by the Administrator or Query specialist in the SQL language, for a parameterized information request. The same query request parameter is shown in full at 3500 in FIG. 35.

### Preferred Embodiment Architecture

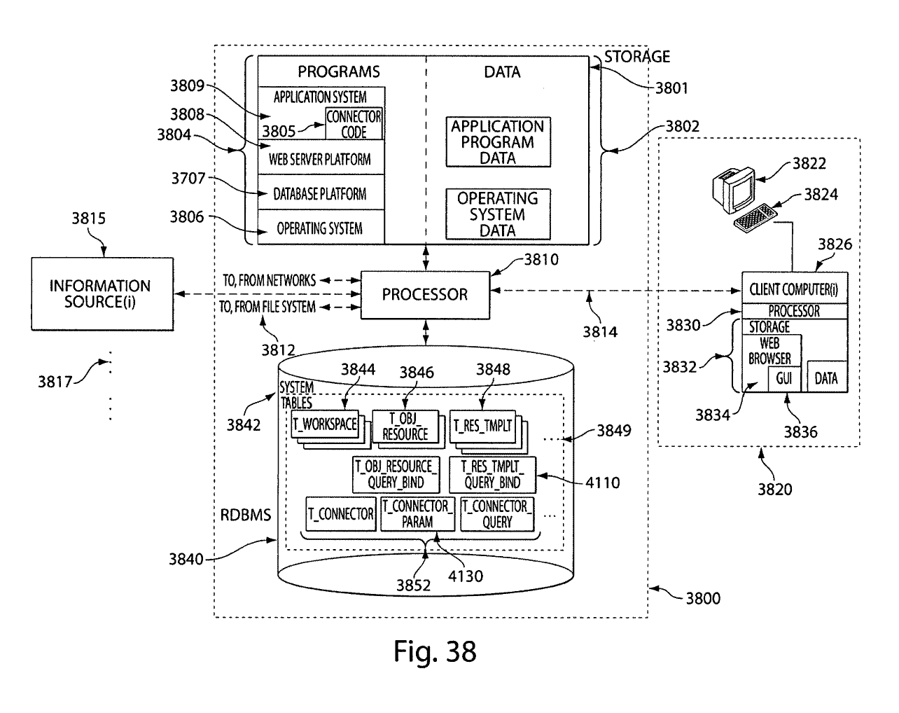

FIG. 38 illustrates the presently-preferred client-server-type architecture embodiment of the system of the Collaboration application as modified for connectors. 3800 shows the server part, and 3820 the client part of the architecture.

Starting with the client part, 3822 shows a client computer such as a personal computer with a display, and one of its input devices, a keyboard 3824. There may be a number of such clients. 3826 illustrates major components of the client computer: a processor 3830 and local storage 3832. The storage holds software programs and data, as shown. One software program is a standard web browser 3834. 3836 illustrates that the client part of the GUI interface of the system of the Connector application is implemented using the web browser. The web browser program communicates with the software components of the system of the Connector application on the server component 3800 via a network connection 3814. The network connection may be over the Internet, a local network, or a combination of networks.

Turning to the server part, the server contains a processor 3810. The processor has storage 3801. The storage contains software programs 3804 and data 3802. As shown in FIG. 38, the data contains both operating system data and application program data for a number of programs, such as local data for the software programs of the system of the Connector application.

The programs 3804 in the storage 3801 include a number of kinds of programs, such as the operating system 3806, database platform 3807, a web server platform 3808, and the application system of this invention 3809. Shown also is the connector code 3805 for software of the connectors which is added to the software of the system of the Collaboration application. The server part of the software of the system of the Connector application is implemented using the web server platform.

The processor also has a relational data base system (RDBMS) 3840. The database tables for a presently-preferred embodiment are illustrated at 3842. A number of the tables of the Collaboration application system are shown in exemplary fashion, including the T_WORKSPACE table 346 and associated tables for workspaces 3844, the T_OBJ_RESOURCE table 329 and associated tables for resources 3846, the T_RES_TMPLT table 337 and associated tables for templates 3848. The ellipses at 3849 refer to other tables of a presently-preferred embodiment.

Also illustrated at 3852 are the table additions and extensions for the system of the Connector application. As shown, these include the T_CONNECTOR, T_CONNECTOR_PARAM, and T_CONNECTORY_QUERY tables. Further tables are illustrated by the ellipses on the right of 3852. 4110 shows the T_RES_TMPLT_QUERY_BIND table, an additional table for the system of the Connector application that is used to extend the resource templates of the Collaboration application system for bind parameters, and the T_OBJ_RESOURCE_QUERY_BIND table 4130, an additional table used to extend the resources of the Collaboration application system for bind parameters.

Returning to the processor 3810, network and other interfaces to and from other systems and components are shown at 3812. As shown, these include interfaces to a local file system, networks such as the Internet, and an interface to information sources 3815. The system can have interfaces to a number of information sources, as shown by the ellipses at 3817.

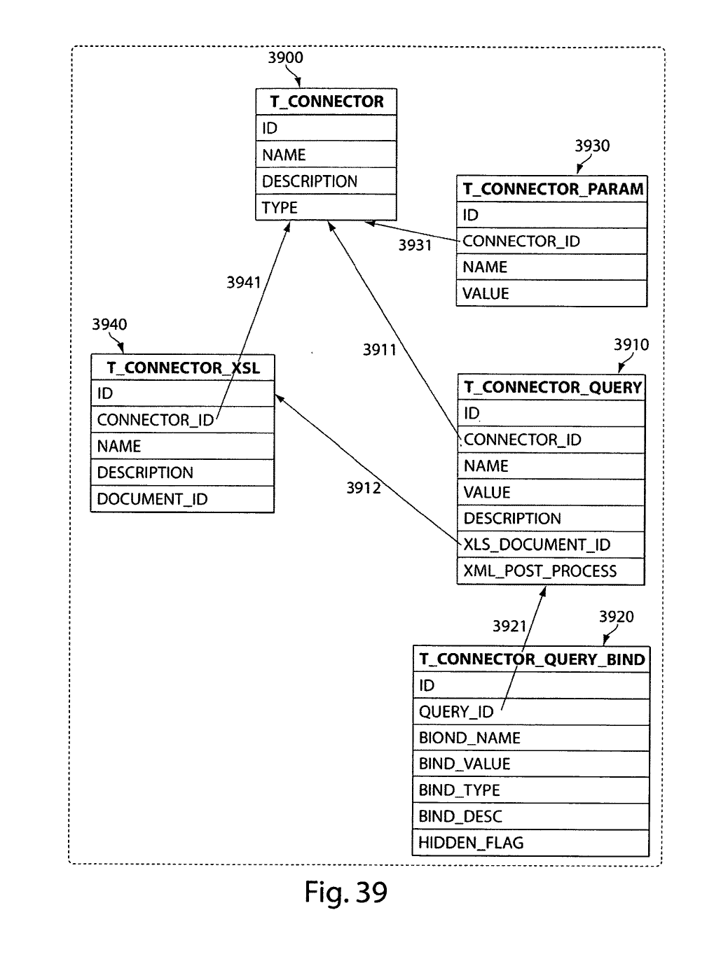

FIG. 39 provides an overview of the additional tables of the system of the Connector application that specify connectors. FIG. 39 is a simplified E-R diagram: E-R diagrams are explained for FIG. 3A through FIG. 4K of the Collaboration collaboration application

The tables of FIG. 39 are described in detail below. Fields that relate to database maintenance and certain general details are omitted from FIG. 39 for clarity, as they will be readily understood from other description. The dotted outline around the tables indicates that these have been added in the system of the Connector application, and not present in the Collaboration application system.

The T_CONNECTOR table 3900 contains a record for each connector specified in the system. A given connector provides access to exactly one information source. However there is no limit on the number of connectors which can access a given information source.

Turning to the T_CONNECTOR_PARAM table 3930: Access to a particular information source may require a number of access parameters. Access parameters are attributes of the particular information source. For example, an information source may require two access parameters “username” and “password” with particular values to permit access.

To avoid confusion regarding the word “parameter”, access parameters will be referred to as “access values” in the remainder of this presentation.

The T_CONNECTOR_PARAM table 3930 contains records for access values for information sources used by connectors. A given connector has a record in the table for each access value (if any) that the connector uses to access the information source associated with the connector. The connector a T_CONNECTOR_PARAM record belongs to is determined by the record's CONNECTOR_ID value, as shown by arrow 3931.

Turning to the T_CONNECTOR_QUERY table 3910: There may be any number of request parameters specified for a given connector. In a presently-preferred embodiment, the request parameters are query request parameters. Each query request parameter for a connector has a record in T_CONNECTOR_QUERY table 3910. Each such record is associated with exactly one connector record in the T_CONNECTOR table 3900 by the CONNECTOR_ID value, as shown by arrow 3911.

Turning to the T_CONNECTOR_QUERY_BIND table 3920: There may be a number of bind parameters specified for a given query request parameter. T_CONNECTOR_QUERY_BIND table 3920 contains a record for each specification for a bind parameter for a request parameter record in the T_CONNECTOR_QUERY table. Each such record is associated with exactly one record of the T_CONNECTOR_QUERY table 3910 by the QUERY_ID value in the T_CONNECTOR_QUERY_BIND record, as shown by arrow 3921.

Turning to the T_CONNECTOR_XSL table 3940: An XSL stylesheet specifies how to process responses from the information source for presentation to a user. Any number of XSL stylesheet documents can be associated with a particular connector, including none. The T_CONNECTOR_XSL table contains a record for each specification of an XSL document. Each record of the T_CONNECTOR_XSL table specifies one XSL document specification, and is associated with exactly one connector record in 3900 by the CONNECTOR_ID value, as shown by arrow 3941. Information on XSL stylesheet documents can be found on the World Wide Web at www.w3.org/Style/XSL. (Reference fetched 6 Mar. 2009)

Each request parameter record of the T_CONNECTOR_QUERY table may be associated with a record of the T_CONNECTOR_XSL table by the XSL_DOCUMENT_ID value of the T_CONNECTOR_QUERY record, as shown by arrow 3912. The record of the T_CONNECTOR_QUERY table and the associated record (if any) of the T_CONNECTOR_XSL table are both associated with the same connector record of the T_CONNECTOR table by the respective CONNECTOR_ID values.

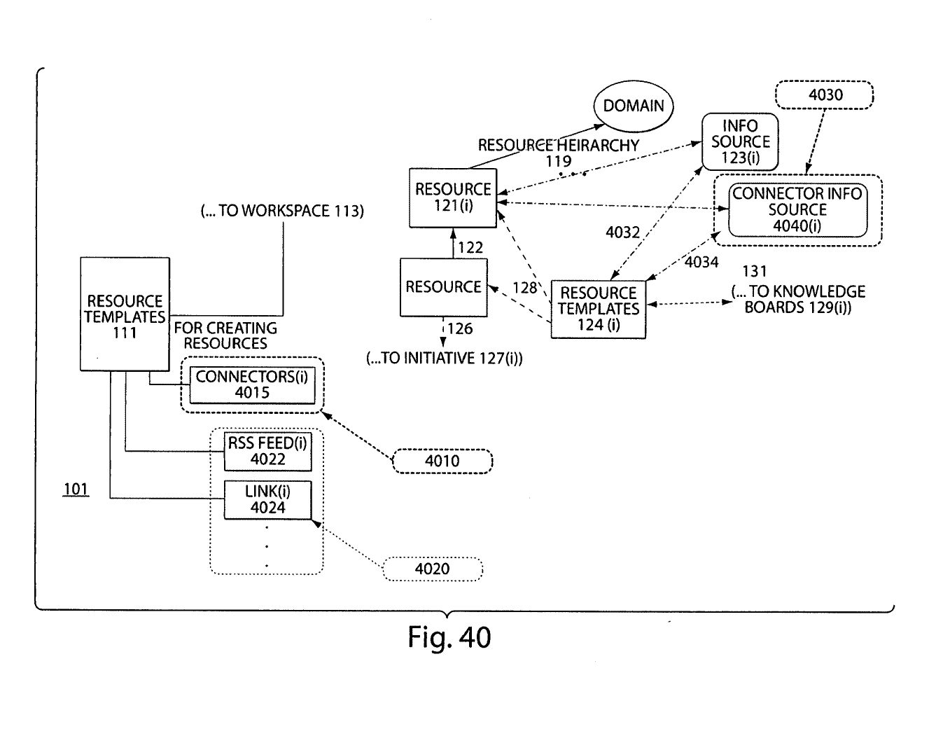

FIG. 40 shows in overview the extensions for the presently-preferred embodiment of the invention of the Connector application. The extensions are shown as additions to the presentation of FIG. 1, described above for the system of the Collaboration application. Two excerpts of FIG. 1 are reproduced in FIG. 40. Elements with the same numbers as FIG. 1 of the Collaboration application represent the same elements in FIG. 40. New elements of FIG. 40 have new numbers. Additional elements not present in the Collaboration application system are outlined in dotted lines as at 4010 and 4040.

FIG. 40 shows the database tables of system 111 having resource templates (table 111) used with workspaces (table 113). The Collaboration application describes how templates are used to relate information sources to resources, however FIG. 1 of the Collaboration application did not show that detail: the detail is shown here with exemplary information source such as the RSS Feeds 4022 and Links 4024: the ellipses below 4024 in FIG. 40 refer to further kinds of information sources of the Collaboration application and Connector application systems.

As already described, in the system of the Connector application, a number of tables, shown at 4010 have been added to represent connections. These include a connector table 4015 and other tables (not shown).

Turning to the excerpted part of FIG. 1 near resources 121, FIG. 40 shows resources 121 belonging to a resource hierarchy 119 belonging to a domain of the Collaboration application system. Resource templates 124 are related to knowledge boards 129 and to resources 121 as described in the Collaboration application. Also shown are information sources 123.

In the system of the Connector application, connectors are shown at 4040 as an additional kind of information source. A connector is associated with a resource when a resource template 124 containing a connector-type field is used as the resource template to create the resource. This aspect of becoming associated is illustrated by the dotted lines at 4032 and 4034 for information sources that are specified as connectors and for other information sources.

### Overview of Tables for Implementing Parameterized Information Requests

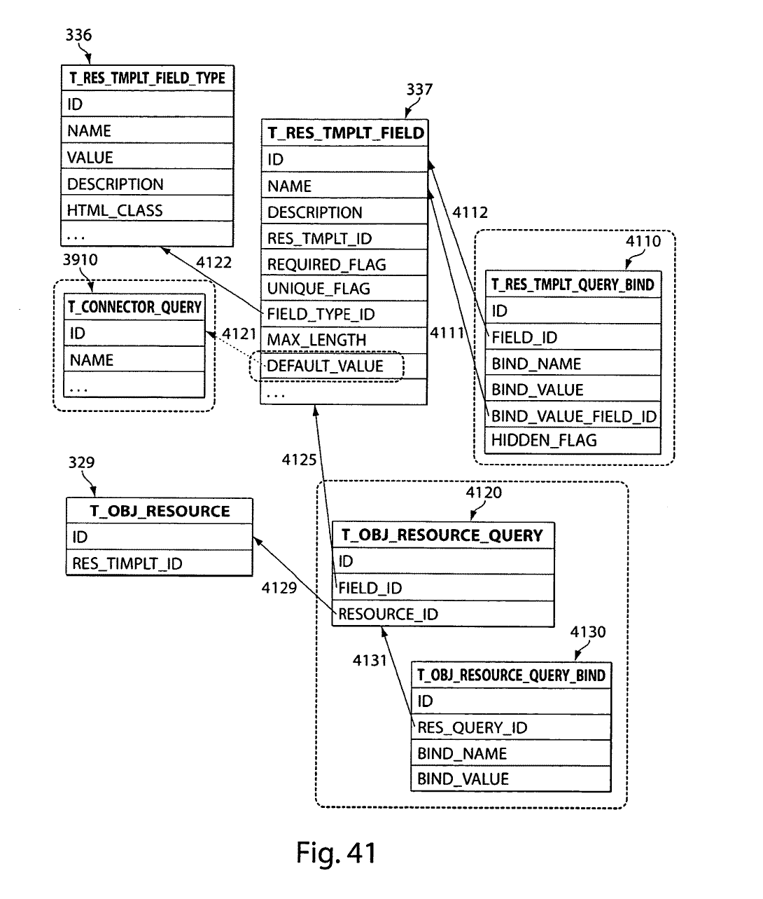

FIG. 41 shows additions to the tables of figures FIG. 4D and FIG. 4G of the Collaboration application.

The additional tables of the system of the Connector application in FIG. 4l have a dashed outline around them. 337, 336, and 329 in FIG. 41 show respectively the T_RES_TMPLT_FIELD, T_RES_TMPLT_FIELD_TYPE, and T_OBJ_RESOURCE tables described for the Collaboration application system. 3910 shows the T_CONNECTOR_QUERY table of FIG. 39.

The T_RES_TMPLT_FIELD_TYPE table 336 is extended by an additional record entry indicating a connector-type field. A field in a template that has the connector type represents a query request parameter that is specified by a record in T_CONNECTOR_QUERY. The template field will be used to display the results of a parameterized information request made by the query request parameter's connector using the query request parameter associated with the resource template field.

A connector-type field in a template is associated with a particular query request parameter for the information source the connector relates to. A number of bind parameters for the query request parameter may be associated with the connector-type field of the template.

A connector-type field in a resource is associated with the connector-type field in the resource template used to specify the resource. A number of bind parameter specifications may be associated with the connector-type field of the resource specification.

The T_RES_TMPLT_FIELD table 337 is extended for a presently-preferred embodiment of the invention from the implementation of the Collaboration application system by the addition of a DEFAULT_VALUE field. When a record in the table has the connector type, the DEFAULT_VALUE field specifies the ID of a record in T_CONNECTOR_QUERY. DEFAULT_VALUE thus relates the record for the connector-type resource template field to the query request parameter and the connector specified in a T_CONNECTOR_QUERY record. This association is shown by dashed-line arrow 4121.

The additional table T_OBJ_RESOURCE_QUERY 4120 associates each connector field specified in a resource with the specification for that connector field in the resource template used to create the resource. Each record of the T_OBJ_RESOURCE_QUERY table is associated with a record of the T_OBJ_RESOURCE table by the value RESOURCE_ID as indicated by arrow 4129, and to a connector field record of the T_RES_TMPLT_FIELD table by the value of FIELD_ID as indicated by arrow 4125. There is only one T_OBJ_RESOURCE_QUERY record associated with a connector-type field in a given resource.

The records of the additional table T_RES_TMPLT_QUERY_BIND 4110 specify bindings for bind parameters for connector-type fields in a template. The number of T_RES_TMPLT_QUERY_BIND records associated with a connector-type field record in table T_RES_TMPLT_FIELD 337 is determined by the number of bind parameters in the query request parameter for the connector-type field.

When a connector-type field is specified in a resource, the collaborator using the resource may have the system of the Connector application perform a parameterized information request to the information source indicated by the connector. The parameterized information request will use the specified query request parameter and will use the bind parameter values specified in the T_RES_TMPLT_QUERY_BIND table records in the query request parameter, except when it is overridden by a binding specified in a resource created using the resource template. Each record in the T_RES_TMPLT_QUERY_BIND table is associated with its connector-type field record in the T_RES_TMPLT_FIELD table by the FIELD_ID value, as shown by arrow 4112.

Each record in the T_RES_TMPLT_QUERY_BIND table that specifies a binding to the value of a template field is associated with the record for that template field by the BIND_VALUE_FIELD_ID record, as shown by arrow 4111.

The additional table T_OBJ_RESOURCE_QUERY_BIND 4130 holds binding specifications for the resource for the bind parameters of connectors. Each record of the T_OBJ_RESOURCE_QUERY_BIND table 4130 is associated with exactly one record of the T_OBJ_RESOURCE_QUERY table by the value of RES_QUERY_ID as indicated by arrow 4131. The number of T_OBJ_RESOURCE_QUERY_BIND records associated with the T_OBJ_RESOURCE_QUERY record is determined by the number of bind parameters specified for the query request parameter in the connector for the connector field. The BIND_NAME column of the T_OBJ_RESOURCE_QUERY record is the name of the bind parameter, and the BIND_VALUE is any value specified for the binding in the resource.

### Details of Additions to Tables

The T_CONNECTOR table and other tables contain additional fields for general database management, such as ARCHIVED_DATE, CREATED_DATE, UPDATED_BY, and OBJ_VERSION. These are used in the same fashion as the fields described above for tables of the system of the Collaboration application, and are omitted from this discussion for clarity.

### Tables of the Connector Class

Each record of the T_CONNECTOR table 3900 represents a connector. A given connector represents only one information source. The fields in the table's entries are as follows:

| Name | Type | Description |
|---|---|---|
| ID | varchar2(32) | record identifier for this connector |
| NAME | varchar2(128) | name of the connector |
| DESCRIPTION | varchar2(4000) | description of the connector |
| TYPE | varchar2(128) | type of information source: |
| | | i.e. JDBC, etc. |

In this and in other tables, the value ID field is a unique identifier for the record and the entity the record represents.

Accessing an information source may require specific access values. Each record in T_CONNECTOR_PARAM table 3930 specifies an access value needed to access the information source used by the connector indicated by CONNECTOR_ID. There is a record in T_CONNECTOR_PARAM for each attribute that the connector specified in the record needs to access the information source. The fields in the table's entries are as follows:

| Name | Type | Description |
|---|---|---|
| ID | varchar2(32) | record identifier |
| NAME | varchar2(128) | name of the access value |
| VALUE | varchar2(4000) | value of the access value |
| CONNECTOR_ID | varchar2(32) | connector ID from |
| | | T_CONNECTOR: this is the |
| | | connector this access value |
| | | specification “belongs to” |

The records of T_CONNECTOR_QUERY table 3910 specify query request parameters for entries of connectors in the T_CONNECTOR table. There is an entry for each such query request parameter. Each entry references the connector's, record in the T_CONNECTOR table 3900. There may be a number of such query request parameters for a given entry in the T_CONNECTOR table 3900. The fields in the table's entries are as follows:

| Name | Type | Description |
|---|---|---|
| ID | varchar2(32) | record identifier |
| CONNECTOR_ID | varchar2(32) | connector ID from T_CONNECTOR: this is |
| | | the connector this query request parameter |
| | | specification “belongs to” |
| NAME | varchar2(128) | name of the query request parameter |
| VALUE | varchar2(4000) | request parameter value, e.g.: |
| | | For JDBC connectors, this is an expression in |
| | | the SQL language. For SOAP connectors, this |
| | | is the name of a SOAP method for the |
| | | information source. |
| DESCRIPTION | varchar2(4000) | description of the query request parameter |
| XSL_DOCUMENT_ID | varchar2(32) | document ID from T_CONNECTOR_XSL |
| XML_POSTPROCESS | char(1) | binary value indicating optional |
| | | pre-processing for an XML response for |
| | | character encodings not compliant with XML. |
| | | Post-processing indicates that |
| | | pre-processing will not be done. |
| | | No-post-processing indicates that |
| | | pre-processing will be done. |

A number of bind values may be specified for bind parameters of a query request parameter. The records of T_CONNECTOR_QUERY_BIND table 3920 specify bindings to values for particular bind parameters of the query request parameter of a record in the T_CONNECTOR_QUERY table 3910. There is a bind parameter specification record in table 3920 for each bind parameter of the query request parameter of the record in the T_CONNECTOR_QUERY table. The fields in the table's entries are as follows:

| Name | Type | Description |
|---|---|---|
| ID | varchar2(32) | record identifier |
| QUERY_ID | varchar2(32) | record ID from |
| | | T_CONNECTOR_QUERY: this is |
| | | the request parameter this query |
| | | binding “belongs to” |
| BIND_NAME | varchar2(128) | name of a variable in the query. |
| | | For query request parameters in |
| | | the SQL language, this is a variable |
| | | preceded by a colon. |
| | | For query request parameters |
| | | expressed in SOAP, this is the name |
| | | of a parameter of the SOAP method. |
| BIND_VALUE | varchar2(1000) | optional default value for variable |
| BIND_TYPE | varchar2(16) | type of binding: text, etc. |
| HIDDEN_FLAG | char(1) | reserved for future use: |
| | | not used in the presently-preferred |
| | | embodiment |

A number of XSL documents may be associated with a given connector. The T_CONNECTOR XSL table 3940 associates an XSL document with a particular query request parameter of the T_CONNECTOR_QUERY table 3910. An XSL document contains script code for formatting information: the script of the XSL document for a connector can be used to format information returned from the information source of the connector for displaying the information to a user.

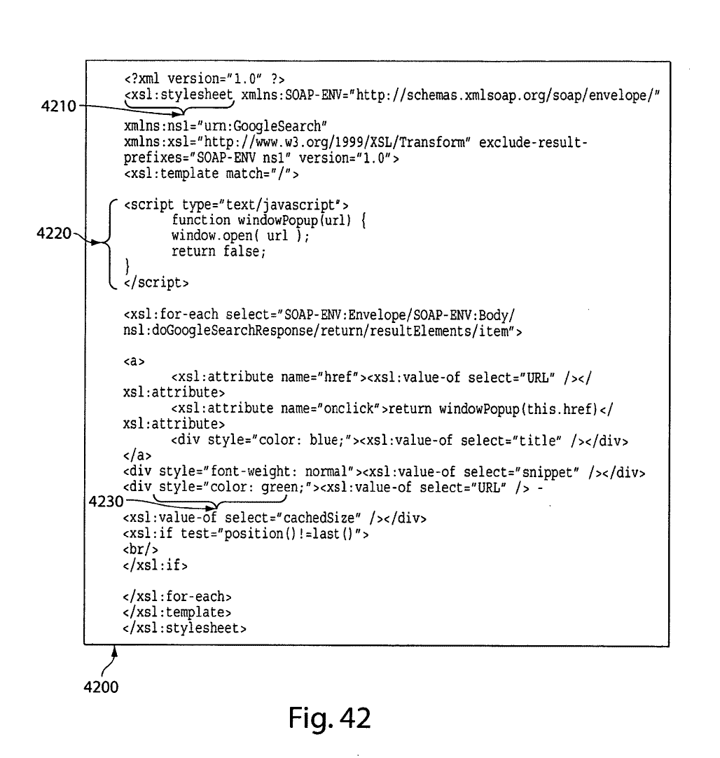

An exemplary XSL document is shown in FIG. 42 at 4200. XSL documents are also referred to as “stylesheets”: the keyword “stylesheet” can be seen at 4210. 4220 shows a segment of script code in the JavaScript language: the script code indicates that an item should be displayed in a pop-up window of a standard web browser. 4230 shows a portion of the XSL referring to displaying an item in a green color.

A given XSL document record of the T_CONNECTOR_XSL table may be associated with a number of records of the T_CONNECTOR_QUERY table 3910. A record in the T_CONNECTOR_QUERY table may have a single XSL document associated with it, or none. The fields of the entries in the records of the T_CONNECTOR_XSL table are as follows:

| Name | Type | Description |
|---|---|---|
| ID | varchar2(32) | record identifier |
| NAME | varchar2(128) | name of the XSL document in the |
| | | system |
| DESCRIPTION | varchar2(4000) | description of the XSL document |
| CONNECTOR_ID | varchar2(32) | connector ID from |
| | | T_CONNECTOR: for each |
| | | connector, there is an optional |
| | | set of XSL documents for |
| | | use with responses to requests |
| | | of that Connector. |
| | | This value identifies the connector |
| | | this XSL document record |
| | | “belongs to”. |
| DOCUMENT_ID | varchar2(32) | identifier of the file in the file |
| | | system of the server for the XSL |
| | | document |

### Tables of the Resource Template Class

The system of the Connector application supports connector-type fields associated with a particular query request parameter in resource templates.

The T_RES_TMPLT_FIELD table 337 is extended for a presently-preferred embodiment of the invention from the implementation of the Collaboration application system by the addition of a DEFAULT_VALUE field. The fields in the table's entries are as follows:

| Name | Type | Description |
|---|---|---|
| ID | varchar2(32) | record identifier |
| NAME | varchar2(128) | name of data field |
| DESCRIPTION | varchar2(2000) | description of data field |
| RES_TMPLT_ID | varchar2(32) | resource template ID from T_RES_TMPLT |
| FIELD_TYPE_ID | varchar2(32) | field type ID from T_RES_TMPLT_FIELD_TYPE |
| MAX_LENGTH | number(10.0) | maximum text length |
| REQUIRED_FLAG | char(1) | set if value required for field |
| SEQUENCE_NUM | number(4.0) | display sequence number |
| DEFAULT_VALUE | varchar2(4000) | Default value for this field. |
| | | If the field is a connector field, DEFAULT_VALUE |
| | | contains instead |
| | | The ID value the query request parameter record |
| | | for the connector in the T_CONNECTOR_QUERY |
| | | table. |

Specification for bind parameter values may be associated with the query request parameters of a connector-type field of a resource template.

The records of T_RES_TMPLT_QUERY_BIND table 4130 specify bind parameter specifications of the resource template. These bind parameter specifications override the bind parameter specification for the particular bind parameter of the T_CONNECTOR_QUERY_BIND table for a connector used in the resource template. The fields in the table's entries are as follows:

| Name | Type | Description |
|---|---|---|
| ID | varchar2(32) | record identifier |
| FIELD_ID | varchar(32) | ID for a connector field in the |
| | | resource template |
| BIND_NAME | varchar2(128) | name of query variable in a query |
| BIND_VALUE | varchar2(4000) | default value for bind parameter. This value is |
| | | used if there is no value from the field defined |
| | | in BIND_VALUE_FIELD_ID |
| BIND_VALUE_FIELD_ID | varchar2(32) | field ID for a field in the resource template |
| | | If defined, the value of this field is the |
| | | replacement value for the bind parameter. |
| HIDDEN_FLAG | char(1) | binary value indicating whether this binding |
| | | should be visible to the Collaborator updating |
| | | the instance of the resource template |

### Tables of the Resource Class

Specifications for bind parameter values may be associated with resource GUI elements associated with request parameters belonging to connectors. The association is made in two stages: a first association from the field in the resource to the field in the resource template used to specify the resource, and a second association from a bind parameter specification to the first association.

The T_OBJ_RESOURCE_QUERY table 4120 relates a connector field in a template to the resource specified using the resource template. The fields of the table's records are as follows:

| Name | Type | Description |
|---|---|---|
| ID | varchar2(32) | record identifier |
| FIELD_ID | varchar2(32) | field ID for a connector field record |
| | | from T_RES_TMPLT_FIELD/ |
| RESOURCE_ID | varchar2(32) | resource ID from |
| | | T_OBJ_RESOURCE: this is the |
| | | resource the field “belongs to” |

The records of the T_OBJ_RESOURCE_QUERY_BIND table 4130 specify bindings for bind parameters for the query request parameter of a connector field used in a resource. The fields in the T_OBJ_RESOURCE_QUERY_BIND table's entries are as follows:

| Name | Type | Description |
|---|---|---|
| ID | varchar2(32) | record identifier |
| RES_QUERY_ID | varchar2(32) | ID from |
| | | T_OBJ_RESOURCE_QUERY |
| BIND_NAME | varchar2(128) | name of query variable in query |
| BIND_VALUE | varchar2(1000) | default value for variable |

### Overview of User Interfaces

The following section describes in overview how connectors are specified in a presently-preferred embodiment. The implementation will subsequently described in more detail below.

An Administrator can specify connectors and their parts, including query request parameters for parameterized information requests. The connectors can then be used by a GUI specialist in the specification of resource templates: the GUI specialist can further specify bindings in the resource template for the query request parameters. The resource templates can then be used by a Manager to create resources: the Manager can also specify bindings in the resource. Collaborators can then use the resources, and the system creates instances of the parameterized information requests that belong to the classes defined by the connectors to get information from information sources.

In the system of the Connector application, a resource template may include a field of type connector. Such fields are associated with query request parameters belonging to connectors; when a collaborator has a resource which includes the query request parameter, the collaborator can specify that the system of the Connector application make a parameterized information request which includes the query request parameter and bindings for any bind parameters in the query request parameter. The system of the Connector application then uses the query request parameter with the specified bindings to make a instance of a parameterized information request and to provide it to the information source associated with the connector. When the information source returns a result, the result is displayed in the resource template field associated with the query request parameter.

FIG. 36 illustrates how a Collaborator uses an exemplary resource. The example is for an information source that can provide current information about shipping vessels in US ports. 3650 shows a portion of the Collaborator GUI for this exemplary resource. In this example, a Collaborator selects a Vessel Records resource in the navigation plane on the left—in this example, the Vessel Record “445548” at 3365—and the system creates particular instances of parameterized information requests using the vessel ID, provides them to the information source, and displays the results in the resource on the right.

In this example, 3660 shows the Title of the resource, which in this example is the vessel identifier 445548. 3670 and 3675 show information provided by the information source for two of the specified information requests that use the vessel identifier as a binding value for bind parameters. 3670 shows the display of the information response for a getVesselSummary request, with information shown including the Vessel ID, Vessel Name, type of service—shown as “Recreational”—and the flag of registry for the vessel. 3675 shows the display of the information response for a getVesselParticulars request, with information shown including the Vessel ID, Gross ton weight of the vessel, and length, breadth and beam dimensions of the vessel.

To see information about another vessel, the Collaborator selects another Vessel Record resource in the navigation pane on the left. The system then displays the results for parameterized information requests for that vessel ID in a resource on the right.

To “refresh” the information abbut a vessel—e.g. the vessel may have left port, and thus the current information may have changed—the Collaborator selects the same Vessel Record again, and the system creates new instances of the parameterized information requests, and displays the new results. Alternatively in the presently-preferred embodiment, the Collaborator may use the “refresh page” feature of the Collaborator's standard web browser.

Thus for the Collaborator, accessing current information in a useful fashion from this complex information source has been made easy.

In overview, creating the resource of the example in FIG. 36 was done in the following steps:
An Administrator specified a connector with a number of query request parameters for getting information the information source providing information about shipping vessels in US ports.
A GUI specialist then specified a resource template using the connector in a number of connector fields for different query request parameters. In the resource template, the GUI specialist specified an input field for a Manager to enter the vessel ID for a vessel, and several connector fields using the value of the vessel ID as the bind value for a bind parameter for the query request parameters in the connector fields.
A Manager then created several resources for getting current information about particular vessels, so that a Collaborator could use the resources.

Further details of FIG. 36 will now be described: 3665 points to a GUI element to let a Manager update the resource. Updating a resource refers to changing the specification of the resource, such as to change the bind value in a bind parameter specification of the resource. For a user who is on a Collaborator and not a Manager, the Update element at 3665 is not available in the GUI, and is not shown in the GUI.

In this example, to specify a resource for obtaining information on a different vessel, a Manager creates a new resource as described in the section Resources of the Collaboration application, selects the resource template previously specified for information about vessels, and enters the vessel ID number into the Title field of this example template whose value is used as the bind value for the connector fields in the new resource. The new resource then will get information from the information source using the new vessel ID value for the bind parameters in the query request parameters specified in the resource template used to specify the resource.

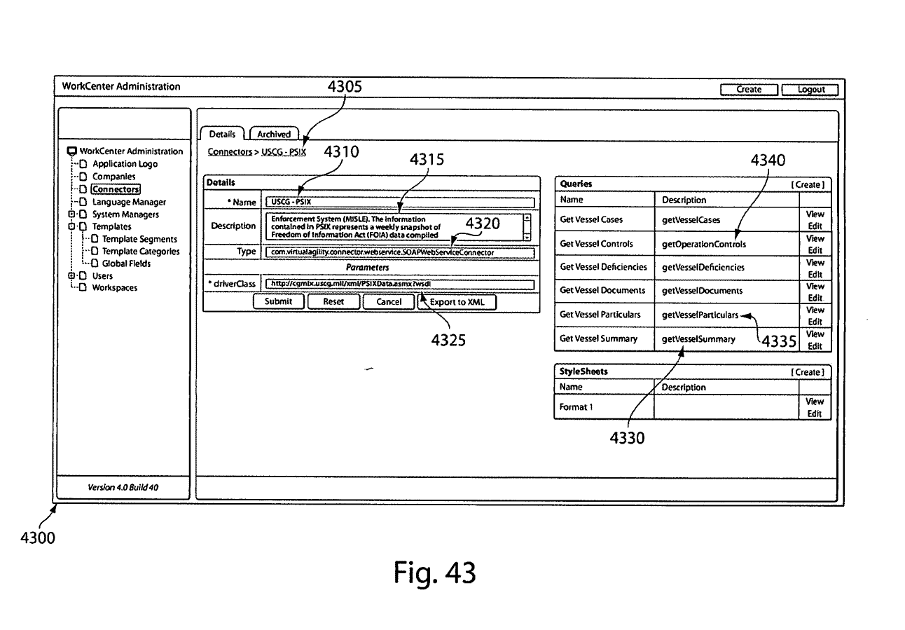

FIG. 43 illustrates in overview the specification of an example connector and the class of parameterized information requests represented by the connector. The example of 43 is for a connector for the information source that can provide information about vessels at US ports.

4300 in FIG. 43 shows a portion of the Administrator GUI to view and edit the specification of connector. 4305 displays the name part of the connector specification: a the name value can be changed by typing a value into the input field 4310 labeled “Name”. The name value is required, as indicated by the red asterisk next to the “Name” label. The field 4315 labeled “Description” shows the description for the connector. At 4320 the GUI shows the type of this connector: this is a SOAP-type connector, as indicated by the value of the Java class shown at 4320. That class was determined for the particular connector when the connector was defined. At 4325, the GUI shows the URI for the WSDL file of the SOAP information source. The WSDL file for a SOAP information source specifies the queries that the SOAP information source will accept. The system of a presently-preferred embodiment automatically processes the WSDL specification of 4325 in XML language.

Information on processing standardized WSDL specifications for web services accessed by SOAP can be found at www.w3.org/TR/wsdl on the World Wide Web (reference fetched on 6 Mar. 2009). In part, a WSDL file specifies in the XML language, the names of a number of SOAP methods that the particular web service may permit to be called, the method parameters including any request parameters of each method, and a description of the information that the web service may provide in response to each method being called.

4300 shows a number of query request parameters that have been specified for this connector, as seen on the right side of 4300. Three are referenced at 4330, 4335, and 4340, for query request parameters named getVesselParticulars, getVesselSummary, and getOperationControls.

### Details of User Interfaces

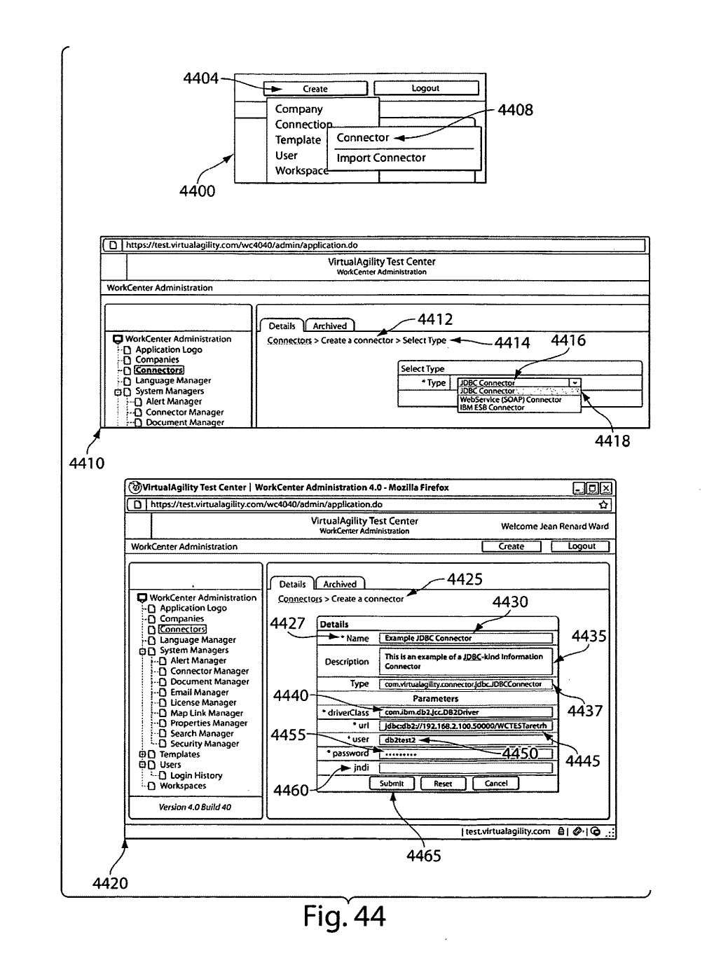

The Administrator interface for specifying a connector is illustrated for an example that is a JDBC-type connector starting with FIG. 44. Specifying a connector creates a record in T_CONNECTOR table 3900 and further records in associated tables, as will be described.

4400 shows the first part of this Administrator interface. The Administrator selects a “Create” menu from a drop-down menu icon 4404 in an Administrator GUI interface. Through a two-level menu list as shown, the Administrator selects first “Connector” from a menu that includes Company, Connector, Template, User and Workspace, and then “Connector” 4408 from a second menu list that includes “Connector” and “Import Connector”, as shown. The “Import Connector” selection allows a connector to be specified by uploading an XML file with the specification data for the connector in an export/import format file supported by the system: this feature is described below.

4410 shows the next part of the interface. The interface indicates “Create a Connector” 4412 to show that the Administrator is creating a connector, and that the current action is to “Select Type” 4414 for the type of the connector to be created. The Administrator selects the type from a drop-down list 4418: shown are the options of a JDBC-type connector, a SOAP-type connector, or an ESB-type connector. The type selected by the Administrator is shown at 4416 “JDBC Connector”. Connector types for additional kinds of information sources may be added to the system of the Connector application. The type of connector will be stored as a string value in the TYPE column of the record created in the T_CONNECTOR table 3900.

4420 shows the next part of the interface for specifying a connector. At 4425, the GUI interface indicates that this is part of specifying a connector. The Administrator enters specification values in a number of fields. At 4430 the Administrator enters a name for the connector in the field labeled “Name”. The red asterisk at 4427 indicates that this value is required. At 4435, the Administrator enters an optional description for the connector. At 4440, the GUI interface shows a string value for the type of the connector: this is determined by the type selected at 4418. The type value shown is the class name of a Java software code class for accessing the information source of the connector.

The name value of 4427 will be written to the NAME column of a new record in the T_CONNECTOR table 3900. Similarly, the “Description” value will be written to the DESCRIPTION column of the new record.

Below the type value are several GUI fields for the Administrator to enter values used to obtain access to the information source associated with a particular connector. Here, the values are those required for a JDBC-type connector.

Each value required to obtain access to the information source associated with the connector is written to a separate record in the T_CONNECTOR_PARAM table 3930. The NAME column of the record identifies which the kind of access values, the VALUE column receives the values, and the CONNECTOR_ID column receives the ID value of the T_CONNECTOR record for the connector the value is associated with.

At 4445, the Administrator enters the character string that is the name of the Java software driver class for accessing the particular information source of this connector. At 4450, the Administrator enters the URL that specifies the network address of the particular information source. The URL is expressed in a standard form that includes information about the network protocol to be used to communicate with the information source.

At 4450 and 4455, the Administrator enters two access values, the security authentication information—in this example, a username and a password—required for access to the information source. As shown, the GUI interface does not show the actual characters of the password value as it is entered. At 4460, the Administrator may enter a value that is required if the information source requires JNDI (Java Native Directory Interface) information. Information regarding JNDI can be found at en.wikipedia.org/wiki/Jndi on the World Wide Web (referenced fetched 21 Feb. 2009).

After entering the necessary information, the Administrator clicks on the “Submit” button at 4464, and the data is written to the T_CONNECTOR and T_CORRECTOR_PARAMS tables. As shown, the Administrator can also click on “Cancel” and not create a connector record, or click on Reset and start entering data for this GUI dialog from the beginning.

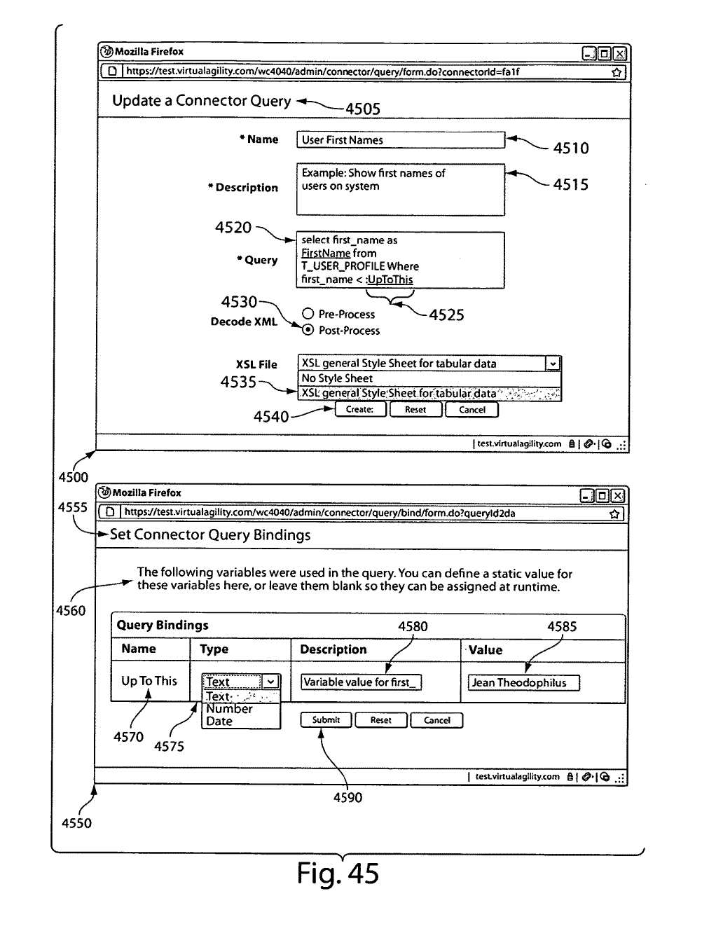

A further step in specifying a connector is specifying one or more query request parameters for the class of parameterized information requests defined by the connector. In a presently-preferred embodiment, the request parameters are query request parameters. This is illustrated in the example of a JDBC-type connector in FIG. 45, which shows further parts of the interface.

4500 shows the interface for specifying a query request parameter for a connector: this indicated by the text in the GUI at 4505 referring to a “Connector Query”. The Administrator enters a value for the name of the connector in the GUI field labeled “Name” at 4510. This value will be stored in the NAME column of a new record in table T_CONNECTOR_QUERY 3910 for the new parameterized information request.

The Administrator enters a required string value for the description for the new parameterized information request in the field labeled “Description” at 4520. This value will be stored in the DESCRIPTION column of the new record in table T_CONNECTOR_QUERY 3910. Similarly, the Administrator enters a query request parameter in the field at 4520 labeled “Query”. This string value will be stored in the VALUE column of the new record in table T_CONNECTOR_QUERY. Since the example is a JDBC-type connector, the string must be a valid expression in the SQL language dialect for the information source associated with the connector: the exemplary SQL expression shown is for obtaining the first names of users of a system from an RDBMS table, up to an character string value: the character string value will be specified by a value for a bind parameter.

4525 points to the variable “:UpToThis”: the colon ahead of the variable's name indicates that it is a bind parameter. The interface for specifying the bind value for a bind parameter is presented below.

At 4530, the Administrator specifies whether responses to the information request are to be pre-processed by the system to translate any character encodings in the response that are not according to the standards for XML-format responses: some information sources include “raw” data values from an RDBMS in the response, without transforming character encodings according to the proper standard. If post-processing is selected, then no special processing will be done. This value will be stored in the new record in the T_CONNECTOR_QUERY table in column XML_POST_PROCESS.

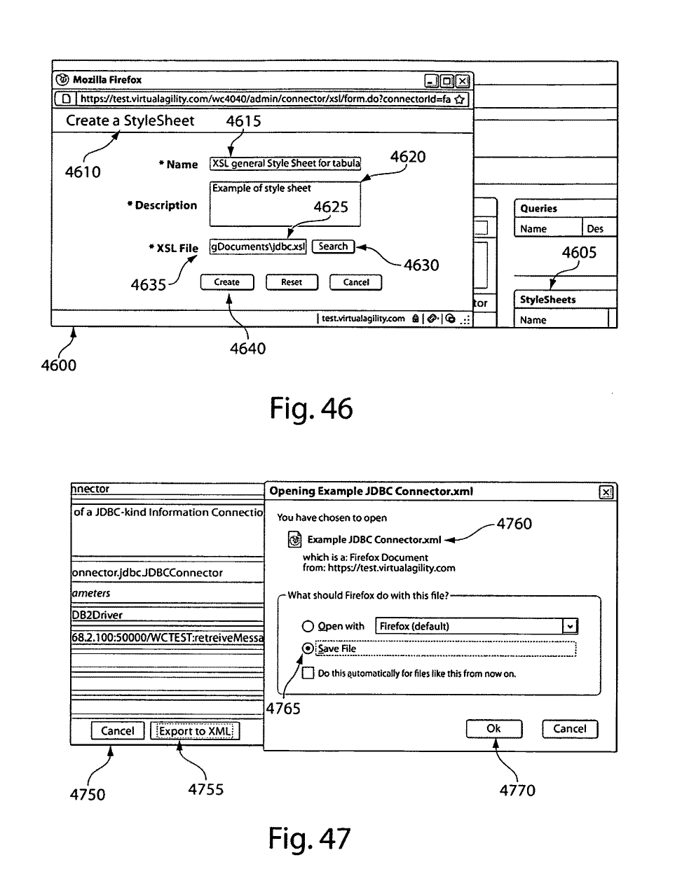

4535 is a drop-down list of XSL stylesheet documents that have been uploaded and specified for this connector: uploading XSL stylesheet documents is described for FIG. 46. The Administrator may select any of the XSL documents, or “No StyleSheet”. An exemplary XSL document is shown in FIG. 42.

After entering the necessary information, the Administrator clicks on the “Create” button at 4540, and the data is written to a new record of the T_CONNECTOR_QUERY table as described. The CONNECTOR_ID value of the new record is set to the ID value of the T_CONNECTOR record for the connector the new T_CONNECTOR_QUERY record is associated with. As shown, the Administrator can also click on “Cancel” and not create a parameterized information request, or click on Reset and start entering data for this GUI dialog from the beginning.

4550 shows the GUI for specifying the default bind parameter binding value for any bind parameters in the SQL expression entered at 4525. This is indicated by the “Bindings” text in the GUI at 4555, and the explanation text at N45X60 referring to the variables used in the query request parameter and to the choices of specifying a static value for the binding here or specifying the binding to be done at run-time as specified in a resource template which has a template field for the query request parameter or in a resource which uses the resource template field. Bindings specified in a template field override those specified in the connector and bindings specified in a resource override those specified in the resource template field or specified in the connector. In the exemplary expression of 4525, there is one variable, and thus one bind parameter “UpToThis” is shown at 4570. The name of the variable, in this example “UpToThis”, will be entered in the BIND_NAME column of a new record in the T_CONNECTOR_QUERY_BIND table 3920.

4574 is a drop-down selection list for the type of value for the binding: choices of Text, Number, or Date are shown. The Administrator selects one of the available value types, here “text”: this value is entered into the BIND_TYPE column of the new record in the table T_CONNECTOR_QUERY_BIND. The Administrator may enter a description for the bind parameter at 4580: this description is entered into the BIND_DESC column of the new record.

The Administrator may also enter a value in the “Value” field at 4585. The format of the value must be according to the type of the binding selected at 4575. If the Administrator specifies a value at 4585, the value is entered into the BIND_VALUE column of the new record in the T_CONNECTOR_QUERY_BIND table 3920.

After entering the necessary information, the Administrator clicks on the “Submit” button at 4575, and the data is written to the new record of the T_CONNECTOR_QUERY_BIND table as described. The QUERY_ID column of the record is set to the ID of the record in the T_CONNECTOR_QUERY record with which this T_CONNECTOR_QUERY_BIND record is associated. As shown, the Administrator can also click on “Cancel” and not create a new record, or click on Reset and start entering data for this GUI dialog from the beginning.

FIG. 46 at 4600 shows the Administrator or GUI specialist interface for uploading an XSL script document file as described above. Part of the GUI interface for defining a connector is shown at 4605: as part of this GUI interface, the GUI specialist can click on a “Create Stylesheet” button (not shown), and a pop-up GUI 4600 is displayed. As indicated by the title referring to “Create a StyleSheet” in this GUI interface at 4610, this GUI interface allows a GUI specialist to specify and upload an XSL document file.

The GUI specialist enters a name for the XSL document in the field labeled “Name” at 4615. This value will be entered in column NAME of a new record of the T_CONNECTOR_XSL table. The GUI specialist enters a description for this XSL document at the field labeled “Description” at 4620. This value will be entered in column DESCRIPTION of the new record in the T_CONNECTOR_XSL table.

4630 is a “Search . . . ” button of the web browser the GUI specialist is using. The GUI specialist can click on this button and use the standard “File Dialog” feature of the browser to select an XSL file to be uploaded for this specification. The browser shows the local file pathname for the file at 4635.

After entering the necessary information, the GUI specialist clicks on the “Create” button at 4640. The web browser uploads the XSL file (if any) and the data is written to the new record of the T_CONNECTOR XSL table as described. The file specified at 4635 is uploaded and stored on the system. A unique identifier for the uploaded file is stored in the new record in column DOCUMENT_ID. The CONNECTOR_ID value of the new record is set to the ID value of the T_CONNECTOR record the new T_CONNECTOR_XSL record ‘belongs to’. As shown, the GUI specialist can also click on “Cancel” and not create a new record, or click on Reset and start entering data for this GUI dialog from the beginning.

### Exporting and Importing Specifications

FIG. 47 at 4750 illustrates a further feature in a presently-preferred embodiment. Specifications for many types of objects in the system can be saved for archiving or potential re-use by exporting them to a specification file. The specification un the file is in the XML language. Specifications can also be specified by importing the specification from such a specification file. The example shown at 4750 is for the Administrator interface for saving the specification for a connector.

A portion of the connector GUI interface for an Administrator is shown in the left part of 4750. The Administrator can click on an “Export to XML” link at 4755: a pop-up GUI interface appears for the standard “file download” dialog of the Administrator's web browser. The Administrator has the option of saving the file, or opening a copy of it from a temporary location with a program. The default name for the file is the name of the connector, with a file extension “.xml” as shown at 4760. At 4765 the Administrator can select that the file should be saved in the local filesystem of the Administrator's client computer. When the Administrator clicks on the “OK” button at 4770, the file is downloaded to the Administrator's client computer and saved.

A similar GUI interface allows specifications for a number of system objects to be specified by uploading and importing a specification file.

### Connection-Type Fields in Templates

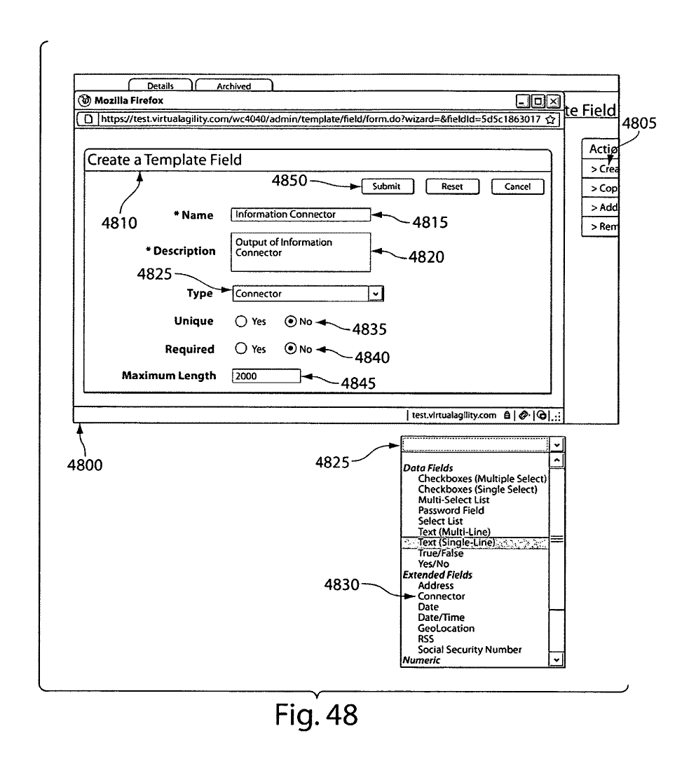

The GUI specialist interface for specifying a connector-type field in a template is illustrated starting at 4800 in FIG. 48.

4805 shows a portion of the GUI interface for specifying a template. A GUI specialist can click on a GUI option (shown in part) to create a field and add it to the resource template specification: a pop-up GUI interface 4800 appears. The function of this pop-up interface indicated by the title at 4810 “Create a Template Field”. The GUI specialist enters a name for the resource template field in the GUI field at 4815. This value will be entered into column NAME for a new record of the T_RES_TMPLT_FIELD table, in the same fashion as in the system of the Collaboration application. The GUI specialist enters a description for the new template field at 4820 in the GUI field labeled “Description”: this value will be entered into the DESCRIPTION column of the new record.

At 4825, the GUI specialist selects the type of field to be created. The GUI specialist selects from a drop-down GUI list, shown in the fragment of the GUI below 4800. Several types of template fields are shown, including Data Fields that include type Select List, Text (Single-Line), True/False, and others. Also shown are Extended Fields 4830 including template field types Address, Date, RSS, and Connector, and Numeric fields. For a connector-type field, the GUI specialist selects Connector from the list: the selected type appears in the field 4825 in 4800.

The type value selected will be entered in column FIELD_TYPE_ID in the new record of the T_RES_TMPLT_FIELD table. The value entered is the record ID for the corresponding record in the T_RES_TMPLT_FIELD_TYPE table 336. An additional record for the “Connector” field type has already been added in the system of the Connector application to the records in table T_RES_TMPLT_FIELD_TYPE.

At 4840, the GUI specialist selects from two radio-button values specifying whether this template field is required in a resource using the new template. The value selected will be stored as the value in the REQUIRED_FLAG column in the new record of the T_RES_TMPLT_FIELD table. At 4835, the GUI specialist also selects from two radio-button values specifying whether this template field must have a unique name in a resource that is using the resource template to which the field belongs. The value selected will be stored in the UNIQUE_FLAG column in the new record.

At 4845, the GUI specialist can enter a maximum length for this template field. The value will be stored in the MAX_LENGTH column of the new record of the T_RES_TMPLT_FIELD table.

After entering the necessary information, the GUI specialist clicks on the “Submit” button at 4850, and the data is written to new record of the T_RES_TMPLT_FIELD table as described. The RES_TMPLT_ID value of the new record is set to the ID value of the T_RES_TMPLT record with which the new T_RES_TMPLT_FIELD record is associated. As shown, the GUI specialist can also click on “Cancel” and not create a new record, or click on Reset and start entering data for this GUI dialog from the beginning.

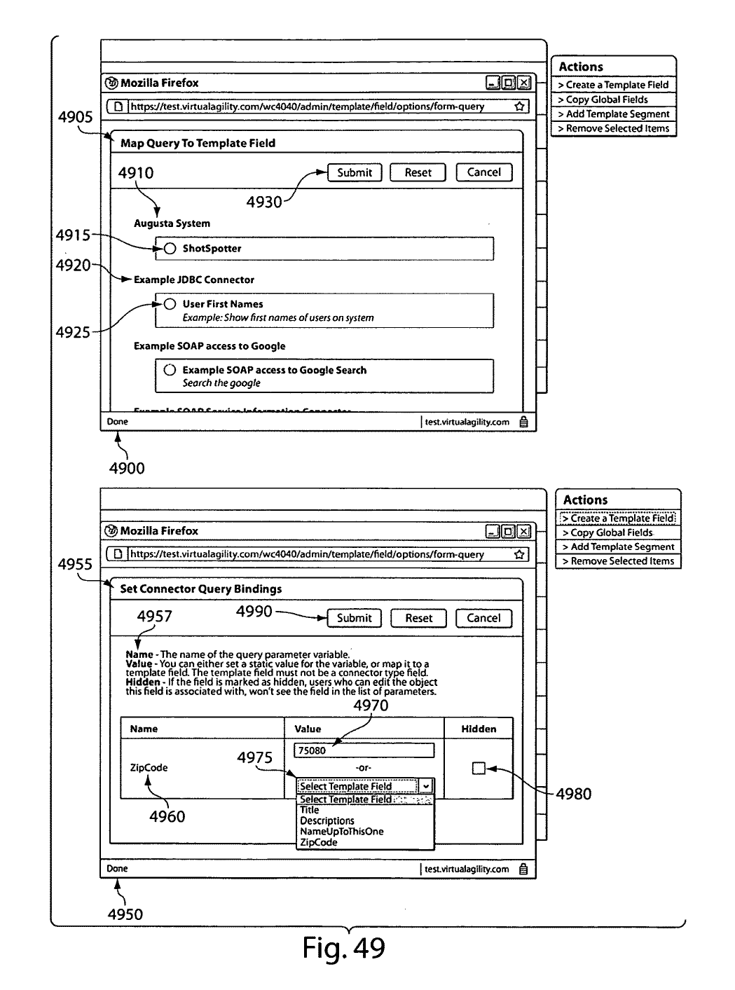

FIG. 49 shows the GUI for the next step in specifying a template field of type connector. As indicated by the title text at 4905 “Map Query to Template Field”, the GUI specialist selects a particular query request parameter request to be associated with the resource template field specified as described for 4800 in FIG. 48

The GUI of FIG. 49 shows all the query request parameters that have been specified for each connector. The query request parameters are shown in groups according to the connectors they are associated with: a radio button GUI element is next to the name of each request, so that the GUI specialist can select one of the query request parameters associated with the connector. At 4910 we see the name of the connector “Augusta System”, for which one query request parameter, “ShotSpotter” 4915, has been specified. Also shown at 4920 is the name of the connector “Example JDBC Connector”, and below that 4925, which specifies the one query request parameter that been specified for it, named “User First Names”. Below the name “User First Names” is the text of the description for that query request parameter. Other connectors and their query request parameters are shown continuing downwards in the GUI dialog: the dialog is scrollable using command key functions of the GUI specialist's Web Browser.

After entering the necessary information, the GUI specialist clicks on the “Submit” button at 4930, and the record identifier of the parameterized information request selected in dialog 4900 is entered as the value for the DEFAULT_VALUE field of the new record of the T_RES_TMPLT_FIELD table. As shown, the GUI specialist can also click on “Cancel” and not create a new template field, or click on Reset and start entering data for this GUI dialog from the beginning.

4950 shows the next GUI interface, a dialog for specifying a bind parameter for each bind parameter of the parameterized information request selected for the connector field using GUI dialog 4900. This is indicated by the title 4955 “Set Connector Query Bindings”. Text at 4957 explains the use of this GUI dialog, referring to a bind parameter variable name, the choice of a specific value to be used or the name of a template field whose value to be used in the binding, and the option of making the binding hidden for Managers who create a resource using the resource template specification of this template field.

4960 shows the one variable name “ZipCode” specified for the exemplary parameterized information request. The GUI specialist can specify a fixed value to be used for the binding in “Value” field 4970, or select a field of the resource template in the drop-down GUI list 4975: the system shows the names of all the available fields of the resource template for the GUI specialist to select from. If a field is selected, then the value in the “Value” field 4970 is ignored. At 4980, the GUI specialist can check a GUI check box to indicate that the binding should be hidden from Managers who create a resource using the resource template specification of this template field.

The name of the bind parameter of 4960 will be entered in the BIND_NAME column of the new record of the T_RES_TMPLT_QUERY_BIND table 4110; the value of 4970 will be entered into the BIND_VALUE column, the resource template field selected (if any) will be entered into the BIND_VALUE_FIELD_ID column, and the selection of the “hidden” option at 4980 will be entered into the HIDDEN_FLAG column. A bind parameter specification specifies a binding either to a specific value, or to a value that the Manager may enter into a specific field of the resource GUI—the two options are mutually exclusive. In the presently-preferred embodiment, if the GUI specialist inadvertently both enters a value and selects a field, the selection of a field is used and not the value that was entered.

After entering the necessary information, the GUI specialist clicks on the “Submit” button at 4990, and the data is written to new record of the T_RES_TMPLT_QUERY_BIND table as described. The FIELD_ID value of the new record is set to the ID value of the T_RES_TEMPLATE_FIELD record the new T_RES_TMPLT_QUERY_BIND record ‘belongs to’. As shown, the GUI specialist can also click on “Cancel” and not create a new record, or click on Reset and start entering data for this GUI dialog from the beginning.

The GUI specialist thus has considerable freedom and flexibility in specifying resource templates. The GUI specialist thus can reduce greatly the burden of complexity that a Manager or Collaborator encounters. For example, the GUI specialist can specify an appropriate bind value for a bind parameter, and further set the bind parameter to be “hidden”: the Manager will then neither need to specify the bind value for that bind parameter, nor will the Manager even be distracted by the bind parameter being visible to the Manager. As a further example, the GUI specialist can specify the same field as the source of a bind value for bind parameters for a number of connector fields in the resource template, and thus allow the Manager to specify a value only once in that one field to set a bind value for a number of connector fields for obtaining a number of kinds of information related to the value. Further, the GUI specialist can make individual fields of the resource template “hidden” from the Manager when the field does not need to be visible to the Manager and would be a distraction.

The hierarchy of bind specifications also contributes to reducing the burden of complexity. For a given instance of a parameterized information request for a resource, the bind value for a given bind parameter will be the bind value specified for the resource in the T_OBJ_RESOURCE_QUERY_BIND table. If no bind value is specified there, the bind value will be value specified for the resource template in the T_RES_TMPLT_QUERY_BIND table. If no bind value is specified there, the bind value will be the value specified for the query request parameter for the connector in the T_CONNECTOR_QUERY_BIND table.

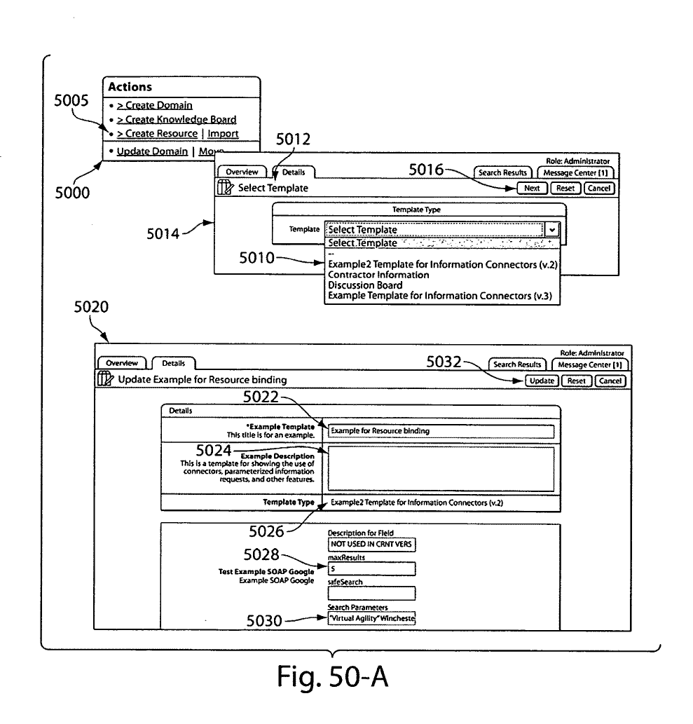

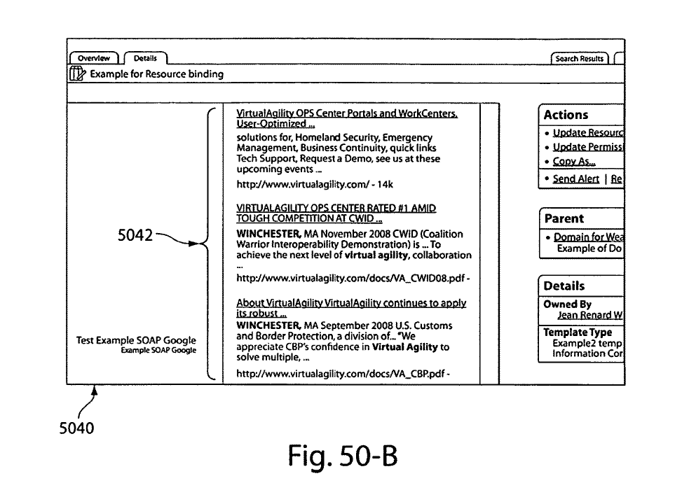

FIG. 50 illustrates the interface for a Manager to specify a resource that using a resource template specification with a resource template field of type connector. The general GUI for specifying resources is described in the section Resources of the Collaboration application.

5000 shows the first step of creating a resource: the Manager clicks on the “Create Resource” link 5005 in the system interface.

The next step is to select the resource template to be used for the resource. This is shown at 5014: the title at 5012 says “Select Template”. 5010 is a drop-down select list for the available templates. The Manager selects the template to be used to specify the new resource. In this example, the Manager will select the template named “Example 2 . . . ” from the list. Then the Manager clicks on the “Next” link at 5016.

The next GUI interface is shown at 5020. The same GUI interface of 5020 is used both for creating a new resource specification, and for updating an existing resource specification. 5020 shows the GUI dialog being used to update an existing resource.

For fields that are connector-type fields, the Manager can specify overriding bind values for bind parameters specified in the resource template that are bound to a value in the resource template specification. If the resource template specified a binding to the value of a field (BIND_VALUE_FIELD_ID of T_RES_TMPLT_QUERY_BIND), rather than to a fixed value (BIND_VALUE of T_RES_TMPLT_QUERY_BIND, the Manager cannot specify an overriding bind value.

5022 shows the title field for the resource: in this example, the Manager may change the value of this field from the default value specified in the resource template by entering a value into this field. 5024 shows the description field for this resource. 5028 and 5030 show two of four bind value specifications of the resource template that may be overridden by entering new values in this GUI. 5028 shows the field for entering a bind value to override the binding of the bind parameter named “maxResults” specified in the resource template. 5030 shows the field for entering a bind value to override the binding of the bind parameter named “Search Parameters” in the resource template.

The connector-type field in the resource template of this example is associated with a parameterized information request for requesting information from a commercial search-engine service. In the example of 5020, the parameterized information request will have bind parameter values specifying a maximum of 5 search-hit results as shown by the value for “maxResults” at 5028, and a bind parameter specifying a search for information on the keyphrases “Virtual Agility” and “Winchester”, as shown by the value for “Search Parameters” at 5030.

Updated or new information is written to the T_OBJ_RESOURCE table and associated tables as described. Binding specifications for the resource are set according to the binding specification of the resource template used to specify the resource, as follows:

When a resource is created using a resource template, a record is created in the T_OBJ_RESOURCE_QUERY table 4120 for each connector field in the resource template. The values in the FIELD_ID and RESOURCE_ID columns are set as described previously for the T_OBJ_RESOURCE_QUERY table.

Further, a T_OBJ_RESOURCE_QUERY_BIND record is created for every T_RES_TMPLT_QUERY_BIND record associated with the connector-type field. The RES_QUERY_ID value of the new record is set to the ID value of the corresponding T_OBJ_RESOURCE_QUERY record for the resource. The BIND_NAME and BIND_VALUE fields of the new T_OBJ_RESOURCE_QUERY_BIND record are set to be the same as the BIND_NAME and BIND_VALUE fields for the corresponding T_RES_TMPLT_QUERY_BIND record.

The Manager may then change the BIND_VALUE value for the T_OBJ_RESOURCE_QUERY_BIND records associated via the T_OBJ_RESOURCE_QUERY records with the resource. Values are then written to the records for the resource as described when the Manager clicks on the button at 5032.

After entering the necessary information, the Manager clicks on the button at 5032: the resource is updated or created according to the circumstance of updating or creating a new resource, as previously described. As shown, the Manager can also click on “Cancel” and not specify a new resource binding field, or click on Reset and start entering data for this GUI dialog from the beginning.

5040 shows the resource with the bind parameter specification set as described for 5020. 5042 shows the result displayed for the connector-type field at 5042. In this example, the information returned by the search engine is for the keyphrases “Winchester” and “Virtual Agility”.

### Improvements to Techniques for Connectors

In the system of the Connector application, there was only one general kind of connector: a connector that represents a query to an external information source. There was more than one type of these external connectors: for example, for external information sources that employed the JDBC protocol, that employed the ESB protocol, and that employed the Web Services SOAP protocol.

In the system of the present application; there are additional types of connectors. The additional types that have been added include the following:
A local resource connector, also termed a WorkCenter resource connector, is a connector that represents a query on the relational database system in which much of the information used by the system is stored, and obtains information of a number of resources of the system defined by users, the resources being determined by the query.
A current resource connector is a connector that represents a query on the relational database system in which information used by the present system is stored, and obtains information of the resource that is the current resource in which the connector query is being used.
A query composer connector is a connector that combines queries belonging to already-existing connector objects.

Other useful additions have also been made to the connectors to the system of the Connector application, including:
Techniques for defining an alternative source for obtaining information instead obtaining the information of from the information source of the connector query permits the performance of a system to be improved easily in useful ways. For example, in one embodiment, a caching of query responses to connector queries permits stored results of previously-performed connector queries to be used as an alternative source.

Further improvements include data augmentation and information merging.
Data augmentation is a technique by which an additional resource or additional information is easily associated with a portion of a first resource, permitting data of the first resource to be augmented with additional data.
Information merging is a technique whereby information from different information sources can be combined easily. In one embodiment, it permits information from different information sources to be transformed to a consistent form. In another embodiment, information from different information sources is combined in other useful ways. One embodiment of information merging employs the techniques of query composer connectors with a transformation component.

A readily-apparent advantage of the techniques of the present invention is that the various techniques may be used in combination and in conjunction.

In all of the following, details that are readily understood, as in view of known art or in view of other description such as the description of embodiments of the system of the Connector application, are omitted for brevity and clarity.

### Workcenter Resource Connectors

As noted previously, experience with an embodiment of the system of the Connector application has shown that users at times need to define resources that access data defined by other users in other user-defined resources of the system, and solutions of the prior art entailed very undesirable problems of complexity.

The techniques and system of the present invention solve these complexity problems by providing a type of connector for accessing local resources of the system: in the following, this type of connector will be referred to as a WorkCenter Resource connector or a local resource connector. In an embodiment, resources and fields of resources of the system can be specified in a connector query of this type, and values of fields of resources are provided in an information result after being obtained by the connector.

From the foregoing, one readily-apparent advantage of the techniques for many embodiments is that when a change is made to the implementation in the RDBMS in which part of the system is implemented, only an appropriate change to the implementation of the WorkCenter resource connector type of connector is necessary for all WorkCenter resource connectors to continue to work.

A further advantage of the techniques is that users do not require specialized expertise in such topics as SQL to access information of resources of the system.

A further advantage is that, in an embodiment of the system that includes permission mechanisms for controlling access to the resources of the system for Collaborative work, the permission mechanisms already in place in the system may be used to control access by users to information of other user-defined resources.

Yet another advantage in many embodiments is that there are significantly reduced security and complexity concerns regarding access by users to the RDBMS.

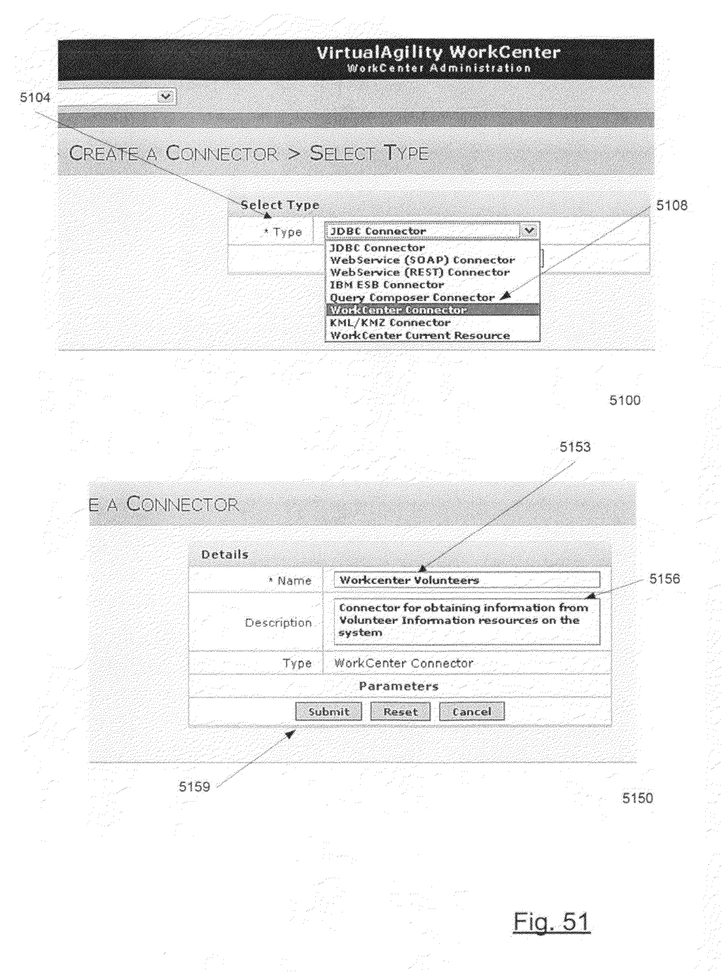

In one embodiment of WorkCenter resource connectors in the system of the present invention, the records stored in the RDBMS for WorkCenter resource connectors are exactly like the records for connectors obtaining information from external information sources, with the exception that a WorkCenter resource connector has no records in the T_CONNECTOR_PARAM table associated with it. In other embodiments, a WorkCenter resource connector or its queries may have such records, and they may be used to store information used to query the RDBMS of the system for Collaborative work. In an embodiment, a WorkCenter resource connector query's implementation combines the well-known Hibernate protocol used by Java programs to communicate with RDBMS's that employ SQL, and readily-understood APIs for obtaining information from the system for collaborative work such as SQL queries for accessing tables of the RDBMS. As they are readily understood, further details need not be described to understand the embodiment, and they are omitted for brevity. Further, because the query is performed in the system for collaborative work, the information needed to make the query can be obtained interactively from a user. An embodiment is shown in FIGS. 51 through 58.

FIG. 51 shows views of two parts of a UI of an embodiment of the system for a user to define a WorkCenter resource connector. Visible at the UI view 5100 is a UI for specifying the type of a connector to be created. The UI element 5104 contains a drop-down list to select the type of connector from the connector types available in the embodiment. In the view 5100, the user has selected the “WorkCenter Connector” type of connector 5108.

The UI view 5150 shows a second part of the UI for creating a connector. View 5150 shows a text field for the user to enter the name of the connector “WorkCenter Volunteers” 5153. The Description field 5156 is a multi-line text field for the user to enter an optional description for the connector. Below the Description field 5156 the UI shows the type of the connector selected at 5108: “WorkCenter Connector”. When the user clicks on Submit button 5159, the system creates the connector.

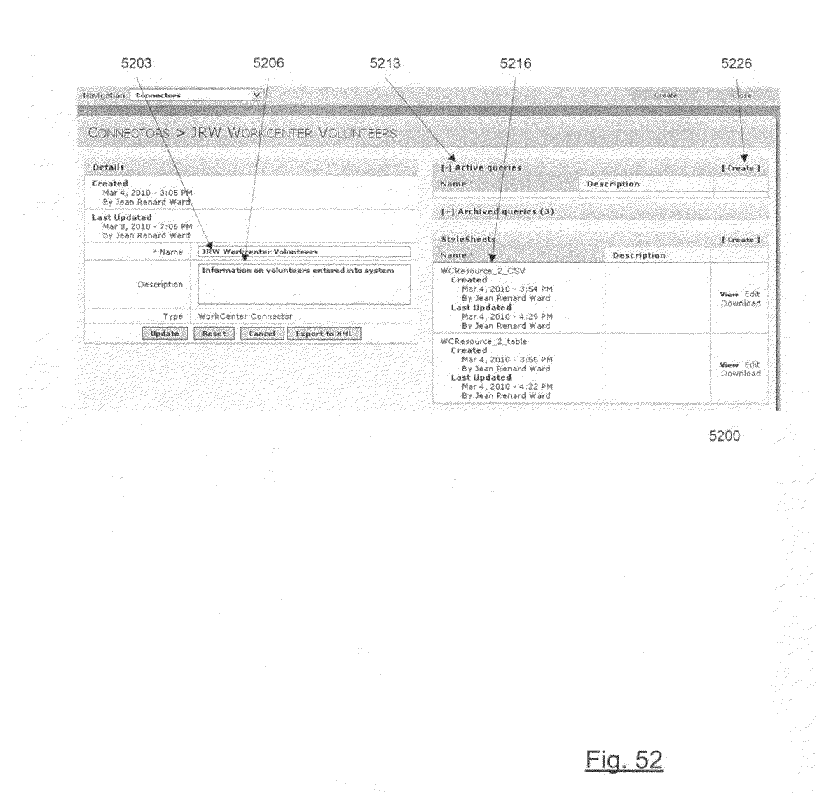

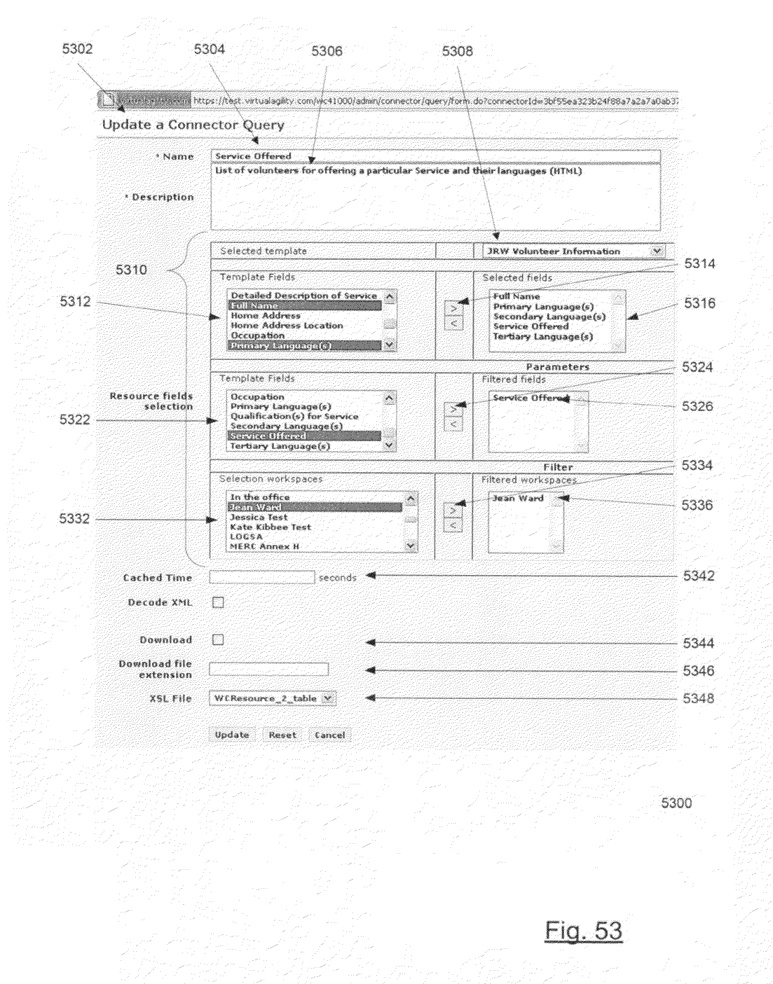

FIG. 52 shows a view 5200 of a UI of the system for viewing the definition of an exemplary WorkCenter resource connector. The Name field 5203 shows the name of the connector, “JRW Workcenter Volunteers”. The Description field 5206 shows the description defined for the connector. The Active queries UI section 5213 shows a collapsible/expandable UI element for showing the current active (not archived) queries defined for the connector: in the example of FIG. 52, there are no active queries presently defined. The UI element 5216 shows WCResource_2_CSV, one of two XSL StyleSheet scripts defined for he connector. The Create link 5226 is a clickable link of the UI of FIG. 52 for defining an active query to be added to the definition of the connector. Clicking on the Create link 5226 causes the system to display a UI like that of FIG. 53.

FIG. 53 shows a view 5300 of a first part of an exemplary UI of the system for updating or creating the definition of a connector query: Visible is the title “Update a Connector Query” 5302 of the UI. The Name field 5304 is a text field for the user to enter the name for the connector query, in this example “Service Offered”. The Description text field 5306 is a multi-line text field for the user to enter a description for the connector query.

The UI Section 5310 with the label “Resource fields section” as shown allows the user to specify the parameters of the query that will obtain information of user-defined resource objects in the system when the query is executed. The Selected template drop-down list 5308 shows a list of the templates defined in the system, subject to any permissions enforced by the particular embodiment. In this example, the user has selected the template named “JRW Volunteer Information”.

After the user has selected the template at the drop-down list 5308, the fields of the selected template are displayed in the scrolling list 5312, and in the scrolling list 5322. The scrolling lists 5312 and 5322 are multi-select lists, and the user can select (for the particular multi-select list) any number of the fields shown in the list.

The Selected fields scrolling list 5316 shows the fields of the template that have been selected as fields whose values are to be obtained from a number of resources defined with the template of Selected template element 5308, when the query is executed. Fields can be added to the scrolling list 5316 by selecting them in the scrolling list 5312, and clicking on the “>” icon of the UI element 5314. Fields can be removed from the scrolling list 5316 by selecting them in the scrolling list 5316, and clicking on the “<” icon of the UI element 5314. In this example, the user has added the fields “Full Name”, “Primary Language(s), “Secondary Language(s)”, “Service Offered”, and “Tertiary Language(s)” to the scrollable list 5316.

The Filtered fields scrolling list 5326 shows the fields of the template that have been selected as fields whose values will be used as query parameter binding values for the query being defined when the query is executed, and whose names will be used as the names of the binding parameters of the query. Fields can be added to the scrolling list 5326 by selecting them in the scrolling list 5322, and clicking on the “>” icon of the UI element 5324. Fields can be removed from the scrolling list 5326 by selecting them in the scrolling list 5326, and clicking on the “<” icon of the UI element 5324. In this example, the user has added the field “Service Offered” to the scrollable list 5326.

Workspaces of the system to which the user has access are displayed in the scrolling list 5332. The scrolling list 5332 is a multi-select select list, and the user can select (for the multi-select list 5332) any number of the workspaces shown in the list.

The Filtered Workspaces scrolling list 5336 shows the names of the workspaces whose resources' information may be obtained when the query is executed. Workspace names can be added to the scrolling list 5336 by selecting them in the scrolling list 5332, and clicking on the “>” icon of the UI element 5334. Workspace names can be removed from the scrolling list 5336 by selecting them in the scrolling list 5336, and clicking on the “<” icon of the UI element 5334. In this example, the user has added only the Workspace named “Jean Ward” to the scrolling list 5336.

Other UI elements of a UI of an embodiment for updating or creating the definition of a connector query are also shown in FIG. 53, such as the “Cached Time” text entry field 5342 for entering an optional caching time value, the “Download” checkbox for specifying a download property for the query, the Download file extension field 5346, and a drop-down single-select element 5348 for selecting an XSL script to be used with the query.

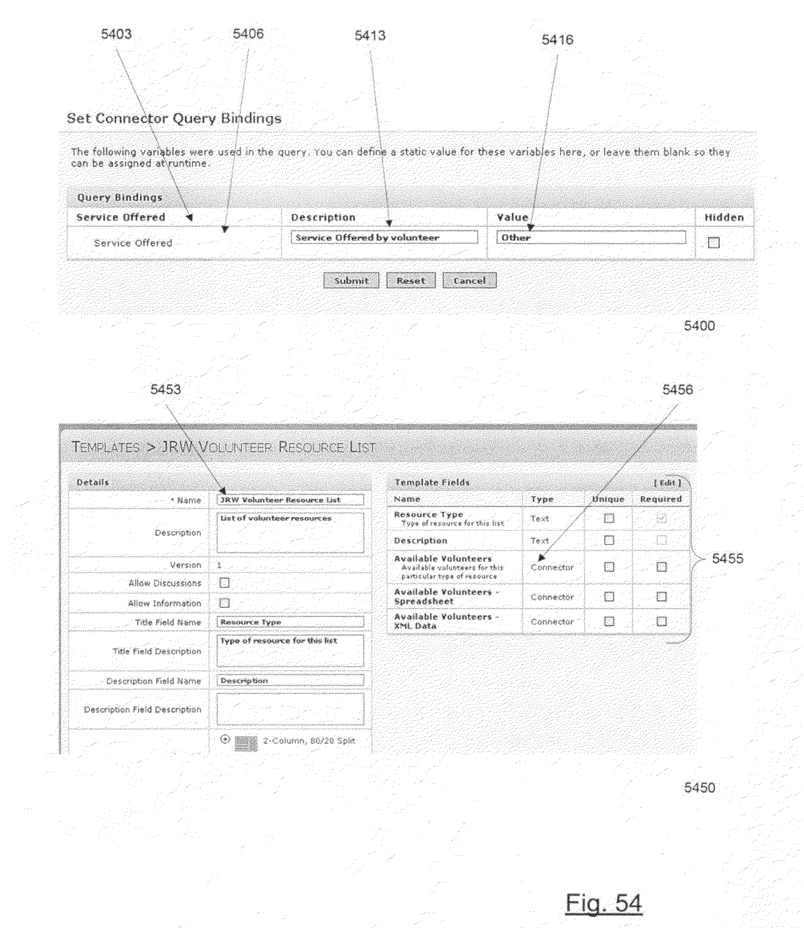

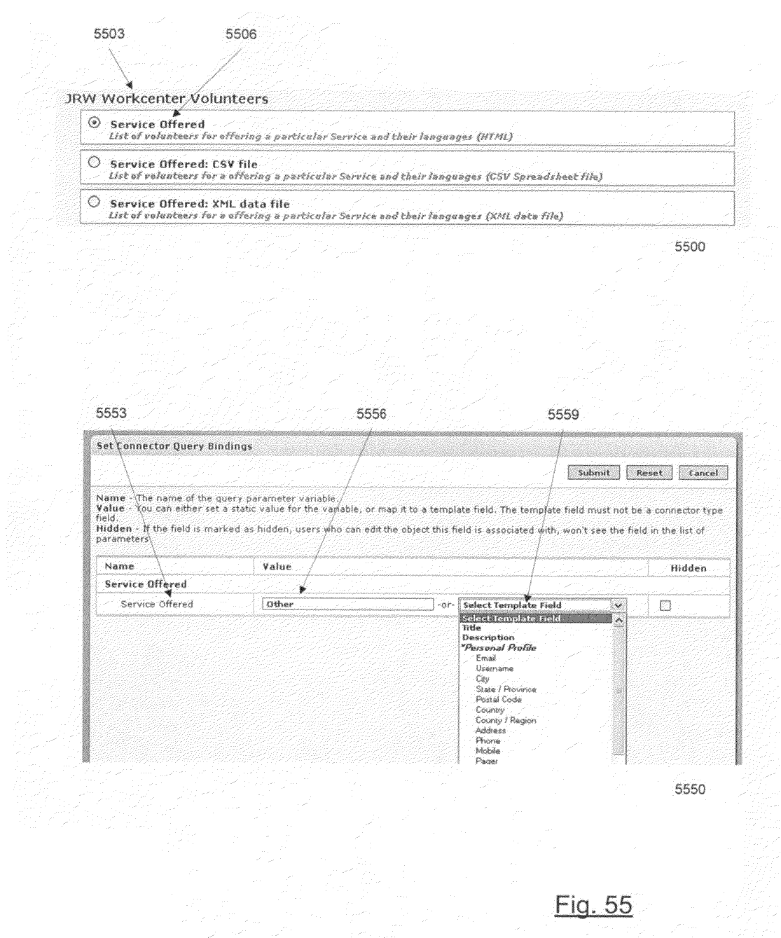

FIG. 54 shows two UI views of an embodiment of the invention. The UI view 5400 shows a part of a UI for defining, at the connector level, a run-time binding parameter value for the binding parameters 5403 defined by their selection in the “Filtered fields” selection list 5326. In this example, the only binding parameter is the binding parameter named “Service Offered” 5306. The Description field 5413 is a text-entry field for the user to enter a description for the binding parameter. The Value field 5416 is a text-entry field for the user to define a value for the binding variable 5406 at the connector level.

The UI view 5450 shows an UI of another embodiment showing the definition of an exemplary template that uses the connector and query of FIG. 53. Name field 5453 shows the name of the template “JRW Volunteer Resource List”. The Template Fields section 5455 shows the names of the fields defined in the template: in this example the UI element 5456 shows the name of connector field “Available Volunteers”.

FIG. 55 shows two UI views of an embodiment. The UI view 5500 shows a portion of a UI for defining the connector query to be associated with the connector field 5456. This UI for selecting a connector query shows a single-select list showing all the names of the connectors that may be used by the user, such as the connector name “JRW Workcenter Volunteers” 5503, and below each connector name a selectable list, via UI radio buttons, of the connector queries of the connector, such as “Service Offered” 5506, which is shown as the query that the user has selected.

The UI view 5550 shows a portion of a UI for specifying a binding value for a binding parameter of the query of 5506 at the template level. In this example, there is only one binding parameter whose value may be specified, named “Service Offered” 5553. The Value field 5556 is a text-entry field for the user to enter a value for the binding parameter named at 5553. Instead of specifying a static value at field 5556, the user may instead selected a data field of the template from the drop-down list 5559 that shows the names of data fields in the template and other fields of the system.

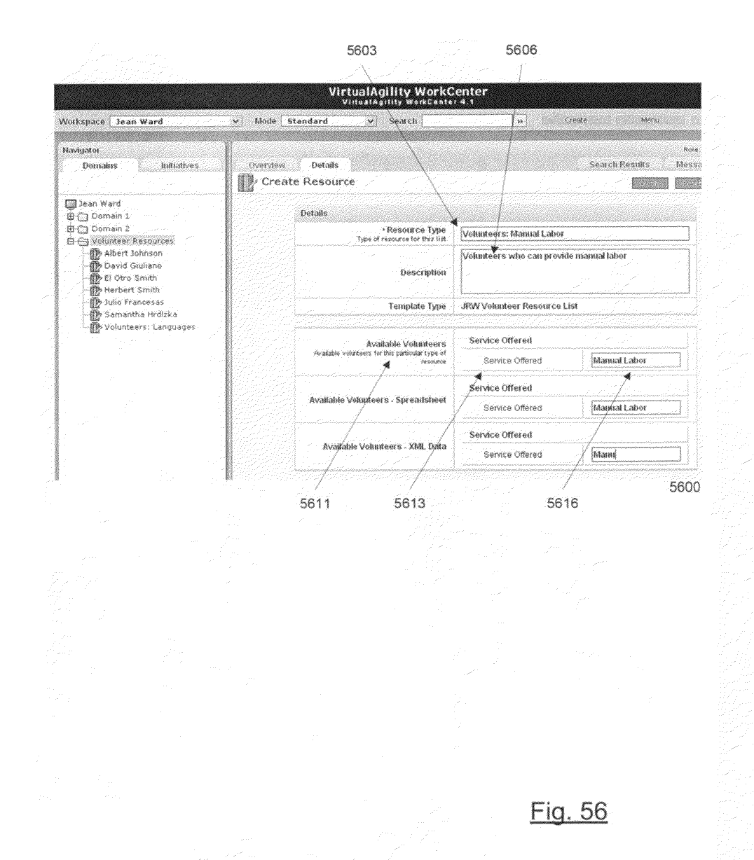

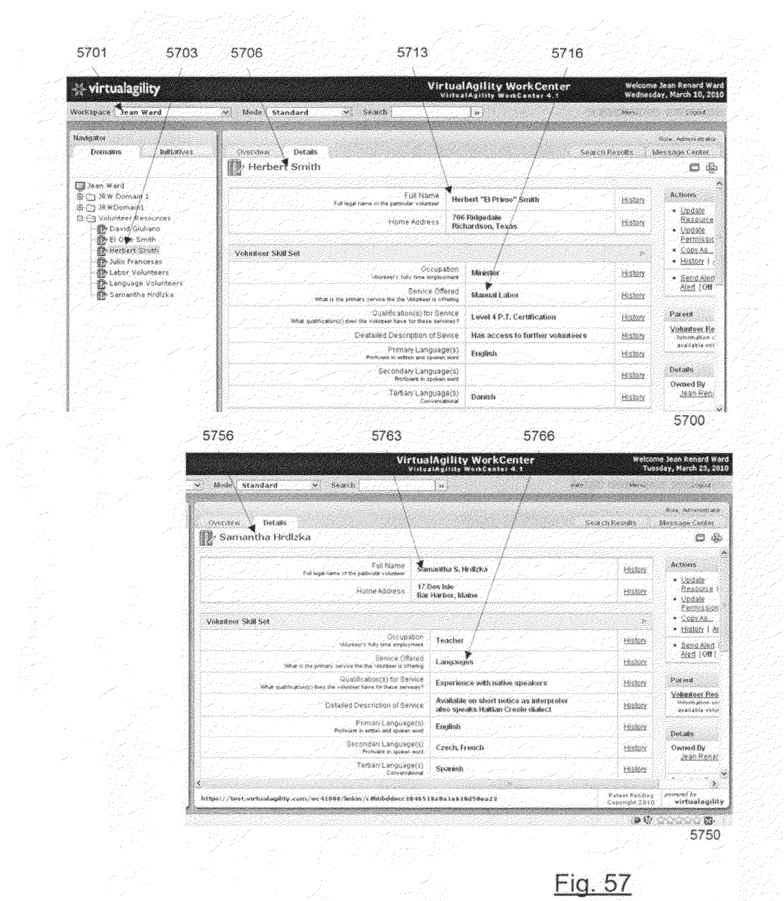

FIG. 56 shows a UI view 5600 of an embodiment for the definition of a resource defined using the template of the UI 5450. In this example, the user is defining the resource to have the name “Volunteers: Manual Labor” in the Resource Type field 5603, and has entered a description for the resource in the Description field 5606. Also visible in the resource definition shown in FIG. 56 is the field “Available Volunteers” 5611. The binding parameter name “Service Offered” 5613 for the field 5611 is also shown, as is the data field 5616 for the user to enter a value for the binding parameter at the resource level: in this example, the value is set to the value “Manual Labor”.

FIG. 57 shows UI views of two of several exemplary resources whose information will be queried by the WorkCenter resource connector query of the resource of FIG. 56. Both resources belong to the Workspace shown at reference number 5701. The UI view 5700 shows a resource with information about a volunteer “Herbert Smith” whose name is shown as the name of the resource 5706. The resource's name 5703 is also visible in the hierarchical UI of 5703. Also shown for the resource are the Full Name field 5713 with the value “Herbert ‘El Primo’ Smith”, and the Service Offered field 5716 with the value “Manual Labor”.

The UI view 5750 shows another exemplary resource for a volunteer named Samantha Hrdlzka” 5756. Also shown are the Full Name field 5763 with the value “Samantha S. Hrdlzka”, and the Service Offered field 5766 with the value “Langauages”.

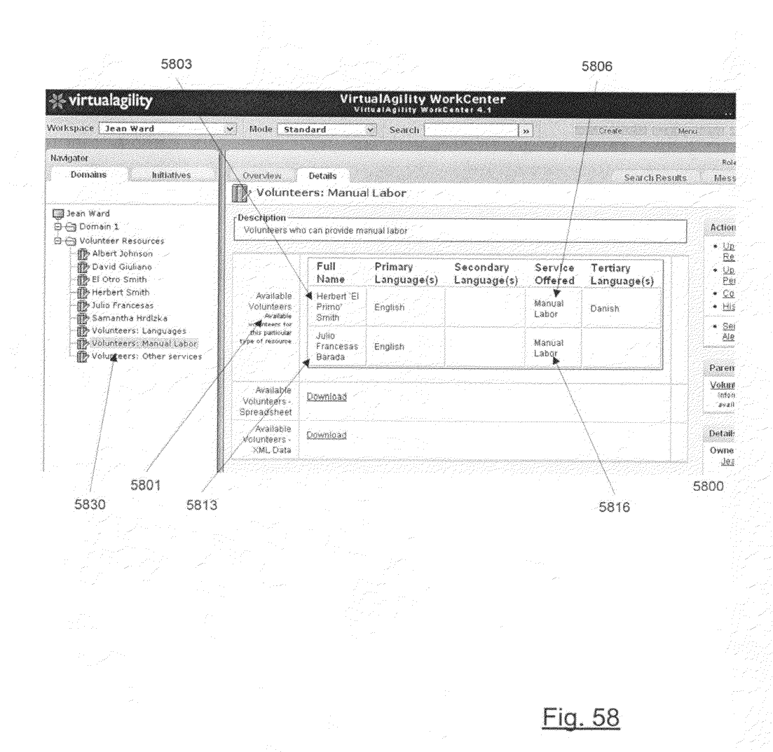

FIG. 58 completes this example by showing a UI view 5800 of the resource of FIG. 56 with the information result obtained by the connector query field. As shown in FIG. 58, the name of the resource is shown in the hierarchical display as “Volunteers: Manual Labor” 5830. The field “Available Volunteers” 5801 shows information Of two user-defined resources according to the Workcenter resource connector query associated with the connector query field: visible are the value “Herbert ‘El Primo’ Smith” from the Full Name field 5713 of the resource 5700, and the value “Manual Labor” from the Service Offered field 5716. Also shown is information from another exemplary resource obtained by the connector query of the field 5801: visible are the value of the Full Name field 5813 of that resource “Julio Francesas Barada”, and the value “Manual Labor” 5816 from the Service Offered field of that resource.

As is readily appreciated, many other embodiments are possible other than those described above. For example, embodiments may be constructed with connectors that obtain information of other kinds of objects of the system, such as objects with information related to users of the system, security objects, and other kinds of objects. Further, the techniques are not limited to embodiments with data relationships or employing connectors as shown, and embodiments may use other forms of storage than an RDBMS, such as forms of associative memories, pointer-based data structures, and structures in which records or other means of storing information relate information symbolically or physically.

### Current Resource Connectors

As noted above, experience with an embodiment of the system of the Connector application showed that users at times need to access information of the current resource, such as values of data fields of the resource, in order to combine it with other information, and the system of the Connector application did not provide a sufficiently general way for a user to accomplish this. Solutions of the prior art were problematically complex.

These problems are solved by techniques and the system of the present invention by providing a type of connector for obtaining information of the resource in which the query of the connector is used. In the following, this is referred to as a WorkCenter Current Resource connector, or a current resource connector: Since the resource is in principle known—in some embodiments it is the resource executing the instance of the query—and the information to be obtained is in principle known—it is the data field values of that resource—the definition of the connector and of a query of the connector can be greatly simplified for the user. Also, as a resource being queried may be used in more than one workspace, the current resource connector may be used in all workspaces that use that resource. Furthermore, in many embodiments maintainability is greatly improved over solutions of the prior art, since a change to the implementation of the system may require no more than an appropriate change to the implementation of the current resource connector type. Other benefits and advantages are apparent upon consideration.

In one embodiment of the system of the present invention, the records stored in the tables of the RDBMS for current resource connectors are exactly like the records for connectors for obtaining information from external information sources, except that a current resource connector has no records associated with it in the T_CONNECTOR_PARAM table, and no binding parameters defined for queries of the connector. In other embodiments, a current resource connector or its queries may have such records, and they may be used to store information used to query the RDBMS of the system for Collaborative work. In yet other embodiments binding parameters and variables may be used. In an embodiment, a current resource connector is implemented using Java programming and the well-known Hibernate protocol to communicate with RDBMS's that employ SQL, and a readily understood API employing SQL is used for obtaining information from the system for Collaborative work. As these are well known, they are readily understood.

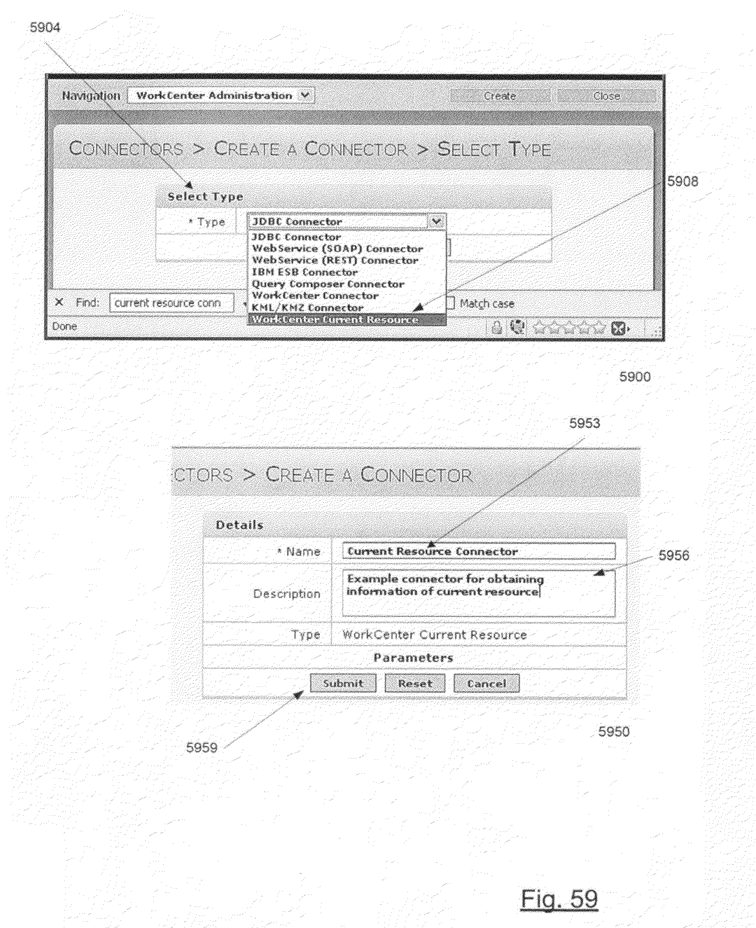

FIGS. 59 through 65 describe details embodiments of the techniques. In the following, details are omitted for clarity and brevity where they are readily understood.

FIG. 59 shows views of two parts of a UI of an embodiment for a user to define a current resource connector. The UI view 5900 shows how a user specifies the type of connector to be created. The UI element 5904 has a drop-down list to select the type of connector to be created from the connector types available in the embodiment. At 5908, the user has selected the “WorkCenter Current Resource” type to create a current resource connector.

The UI view 5950 shows a subsequent part of a UI for creating a Current resource connector. The Name field 5953 is a text data-entry field for the user to specify the name for the connector that is being created: the name “Current Resource Connector” is shown. The Description field 5956 is a multi-line text data entry field for the user to enter a descriptive text for the connector. When the user clicks on the Submit button 5959, the system creates the connector.

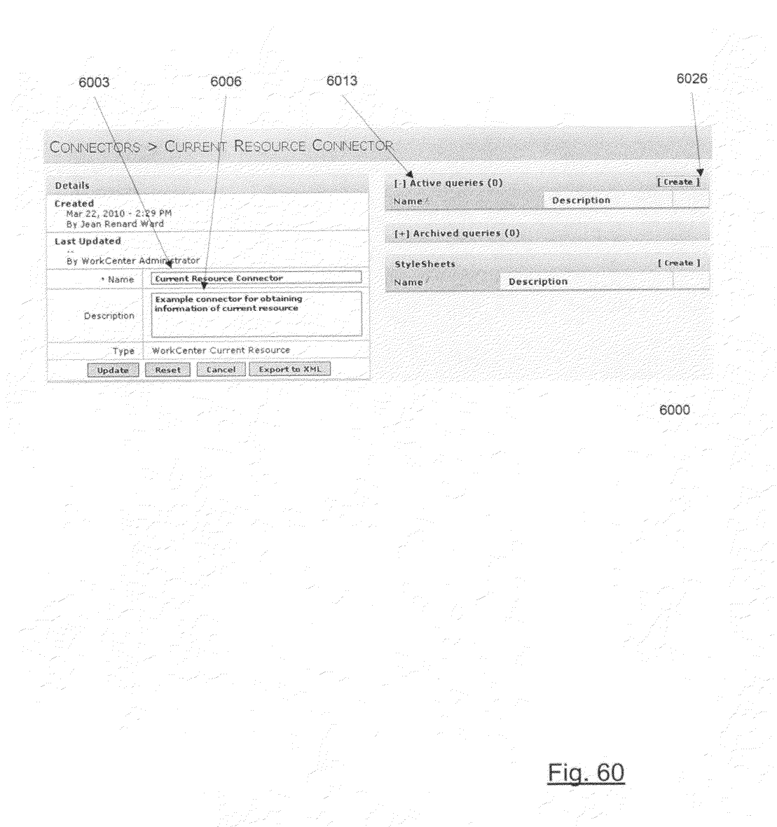

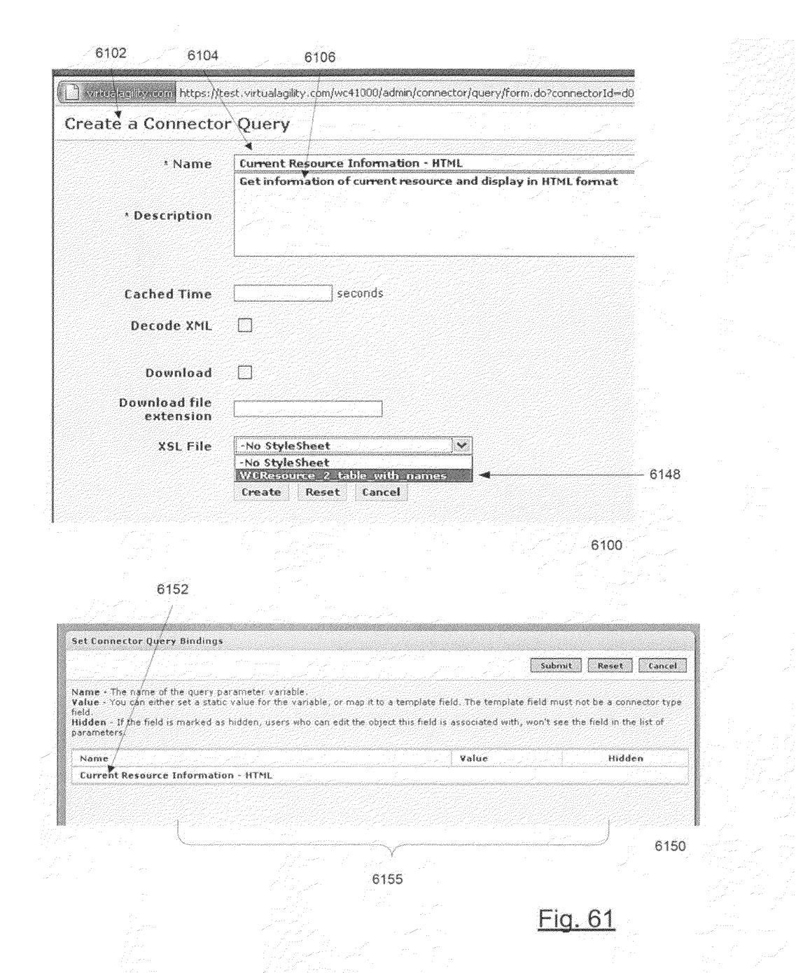

FIG. 60 shows a view 6000 of a UI of embodiments showing the definition of the current resource connector just created. The Name field 6003 shows the name of the connector “Current Resource Connector”. The Description field 6006 shows the description defined for the connector. The Active queries section 6013 shows that no active (not archived) queries are currently defined for the connector. The Create link 6026 allows the user, by clicking on the link, to define a query for the connector starting with a UI like that of FIG. 61

FIG. 61 shows two views of parts of a UI of an embodiment for defining a connector query for a Current resource connector. In the view 6100, the title 6102 shows “Create a Connector Query”. The Name field 6104 is a text data-entry field for the user to enter the name for the query: in this example it is “Current Resource Information—HTML”. The Description field 6106 is a multi-line text data entry field for the user to enter a description for the query. Also shown is the XSL File field 6148, for the user to select an optional XSL script to be used with the query: in this example, the user has selected the XSL script named “WCResource_{—}2_table_with_names”. Other elements of the UI for specifying a query of a connector are also shown.

The UI View 6150 shows another part of a UI for defining a connector query for a Current resource connector, for specifying binding values for binding parameters and variables. The Name 6152 of the query is visible: “Current Resource Information—HTML”. In the embodiment of this UI, no binding parameters or variables are associated with a Current resource connector's queries: The UI section 6155 for displaying binding parameters and their bindings at the connector level is blank in this UI.

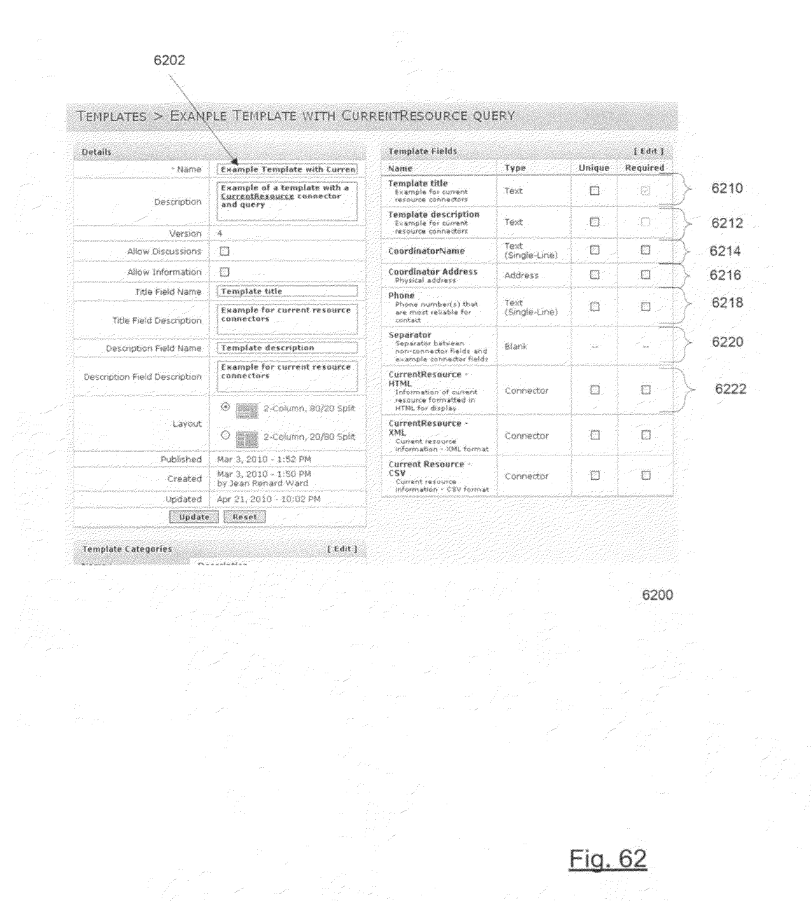

FIG. 62 shows a UI of an embodiment that shows the definition of an exemplary template that uses the current resource connector and connector query of FIG. 61. The Name field 6202 shows the visible portion of the name of the template, “Example Template with CurrentResource query”.

The template has a number of fields that are exemplary for showing the operation of a current resource connector. As shown, the Template title field 6210 is defined as a Text field, the Template description field 6212 is defined as a Text field, the CoordinatorName field 6214 is a single-line text field, and the Coordinator Address field 6216 is an Address type field. In the embodiment of this example, an Address type field is a field for which a user can specify a text value for a street address, and when the field is displayed in a resource, the system also displays an interactive graphical map of the locale of the address—the information for the graphical map is obtained by the system from an information source for maps that may be configured on the system.

Further fields are also shown: the Phone field 6218 is a single-line text field, the Separator field 6220 is a field whose function is to create a separation space in the UI when the resource is displayed, and the Current Resource—HTML field 6222 is a Current resource connector field that performs the query of FIG. 61 and displays the information result.

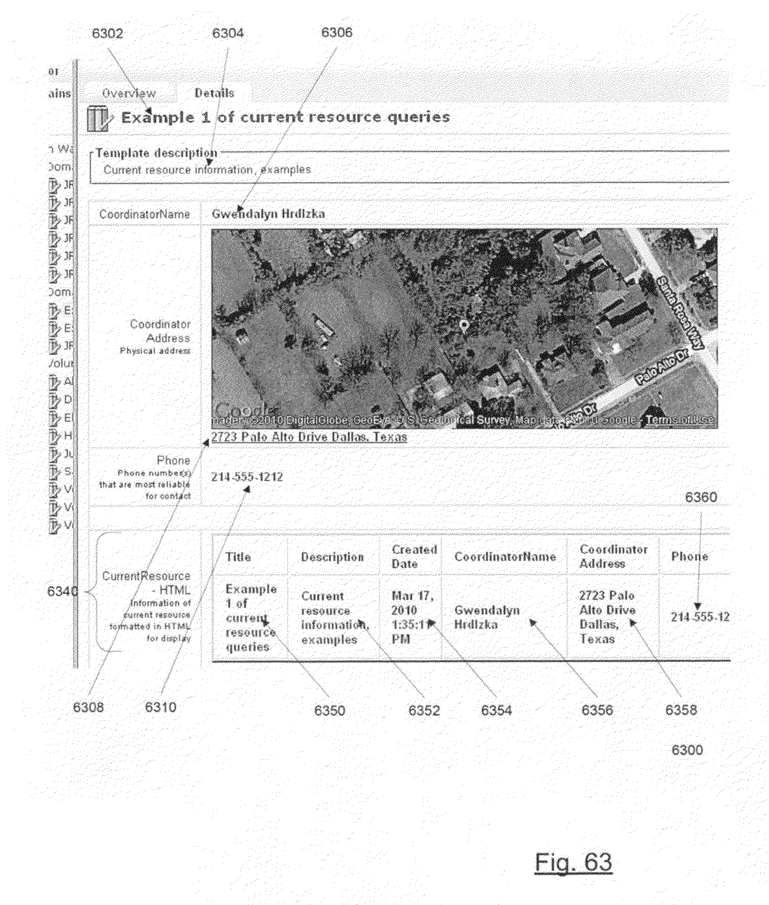

FIG. 63 shows a UI view 6300 of a resource that has been defined using the template of FIG. 62, and the resource created by a user. The Name field 6302 shows the name of the resource at the top of the UI, “Example 1 of current resource queries”. The Template description field 6304 shows the description for the template: in this example, the description is “Current resource information, examples”. The CoordinatorName field 6306 shows the value entered when the resource was created or most recently updated. The Coordinator Address field 6308 shows both the text value of the field—in this example, a street address in Dallas Tex.—and an interactive map showing the locale of the street address. The Phone field 6310 shows a phone number text value entered by the user when the resource was created or most recently updated.

The Current Resource—HTML field 6340 shows the information result obtained by the Current resource connector query of FIG. 61. (Note that in the embodiment of this example, a number of internal fields and internal names of fields of the resource are also obtained by the query, and not only fields and names defined explicitly by a user: other embodiments may vary in the information that is returned.) The XSL script 6148 of this exemplary query has formatted the information obtained as an HTML table that can be displayed in a UI of a resource of an embodiment.

As shown, the HTML table 6340 shows the name of the data fields of the current resource—the resource of FIG. 63—as the header titles of each column of the HTML table. The values of each data field of the current resource are shown in the columns of the second row of the table. As shown, the name of the Name field 6302 is shown as “Title” in the header of column 6350, and the value of the Name field 6302 is shown in the cell of the column 6350. Similarly, the name of the Title description field 6304 is shown as “Description” in the header of column 6352, and the value of the Description field 6304 is shown in the cell of the column. In column 6354, the table shows the name of an internal field “Created Date” and the value of the internal field, a timestamp value for when the resource was created.

Continuing with other columns of the HTML table 6340, the column 6356 shows in the header the name of the CoordinatorName field 6306, and the cell of the column shows the value of the CoordinatorName field 6306. The column 6358 shows in the header the name of the Coordinator Address field 6308, and the cell shows the text value entered by the user for the value of the Coordinator Address field 6308. Finally in FIG. 63, the column 6360 shows the name of the Phone field 6310, and the field's value. Other fields and internal fields of the resource in the embodiment of the example are shown in the UI to the right of the column 6360, but are not visible in FIG. 63.

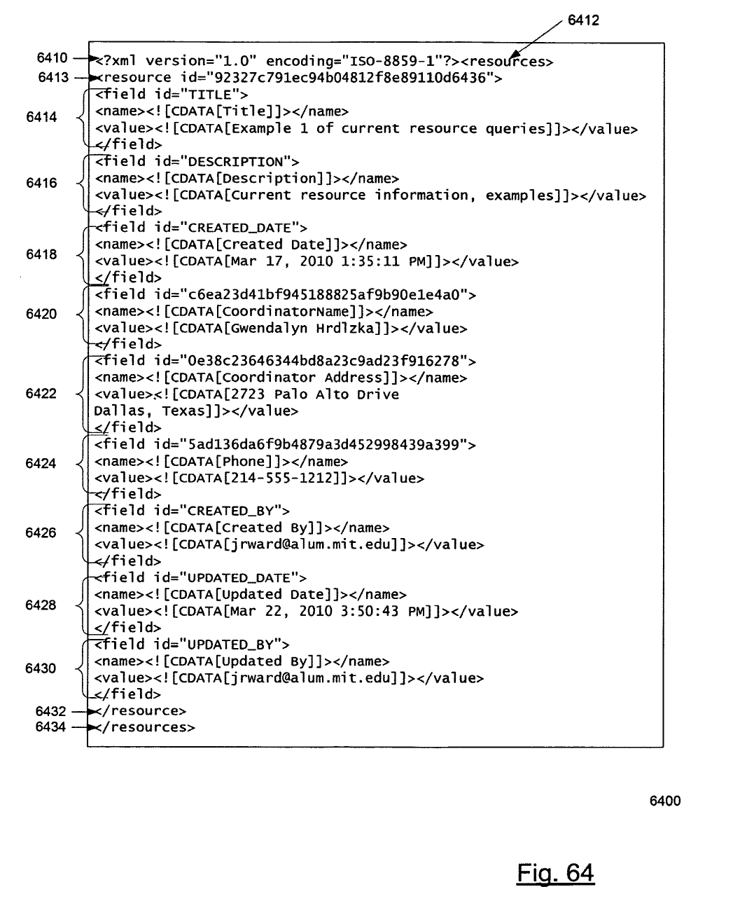

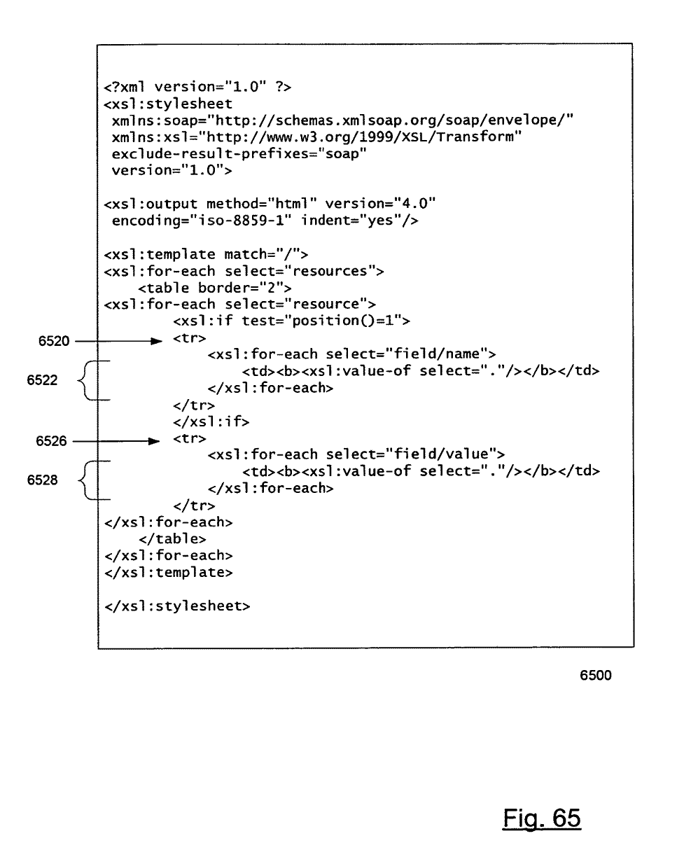

FIGS. 64 and 65 illustrate one embodiment in which the information result obtained by a Current resource connector may be used and further details of an embodiment of a Current resource connector.

The data view 6400 of FIG. 64 shows an information result obtained by the Current resource connector query of FIG. 61 from a current resource like that of FIG. 63. In an embodiment, the information result obtained is in an XML format. The XML header 6410 is a header indicating that the information is in an XML form. The XML tag 6412 “<resources>” indicates the start of an XML structure: the XML tag 6434 indicates the end of this structure. The XML tag 6413 indicates the start of a nested XML structure, and contains a unique identifier value identified by “id=”: the XML tag 6432 indicates the end of this nested structure.

The XML structure 6414 is an XML structure encapsulating the name of a field of the current resource “Title”, and the value of the field, “Example 1 of current resource queries”.

Similarly, the XML structure 6416 is encapsulates the name of a field “Description” and the value of the field, and the XML structure 6418 encapsulates the name of a field “Created Date” and the value of the field: in the embodiment of this example, this is an internal field. The XML structure 6420 encapsulates the name of a field “CoordinatorName” and the value of the field “Gwendalyn Hrdlzka”, and the XML structure 6422 encapsulates the name of a field “Coordinator Address” and the text data value of the field: in this example, the value of 6422 is a multi-line text value, and is shown containing a line break.

Similarly, XML structure 6424 encapsulates the name of a field “Phone” and the value of the field. The XML structures 6426, 6428, and 6430 encapsulate further internal fields of the embodiment.

FIG. 65 shows an exemplary XSL script 6500 like the XSL script 6148 of the Current resource connector query of FIG. 61. The purpose of the customized script 6500 is to transform the XML-format information of the information result of 6400 to an HTML table. XSL scripting and HTML are known in the art, and the script is thus readily understood in the context of the figures and other description herein. The script line 6520, for example, outputs the HTML tag “<tr>” for the start of the header row of the HTML table, and the script lines 6522 output the name part of each encapsulated field as the value for the header of a column of the HTML table. The script line 6526 similarly outputs the HTML tag “<tr>” for the start of a row with values in the HTML table, and the script lines 6528 output the value part of each encapsulated field as the value for a cell in that row of the HTML table.

The foregoing is exemplary in all respects. It will be readily appreciated that an information result obtained using a current resource connector may be used in other ways than those described. For example, information obtained from a Current resource connector may be used in the creation or definition of additional resources or objects of the system, and a current resource connector may be used in conjunction with other techniques of the present invention, such as query composer connectors, data augmentation, and information merging. In some embodiments, a script of a query composer connector may use information obtained by a current resource connector to filter or enhance information obtained using other connectors.

Many other embodiments are possible other than those described herein. For example, the techniques are not limited to embodiments employing connectors as described, may be implemented with other means for storing data, and may be implemented in other programming systems. Further, the techniques may be applied in embodiments to obtain information objects related by a hierarchical or other kind of relationship.

### Information Merging and Query Composer Connectors

As noted above, experience with an embodiment of the system of the Connector application showed that there often exists a need for information merging, in this context a need to combine easily differently-structured information from separate external systems and organizations, or to obtain information from more than one information source in single parameterized information request. Solutions of the prior art entailed problems such as undesirable complexity.

The method and system of the present invention solves these information merging problems by using an information-merging connector that performs more than one parameterized information request (hereinafter “PIR”) in a single connector query and then processes the data received from the PIRs such that the combined information is returned by the connector query in a desired form, for example in consistent format and structure for the information results received from the PIRs. In one embodiment, the PIRs or the information results obtained by them need not be identical.

One embodiment of the techniques of the present invention regarding information merging uses a query composer connector and a transformation component. The query composer connector combines together pre-existing queries of connectors for one or more information sources to obtain the information retrieved by each of the pre-existing queries. In some embodiments, the transformation component is a customizable script of the query composer connector. The system employs the script to process and transform the combined information from the information sources to the desired form. In one embodiment, the transformation component may determine which data is from which information source or which pre-existing query, and then transform the data from each information source or pre-existing query to a consistent form and structure for the information from each of the pre-existing queries. In another embodiment, the information from the information sources is combined in complex ways by using a customized script of a connector.

Note that in the following, a number of details of the implementation are readily understood, and have been omitted for clarity.

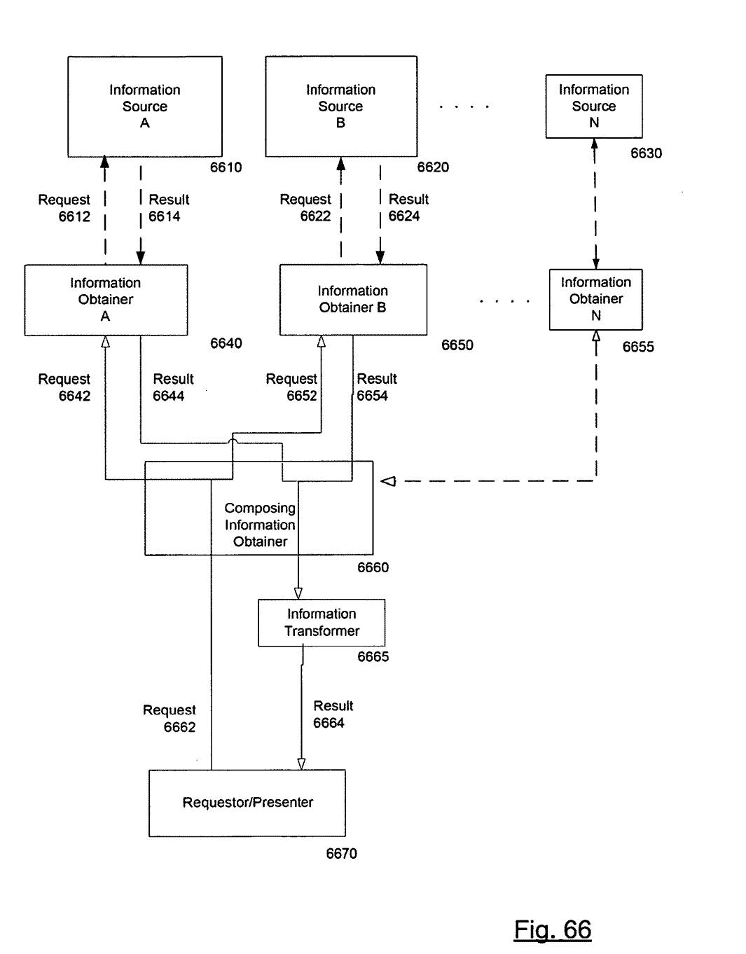

FIG. 66 shows in general block-diagram form an overview of an embodiment of the techniques for information merging according to the present invention. The Requester/Presenter component 6670 presents an information request 6662 to the information obtainer 6660, and receives as a consequence of the request, the information result 6664 from the information obtainer 6660. The Requester/presenter component 6670 is shown as a single component, but may of course be implemented as distinct requester and presenter components or in another fashion.

The information obtainer 6660 is a composing information obtainer. When the composing information obtainer 6660 receives the request 6662, the information obtainer 6660 makes the distinct information requests 6642 of the information obtainer 6640 and the information request 6652 of the information obtainer 6650, as shown.

The information obtainer 6640, upon receipt of the information request 6642, makes a further information request 6612 of the information source 6610, using a form to which the information source 6610 responds. The information source 6610 responds by providing, in a form specific to the information source 6610, the information result 6614 to information obtainer 6640

Similarly, the information obtainer 6650, upon receipt of the information request 6652, makes a further information request 6622 of the information source 6620, using a form to which information source 6620 responds. The information source 6620 responds by providing, in a form specific to the information source IMXZ20, the information result 6624 to information obtainer 6650

Upon receipt of the information result 6614, the information obtainer 6640 provides the information result 6644 containing information of the information result 6614 to the composing information obtainer 6660. In one embodiment, the information obtainer 6640 may transform a portion of the information of the information result 6614 prior to providing the information result 6644 to the information obtainer 6660.

Similarly, upon receipt of the information result 6624, the information obtainer 6650 provides the information result 6654 containing information of the information result 6624 to the composing information obtainer 6660. Again, in one embodiment, the information obtainer 6650 may transform a portion of the information of the information result 6624 prior to providing the information result 6654 to the information obtainer 6660.

Also shown in FIG. 66 are further possible exemplary information source 6630 and information obtainer 6655.

Upon receipt of the information results 6644 and 6654, the composing information obtainer 6660 provides a combined information result of 6644 and 6654 to the information transformer 6665. The information transformer 6665 may be customized by a user of a system employing the techniques to transform the combined information of 6644 and 6654 to a desired form. For example, in one embodiment, the information transformer 6665 may be customized to transform information of the two information sources 6610 and 6620 to a consistent form. In another embodiment, the information transformer 6665 may make no or very little transformation of the combined information.

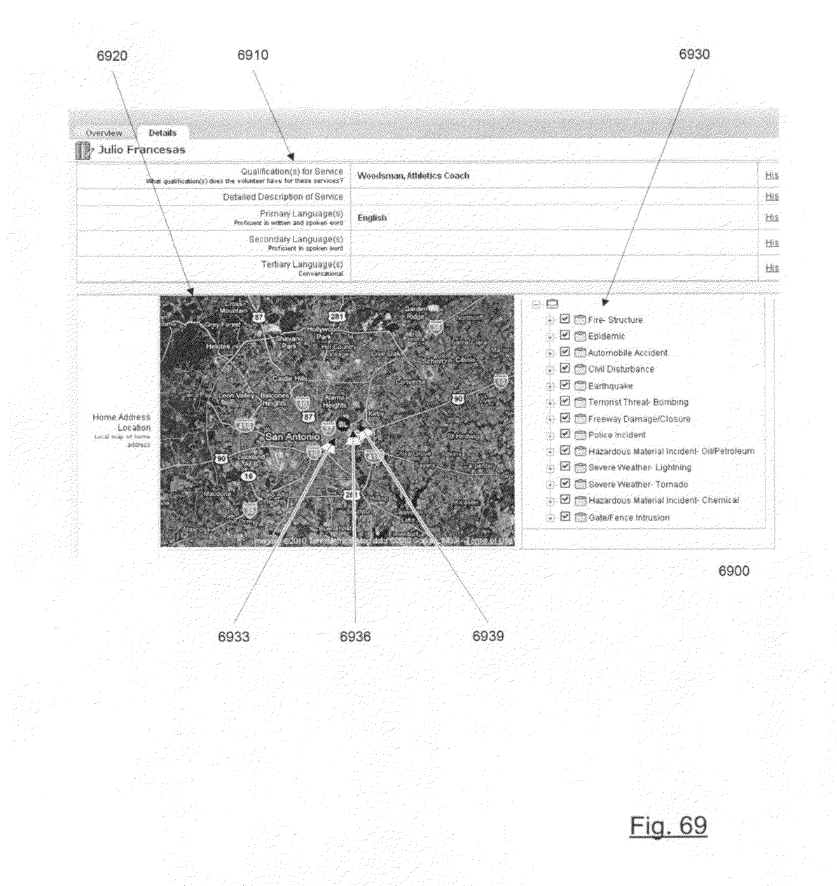

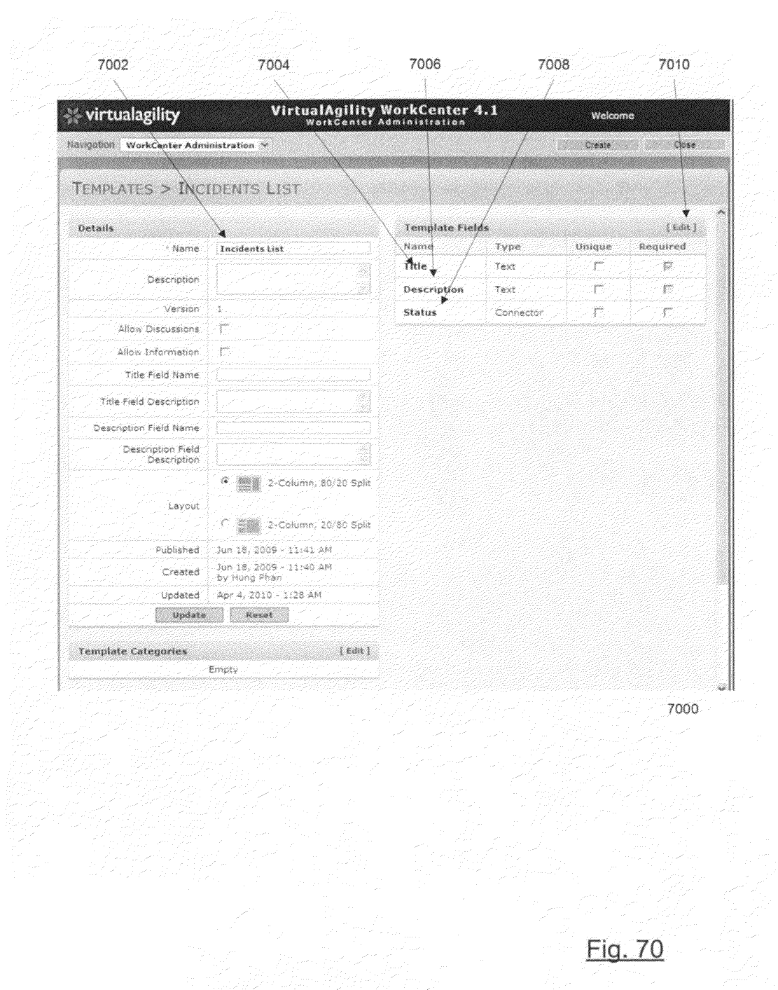

In yet another embodiment, the information transformer 6665 may combine all or part of the information of one information source with information from another information source in a desired or useful fashion. For example, an embodiment may combine information from one information source for displaying maps with information from another resource concerning locations of emergency events to display information about the events within the geographic locale of the maps on the maps. An example of a use of such an embodiment is shown in FIG. 69, which is explained further below. In another embodiment, the locale of a map is further set to a local of an address obtained by a current resource connector.

Returning to FIG. 66, the information transformer 6665 subsequently provides at least a portion of the combined information transformed by the transformer 6665 to the requester/presenter 6670 as the information result 6664.

It is readily apparent that one of many advantages of the techniques of the present information merging invention is that information obtainers may be implemented in a general fashion, thus reducing the complexity of combining information from information sources to little more than the specification of information obtainers such as 6660 and the customization of one or more information transformers such as 6665.

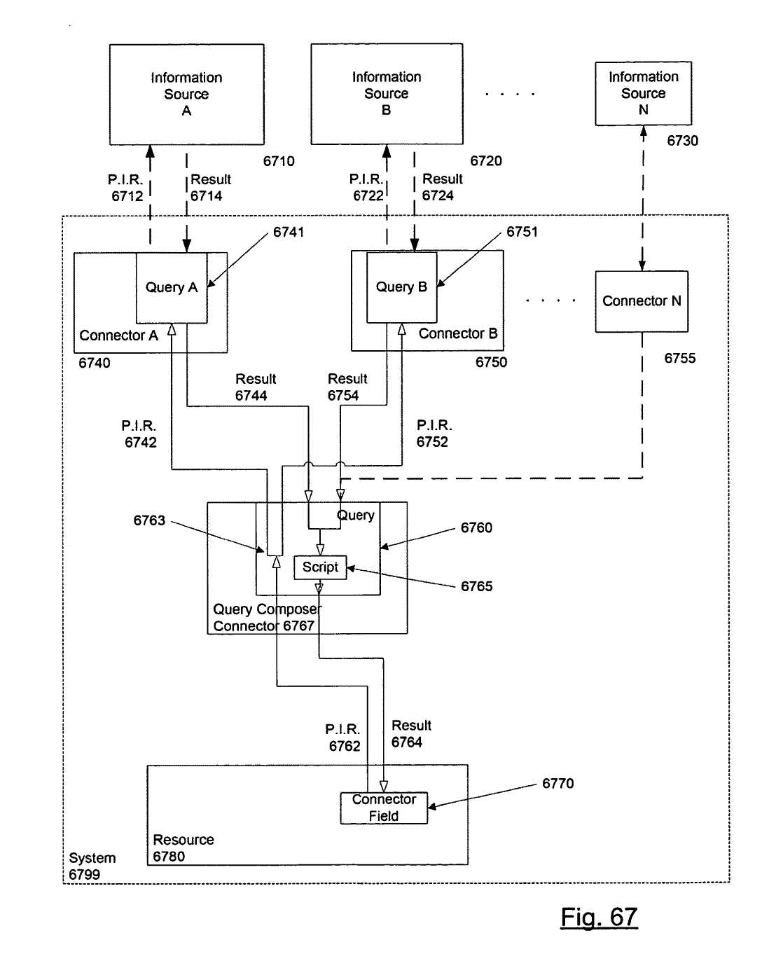

FIG. 67 shows in block-diagram form an implementation of the techniques of FIG. 66 in an embodiment employing connectors.

The resource 6780 is a resource of an embodiment of the invention of the present system 6799. The resource 6780 includes the connector field 6770. The connector field 6770 is defined using the query composer connector 6767. The field 6770 displays information in a user interface (also referred to herein as “UI”) of the system 6799 that is obtained by the parameterized information request 6762 to query 6765 of the connector 6767. When a user displays the resource 6780, the system 6799 performs the parameterized information request 6762 to obtain the information result 6764 via the query 6760 of the connector 6767, and displays the result 6764 for the field 6770 in the resource 6780.

The query composer connector 6767 has a query 6760 that composes two queries of the connectors 6740 and 6750. When the connector 6767 receives the request-6762, the query 6760 makes the parameterized information requests 6742 and 6752 of the queries of the connectors 6740 and 6750 respectively, as shown at 6763.

The connector 6740, upon receipt of the parameterized information request 6742, makes a further parameterized information request 6712 of the information source 6710 via the connector query 6741, using a form to which information source 6710 responds. Information source 6710 responds by providing, in a form of the information source 6710, the information result 6714 to connector 6740.

In a similar fashion, the connector 6750, upon receipt of the information request 6752, makes the further information request 6722 of the information source 6720 via the connector query 6751, using a form to which information source 6720 responds. Information source 6720 responds by providing, in a form of the information source 6720, the information result 6724 to connector 6750.

Upon receipt of the information result 6714, the connector 6740 provides the information result 6744 containing information of the information result 6714 to the query composer connector 6767. In one embodiment, the connector 6740 may transform a portion of the information of the information result 6714 as part of the function of its query 6741 prior to providing the information result 6744 to the connector 6767.

Similarly, upon receipt of the information result 6724, the connector 6750 provides the information result 6754 containing information of the information result 6724 to the query composer connector 6767. In one embodiment, the connector 6750 may transform a portion of the information of the information result 6724 as part of the function of its query 6751 prior to providing the information result 6754 to the connector 6767.

Also shown in FIG. 67 are further possible exemplary information source 6730 and connector 6755.

Upon receipt of the information results 6744 and 6754, the query composer connector 6767 provides the combined information result of 6744 and 6754 to the script 6765 of the connector query 6760 of the connector 6767. The script 6765 may be customized by a user of the system to transform the combined information of 6744 and 6754 in a desired fashion. In one embodiment, the script 6765 is implemented as an XSL script.

Subsequent to processing by the script 6765 of the query 6760, the connector 6767 provides at least a portion of the combined information transformed by the query 6760 to the resource 6780 as the information result 6764, and the result is displayed by the connector field 6770 of the resource 6780 in its UI.

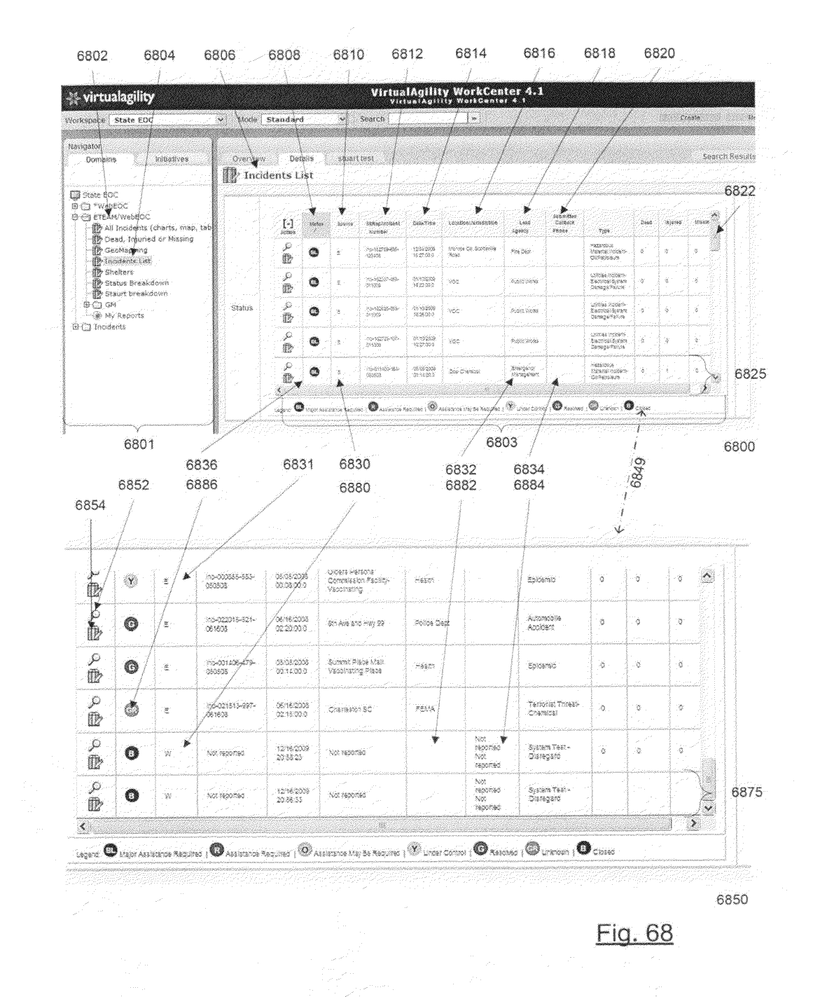

FIG. 68 shows two screenshots illustrating an exemplary use of the techniques of the present system. For clarity, a single scrollable screen is shown in two screenshots. The bottom screenshot 6850 of FIG. 68 is simply the lower portion of the screen shown in the upper screenshot 6800. The example of FIG. 68 is a resource that shows information concerning emergency incidents from two different information sources that provide information about emergency incidents, called here the WebEOC information source the ETEAM information source. These two information sources are described for purposes of example only. Any number and kind of information source may be used. The two information sources of this example provide information in different formats via different protocols. There are also differences in naming and structure for the information provided by the two information sources. The information from the different information sources is obtained using a query composer connector according to one embodiment of the system of the present invention. In this example, for incident information from either information system, the information about an incident is processed to be shown in a consistent form in a row of an HTML table. The HTML table itself is exemplary of one possible embodiment in which the system is implemented in a client/server form and the UI of the system is a web-browser UI, and other embodiments are possible, such as a UI running on a mobile device or a stand-alone system.

The UI shown by screenshots 6800 and 6850 displays the information about incidents from the two information sources in a consistent format and structure in a scrollable HTML table 6822, with the scroll bar as shown for the user to scroll to different parts of the table. The lower screenshot 6850 shows the HTML table of the screenshot 6800 scrolled to the bottom of the table so that other rows of the HTML table are visible. Each row of the HTML table shows information about one incident. Row 6825 is an exemplary row showing information about an incident from the ETEAM information source. Row 6875 is an exemplary row showing information about an incident from the WebEOC information source.

The hierarchal portion 6801 of the UI view 6800 shows the relational position of the example resource in the hierarchy of objects in the system. The resource title 6804 shows the resource by its title “Incidents List”; the parent object of the resource 6804 is the domain “ETEAM/WebEOC” shown at 6802.

The portion 6803 of the UI screenshot 6800 shows an HTML table exemplary embodiment. The reference numeral 6806 shows the title of the resource, “Incidents List”. The title Incidents List” 6806 is the same as the highlighted title 6804 from the hierarchy shown in the UI index portion 6801. The columns 6808 through 6820 are a number of exemplary columns of the HTML table 6822. Other columns are also visible. In other embodiments, a redacted, expanded or different list of columns may be used, or information may be shown in other forms for displaying information, including other visual or non-visual forms of displaying or presenting information, such as audio or tactile displays. The “Status” column 6808 includes the header “Status” and is used to indicate the status of the incident. The “Source” column 6810 includes the header “Source” and indicates whether the incident information of a row was obtained from a connector for obtaining information from the WebEOC or from the ETEAM information source. The “Incident Number” column 6812 includes the header “SitRep/Incident Number” and indicates an identifying number for an incident. Further, the “Date/Time” column 6814 includes the column header “Date/Time” and indicates when the incident occurred or was first reported, the “Location” column 6816 includes the column header “Location/Jurisdiction” and indicates the locale where the incident occurred, the “Lead Agency” column 6818 includes the column header “Lead Agency” and indicates the organization with primary responsibility for handling the incident, and the “Callback” column 6820 includes the column header “Submitted/Callback phone” and indicates a telephone number. In other embodiments, the entries in the HTML table 6822 may include data or may be empty, depending on whether information is available for a particular row, cell, or incident.

In the example shown in FIG. 68, the information source for the information in a row is shown in the “Source” column 6810 by an “E” for the ETEAM information source, such as at the entries 6830 and 6831, and by a “W” for the WebEOC information source, such as at the entry 6880. In this embodiment, information about which information source provided information regarding an incident is not present in the information obtained from either information source. In this example, the value for the “Source” column in a given row is inferred: the value is determined by a script of a query composer connector, based on XML meta-information tags added by the query composer connector to indicate the pre-existing connector query used to obtain the information about an incident. These tags are used by the script to determine which information source was the source of the information about an incident. An indicator of the information is then added to the column 6810 by the system of the present invention. In other embodiments, the source of the information is not included in the table 6822, or other information may be inferred.

One difference between the structures of the information from the ETEAM and WebEOC information sources is that the ETEAM information source does not include or provide information for a phone number, but the WebEOC source does. As part of presenting the information in a consistent fashion, a blank or empty value such at the entry 6834 is shown for the column 6820 when the information source is the ETEAM information source. In the information from the WebEOC source, if a phone number is not known for a particular incident, the WebEOC source provides an information value “Not Reported”, as is shown in column 6820 at the entry 6884. In other embodiments, other representations may be used to indicate that the data is not available or the entry may be left empty.

Another difference between the two sources of information in the example is that the ETEAM information source provides information for a “Lead Agency”, such as that shown at the entry 6832, but the WebEOC information source provides no information that would be considered equivalent in the context of this example. The information about incidents from the two sources is provided to the user in a consistent fashion by showing a blank value such as the entry 6882 for the column 6818 in rows with information from the WebEOC source.

Further, the different information sources in this example provide different status classification indications for incidents, and provide this information in different forms. In this example, the information regarding status is presented in a consistent form in the “Status” column 6808 using colored icons with character labels, such as the black icon with the characters “MR” shown at the entry 6836, and the colored icon with the character “B” shown at the entry 6886. In other embodiments, other types of indicators may be used to show status.

In other embodiments, there are a number of ways to use and combine the techniques of the present invention to merge information from different information sources. The present example employs a query composer connector that composes connector queries for each of the desired information sources. Each of the composed connector queries returns information in its own format and structure. A connector query, such as the composed connector query of the example shown in FIG. 68, may include an XSL script to perform translation or processing of the information obtained from the information source of the query, such as to convert a proprietary format to an XML format for convenience, or to an HTML format so that the query may be conveniently employed in a number of templates to display information.

In one embodiment of the system, a query composer connector obtains a combined result of the individual results of the composed connector queries, in which each of the individual results is encapsulated in a portion of an XML format for the combined result. The query composer connector also has an XSL script that processes the combined result. In the present example, the script of the query composer connector identifies each individual portion from a particular information source by tags of the XML format. For each identified portion, the XSL script of this example contains instructions that when performed, identify the elements of the information from the particular information source, and modify the data or its format or structure to the desired form for use in the resource of the example.

XSL scripting and encapsulation of data using XML are known in the art, and thus need not be explained in detail here. In an embodiment, customized XSL scripts may be written to perform any desired merging or other processing of information obtained using a connector query. For example, FIG. 69 shows an example of an embodiment in which information from map information source and information from an emergency incident information source are combined to show the locations of the incidents on an interactive map. The screenshot 6900 in FIG. 69 shows a UI displaying information 6910 about an emergency worker, a map 6920 of the area near the worker's address, and selectable information about current emergency incidents at the hierarchical UI 6930. The information about the emergency worker 6910 is information of the system itself, obtained using the technique of a local resource connector, and includes the worker's street address (not visible). The information for the map 6920 is obtained from one information source, such as Google Maps: Google Maps is representative. Information about current emergency incidents 6930 is obtained from another information source, such as MERIS, a representative public-emergency information source. A customized information transformer in the form of an XSL script of a query composer connector processes the combined information from multiple separate information sources to show map icons 6933, 6936, and 6939 on the display of the map 6920 for incidents in the geographic locale of the map. In one embodiment the map is interactive, in that a user can select or unselect types of incidents via the UI portion 6930 from the information obtained from the emergency incident information source to be represented on the map: selecting different types of incidents may not only change the icons displayed with the visual map, but also the scale of the map.

The connector field and the associated query composer connector:

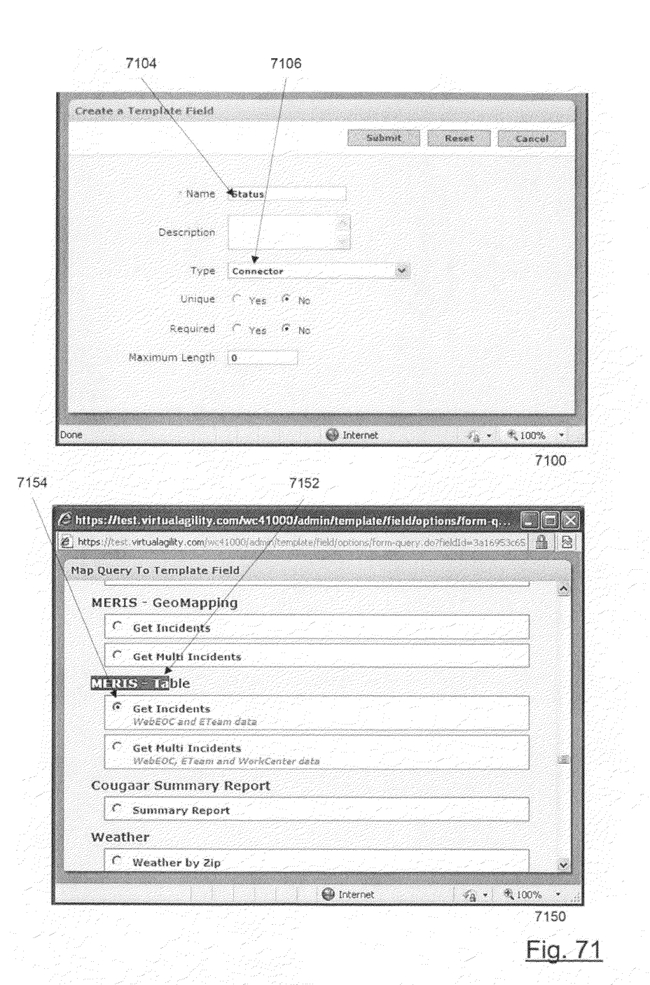

FIGS. 70 through 90 show further details of the template, the query composer connector, the pre-existing connector queries, the combined result, and the XSL script of the example of FIG. 68.

The UI 7000 shown in FIG. 70 shows the definition of the template “Incidents List” for the example of FIG. 68. The name field 7002 shows the name of the template, “Incidents List”. The section of the UI in the upper right shows the different fields available in the template. In the embodiment shown in FIG. 70, there are three fields: a “Title” field 7004, and a “Description” field 7006 and a “Status field 7008. Each of the three fields also has a type. The “Title” field 7004 is a text field, the “Description” field 7006 is a text field, and the “Status” field 6808 is a connector field. Also visible is an “Edit” link 7010. Clicking on this link brings up a UI for editing the fields of the template. In other embodiments, other UI elements, fields, and other links may be available in the template.

FIG. 71 shows screenshots of the first two parts 7100 and 7150 of a UI of the system for the definition of the “Status” field 7008. The first part 7100 of the UI specifies information such as the name of the field and the type of the template field. The “Name” field 7104 is a UI field that allows the user to enter the name of the template field. The “Type” field 7106 is a drop-down list for field types. In the example shown in FIG. 71, the selection in this example is that this field be a Connector-type field. The other part 7150 of the UI is for selecting the connector of the system and the connector query of the connector for the template field 7008. As shown at reference numeral 7152, the template field 7008 in a resource using this template will show information obtained using the connector named “MERIS—Table” and that connector's query “Get Incidents” 7154.

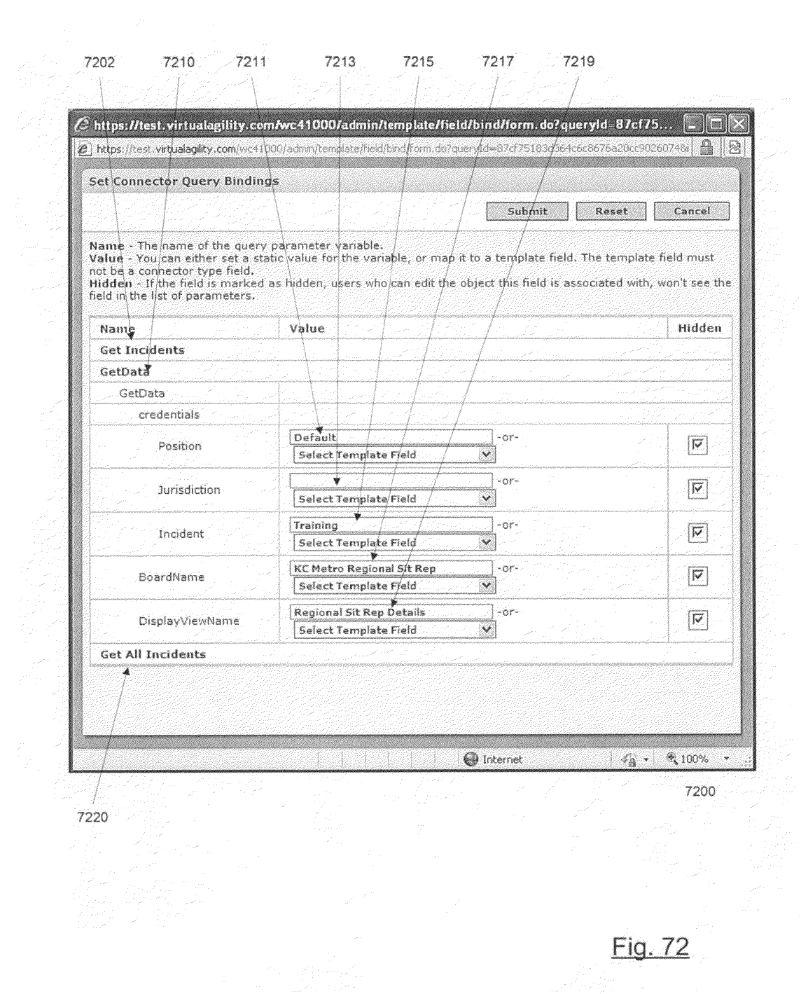

FIG. 72 shows a screenshot of third part 7200 of the UI of FIG. 71. UI part 7200 is used to define query bindings for variables of the composer connector query associated with template field 7008 at the template level. The reference numeral 7202 identifies the name of the connector query “Get Incidents”. The reference numbers 7210 and 7220 identify the names of the two composed connector queries “GetData” and “Get All Incidents”, respectively, that are composed by the query composer connector's query.

Template fields 7211, 7213, 7215, 7217, and 7219 show definitions of binding values at the template level for variables of the connector query for a parameterized information request of the WebEOC information source. The “Position” field 7211 shows that the parameter “Position” should be bound to the value “Default”. The “Jurisdiction” field 7213 shows that no binding is specified at the template level for the parameter “Jurisdiction”. The “Incident” field 7215 shows that the parameter “Incident” should be bound to the value “Training”. The “BoardName” field 7217 shows that the parameter “BoardName” should be bound to the value “KC Metro Regional Sit Rep”. Finally, the “DisplayViewName” field 7219 shows that the parameter “DisplayViewName” should be bound to the value “Regional Sit Rep Details”. In this example, there are no variables in the connector query 7220 “Get All Incidents”, and thus no bindings are to be defined in the UI of FIG. 72 at the template level for the connector query 7220.

The query composer connector query and the pre-existing connector queries:

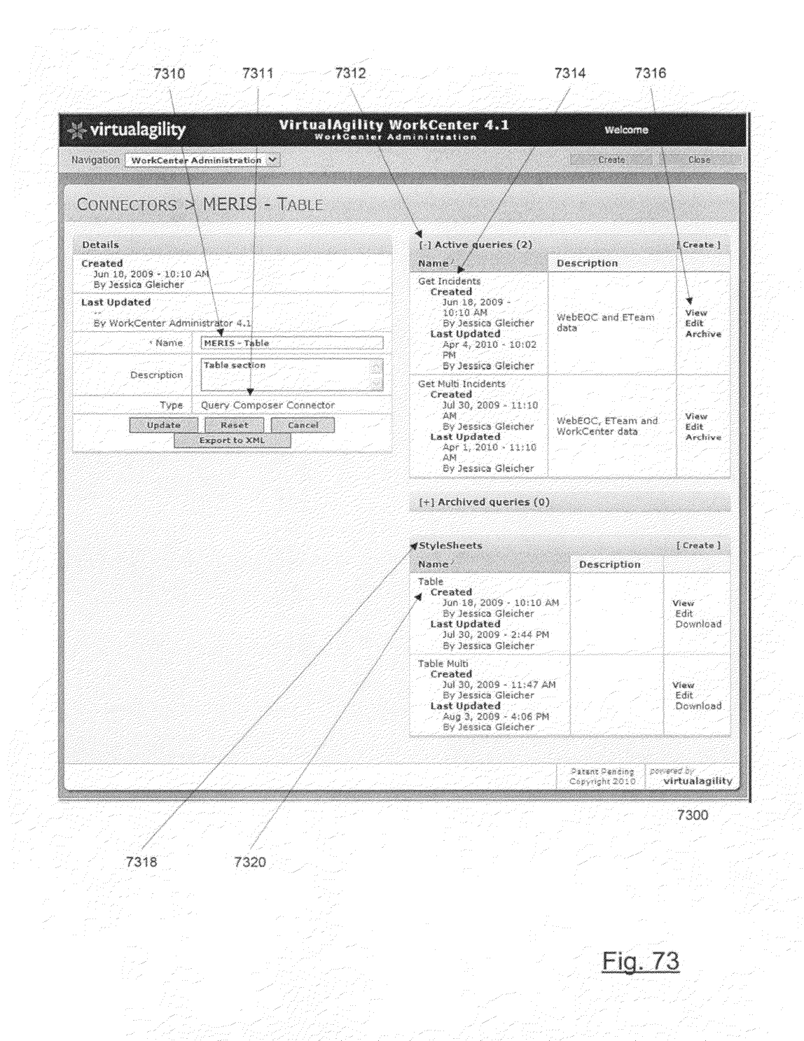

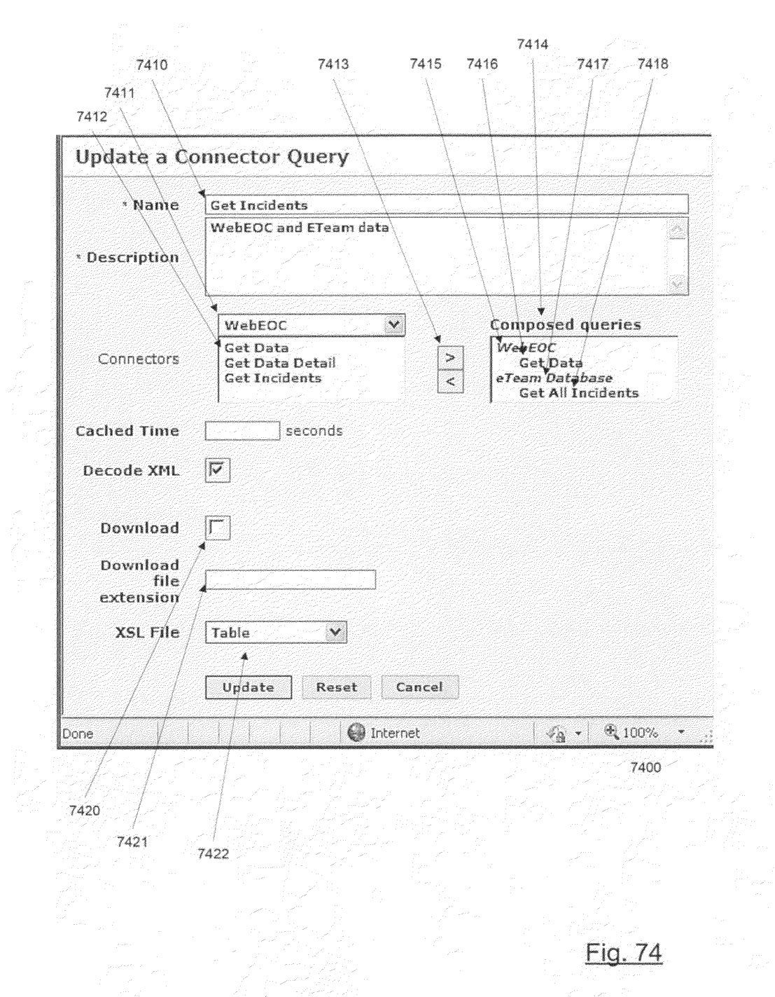

FIG. 73 shows a screenshot of the UI of the connector 7300 according to a an embodiment of the present invention for the definition of the query composer connector with the “Get Incidents” query used in the example of FIG. 71. As shown, the name 7310 of the connector is “MERIS—Table”. The connector is a query composer connector, as shown at the “Type” field 7311.

The UI section 7312 shows the active connector queries of the connector 7300. As shown, two active (not archived) connector queries are defined for the connector 7300, including the query 7314 used in this example titled “Get Incidents”. The portion 7316 of the UI shows three clickable links “View”, “Edit”, and “Archive” respectively to View results returned by, to Edit the definition of, or to Archive the definition of the connector query 7314.

The StyleSheets section 7318 of the UI the connector 7300 shows XSL Style Sheets that have been defined for the connector 7300, including the XSL style sheet 7320 named “Table”.

FIG. 74 shows a screenshot of the first part 7400 of a UI according to one embodiment of the invention for the definition of the “Get Incidents” connector query 7314 of FIG. 73.

The name field 7410 shows the name of the query, “Get Incidents”. The drop down list 7411 allows the user to select a connector of the system by the names of the connectors. When a connector such as “WebEOC” 7411 has been selected, the query list 7412 shows a single-selection list of the connector queries of the selected connector. Visible at the Connectors field 7412 are three connector queries “Get Data”, “Get Data Detail” and “Get Incidents”. A connector query of the Connectors field 7412 is selected by the user clicking on the name of the desired query shown in the Connectors field 7412.

The Composed Queries section 7414 of the UI shows queries that have been defined to be composed by the composer connector query 7410 of the UI. Pre-existing connector queries are shown by the name of the connector query's connector and the name of the query of the connector. In FIG. 74, the Composed queries field 7414 shows the two composed connector queries composed for the query composer connector 7410: the connector “WebEOC” 7415 and its connector query “Get Data” 7416, and connector “eTeam Database” 7417 and its connector query “Get All Incidents” 7418. A query of Composed queries field 7414 is selected by the user clicking on the name of the desired query shown in the Composed queries field 7414.

The edit element 7413 allows a user to add a connector query selected in the Connectors field 7411 to the queries of the Composed queries field 7414 and to the set of composed connector queries by clicking on the “>” icon of the edit element 7413. The edit element 7413 also allows a user to remove a connector query selected in the Composed queries field 7414 from the queries and from the set of composed connector queries by clicking on the “<” icon of the edit element 7413.

The “Download” checkbox 7420 of the UI is for a “Download” property of the query of the UI. In one embodiment, if this property is selected as part of the definition of the query, a template field that is defined to use the query will be displayed in a resource's UI as a “Download” link. If the user clicks on the “Download” link in the resource, the system showing the resource will perform a “download” operation of the UI (such as a standard web browser download to download to a local file on the user's computer), rather than information from the connector query being displayed by the UI. In one embodiment, an XSL style sheet may be defined for the connector query to transform the information to any desired format, such as a special file format or a standard format such as CSV, or to a form such as a multimedia output.

The “Download file extension” field 7421 shows a UI text input field. If the connector query has the “Download” property of 7420, a text defined here will be the default file extension text, such as “.csv”, of the downloaded file.

The “XSL File” field 7422 shows a drop-down selection list for selecting an XSL script file that has been uploaded to the system for use by the query composer connector. Shown at the “XSL File” field 7422 is the XSL script file name “Table”, the XSL script file of the composed query of the present example.

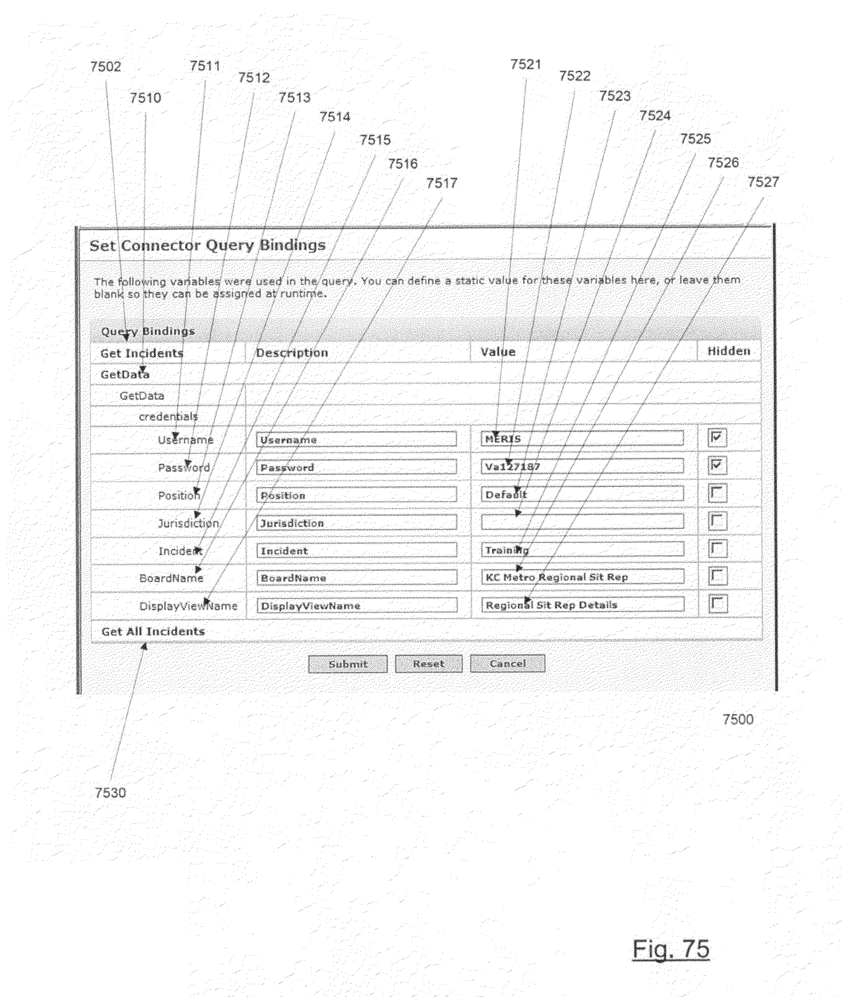

FIG. 75 shows a screenshot of a further part 7500 of the UI of FIG. 74 for the definition of query bindings for variables of the composer connector query at the connector level. The name of the connector query “Get Incidents” is identified by reference number 7502. The “GetData” 7510 and “Get All Incidents” 7530 connector queries are connector queries that are composed by the composer connector query.

The fields 7511, 7512, 7513, 7514 7515, 7516 and 7517 show parameter variables of the “GetData” query 7510 for which binding values may be defined at the connector query level for the connector query for a parameterized information request of the WebEOC information source. The parameters are named respectively “Username”, “Password”, “Position”, “Jurisdiction”, “Incident”, “BoardName”, and “DisplayViewName”.

The fields 7521, 7522, 7523, 7524 7525, 7526 and 7527 show the corresponding definitions of binding values for the variables. The values are respectively “MERIS” at the field 7521, “Va127197” at the field 7522, “Default” at the field 7523, no value at the field 7524, “Training” at the field 7525, “KC Metro Regional Sit Rep” at the field 7526, and “Regional Sit Rep Details” at the field 7527.

In this example embodiment, there are no variables in the connector query “Get All Incidents” 7530, and thus no bindings are shown in the UI of FIG. 75 for the composed connector query “Get All Incidents”7530.

### Composed Connector Queries:

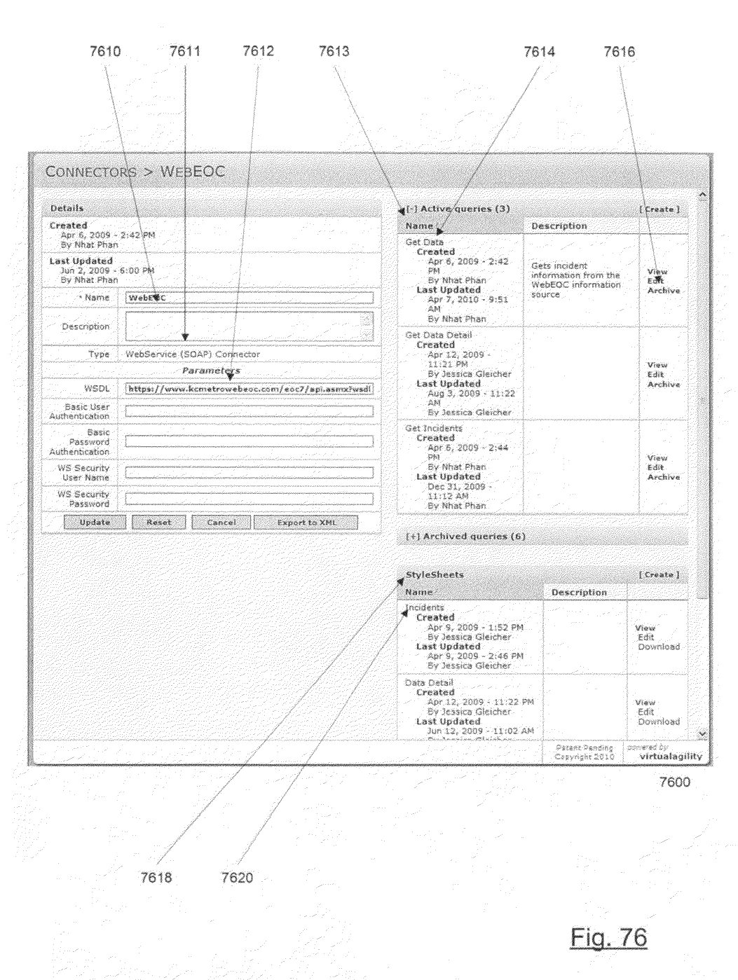

We now turn to the “GetData” connector query of the “WebEOC” connector. FIG. 76 shows the UI screenshot 7600 of the system for the definition of the connector “WebEOC” with the “GetData” query used in the example for obtaining information from the WebEOC information source. The name field 7610 of the connector is shown as “WebEOC”. The connector is a WebService (SOAP) connector type of connector, as shown at the Type field 7611. The URL for the WSDL file that defines the interface for the information source of this connector is shown in the “WSDL” field 7612. SOAP and WSDL files are known in the art, and thus need not be explained here.

The Active queries section 7613 shows the active connector queries of the connector shown in the UI 7600. Three active (not archived) connector queries are defined for the connector, including the query used in this example, “GetData” shown at query field 7614. The actions box 7616 shows a portion of the UI with three clickable links “View”, “Edit”, and “Archive” respectively to View results returned by, to Edit the definition of, or to Archive the definition of the connector query of the query field 7614.

The StyleSheets section 7618 shows names of XSL Style Sheets that have been defined for the connector, including XSL style sheet name “Incidents” 7620.

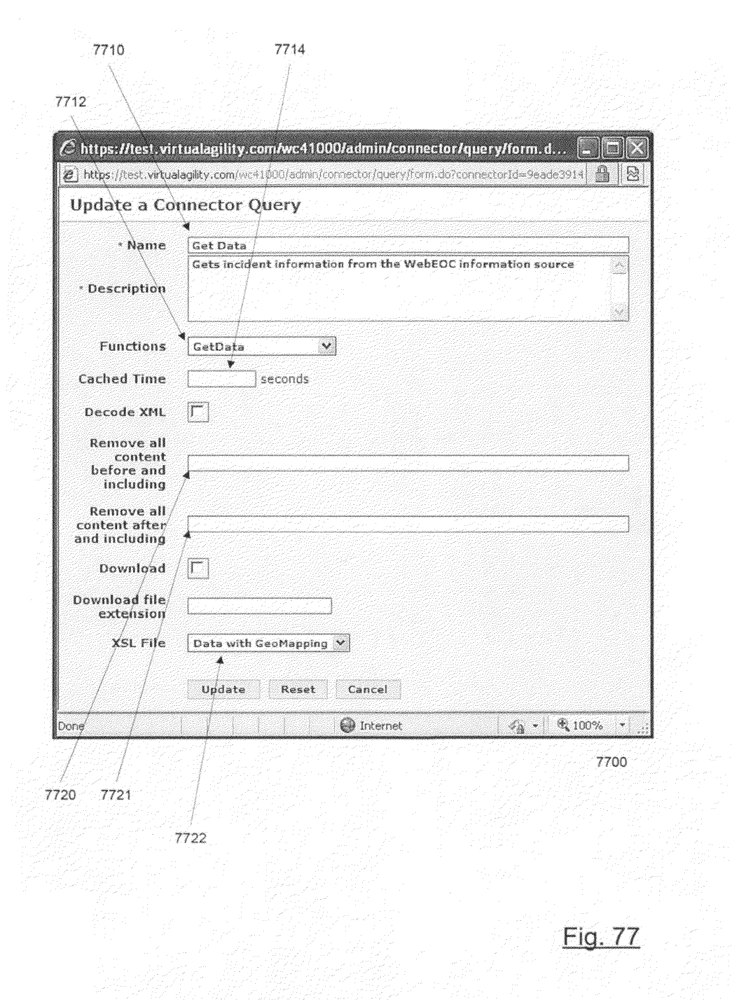

FIG. 77 shows a first part 7700 of a screenshot of the UI of the system for the definition of “GetData” connector query 7614 of FIG. 76. The name of the query is shown at the “Name” field 7710 as “GetData”. A drop down list for the “Functions” field 7712 allows the user to select a function defined in the WSDL file of field 7612 of FIG. 76. As shown at the “Functions” field 7712, the “GetData” function has been selected. The “Cached Time” field 7714 permits the user to enter an optional caching time in seconds. If a value is entered for this property of the query, the system stores results obtained from a parameterized information request for this query for this period of time after obtaining the results for possible re-use. In one embodiment, if the same query with the same binding values is to be performed again during this period of time, the system does not perform the parameterized information request again, and instead returns a stored result.

The “Remove all content before and including” field 7720 and the “Remove all content after and including” field 7721 are two optional data entry fields. In one embodiment, if a value is specified for the field 7720, the system removes all content of the data obtained from the parameterized information request of the query up to and including the text of the value, before further processing of the result. Similarly, if a value is specified for the field 7721, the system removes all content of the data obtained from the parameterized information request of the query including the text of the value and all subsequent data in the result, before further processing of the result.

The “XSL File” field 7722 shows a drop-down selection list for selecting an XSL script file that has been uploaded to the system for use by the query composer connector. Shown at the field 7722 in the example is the XSL script file “Data with GeoMapping”, which is the XSL script file of the query of the example shown in FIG. 77.

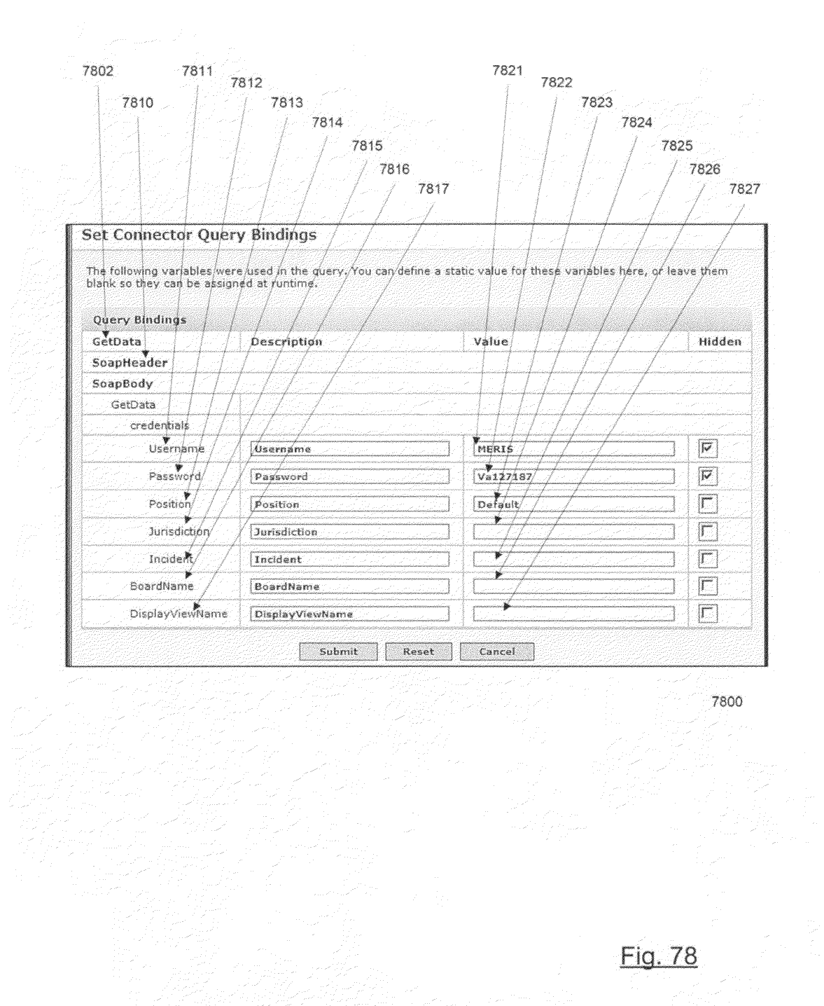

FIG. 78 shows a screenshot of a further part 7800 of a UI of the system for the definition of query bindings for variables of the connector query of 7510 at the connector level. The name 7802 of the connector query is “GetData”. The connector is a SOAP-connector type of connector. The “SoapHeader” portion 7810 of the UI shows bindings for parameters defined by the WSDL file of field 7612, if there are any.

The fields 7811, 7812, 7813, 7814 7815, 7816 and 7817 show parameter variables of the “GetData” query 7802 for which binding values may be defined at the connector level for query “GetData” 7802. As shown, the parameters are named respectively “Username”, “Password”, “Position”, “Jurisdiction”, “Incident”, “BoardName”, and “DisplayViewName”.

The value fields 7821, 7822, 7823, 7824 7825, 7826 and 7827 show the corresponding definitions of bindings for values for the variables at the level of the connector of the “GetData” query 7802. The Username value 7821 is “MERIS”. The Password value 7822 is “Va127197”. The Position value 7823 is “Default”. The fields 7824, 7825, 7826, and 7827 have no values defined. In one embodiment, the Username field 7821 and the Password field 7822 are authentication parameters required for access to the information source of the connector query 7802.

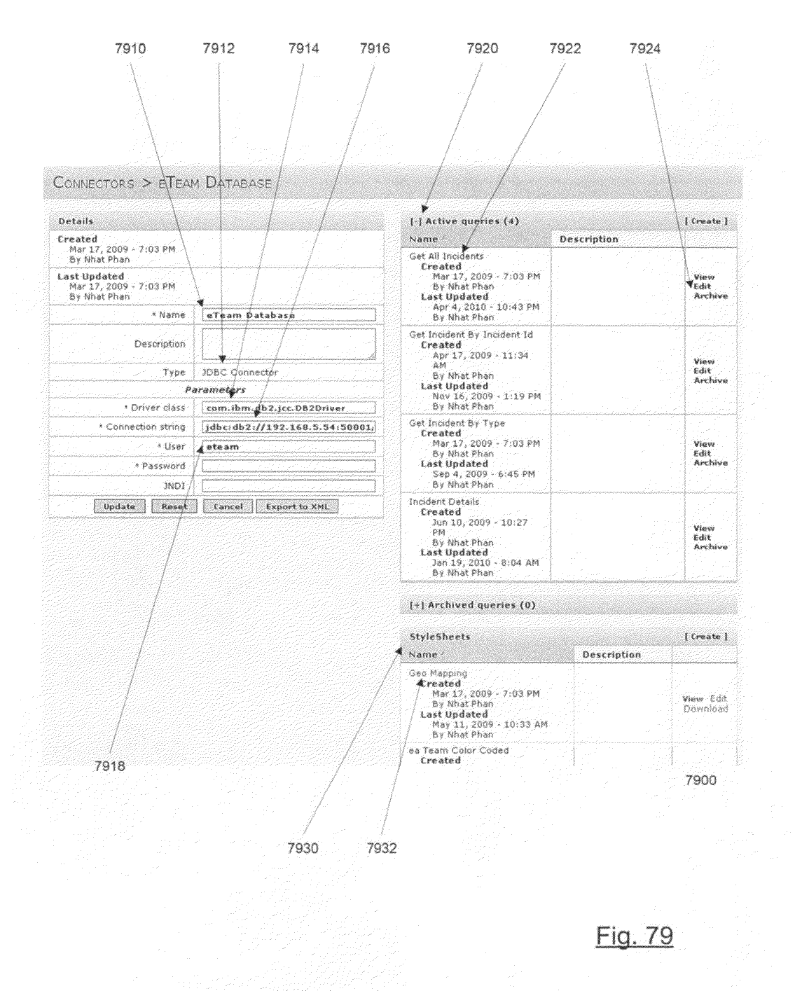

The discussion will now turn to the definition of the “Get All Incidents” connector query of the “eTeam Database” connector. FIG. 79 shows the UI 7900 of the system for the definition of the connector “eTeam Database” with the “Get All Incidents” query used in the example for obtaining information from the ETEAM information source. The Name 7910 of the connector is shown as “eTeam Database”. The connector is a JDBC Connector type of connector, as shown at Type field 7912. Several connector parameter values are shown for the connector in the UI 7900, including the JDB driver class 7914, the connection string 7916 for a JDBC-connection, and authentication parameter “eteam” at User field 7918.

The Active Queries section 7920 shows the active connector queries of the connector of the UI 7900. As shown, four active (not archived) connector queries are defined, including the query used in this example, “Get All Incidents” 7922. The UI portion 7924 shows three clickable UI links to View results returned by, to Edit the definition of, or to Archive the definition of the connector query 7922. The section 7930 of the UI 7900 shows names of XSL Style Sheets that have been defined for the connector, including the XSL style sheet name 7932 “Geo Mapping”.

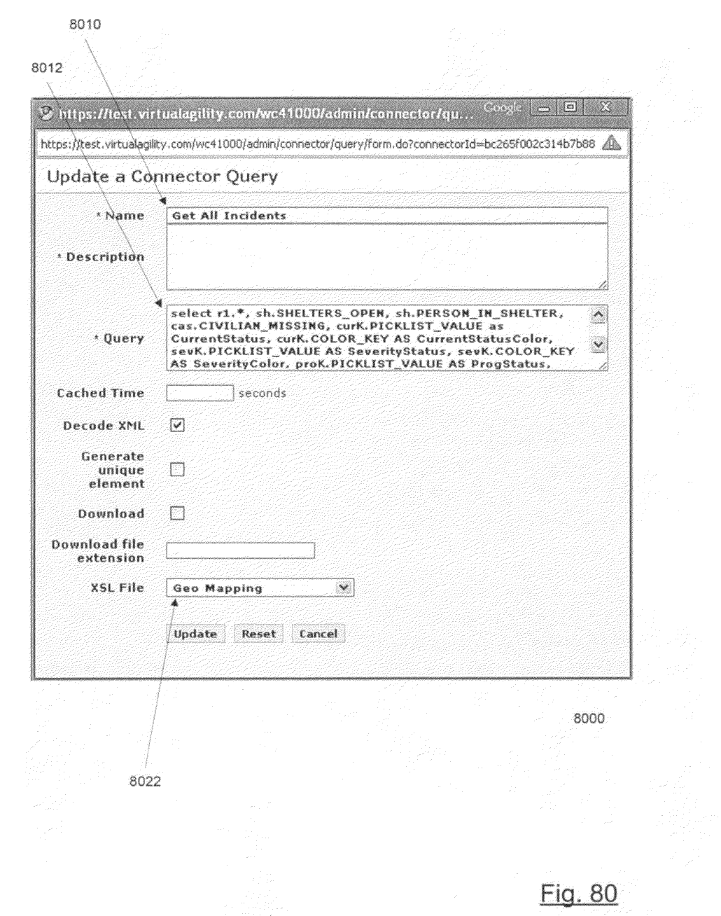

FIG. 80 shows the first part 8000 of a UI of the system for the definition of “Get All Incidents” connector query 7922 of FIG. 79. The Name field 8010 of the query is shown as “Get All Incidents”. The scrollable text data field 8012 shows the database query in the SQL language that has been defined for the parameterized information request of this connector query. The first part of the SQL database query is visible. The XSL File field 8022 shows a drop-down selection list for selecting an XSL script file that has been uploaded to the system for use by the query composer connector. In the example shown, the XSL File field 8022 identifies the XSL script file “Geo Mapping”, which is the XSL script file of the example query of the UI 8000.

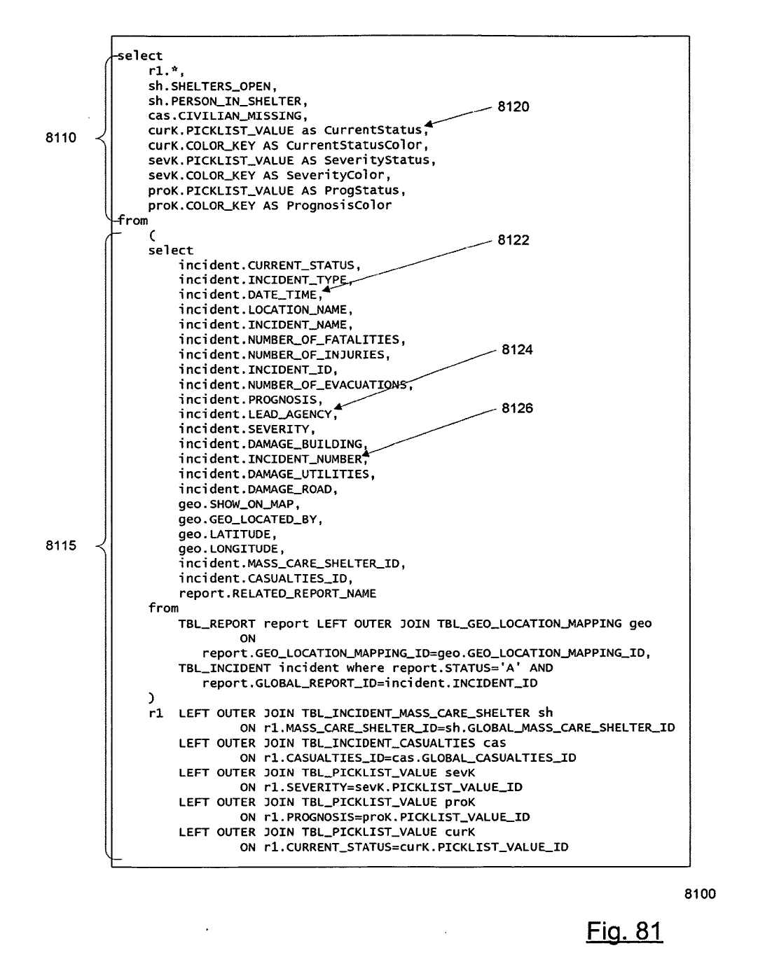

FIG. 81 shows an exemplary embodiment of an SQL query 8100 of the Get All Incidents query 8010 of FIG. 80. The complete text of the SQL query is not visible in FIG. 80 in the Query field 8012. As can be seen, the SQL query 8100 contains no variables for which bindings need to be defined. The SQL programming language is known in the art, and need not be explained in detail. Exemplary SQL query 8100 starts with the SELECT clause 8110 and ends with FROM clause 8115. The SQL query 8100 returns a result set consisting of rows of data containing a number of fields, for example the fields “CurrentStatus” 8120, “DATE_TIME” 8122, “LEAD_AGENCY” 8124, and “INCIDENT_NUMBER” 8126.

### Implementation of Query Composer Connectors in an Embodiment's Relational Database:

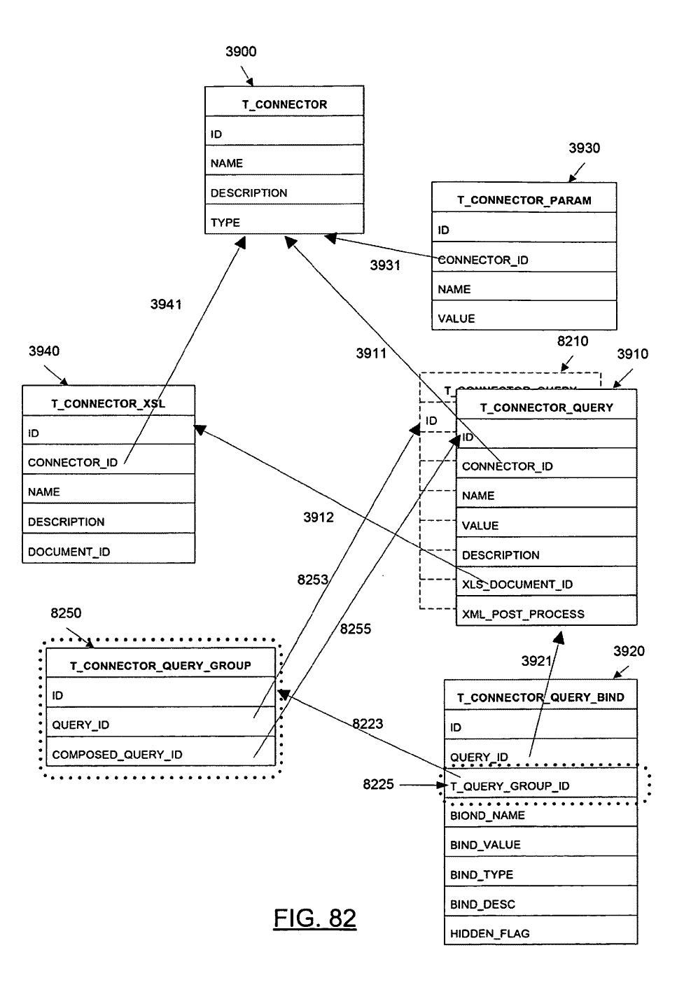

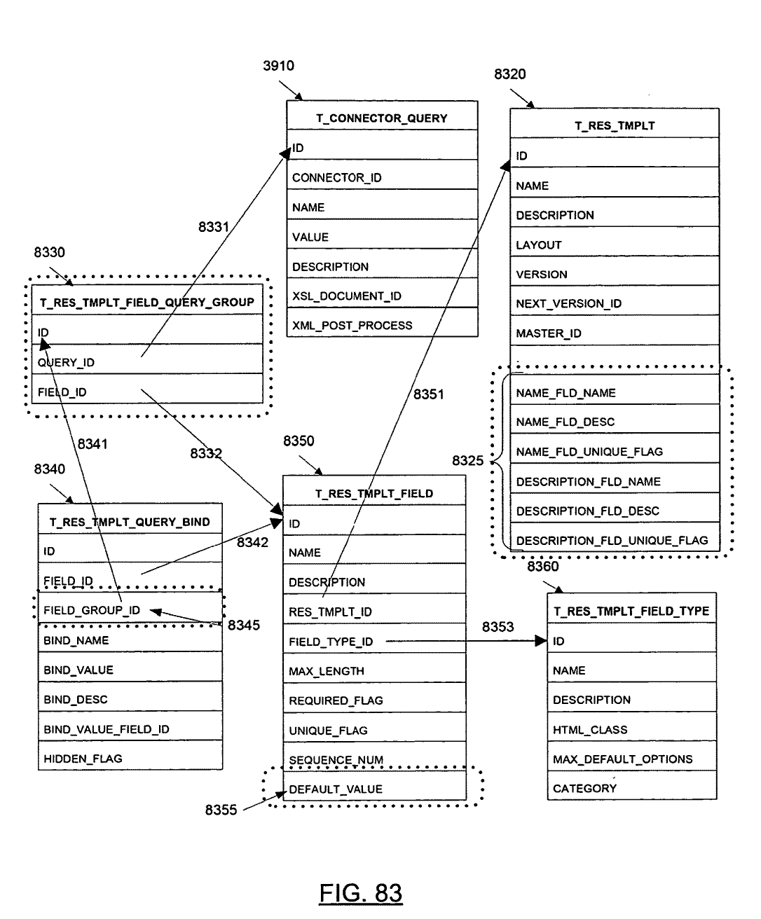

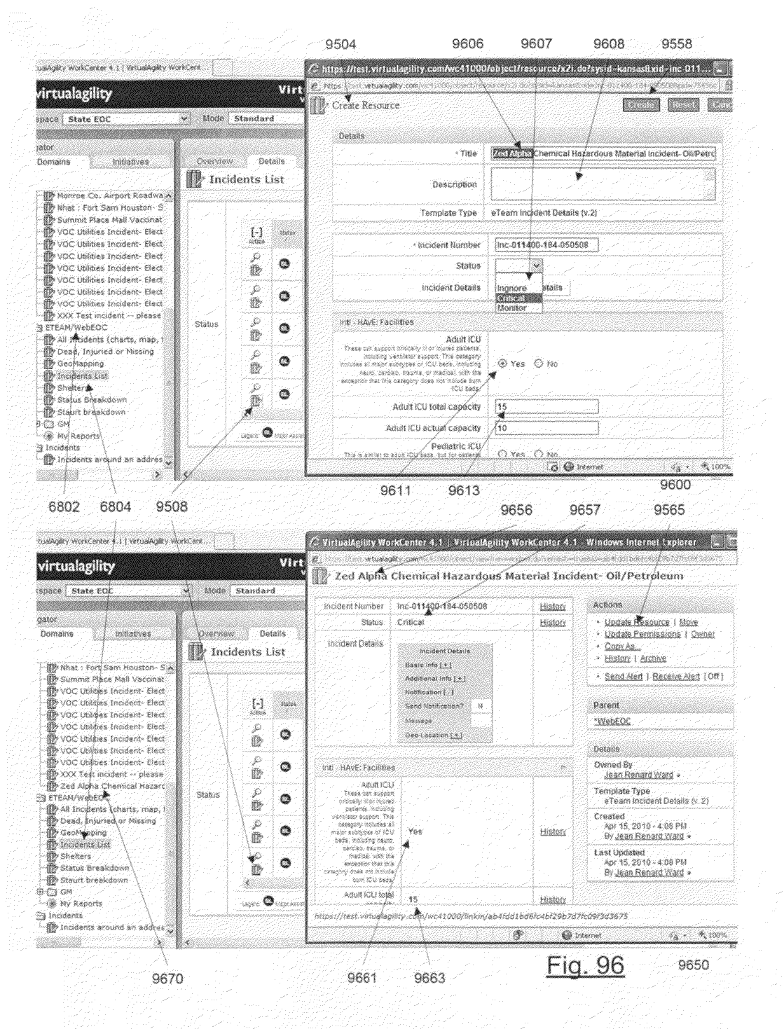

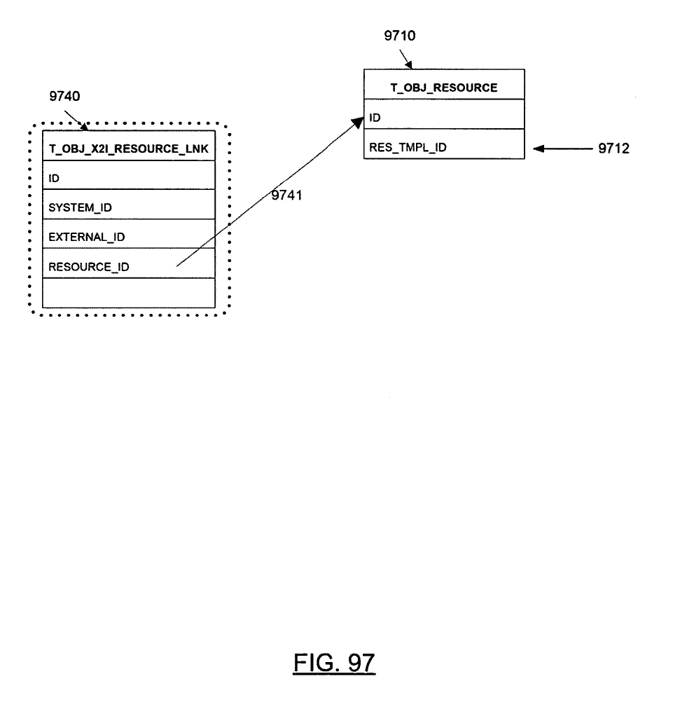

FIG. 82, FIG. 97, and FIG. 83 provide details of additions made to tables of the system of the Connector application in implementing one embodiment of the system of the present invention. FIG. 82, FIG. 97, and FIG. 83 are simplified E-R diagrams similar to that of FIG. 39. E-R diagrams are explained for FIGS. 3A through 4K of the Collaboration application.

The tables of FIG. 82, FIG. 97, and FIG. SXQN are described in detail below. Fields that relate to database maintenance and other general details, as well as details from the descriptions for figures of the systems of the Collaboration and Connector applications, are omitted for clarity, as they all will be readily understood. Dotted outlines around tables or fields indicate that these have been added in an embodiment of the system of the present application, and were not present in earlier embodiments of systems of the Collaboration or Connector applications.

Connectors were implemented in the system of the Connector application as shown in FIG. 82, other than the table T_CONNECTOR_QUERY_GROUP 8250 and its fields ID, QUERY_ID, and COMPOSED_QUERY_ID as shown, and the field T_QUERY_GROUP_ID 8225 of the table T_CONNECTOR_QUERY_BIND 3921. Elements of FIG. 82 not described in detail here will be readily understood from the description of FIG. 39 for the system of the Connector application.

As is described in detail for the system of the Connector application, each record of the T_CONNECTOR table 3900 represents a connector. The TYPE field of the T_CONNECTOR table 3900 specifies the type of the connector. In some embodiments of the system, this may indicate any of the new connector types of the present system, such as a WorkCenter resource connector or a query composer connector. Related to each record of the T_CONNECTOR table 3900 are the following records in other tables:
The T_CONNECTOR_QUERY table 3910: each record of this table describes a query made by the connector identified by the CONNECTOR_ID field of the record.
The T_CONNECTOR_QUERY_BIND table 3920: each record of this table is related to a record of T_CONNECTOR_QUERY table 3910 by the value of field QUERY_ID, and contains information defining a run-time parameter value for the query in the T_CONNECTOR_QUERY record that the T_CONNECTOR_QUERY_BIND record is related to.
The T_CONNECTOR_PARAM table 3930: each record of this table contains information needed to connect to the external data source of the connector identified by the CONNECTOR-ID field of the record.
The T_CONNECTOR_XSL table 3940: each record of this table is related to a record of T_CONNECTOR table 3900, and identifies an XSL style sheet document for putting the information obtained by a query of the connector into a desired form.

The new table T_CONNECTOR_QUERY_GROUP 8250 is used in an embodiment of the present system in the implementation of connectors that are composed query connectors. Each record of the table T_CONNECTOR_QUERY_GROUP 8250 includes the three fields shown: ID, QUERY_ID, and COMPOSED_QUERY_ID, in addition to general fields used for database management (not shown in FIG. 82). The ID field contains a unique identifier value for the record. The QUERY_ID field and the COMPOSED_QUERY_ID fields identify records in T_CONNECTORY_QUERY table, according to the following description for one embodiment.

A query composer connector combines queries from already-existing connectors into a single query. In the following, each query of the queries combined by the query composer connector in a single query may be referred to as a pre-existing query, and the single resulting query may be referred to as the composed query or as the composing query. Note however that in other embodiments, queries that are combined need not already exist. In other embodiments queries that are combined need not be associated with connectors.

The pre-existing queries of a composed query may come from connectors of different types, and further may obtain information from different information sources, and the information they obtain may be structured differently. Like other connectors, a query composer connector has a record in the T_CONNECTOR table 3900. A composed query has a record in T_CONNECTOR_QUERY table 3910 that identifies the query composer connector to which it belongs. The queries that make up the pre-existing queries of the composed query are specified by records in the T_CONNECTOR_QUERY_GROUP table 8250. There is a record in this table for each pre-existing query in the composed query. The QUERY_ID field of the T_CONNECTOR_QUERY_GROUP record for a given pre-existing query identifies the given pre-existing query's record in the T_CONNECTOR_QUERY table 3910, as shown by the relational arrow 8253 and dotted-line record 8210 of the T_CONNECTOR_QUERY table 8210. The COMPOSED_QUERY_ID field of the pre-existing query's record in the T_CONNECTOR_QUERY_GROUP table 8250 identifies the composed query's record in the T_CONNECTOR_QUERY table 3910, as shown by the relational arrow 8255.

The record of the T_CONNECTOR table 3900 for a query composer connector also has a related T_CONNECTOR_XSL record that specifies a style sheet for the composed query.

In some embodiments, a query composer connector does not have a related record in T_CONNECTOR_PARAM table 3900. In an embodiment of the present system, the information necessary to connect to the information sources for the pre-existing queries making up the composed query of a query composer connector is obtained from the records of the T_CONNECTOR_PARAM table 3900 for the pre-existing connectors specified in the record of the T_CONNECTOR_QUERY table 3910 for the pre-existing queries making up the composed query. In some embodiments, queries that are not part of query groups also have records in T_CONNECTOR_QUERY_GROUP table 8250. In the records for these queries, the values of the QUERY JD and COMPOSED_QUERY_ID fields both specify the query's record in T_CONNECTOR_QUERY table 3910.

As set forth in the description of the embodiment of the system of the Connector application, run-time parameter values may be bound to a connector's query at the level of the query's connector, at the level of a resource template used by a resource, and at the level of the resource. At the connector level, records in the T_CONNECTOR_QUERY_BIND table 3920 specify the bindings for a query.

In one embodiment of the present invention, to provide bindings for composed queries at the connector level, a field T_QUERY_GROUP_ID 8225 has been added to the records in the T_CONNECTOR_QUERY_BIND table 3920. A pre-existing query that is used in a composed query of a particular query composer connector may have records in T_CONNECTOR_QUERY_BIND table 3920 for any run-time parameter values to be used with that pre-existing query in the composed query for the query composer connector. Each record includes the pre-existing query's identifier as the value for the field QUERY_ID as indicated by relational arrow 3921, and the field T_QUERY_GROUP_ID 8225 contains the identifier of the record in T_CONNECTOR_QUERY_GROUP table 8250 for the composed query as indicated by relational arrow 8223.

We turn now to FIG. 83, which shows a number of tables used in the implementation of an embodiment of resource templates and fields. Elements not added to an embodiment of the Connector application are outlined with dotted lines. Details readily understood are omitted for clarity and brevity.

FIG. 83 shows the table T_CONNECTOR_QUERY 3910, with fields ID, CONNECTOR_ID, NAME, VALUE, DESCRIPTION, XSL_DOCUMENT_ID, and XML_POSTPROCESS.

Also shown is the table T_RES_TMPL 8320 with the fields ID, NAME, DESCRIPTION, LAYOUT, VERSION, NEXT_VERSION_ID, and the new fields 8325 NAME_FLD_NAME, NAME_FLD_DESC_NAME_FLD_UNIQUE_FLAG, DESCRIPTION_FLD_NAME, DESCRIPTION_FLD_NAME, and DESCRIPTION_FLD_UNIQUE_FLAG. The new fields 8325 are employed to support certain UI features in an embodiment, such as to permit a user defining a template to change what is displayed in a UI for the label of the Name or Description fields.

Also shown is the table T_RES_TMPLT_FIELD_TYPE 8360 with the fields ID, NAME, DESCRIPTION, HTML_CLASS, MAX_DEFAULT_OPTIONS, and CATEGORY. Records of this table define a type for a resource template field, as indicated by the relational arrow 8353.

FIG. 83 also shows the table T_RES_TMPLT_FIELD 8350, with the fields ID, NAME, DESCRIPTION_RES_TMPLT_ID, FIELD_TYPE_ID, MAX_LENGTH, REQUIRED_FLAG, UNIQUE_FLAG, SEQUENCE NUM. Records of this table define a field of the resource template indicated by the value of field RES_TMPLT_ID, which identifies a record of T_RES_TMPLT table 8320 as indicated by the relational arrow 8351. Also shown is the field DEFAULT_VALUE 8355, which defines an optional initial default value for the template field in a resource when the resource template identified by the value of RES_TMPLT_ID is used in a resource.

Further, FIG. 83 shows the table T_RES_TMPLT_QUERY_BIND 8340, with fields ID, FIELD_ID, BIND_NAME, BIND_VALUD, BIND_DESC, BIND_VALUE_FIELD_ID, and HIDDEN_FLAG. Records of this table define a run-time parameter value binding at the level of a resource template. A record of the T_RES_TMPLT_QUERY_BIND table 8340 is related to the template field of a resource template by the value of the FIELD_ID field, which contains the identifier of the template field's record in T_RES_TMPL_FIELD table 8350. This is indicated the relational arrow 8342.

Turning for the moment back to FIG. 82, the pre-existing query that is used in a particular query of a query composer connector may have records in the T_CONNECTOR_QUERY_BIND table 3920 for any run-time parameter values to be used with that query in the composed query for the query composer connector. Each such record of the table T_CONNECTOR_QUERY_BIND 3920 will include the value of the pre-existing query's identifier in the field QUERY_ID, as indicated by the relational arrow 3921, and the query composer connector's identifier in the field QUERY_GROUP_ID, as indicated by the relational arrow 8223.

Referring again to FIG. 83, the new field FIELD_GROUP_ID 8345 has been added to records of the table T_RES_TMPLT_QUERY_BIND 8340 as shown, and also the new table T_RES_TMPLT_FIELD_QUERY_GROUP 8330 has been added with fields ID, QUERY_ID, and FIELD_ID as shown.

In an embodiment of the present system, a group of queries may be related to a template field of connector type in a resource template. This relationship is represented by records in the T_RES_TMPLT_FIELD_QUERY_GROUP table 8330. There is a record in this table for each pre-existing query that belongs to a group of pre-existing queries that correspond to a connector field in a resource template record of table T_RES_TMPLT. The value of the QUERY_ID field of the table

T_RES_TMPLT_FIELD_QUERY_GROUP 8330 contains the value of the pre-existing query's record in the T_CONNECTOR_QUERY table 3910, as indicated by the relational arrow 8331. The template field is indicated by the value of the field FIELD_ID in the table T_RES_TMPL_FIELD_QUERY_GROUP 8330, as indicated by the relational arrow 8332 pointing into the table T_RES_TMPL_FIELD 8350. Bindings at the template level are specified in the T_RES_TMPL_QUERY_BIND table 8340, which contains a record for each template-level binding. Where there is a binding for a pre-existing query belonging to a group, the record of the T_RES_TMPLT_QUERY_BIND table 8340 for the binding specifies in the field FIELD_ID the identifier for the record of the template field of the connector type to which the binding belongs, the BIND_NAME field specifies the name of the parameter to which the value is being bound, and the BIND_VALUE field specifies the parameter's value.

### Data Obtained by the Exemplary Query Composer Connector:

The query 7314 of composer connector 7310 obtains information by means of the pre-existing connector queries 7418 for the ETEAM information source, and query 7416 for the WebEOC information source. The results obtained by query 7314 of query composer connector 7310 are comprised of the results obtained by each of the pre-existing connector queries, encapsulated in an XML format.

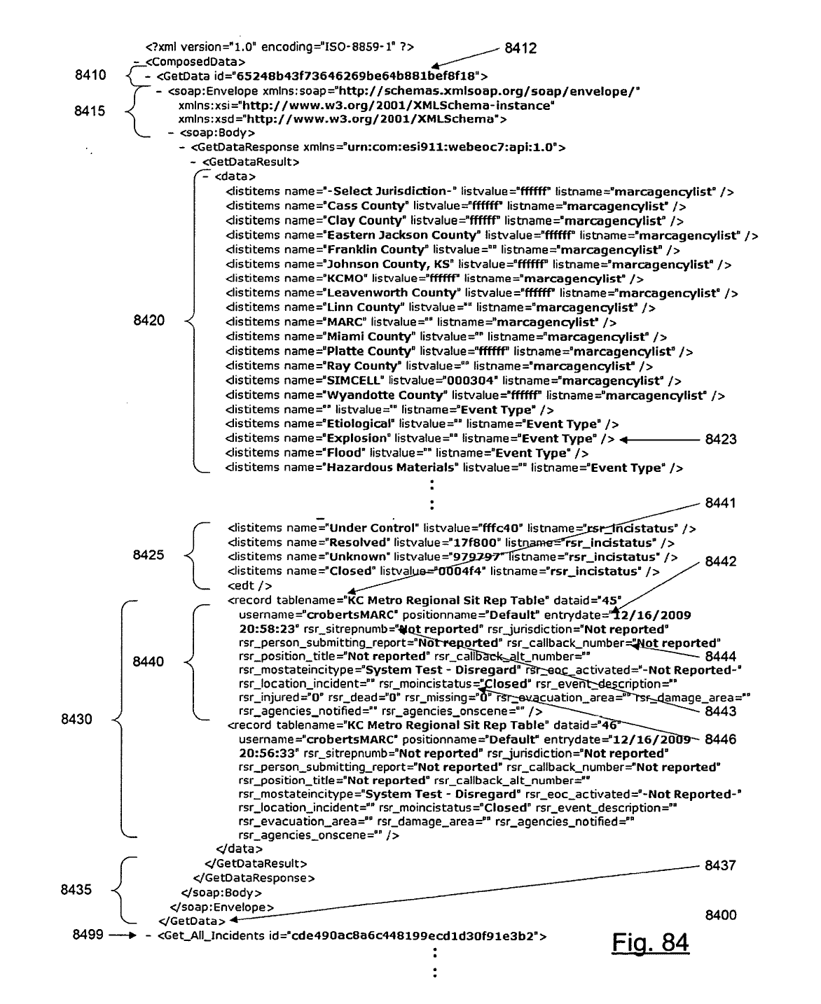

FIG. 84 shows an exemplary portion 8400 of information result information encapsulated in an XML format obtained from an information source, the ETEAM information source by query composer connector 7310's query 7314. In UI portion 8410, the XML tag 8412 beginning “<GetData” shows the start of the result obtained by “GetData” query 7310 from the ETEAM information source. In the exemplary embodiment of FIG. 84, the information from the ETEAM source is obtained using a SOAP-type protocol interface. The portion 8415 shows a SOAP header portion of the result. The data obtained from the ETEAM source includes both meta-information and information. Two portions of a meta-information section of the information are shown at 8420 and 8425. The ellipses indicate a portion of the section that has been omitted from portion 8400 for clarity.

Continuing this example, the meta-information of portions 8420 and 8425 describes aspects of the information returned from the ETEAM source. The element 8423 is exemplary, and indicates that one of the possible values for the “EventType” field of the information is “Explosion”.

Following the meta-information section of 8420 and 8425 is the information section 8430, containing records of information, one record for each incident about which information is provided in the result set. Visible following the information section 8430 are XML tags 8435. The tag “</GetData>” 8437 indicates the end of the information from the ETEAM information source obtained by the “GetData” pre-existing connector query 7510.

The start of each record of the information section 8430 is indicated by a “<record tablename=” tag such as tag 8441. The first such record is the record 8440. Shown in this exemplary record are field name and value pairs for fields of the record, such as field name “entrydate” with value “Dec. 16, 2009 20:58:23” at field 8442, field name “rsr_sitrepnumb” and value “Not Reported” at field 8443, field name “rsr_callback_number” with value “Not reported” at field 8444, and field named “rsr_moincistatus” with value “Closed” at field 8446.

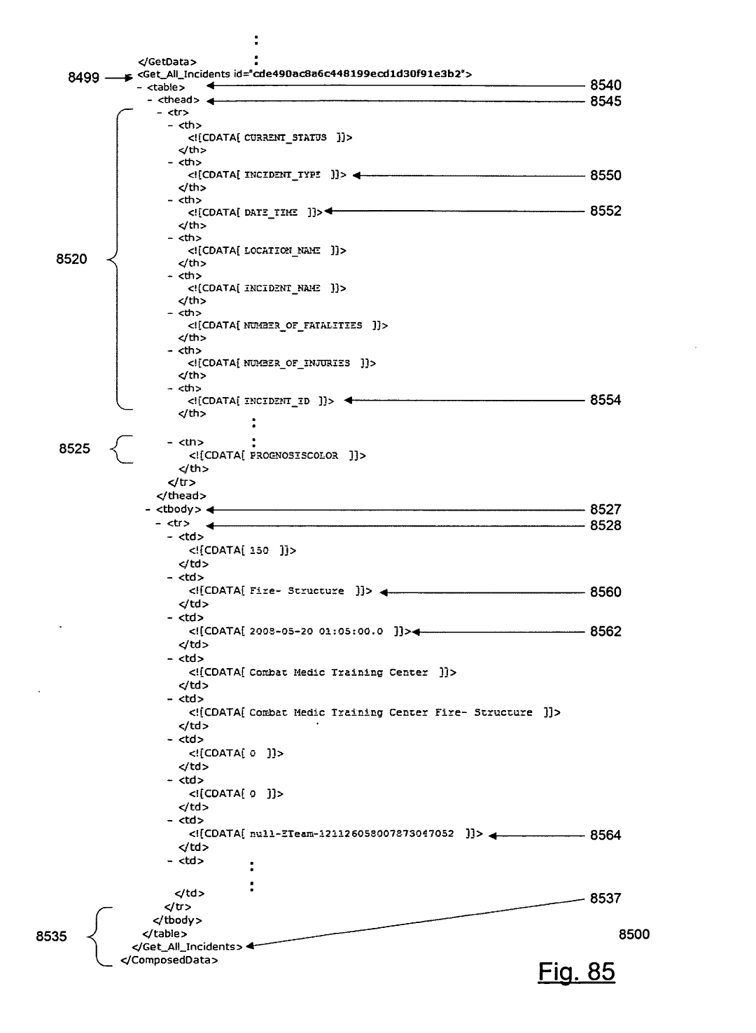

The tag beginning, “<Get_All_incidents id=” 8499 indicates the start of the result information obtained from the WebEOC information source by the pre-existing query 7416. This is described in further detail in the discussion of FIG. 85.

FIG. 85 shows a second exemplary portion 8500 of the result information obtained from the WebEOC information source by query composer connector 7310's query 7314. Portions of the result information that are omitted for clarity are indicated by ellipses.

The “<Get_All_Incidents” XML tag 8499 (also shown in FIG. 84) shows the start of the result obtained from the WebEOC information source by the “Get All Incidents” query 7416. The information obtained from the WebEOC source is obtained using a JDBC-type interface as a set of SQL records. The “Get All Incidents” connector query 7416 includes an XSL script that returns the result values encapsulated in an HTML table as indicated by the HTML tag 8540, with the names for the fields of the SQL records as the column names of HTML table 8540, and the values for the fields of the SQL records as values in rows of HTML table 8540.

The section 8520 shows a first portion of the column header names of HTML table 8540, which are the names of the fields in the information about each incident. The start of the header names is indicated by the HTML tag “<thead>8545. These include the second column name “INCIDENT_TYPE” 8550, the third column name “DATE_TIME” 8552, and the eighth column name “INCIDENT_ID” 8554. The final column header and the end of the column header information is shown at 8525.

As shown in FIG. 85, the start of the information about incidents is indicated by the HTML tag “<tbody>8527 [indicating the body of the HTML table 8540. The start of each row is indicated by a “<tr>” tag, such as the tag 8528 for the first HTML table row.

Each value for a field of information about an incident is given at the position in the HTML row corresponding to the HTML column header name for the column of information. This can be seen at line 8560 for the second value of the row of the tag 8528, with the value “Fire-Structure” 8560 for the field named “INCIDENT_TYPE” 8550, third value “2008-05-20 01:05:00.0” 8562 for the field named “DATE_TIME” 8552, and eighth value “null-ETEAM-121126058007873047052” 8564 for the field named “INCIDENT_ID” 8552.

The final section 8535 shows XML tags indicating the end of the result obtained by the query composer connector. The tag “</Get_All_Incidents>” 8537 indicates the end of section with information obtained from the WebEOC information source by the “Get All Incidents” query 7416.

Processing Combined Result with XSL Script:

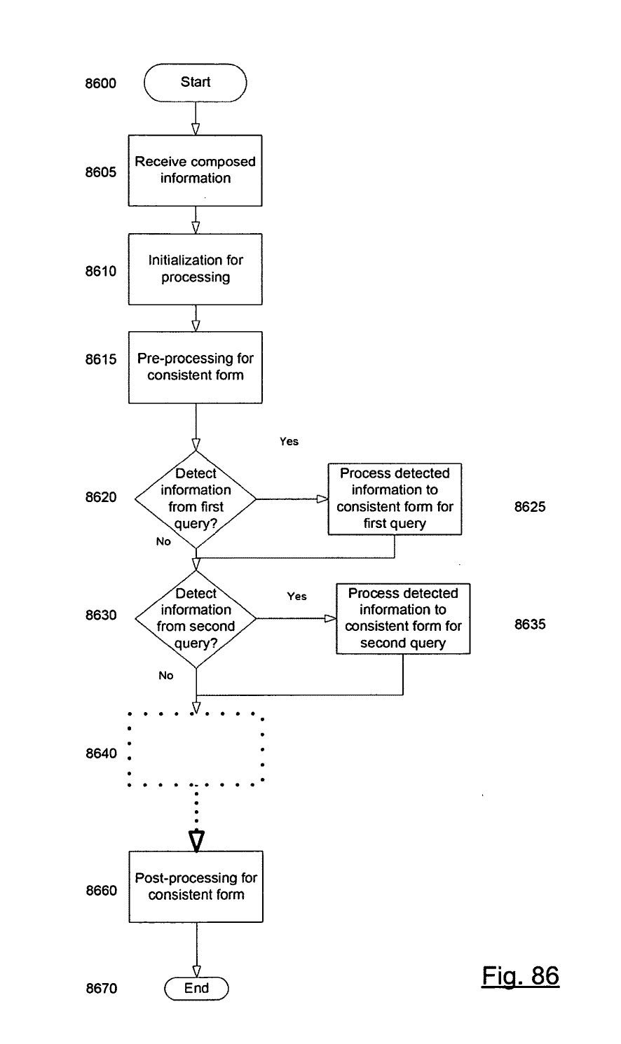

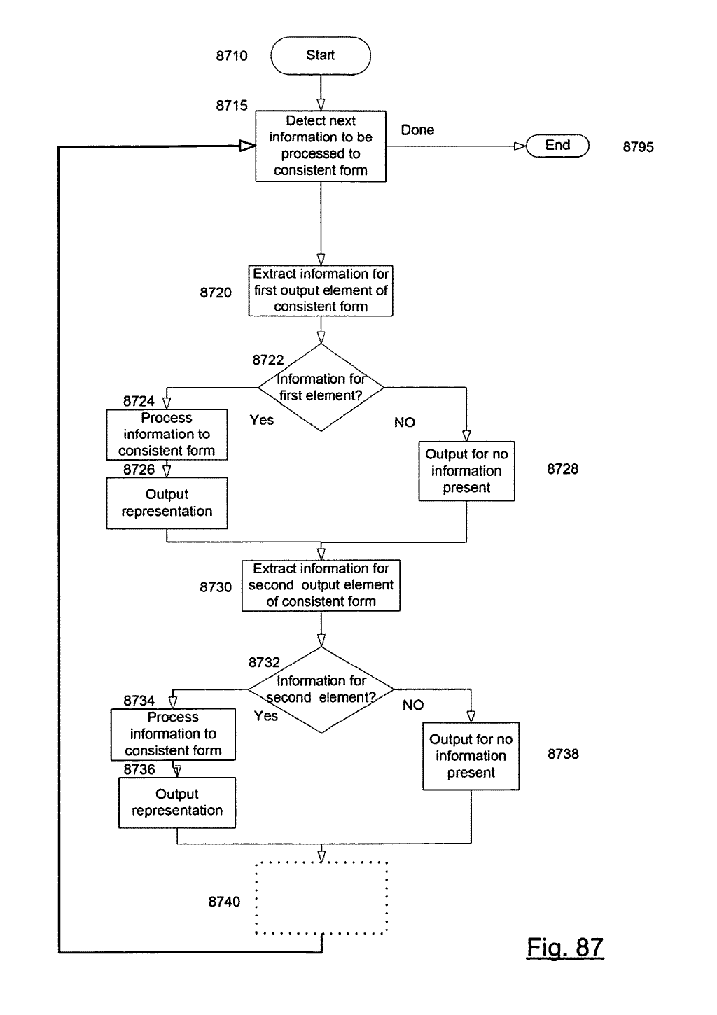

In one embodiment of the system of the present invention, a query composer connector query has a customized XSL script containing code such that, when executed, the system formats and renders the information from the information sources in a desired fashion. In the present example, the script processes the information of the combined information result so that information about incidents is in a consistent form and structure. FIGS. 86 and 87 show, in flowchart form how one customized embodiment script processes an information result like that of FIGS. 84 and 85 to a consistent form, like that of the HTML table 6822 in FIG. 68.

Once processing starts at step 8600, the embodiment receives the composed information with information from more than in information source at step 8605. In this example, the information from one information source is obtained by a first pre-existing query, and the information from a second source by a second pre-existing query. Next at step 8610, the script performs initialization as required, such as initializing internal variables. At following step 8615, the script performs pre-processing for the consistent form, such as outputting the starting tags of an HTML table.

Continuing to step 8620, the script detects the information obtained by the first query. If no such information is detected (the information result of that query could have returned an empty result), the script proceeds directly to step 8630. If such information is detected, the script performs step 8625 of processing the detected information to the consistent form for the information of the first query, as described in FIG. 87, before continuing to step 8630.

Similarly at step 8630, the script detects the information obtained by the second query. If no such information is detected, the script proceeds directly to step 8640. If such information is detected, the script performs step 8635 of processing the detected information to the consistent form for the information of the second query, as described in FIG. 87, before continuing to step 8640.

Step 8640 indicates that further similar processing may be performed for information of other pre-existing queries. After all such steps are complete, the script proceeds to step 8660 to perform post-processing for consistent form, such as output the ending tags of an HTML table.

FIG. 87 shows in flowchart form the processing of steps 8625 and 8635 above.

Processing starts at step 8710. Next, the script detects the next (or first) information to be processed to consistent form at step 8715, such as a value from a first result set row with multiple items of information or fields from the query's information result. If there is not one, processing is done, and the script ends at step 8795.

Otherwise, the script continues to step 8720 to extract information from the data for the first output element of the consistent form, and continues to step 8722, where the script determines whether there is any such information.

If there is not, the script continues to step 8728 to output a representation for there being no information for the current output element, and continues directly to step 8730. If there is, at step 8724 the script processes the extracted information to the desired consistent form for the current output element, proceeds to step 8726 to output the representation for the processed information, and continues to step 8730.

Steps 8730, 8732, 8734, 8736, and 8738 concern the second output element of the consistent form, and are readily understood, as they are similar to steps 8720, 8722, 8726, and 8728 for the first output element, and continue to step 8740.

8740 indicates that the script executes similar steps for the other elements of the desired output form, before continuing to 8715 for the to detect the next information to be processed to a consistent form.

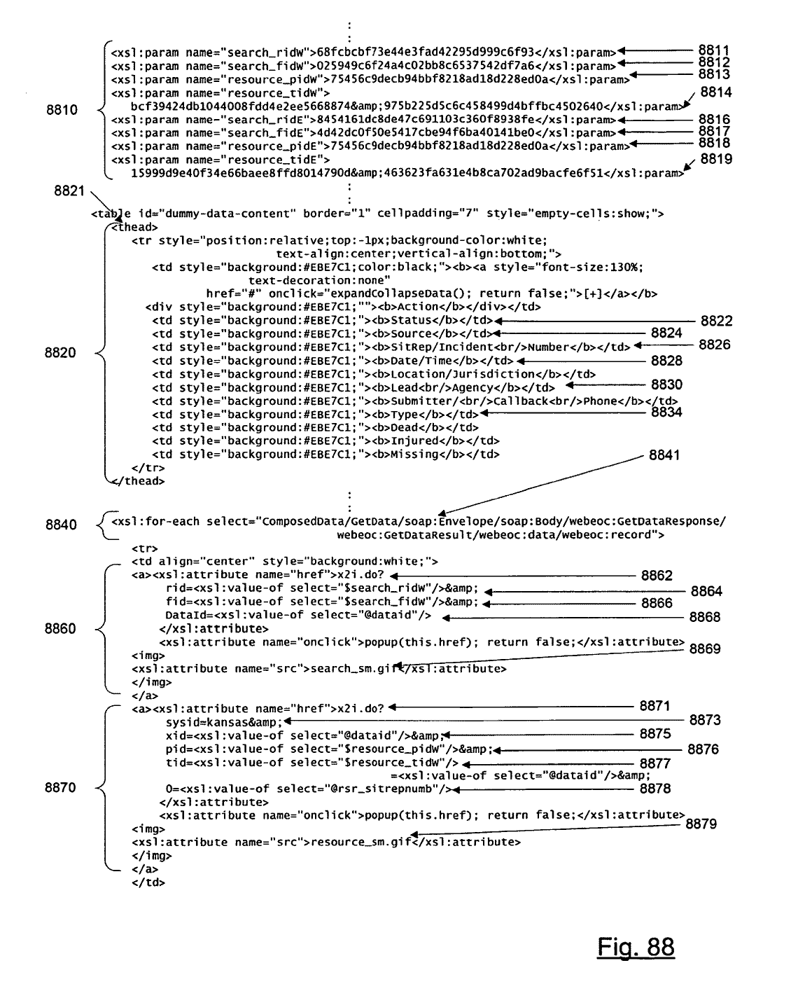

Turning to the script in detail, FIGS. 88, 89 and 90 show exemplary excerpts from the XSL script 7422 “Table” of the query composer connector 7314 of the example. The XSL script 7422 formats and transforms the information of the information sources to an HTML table, showing in consistent form information about incidents from both the ETEAM and the WebEOC information sources. As XSL scripting, HTML format, and other details are known in the art, some details of the script of the present example are omitted in the following for brevity, as they are readily understood. Certain parts of the script not relevant to the present explanation are explained elsewhere in this specification in more detail regarding Data Augmentation.

The script excerpt 8810 shows initialization of a number of variables. This is explained in more detail elsewhere regarding Data Augmentation.

The excerpt 8820 shows the part of the script that produces the headings for the columns of the HTML table, at the “<thead>” tag 8821. The “Status” line 8822 shows the heading “Status” for the HTML table column for status information about the incident, the “Source” line 8824 shows the heading “Source” for an indicator of the source of the incident information in the row (ETEAM or WebEOC information source), the “Incident Number” line 8826 shows the heading “SitRep/Incident Number” for the incident identifier, the line 8828 shows the heading “Date/Time” for the date and time of the incident, the “Agency” line 8830 shows the heading the “Lead Agency” for the agency with primary responsibility for dealing with the incident, the “Type” line 8834 shows the heading “Type” for the type of incident, and so forth.

The script section 8840 shows the portion of the script that detects the start of portion of the composed information results that is information from the query for the WebEOC information source. This portion of the result is detected by a conditional check 8841 for a tag “ComposedData/GetData/soap:”.

The XSL code of the excerpt 8860 outputs a “spyglass” icon. The excerpt 8870 shows XSL code that outputs a “notebook” icon. These are explained in more detail elsewhere regarding Data Augmentation.

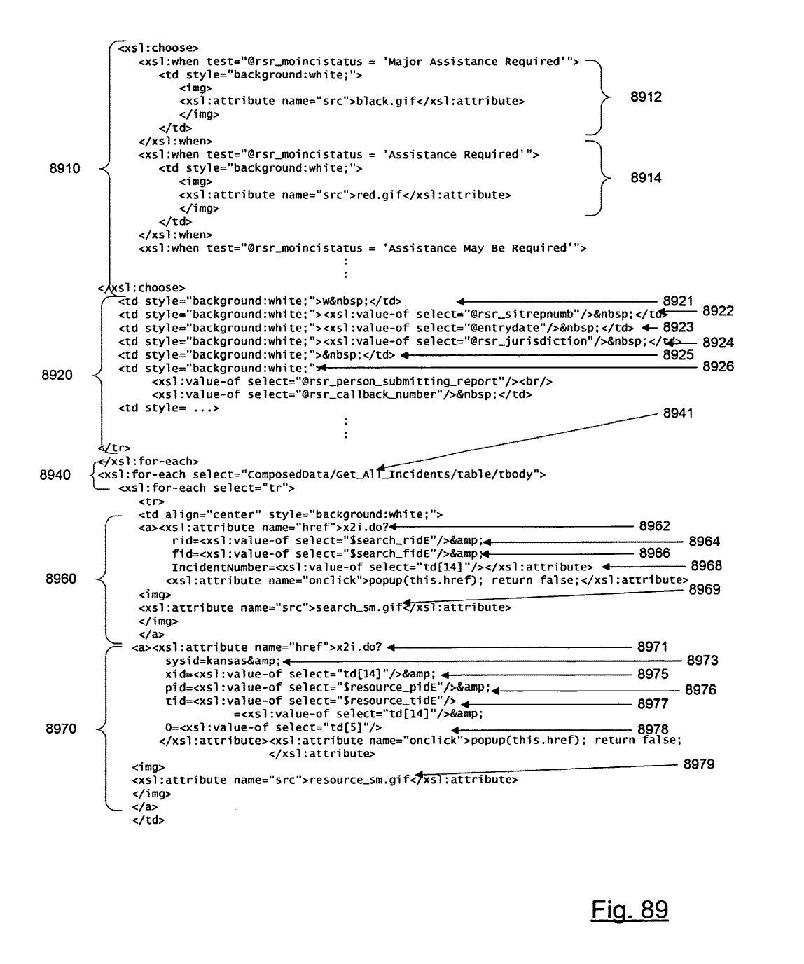

Continuing on FIG. 89, the excerpt 8910 shows the part of the portion of the XSL script that detects the value for the WebEOC field “rsr_moincistatus” for an incident, and outputs a particular icon in the “Status” column 6808 of the row for the incident in the HTML table of the UI 6800. The script code 8912 tests for a value of “Major Assistance Required”, and outputs a black icon containing the characters “MR”. The script code 8914 tests for a value of “Assistance Required”, and outputs a red icon containing the letters “R”. Other values for “rsr_moincistatus” are transformed to a consistent form in a similar fashion.

The script code 8920 illustrates a number of succeeding fields in the HTML table of the UI 6800.

At line 8921, the XSL script outputs a “W” for the “Source” column 6810 to represent that the information was obtained from the WebEOC information source. It should be noted that the WebEOC information result contains no such indicator in its structure.

At line 8922, the XSL script outputs the value of the “rsr_sitrepnumb” field of the information result for the “SitRep/Incident Number” column 6812.

At line 8923, the XSL script outputs the value of the “entrydate” field of the information result for the “Date/Time” column 6814.

At line 8924, the XSL script outputs the value of the “rsr_jurisdiction” field for the “Location/Jurisdiction” column 6816.

In this example, the WebEOC information source provides no information that would be meaningful for “Lead Agency” column 6818, as such information is not present in the structure of the data from the WebEOC source. At 8925, the XSL script outputs a blank space for the “Lead Agency” column 6818 to represent that no value is present for this information about the incident of the current HTML table row.

At line 8926, the XSL script concatenates and outputs the values of the “rsr_person_submitting_report” and “rsr_callback_number” fields for the “Submitter/Callback Phone” column 6820.

Information for other columns is processed in a similar fashion.

The script processes all the information of incidents from the WebEOC source in a similar fashion for further rows of the HTML table.

As will be readily understood, other information provided by an information source beyond that which is to be shown in the UI's HTML table need be output neither by the XSL script nor by a query in which the XSL script is used. It may in fact be desirable to omit details of information from the output, and to make the information available to a user instead by other means, such as part of information made available using the technique of Data Augmentation of the present invention as described herein.

The script excerpt 8940 shows the part of the script that detects the portion of the data that was obtained from the ETEAM information source by “Get All Incidents” query 7416. This portion of the data is detected by a conditional check for the “ComposedData/Get_All_Incidents” tag, as shown at line 8941.

The XSL code excerpt 8960 outputs a “spyglass” icon. The excerpt 8970 shows XSL code that outputs a “notebook” icon. These are explained in more detail elsewhere regarding “Data Augmentation”.

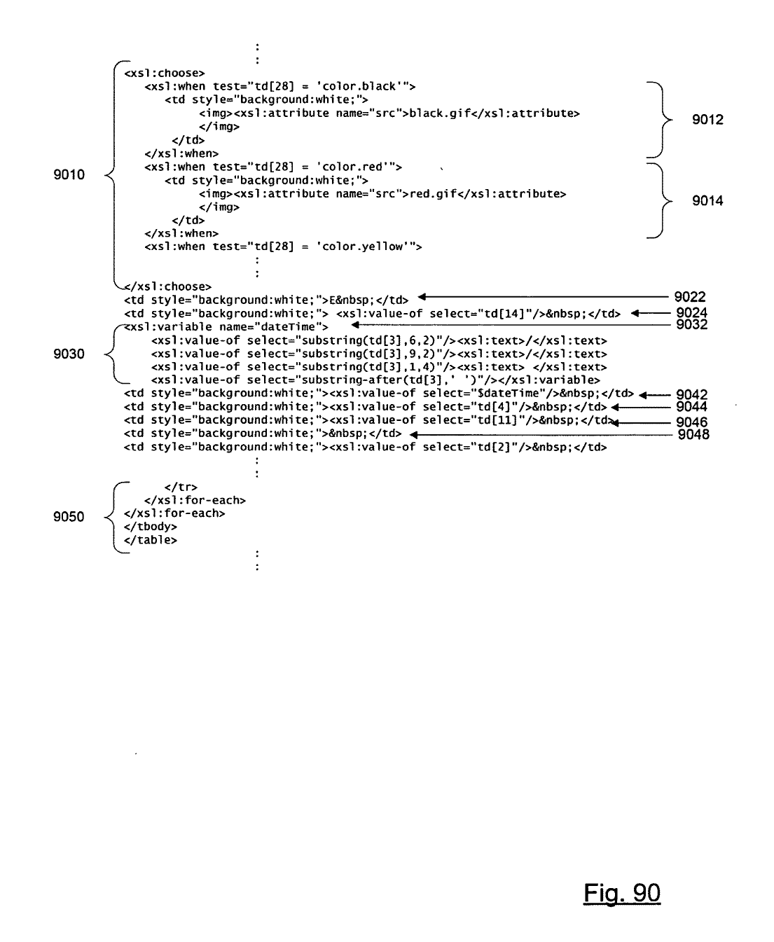

Continuing in FIG. 90, the script section 9010 shows the first part of the script that processes the status information for an incident for information from the ETEAM information source to the desired consistent form for the “Source” column 6808.

In one embodiment of the invention, for the ETEAM information result, the status of an incident is indicated by a color indicator tag, such as “color.black” in the 28th field of the information about an incident. The code excerpt 9012 shows how the XSL script detects a value of “color.black” for the 28th field and represents it by the previously described black icon image 8912. The code excerpt 8914 shows how the script detects a value for the 28th field of “color.red” and represents the status by the previously described red icon image of 8914. Processing of other values representing status is done in a similar fashion, and will be readily understood.

The script line 9022 outputs an “E” for the “Source” column 6810 to represent that the information was obtained from the ETEAM information source. It is worth noting that this information is not provided in the information result from the ETEAM information source.

The script line 9024 outputs the value of the 14th field of the information from the ETEAM information source as the value for the “SitRep/Incident Number” field 6812.

Date/Time values are represented differently in the ETEAM information result than the consistent form desired. The script portion 9030 extracts portions of the value of the third field of the ETEAM information result to construct a value in the desired consistent form and assigns that value to the script variable “dateTime” at line 9032. At line 9042, the value so assigned to the “dateTime” variable is output as the value for the “Date/Time” column 6814.

The script line 9044 outputs the value of the fourth field of the information from the ETEAM information source as the value for the “Location/Jurisdiction” field 6816.

The script line 9046 outputs the value of the eleventh field of the information from the ETEAM information source as the value for the “Lead Agency” field 6818.

In this example, there is no information in the structure of the ETEAM information result that would be appropriate for the “Submitter/Callback” column 6820 of the desired consistent form. The script line 9048 outputs a blank value to represent that there is no information for the “Submitter/Callback” column 6820 for the incident for the current HTML table row.

Information for other columns is processed in a similar fashion, and is readily understood.

The foregoing is exemplary, and many other embodiments of the inventive techniques and their use are possible, and they may be applied to other kinds of information. As described. Other kinds of UIs may also be employed. For example, in some embodiments the UI is audible and at least part of the information to be merged is multimedia or haptic data, and information that is multimedia data may be merged by multimedia mixing according to the techniques.

### Alternative Source for and Reuse of Information Results in Connector Queries:

As noted above, experience with an embodiment of the Connector application showed that there was a need for a way for a user conveniently to allow results obtained with connectors to be obtained from an alternative source other than the information source of the connector. In some systems, it might be appropriate and useful to obtain and reuse a previously-obtained information result rather than executing a connector's query to make a further parameterized information request of an external information source.

The system of the present invention solves this problem of a convenient technique for allowing results to be obtained from a source other than the information source of a connector by employing a configurable property in a connector query for an alternative source for obtaining information results. In one embodiment, a configurable caching capability is added to the connectors of the system of the Connector application, and stored values matching previously-performed queries are used as the alternative source.

FIG. 77 shows a screenshot of an embodiment of a UI for defining an optional caching property for a connector query according to the techniques of the present invention. A user defining a connector query may define an optional caching property by entering a number of seconds in the “Cached Time” field 7714. If a value is entered for this property of the query, the value is stored in a record related to the connector query in the T_CONNECTOR_QUERY_PARAM table as the value of a name/value pair. When the connector query is executed and such a record for the query exists, the system stores results obtained from a parameterized information request for this query for this period of time after obtaining the results. If the same query with the same binding values is to be performed again during this period of time, the system does not perform the parameterized information request again, and instead returns a stored result.

Techniques for caching as known generally in the art are marked by such limitations as: requiring a user to master complexities of configuration and implementation; requiring a user to master multiple implementations specific to particular information sources, kinds of information sources, or different means such as protocols of obtaining information from information sources; the caching being configurable only globally and/or not being configurable specifically such as for different information sources or queries; the caching not being dependent on the general content of the information of the query but only on information specific to caching itself such as a caching time value; and combinations of such limitations. These and other limitations are overcome with the techniques of the present invention.

An embodiment of the present system employs the techniques of hashing and of hashmaps, which are known in the art and thus need not be explained in detail.

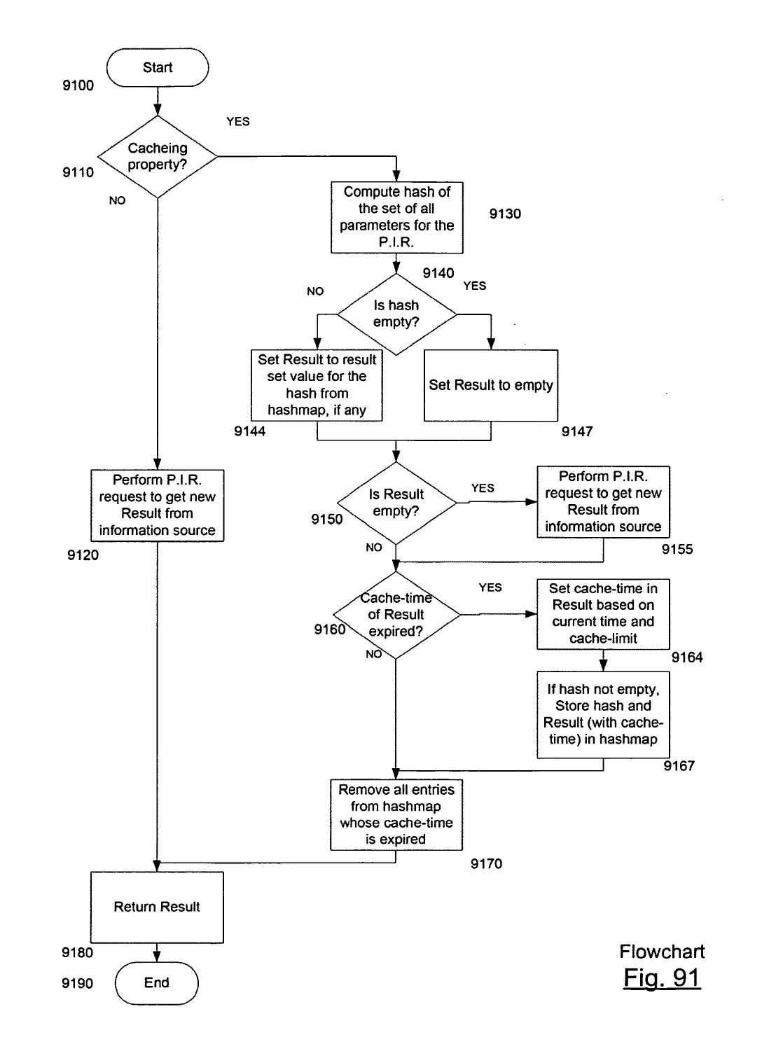

FIG. 91 shows a flowchart of the steps performed by an embodiment of a connector query caching method according to the present invention.

In the system of the Connector application, when a connector query was to be performed, the system would perform the parameterized information request of the query to get a new information result from an information source, as shown at step 9120, and return the information result as the result of the connector query, as shown at step 9180.

For one embodiment of connector query caching, the system contains a singleton hashmap data structure that maps hash values derived from query bindings to information result values and cache-time values. The hashmap data structure is stored by the system.

In an embodiment of the present system, this action is performed as shown in FIG. 91. When a connector query is to be performed (step 9100) the system first determines whether a caching property has been defined for the query (step 9110). If not, the system performs the parameterized information requests of the query as before (step 9120), returns the information result (step 9180), and is done (step 9190). If a caching property has been defined, the system computes a hash of the set of parameters for the parameterized information request of the query (step 9130) and determines whether the computed hash is empty (step 9140). If the hash value is not empty, the system determines the hashmap entry corresponding to the hash value; if there is a hashmap entry, the information result for the connector query is set to the information result of the hashmap entry; if there is not, the information result is set to an empty value (step 9144). If the hash value is empty, the information result for the connector query is set to an empty value (step 9147).

Following whichever of steps 9144 or 9147 is performed, the system determines whether the information result is empty (step 9150). If the information result is not empty, the system proceeds to step 9160. If the information result is empty, the system performs the parameterized information request of the connector query to obtain an information result from the information source of the connector, and this becomes the information result for the connector query (step 9155); the system then proceeds to step 9160.

At step 9160, the system determines whether the cache-time value of the hashmap entry (if there was a hashmap entry found at step 9144) has expired. If it has not expired, the system proceeds to step 9170. If it has expired (or no hashmap entry was found), the system computes a cache-time value from the current time and the number of seconds in the caching property of the connector query (step 9164). Subsequently, if the hash value is not empty, the hash value, information result, and cache-time value are added to the hashmap (step 9167), and the system proceeds to step 9170.

At step 9170, the system removes from the hashmap all those entries having a cache-time value that has expired. After step 9170, the system proceeds to step 9180 to return the information result as the result of the connector query, and is done (step 9190).

Many variations and embodiments of the techniques of the present invention are possible. Among these, instead of a cache-time property, an implementation may make use of information from the information source or another source about another property of the information result or the query. For example, a cost-to-obtain value may be computed for an information result that may be obtained for an information source that charges for providing information, and used to determine whether a previously-cached information result should be used as the result for the connector query, or whether a current result should be cached. As another example, a connector query or connector property may specify a value for determining a desired timeliness of a result, or a maximum latency for obtaining a result, and this information may be used to determine whether a previously-cached information result should be returned, an information result should be obtained from another alternative information source, or whether a current result should be cached.

Further, the techniques are not limited to use with connectors. For example, an embodiment may provide for an alternative-source property to be associated with types of connectors, particular resources, particular queries, or other objects of the system, or for such a property to be associated in another manner.

Other means of storing information results, other techniques than hashing or hashmaps, and other means for employing alternative sources may of course also be employed, such as one or more lists, associative functions, trees, relational tables, or other data structures. Further variations include making a parameterized information request of an alternative information source rather than using a previously-cached value, for example to optimize performance costs, such as if the latency of making the request of an information source is known to vary and an alternative information source may have a lesser latency.

### Data Augmentation.

As noted above, experience with an embodiment of the system of the Connector application showed there was a need for a sufficiently easy way for users define resources making use of data augmentation, and for users to use augmented data with resources of the system.

The method and system of the present invention solve this problem by providing techniques for data augmentation to associate an additional resource or additional information with a portion of another resource.

In one embodiment of the techniques in a system according to the present invention, when a user clicks on a particular element of a GUI displaying a first resource, the system displays an additional resource for which the user may add or modify information to augment the information of the original resource. In one such embodiment the additional resource displays information that has been related to a portion of the first resource. In a further embodiment, the additional resource is a resource of the system in its own right, available for other users to use within the permissions enforced by the system. In other embodiments, more than one such additional resource may be associated with a portion of a first resource.

In some embodiments, a UI element in a UI of the first resource causes a UI for the additional resource or additional information to be displayed at the same time that the user views the UI for the first resource. In other embodiments, the additional information is not part of a resource, and a portion of the information may be obtained by a connector query of the system according to the UI element.

Two exemplary embodiments of data augmentation are shown in the example of FIG. 68. Details of FIG. 68 and other figures that are readily understood are omitted here for clarity and brevity; some details are understood readily in light of other description, including description of Information Merging.

FIG. 68 as previously described shows screenshots displaying information about emergency incidents. Information about incidents is shown in a UI in the HTML table 6822, with information about each incident shown in a distinct row.

In FIG. 68, each row for an incident shows a “spyglass” icon such as spyglass icon 6852, and a “notebook” icon such as notebook icon 6854. In this embodiment, both UI icons 6852 and 6854 indicate that augmented data is available. Both icons are browser link icons that result in a pop-up window of the icon of the browser displaying a web page corresponding to the URL link of the icon. The links of the icons invoke URL APIs of an embodiment of the present system to obtain what is shown in the respective pop-up window, as is explained below.

In some embodiments, a spyglass icon such as spyglass icon 6852 is a UI element indicating that there is additional information related to the portion of the resource where the spyglass icon 6852 appears, and that the user may click on the icon to view the additional information. In the example of FIG. 68, the additional information of a spyglass icon is related to the incident of the portion that is the icon's row of the HTML table 6822.

In some embodiments, a notebook icon 6854 is a UI element indicating that there is an additional resource of the system with information related to the portion of the resource where notebook icon 6854 appears or that such an additional resource can be created. The user may click on the icon to create the additional resource if it does not yet exist, or to view the resource if it does already exist. Subject to the details such as permissions of the particular embodiment, the user may edit or add some portion of the information of the additional resource. In one embodiment, the additional resource is a full-fledged resource of the system in its own right. In the example embodiment of FIG. 68, the additional resource displays information related to the incident of the icon's row of the HTML table 6822

We turn first to the operation of a spyglass icon such as spyglass icon 6852.

In the example of FIG. 68, a spyglass icon such as spyglass icon 6852 displays additional information related to the emergency incident of the spyglass icon's row. Another term that may be applied in this context is that the user may use the spyglass icon to “drill down” to see more detailed or additional information related to the incident. One benefit is that a UI such as that of FIG. 68 may be made less cluttered and more understandable, as information about an incident conveniently may be shown at different levels as the user wishes, yet still in association.

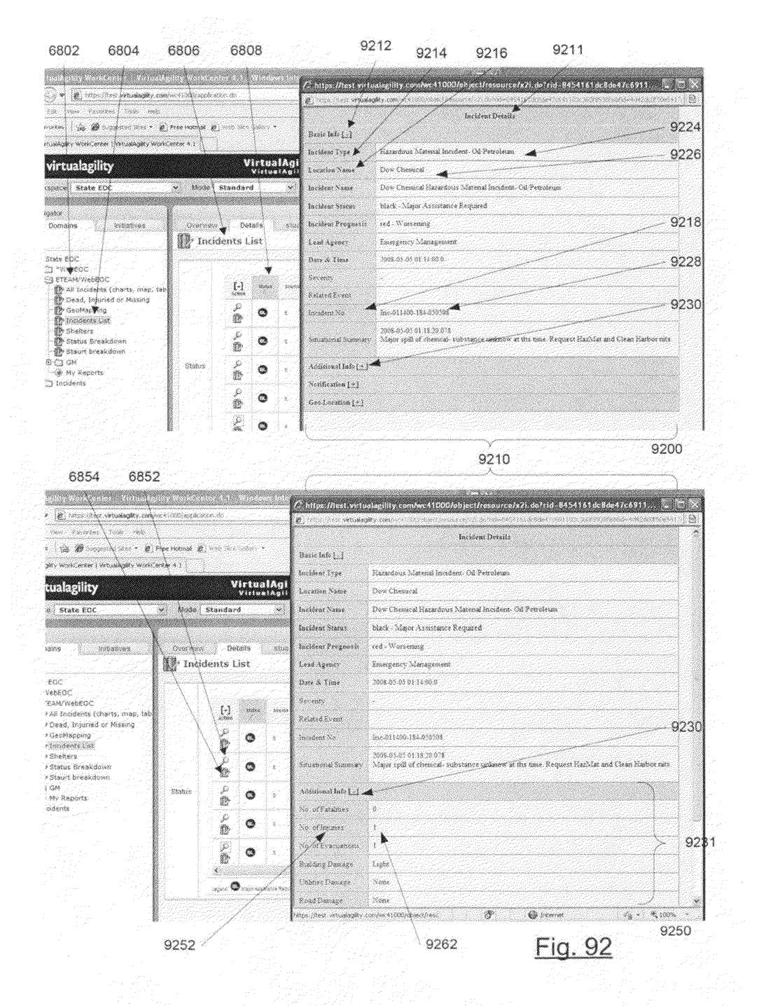

FIG. 92 illustrates the effect of clicking on a spyglass icon such as the spyglass icon 6852 of the UI of FIG. 68. FIG. 92 shows two views 9200 and 9250 of the same UI. Both views show the UI window 9210 brought up by a user clicking on the spyglass icon 6852. In view 9250, the user has scrolled the HTML table 6822 of a first resource to reveal the bottommost row of the table, and expanded the “Additional Info” section 9230 in the pop-up window 9210 of the view 9200. Visible in views 9200 and 9250 are portions of the UI of FIG. 68. Elements 6802, 6804, 6806, 6808 of FIG. 68 are visible in view 9200, and the spyglass icon 6852 and the notebook icon 6854 are visible in view 9250.

In view 9200, the title “Incident Details” 9211 is the title of the pop-up UI window 9210. In this example, the information shown in the window 9210 is divided among a number of divisions of the UI that can be expanded or collapsed to reveal more or less of the information. In one embodiment, the expanding and collapsing of the divisions is implemented with JavaScript of the browser UI, using techniques known in the art. In other embodiments, other techniques for manipulating the UI may be used, and the UI may not be a browser UI.

The label “Basic Info” 9212 shows a first expandable/collapsible division. Clicking on the “-” icon at the label “Basic Info” 9212 will cause the division down to division label “Additional” info 9230 to collapse. In the division “Basic Info” 9212 are shown an “Incident Type” 9214 field having a value “Hazardous Material Incident—Oil/Petroleum” 9224, a “Location Name” field 9216 having a value “Dow Chemical” 9226, an “Incident No.” field 9218 having a corresponding value 9228, and other fields and values.

View 9250 shows the division 9231 of the division “Additional Info” 9230 after the user has clicked on the “+” icon of the division 9230 in the view 9200 to expand the division 9230. Visible are the field “No. of Injuries” 9252 and corresponding value “1” 9262 and other labels and values.

We now turn to the implementation of the spyglass icon in an embodiment.

When the user clicks on a spyglass icon 6852, the browser UI uses known scripting techniques of the browser to call a URL-based API of the system. The API call passes parameters to an action page of the system identifying a connector query to be performed, and may also pass additional values to be used in performing the query. Different implementations for the URL-based API may identify the connector query in different ways, such as by an identifier of the connector query in the system, or by identifiers of a resource and of a connector field of the resource associated with the connector query, or by identifiers of a template and of a connector field of the template, or by other means.

One embodiment of the present system implements privilege rules that determine which objects of the system a given user may access. If the privilege rules permit, then the system performs the connector query with the appropriate bindings (as defined for the connector, template, and/or resource identified), and returns the result obtained by the connector query to the browser UI. The browser UI subsequently displays the result in a pop-up UI window, as shown for the exemplary pop-up UI window 9210 of FIG. 92. In some embodiments, the connector query performed may include an XSL script that produces HTML, JavaScript or other information to be provided to the browser UI for the pop-up window, for example JavaScript for collapsing and expanding divisions of the pop-up window's UI.

In an embodiment, as the connector query identified by the parameters of the API may be any desired connector query of the system, the information displayed in the pop-up window in response to the user clicking on the spyglass icon may be from any number of information sources, and may include information that has been related in any desired fashion by the definitions of connectors, templates, resources, scripts, or other objects of the system to the portion of the first source in a desired way. As the UI of one such embodiment is a browser UI, script programming of the browser may be employed to obtain values for parameters from any part of the UI, or from any other source, for example by using techniques known for AJAX and other browser programming.

Note that more than one such UI element and more than one spyglass icon may be associated with the same portion of a resource. For example, an embodiment of the present system may be employed to associated more than one “spyglass” icon in association with the same portion of a resource. Such an embodiment may desirable for any of a number of reasons, such as for convenience, or to enable a user to “drill down” or view additional information for different elements shown in a portion of a resource, or to view different sets of additional information. More than one icon, such as a different icon, may also be employed. Any information that can be provided by the system that a user may wish to associate with a portion of a resource may of course be associated using these techniques. Furthermore, as is readily appreciated, the techniques are not limited to browser ills or to graphical UIs, or to an embodiment using URLs, but may be employed in any kind of system in which the techniques can be applied.

### Details of the Implementation of the Spyglass Icon in an Embodiment:

Turning now to details of the implementation of the spyglass icon 6852, we now describe portions of the XSL script of FIG. 88 relating to the spyglass icons 6852. Details for the script that are readily understood are omitted for brevity and clarity.

The script portion 8810 shows initialization of a number of scripting variables. Note that in the following, tables of the system refer to the tables of FIGS. 82, 97, and 83.

The script line 8811 initializes variable “search_ridW” to the unique identifier value of a resource. In other embodiments, identifier values need not be unique, and may be symbolic.

The script line 8812 initializes the variable “search_fidW” to the identifier value of a connector field of the template used to define the resource. As previously described for connectors, the connector field is associated with a particular connector query by means of records in the T_CONNECTOR_and T_CONNECTOR_QUERY tables. Together, the resource identifier value of 8811 and the connector field identifier value of 8812 uniquely identify a particular connector query of the system, and permit the system to determine query parameter bindings at the connector, template, and resource levels.

Similarly, script lines 8816 and 8817 respectively initialize variables “search_ridE” and “search fidE” to identifier values for a resource and a connector field of a template for the case that information is to be shown about incidents of information from the ETEAM information source. Details are omitted, as they are readily understood from the foregoing description of the script 8811 and 8812 for information from the WebEOC information source.

The script portion 8860 implements a spyglass icon in the UI of FIG. 68, for information about an emergency incident obtained from the WebEOC information source. As shown, the script 8869 outputs the image of the spyglass icon as image

The script 8864 defines a named parameter “rid” with the value of the “search_ridW” resource identifier of line 8811.

The script 8866 defines a further named parameter “fie with the value of the “search_fidW” field identifier of line 8812.

The script 8868 defines a further named parameter “DataId” with the value of the “dataid” field of the information about the incident from of the information from the WebEOC information source. In this example, this value will be used in the web page API to specify a binding value for the query identified by the rid and fid parameter values.

Similarly, the script 8960 of FIG. 89 implements a spyglass icon in the UI of FIG. 68 for information obtained from the ETEAM information source, and is similar in function to the script portion 8860 for the WebEOC information source. Readily understood details regarding the script 8960 are omitted, although addition reference numbers such as 8964, 8966, and 8969 are included for as an aid for clarity.

The script 8968 defines a named parameter “IncidentNumber” with the value of the 14th field of the information about the incident from of the information from the ETEAM information source.

When a user clicks on a spyglass icon such as the spyglass icon 6852, a URL like of the URL 9300 shown in FIG. 93 is produced by the user's browser from the link 8862 or 8962 associated with the icon 6852, and the browser sends the URL to the system as a web page request. The example URL 9300 follows the example of the script 8860.

The URL 9300 includes a base part 9305 of the URL identifying a web server of an embodiment, the web page “x2i.do” 9310 of the web server as defined by the script 8862 or 8962 of FIG. 88 and FIG. 89, the parameter “rid” and the associated value 9315 as produced by the script 8864 or 8964, the parameter “fid” and the associated value 9320 as produced by the script 8866 or 8966, and the parameter “DatalD” 9325 and the associated value as produced by the script 8868 or 8968. For the script 8968, the parameter is named “IncidentNumber” as previously described.

To respond to receiving the web page requests of the URL 9300, an embodiment of the present system determines the connector query identified by the URL parameters that are passed. In this example, the system determines the connector query that is to be performed by using the value of the rid parameter 9315 to locate a resource, the fid parameter 9320 to locate the record in the T_RES_TMPLT_FIELD table that is related to the connector query, and locates the connector query's record in the T_CONNECTOR_QUERY table, and from that record, the record of the T_CONNECTOR table for the query's connector. The value of the DataId parameter 9325 is used as a run-time binding value for the query. At this point, all the information needed to execute the query is available to the system including the appropriate query parameter bindings. The system performs the connector query, and returns the result obtained to the browser UI, where it is displayed in the popup window 9210.

The number of runtime parameter values employed in the URL and in the UI may be more or less than that of the exemplary parameter Datald 9325, depending on the particular query to be executed and the desired query parameter bindings.

It should be noted here that the information obtained by the connector query is dynamic. Whenever the user clicks on the spyglass icon, the connector query of the singleton resource is performed and the information obtained is what is displayed. For example, the binding values for the query may be determined dynamically by JavaScript of the browser UI showing the HTML table, and the connector query of the singleton resource may thus be performed using different binding values. Further, the information source from which the connector query obtains information may return different or updated information. In each case, the user may obtain different or more recent information by clicking on the icon anew.

We turn now to the operation of a notebook icon such as the notebook icon 6854.

In the example of FIG. 68, the operation of the notebook icon is to display an additional singleton resource related to the emergency incident of the notebook icon's row. If the additional resource does not yet exist, it is created. The additional resource can contain additional or changed information provided by the user. For example, a user may use the additional resource to add augmenting information about the incident, such as a local identification value or information about emergency staff, or augment the information by providing changed information about the incident, such as providing a different status classification than one that may have been obtained from a particular information source. The additional resource may also show additional information.

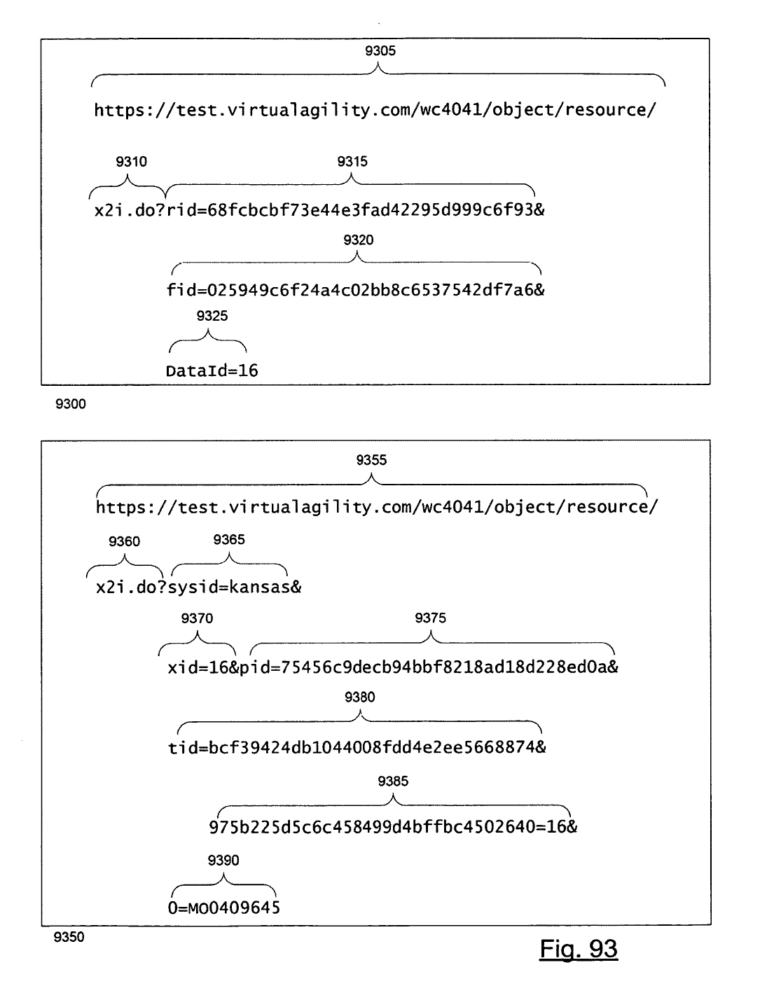

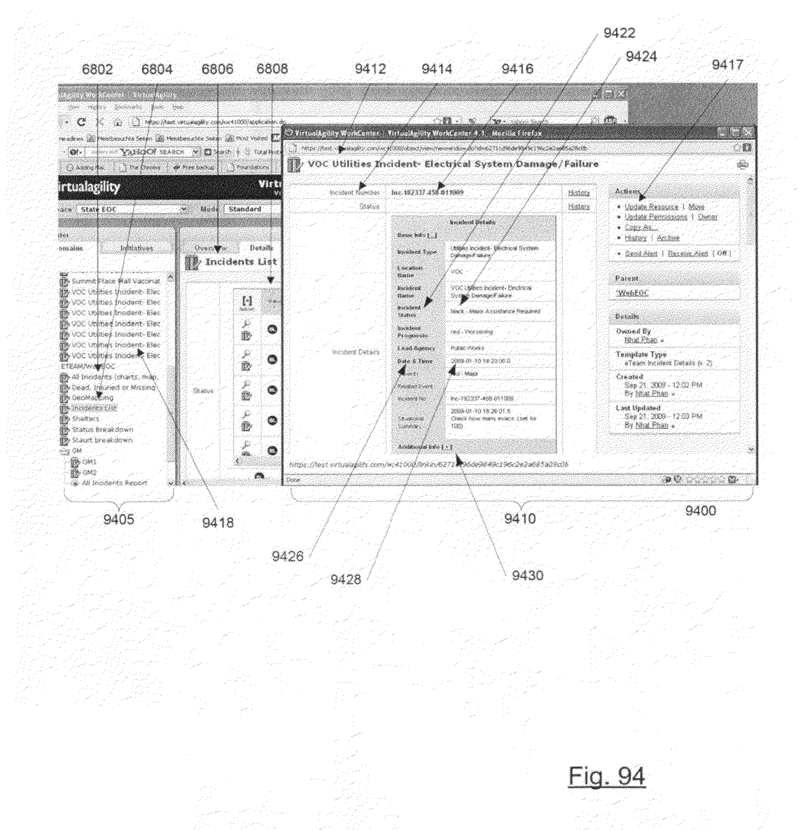

FIG. 94 illustrates what happens in one embodiment when a user clicks on a notebook icon such as the notebook icon 6854 of the UI of FIG. 68. FIG. 94 shows a view 9400 of the UI of FIG. 68 with the pop-up UI window 9410, brought up by a user clicking on the notebook icon 6854. Visible in FIG. 94 is the UI of FIG. 68, including elements 6802, 6804, 6806 and 6808.

In this example, the additional resource (in some embodiments, it is a singleton resource) already exists at the time the user clicks on the notebook icon 6854. Visible in FIG. 94 is title “VOC Utilities Incident—Electrical System Damage/Failure” 9412 of the additional resource pop-up UI window 9410. Also visible are elements of the resource of the window 9410: the field “Incident Number” 9414 shows a value 9416, which is the same value shown for the SitRep identifier value in the incident row of the notebook icon 6854. In this example, this indicates to the user that the information of the window 9410 relates to the incident of the row of the notebook icon 6854.

Also visible are other fields and values of the additional resource, for example the field “Incident Status” 9422 has the corresponding information value “black—Major Assistance Required” 9424, and the field “Date & Time” 9426 has the associated value “2009-01-10 18:23:99” 9428. The GUI element 9430 allows a user to collapse/expand a division of the UI of the pop-up window 9410 to reveal more or less information.

On one embodiment, the additional resource of the pop-up window 9410 is a full-fledged resource in the present system, and may be accessed, manipulated and used as such in the present system. Visible are the “Update Resource” link 9417, which allows the user to edit or change data values of the additional resource. Further, the resource is properly placed in the hierarchy of objects and resources of the system and may be used like any other resource of the system. The position in the hierarchy of the resource shown in the pop-up window 9410 is indicated by its title 9418 being shown in the scrollable hierarchical display UI portion 9405 under its domain name “ETEAM” (the domain name “ETEAM” itself is not visible in FIG. 94).

It should be noted that as the additional resource may be defined using any of the applicable capabilities of the system, such as templates, connectors, and connector queries, the additional resource may of course include any information that may be provided by the system, and the UI may make use of any available UI capabilities: for example, in one embodiment the browser UI of the additional resource may make use of any of the capabilities of a browser, such as AJAX and JavaScript. As will be readily appreciated, the techniques are not limited to browser UIs or client/server implementations such as web servers.

It should also be noted that the additional resource is dynamic. Whenever a user selects the resource, the system will execute the connector queries of the resource and the results of the executions will be incorporated into the resource. For example, a resource such as that associated with the icon 6854 may provide updated information from an external information source. Static information provided at the time the resource is created or last updated by a user for data fields however remains the same, but however the resource may be updated by the user clicking on the “Update” link such as that of the Update link 9417 in FIG. 94.

It should further be noted that more than one additional resource and more than one link may be employed, that the multiple resources need not be of the same form, provide the same information, nor have similar definitions, and that an additional resource may be related to multiple other resources, depending on the embodiment.

### Implementation of the Notebook Icon 6854 of FIG. 68:

Turning to details of the implementation of the notebook icon 6854 in an embodiment, we now describe portions of the XSL script of FIG. 88 in relation to the notebook icon 6854. Details of the script and implementation that are readily understood are omitted.

The script portion 8810 of FIG. 88 shows initialization of a number of scripting variables of the XSL script. The script line 8813 initializes the script variable “resource_pidW” to the value of the unique identifier of the parent object for the singleton resource of the notebook icon 6854, in the hierarchy of objects of the system, for the case that the singleton object is associated with information of an emergency incident from the WebEOC information source.

The script 8814 initializes the script variable “resource_tidW” to a value that is the concatenation of the identifier value of the template of the system that is the template for the singleton resource, and of the identifier value of a field of that template. As shown by the encoded script text “&amp;” the two concatenated identifier values are joined by an ampersand.

Similarly, script 8818 and 8819 initialize script variables regarding the ETEAM information source. As the function is similar to that of script lines 8813 and 8814, it is readily understood, and description is omitted for brevity.

The script portion 8870 implements the notebook icon 6854 in the UI of FIG. 68 for information about an emergency incident obtained from the WebEOC information source. As shown at line 8879, the script of FIG. 88 produces the image of the notebook icon 6854 as image “resource_im.gif” in the first column of the row of the HTML table of FIG. 68. At line 8871, the “<a>” HTML tag associates with the icon of line 8879 with a clickable link for displaying a web page from the system in a pop-up window. As shown at line 8871, the clickable link of line 8871 produces a URL for a page “x2i.do?” of the present system: this page defines a Web URL API of the system. The script also defines a number of URL parameters to be passed to the web page API.

The script 8873 defines a named parameter with the URL parameter name “sysid” with the value “kansas”.

The script 8875 defines a further named parameter with the URL parameter name “xid” with the value of the “dataid” field of the information result about the incident of the HTML row of information from the WebEOC information source.

The uses of the “sysid” and “xid” parameters values are described in detail regarding the SYSTEM_ID and EXTERNAL_ID fields, respectively, of the T_OBJ_X2I_RESOURCE_LNK table 9740 of FIG. 97. FIG. 97 is described below.

The script 8876 defines a further named parameter with the URL parameter name “pid” and the value of the “resource_pidW” script variable assigned in the script portion 8810.

The script 8877 defines a further named parameter with the URL parameter name “tid” and the value of the “resource_tidW” script variable assigned in the script portion 8810, followed by the value of the “dataid” field of the information about the incident of the HTML row.

The script 8878 defines a further parameter with the label “0”, followed by the value of the “rsr_sitrepnumb” field of the information about the incident of the HTML row.

Turning to FIG. 89, the script portion 8970 similarly implements the notebook icon 6854 in the UI of FIG. 68 for information about an emergency incident obtained from the ETEAM information source. As many details are readily understood from the foregoing explanation, they are omitted here for clarity and brevity. Additional reference numbers such as 8971, 8973, 8976, and 8979 are provided for convenience in understanding.

The script 8975 defines a named parameter with the URL parameter name “xid” with the value of the 14th field of the information about the incident of the HTML row of information from the ETEAM information source.

The script 8977 defines a further parameter with the URL parameter name “tid” and the value of the “resource_tidE” script variable, followed by the value of the 14th field of the information about the incident of the HTML row.

The script 8978 defines a further parameter with the label “0”, followed by the value of the fifth field of the information about the incident of the HTML row.

When a user clicks on a notebook icon such as notebook icon 6854, a URL like the URL 9350 in FIG. 93 is produced by the user's browser from the associated link 8871 or 8971, and the browser sends the URL to the system as a web page request. The URL 9350 includes the base part 9355 of the URL for a web server of an embodiment of the present invention, the web page“x2i.do” 9360 as defined by script 8872 or 8971 of FIG. 88 and FIG. 89, the URL parameter “sysid” and the value “kansas” 9365 as produced by the script 8873 or 8973, the parameter “xid” and the associated value “16” 9370 as produced by the script 8875 or 8975, the parameter “pid” and the associated value 9375 as produced by the script 8876 or 8976, the parameter “tid” and the associated value 9380/9385 as produced by the script 8877 or 8977, and the label “0” and the associated value “M00409645” 9390 as produced by the script 8878 or 8978:

In an embodiment, the value of the “pid” parameter 9375 is the identifier of a parent object of the system, and the value of the “tid” parameter is the identifier of a template of the system.

### Operation of the System in Response to the URL of the Notebook Icon 6854:

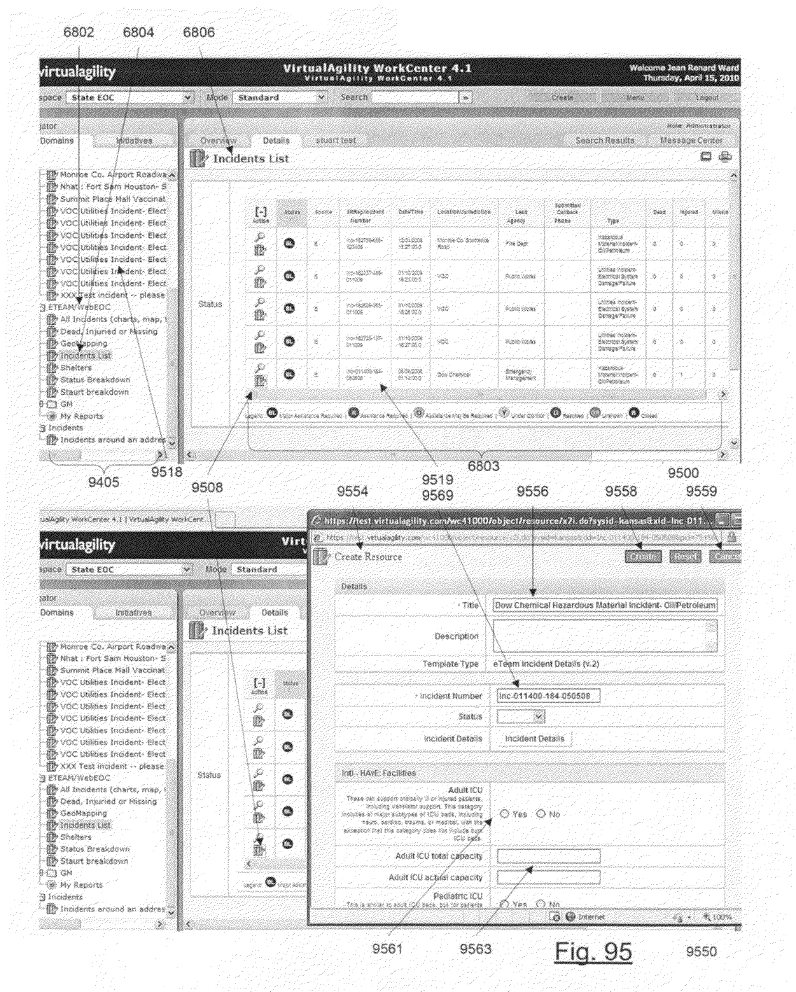

View 9500 of FIG. 95 shows the UI of FIG. 68. Visible are the elements 6802, 6804, and 6806, a portion of the HTML table 6803, and hierarchical UI display portion 9405 that was described for FIG. 94. Also shown are an exemplary notebook icon 9508 for a row of the HTML table IMMA03, and the SitRep/Incident identifier number 9519 for the same row.

When the user clicks on a notebook icon such as the notebook icon 9508 in UI 9500, for the case that the associated resource does not yet exist, the system creates it. As part of creating the resource, the system displays the “Create Resource” UI 9554 as shown in view 9550. Visible is the “Create” link 9558. The user may click on this link to cause the resource to be created in the system with the current input values of data fields of the UI 9554. Also visible is “Cancel” link 9559. The user may click on this link, in which case the system does not create the additional resource.

The resource is defined initially with information defined by the template, template fields, and connector queries of the resource, and may include information determined by parameters provided by the UI and defined by the XSL script of the UI of FIG. 68, or provided as parameters of the URL link of the notebook icon 9508.

Visible are the “Title” data field 9556 showing the name of the incident of the HTML row of the notebook icon 9508, and the “Incident Number” field 9569, showing the same incident number value of the SitRep/Incident number field 9519 of the HTML row of the notebook icon. Also visible is the UI element 9561 “Adult ICU” for the user to enter whether there is an Adult ICU facility available for the emergency incident: as shown, no value is presently defined for this in the resource. Also visible is the data field 9563 “Adult ICU total capacity” for the number of beds available in the Adult ICU unit, which as shown also has no value at present.

UI view 9600 of FIG. 96 shows the UI of the view 9550 in which the user is augmenting the information about the emergency incident by adding certain information, and by changing certain information from what was defined initially for the resource. The field 9606 shows that the user is changing value for the “Title” field of the resource to start with “Zed Alpha Chemical” rather than “Dow Chemical”. The field 9607 shows that the user is selecting a value of “Critical” for the “Status” field using a drop-down selection list of the UI. The field 9611 shows that the user is selecting “Yes” as the value of the “Adult ICU” field of the resource. The field 9613 shows that the user is entering the value “15” for the number of beds available in the Adult ICU unit.

After augmenting the information of the resource (or not), the user subsequently may click on the “Create” link 9558 to create the singleton resource.

The UI View 9650 shows the UI of the system after the user has clicked on the “Create” link 9558, and the resource has been created.

In an embodiment, the additional resource is at this point a full-fledged resource of the system. The name of the resource is now shown in the UI of the object hierarchy at position 9670, in its relation to its parent object. The field 9656 shows the value for the title of the resource as augmented by the user at the field 9606. The field 9657 shows the “Status” value of “Critical” that the user provided to augment information at the field 9607. The fields 9661 and 9663 show the information augmented by the user at the fields 9611 and 9613, respectively. The resource can also be updated by the user clicking on the “Update Resource Link 9565 and editing values of the resource.

### Further Details of Implementation of Data Augmentation in the Relational Database of an Embodiment:

FIG. 97 shows details of additions made to tables of the system of the Connector application in implementing an embodiment of data augmentation. FIG. 97 is a simplified E-R diagram like that of FIG. 39. Fields that relate to database maintenance, details already described, and other details that are readily understood have been omitted for clarity. Dotted outlines around tables or fields indicate that these have been added in an embodiment of the system of the present application, and were not present in earlier embodiments of systems of the Collaboration or Connector applications.

In one embodiment of the present system, when a user clicks on a notebook icon such as 6854, the system determines the associated additional resource and displays it, creating the additional resource if the resource does not already exist. What is in the resource and how it is displayed is determined by the definition of the resource in the system. In one embodiment, the additional resource is related to the particular icon and the icon to the resource by mean of records of tables shown in FIG. 97.

FIG. 97 shows the T_OBJ_RESOURCE table 9710, containing the fields ID and RES_TMPL_ID. Further details of this table have been described previously and are omitted, as they are readily understood.

Also shown is the new table T_OBJ_{—}2I_RESOURCE_LNK 9740, with the fields ID, SYSTEM_ID, EXTERNAL_ID, and RESOURCE_ID. In each record of the T_OBJ_X2I_RESOURCE_LNK table 9740, the value of the ID field is a unique identifier for the record. The value of the SYSTEM_ID field is an identifier for a particular external information source; for example, it may be a unique identifier assigned by a user writing an XSL script for data augmentation. The value of the EXTERNAL_ID field is an identifier value obtained from the external information source that identifies information provided by the external information source: for example, it may be the identifier value of a particular incident within an external information source that maintains records about incidents, and be an identifier that may be used in a parameterized information request to obtain information about the incident from the external information source

Together the SYSTEM_ID value and the EXTERNAL_ID value constitute a sufficient identifier within the system for Collaborative work for an identifier of a particular external information source, whereas the EXTERNAL_ID value alone might not be sufficient, as two external information sources might use the same identifier value independently within themselves as identifiers for their own information.

Each record of the table T_OBJ_X2I_RESOURCE_LNK 9740 is related to a resource by the identifier value of the RESOURCE_ID field, which identifies the particular record of the T_OBJ_RESOURCE table 9710 for a particular resource. This is indicated by the relational arrow 9741. In one embodiment, as is the case with all resources, a resource's record in the T_OBJ_RESOURCE table 9710 includes an identifier (the value of the RES_TMPL_ID field 9712) for the template to be used to create the resource and to provide the GUI used to manipulate the resource.

A particular notebook icon is related to its additional resource by the UI associating with the notebook icon a URL (also referred to in this context as a link) with URL parameters whose values are the values of the SYSTEM_ID and EXTERNAL_ID fields of a row in the T_OBJ_X2I_RESOURCE_LNK table 9740. In an embodiment, the value of the SYSTEM_ID value is chosen to be such that the SYSTEM_ID and EXTERNAL_ID values together constitute an identifier value for mapping a notebook icon to its additional resource, the additional resource being identified by the value of the RESOURCE_ID_field. Once a row in the T_OBJ_X2I_RESOURCE_LNK table has been made, the row can be used to relate the icon to its additional resource.

### The Notebook Icon Action:

When a user clicks on a notebook icon, an embodiment of the system responds by the UI generating a URL for a web-page API as previously described, and displaying the associated additional resource as provided by the system in response to the system receiving the URL.

In general, the URLs and API of the present system work as follows: the web page of URL portion 9360 invokes Java code that performs actions represented by the icons. Java code of the web page “x2i.do” 9360 looks for a record in the table T_OBJ_X2I_RESOURCELNK 9740 with the values for SYSTEM_ID and EXTERNAL_ID that match the values of the URL “sysid” parameter 9365 and the URL “xid” parameter 9370, respectively. If such a record exists, there is already an additional resource for the desired query in the system, and the identifier for the additional resource is the value of the RESOURCE_ID field in the table row. The system obtains the resource, executing the queries for connector fields of the resource, and the resource is displayed in the UI.

If no such record exists for the resource in the T_OBJ_X2I_RESOURCE_LNK table, the resource has to be created. To create the resource, the system uses the value of the “tid” parameter 9380 for the template of the resource, and the value of the “pid” parameter 9375 to identify the desired parent object of the resource in the object hierarchy of the system. The system uses additional parameters of the URL link such as elements 9385 and 9390 as binding parameter values for connector queries of the resource. The system displays a “Create Resource” UI as shown at the UI 9554 in FIG. 95 in view 9550, and the user can then create the resource.

In the particular embodiment shown, some of the information shown in the “Create Resource” UI 9554 to create the resource is obtained from connector queries defined in the resource's template, and some may be provided by URL parameters of the notebook icon as provided by the UI. In view 9550, the value for the “Title” UI field 9556 and for the “Incident Number” field 9569 come from a query. However, as described for view 9600 in FIG. 96, the user who is creating the resource may alter or overwrite a portion of the information. In the example of the view 9600, information for the “Description” UI field 9608 is however not obtained from a query and may be provided by the user who is creating the resource, the same as is the case for “Status” UI element 9607.

### Applications for the Techniques in Relation to Augmented Data:

The examples of the various figures show a number of uses of the techniques of augmented data, though it is impossible to enumerate all possible uses or embodiments of the techniques of the present invention here. The UIs of the examples are from an exemplary application of the system for collaborative work in which the system is used by a regional or state emergency operations center to monitor situation reports from local and regional responders. In such an application, the techniques make it possible to augment reports being monitored with additional information such as by associating a state Emergency Operations Center status with a report that may be different from any local or any national status for the report. The techniques also make it possible to associate a state-level or other Emergency Operations Center incident ID with the report. Because the augmenting data is separate from the information obtained from an external information source, for example information of the original report, there is no need for the external information to be concerned with the augmentations.

Many other applications and uses are of course apparent upon consideration. While data augmentation is particularly valuable when it is used with resources that employ connectors to obtain information, it can also be employed in any situation where an external identifier needs to be related additional information. For example, in an application in which a system for collaborative work is used to manage health care in a health care facility, the external identifier may be a customer ID number that identifies a patient to the patient's health insurance provider. Data augmentation as described herein can be used to associate the external customer ID number with an object that contains data concerning the health service that the health care facility provides to the patient, or vice versa.

Data augmentation can of course be used in other embodiments and systems than those of the present example, including systems that provide information to users in other forms and fashions, such as streaming data, and augmented data may itself be of other forms. Data augmentation may also be employed in embodiments for information from an information source that is not an external information source, embodiments in which information may be related to other information in other ways other than those described, and resources, objects and queries may be identified by parameters or identifiers that are different from those of the examples.

### CONCLUSION

The foregoing Detailed Description has described to those skilled in the relevant technologies how to make and use Applicants' improved techniques for connectors in a system for collaborative work. The Detailed Description has further disclosed how to implement the techniques in an improved system for collaborative work, and has disclosed graphical user interfaces for use with embodiments of the techniques as well as the apparatus of the techniques. In all cases, the disclosures have set forth the best mode presently known to the Applicants for practicing their techniques.

It will, however, be immediately apparent to those skilled in the relevant arts that the principles of Applicants' techniques may be implemented in many other ways. For example, Applicants' improved techniques for connectors have been added to a pre-existing system and many of the characteristics of the preferred embodiment are determined by the system in which the preferred embodiment is implemented. That is particularly the case as regards the manner in which the improved connectors relate to other connectors, to resource templates and to resources.

Additionally, in one presently-preferred embodiment, techniques for data augmentation and information merging involve the use of connector, template, and resource objects and particular relations among them. Embodiments of the techniques of the present invention may involve other relations and other kinds of objects. Further, there are many ways of implementing the objects used to represent connectors other than those disclosed herein. For example the objects need not be implemented as rows in database tables, and if they are, the subdivision of information among the tables may be different from that of the preferred embodiment.

For all of the foregoing reasons, the Detailed Description is to be regarded as being in all respects exemplary and not restrictive, and the breadth of the invention disclosed herein is to be determined not from the Detailed Description, but rather from the claims as interpreted with the full breadth permitted by the patent laws.

What is claimed is:

1. A system for combining data from parameterized information requests to a plurality of information sources, comprising:
a data storage that stores objects including:
connector objects representing classes of parameterized information requests;
request parameter objects defining request parameters for parameterized information requests belonging to the classes; and
information source access objects specifying attributes of a plurality of information sources which will receive instances of the parameterized information requests that belong to each class, the plurality of information sources providing information in different formats; and
a processor capable of accessing the data storage, the processor including:
a query creation module that creates the instances of parameterized information requests for the plurality of information sources by using the objects stored in the data storage; and
a combination module that combines results of the parameterized information requests from the plurality of information sources.

2. The system of claim 1, wherein the combination module further comprises a formatting module that formats the results of the parameterized information requests from the plurality of information sources into a predetermined format.

3. A system for specifying an object for combining data using parameterized information requests to a plurality of information sources, comprising:
a data storage that stores objects including:
connector objects representing types of parameterized information requests;
request parameter objects defining request parameters for parameterized information requests belonging to the types; and
information source access objects specifying attributes of a plurality of information sources which will receive instances of the parameterized information requests that belong to each types, the plurality of information sources providing information in different formats; and
a processor capable of accessing the data storage, the processor creating the instances of parameterized information requests for the plurality of information sources by using the objects stored in the data storage.

4. A system for providing a user with a graphical user interface, the graphical user interface permitting specification of a combining object in a data storage for combining data using parameterized information requests to a plurality of information sources, the system being implemented using a processor that produces and responds to inputs from the graphical user interface and has access to the combining object and to the data storage, the system comprising:
a specification in the graphical user interface of the combining object,
objects in the data storage including:
a combining object created by the system in response to the specification;
connector objects representing types of parameterized information requests;
request parameter objects defining request parameters for parameterized information requests belonging to the types; and
information source access objects specifying attributes of a plurality of information sources that will receive instances of the parameterized information requests that belong to each types, the plurality of information sources providing information in different formats;
the processor creating the instances of parameterized information requests for the plurality of information sources by using the objects stored in the data storage.
